(19) United States
(12) Patent Application Publication
(10) Pub. No.: US 2025/0362486 A1
(43) Pub. Date: Nov. 27, 2025

(54) VARIABLE MAGNIFICATION OPTICAL SYSTEM AND IMAGING APPARATUS

(71) Applicant: FUJIFILM Corporation, Tokyo (JP)

(72) Inventors: Takuya TANAKA, Saitama-shi (JP); Motoari OTA, Saitama (JP); Daiki KAWAMURA, Saitama-shi (JP)

(73) Assignee: FUJIFILM Corporation, Tokyo (JP)

(21) Appl. No.: 19/292,272

(22) Filed: Aug. 6, 2025

Related U.S. Application Data
(63) Continuation of application No. PCT/JP2024/002025, filed on Jan. 24, 2024.

(30) Foreign Application Priority Data
Feb. 22, 2023 (JP) 2023-026733

(51) Int. Cl. G02B 15/14

(52) U.S. Cl. CPC G02B 15/1461

(57) ABSTRACT

A variable magnification optical system consists of, a front group, an intermediate group, and a rear group in this order from an object side. The front group consists of two or fewer lens groups having a positive refractive power. The intermediate group consists of two or fewer lens groups having a negative refractive power. The rear group consists of a plurality of lens groups. All spacings between adjacent lens groups are changed during magnification change. The variable magnification optical system satisfies predetermined conditional expressions.

### CROSS-REFERENCE TO RELATED APPLICATIONS

This application is a continuation application of International Application No. PCT/JP2024/002025, filed on Jan. 24, 2024, which claims priority from Japanese Patent Application No. 2023-026733, filed on Feb. 22, 2023. The entire disclosure of each of the above applications is incorporated herein by reference.

### BACKGROUND

### Technical Field

The technology of the present disclosure relates to a variable magnification optical system and an imaging apparatus.

### Related Art

In the related art, a zoom lens disclosed in WO2014/155463A is known as a variable magnification optical system that can be used in an imaging apparatus such as a digital camera.

### SUMMARY

There has been a demand for a variable magnification optical system that is compactly configured, that has a small F-number over an entire magnification change range, and that maintains good optical performance throughout the magnification change range. The levels of these requirements have been increasing year by year.

The present disclosure has been made in view of the above-described circumstances, and an object of the present disclosure is to provide a variable magnification optical system that is compactly configured, that has a small F-number over an entire magnification change range, and that maintains good optical performance throughout the magnification change range, and an imaging apparatus comprising the variable magnification optical system.

An aspect of the present disclosure relates to a variable magnification optical system consisting of a front group, an intermediate group, and a rear group in this order from an object side to an image side, in which the front group consists of two or fewer lens groups having a positive refractive power, the intermediate group consists of two or fewer lens groups having a negative refractive power, the rear group consists of a plurality of lens groups, all spacings of adjacent lens groups change during magnification change, and in a case in which a sum of a distance on an optical axis from a lens surface of the front group closest to the object side to a lens surface of the rear group closest to the image side and a back focus of an entire system in terms of an air-equivalent distance, in a state in which an infinite distance object is in focus at a wide angle end, is denoted by TLw, a focal length of the entire system in a state in which the infinite distance object is in focus at a telephoto end is denoted by ft, an open F-number in a state in which the infinite distance object is in focus at the telephoto end is denoted by Fnot, a sum of the distance on the optical axis from the lens surface of the front group closest to the object side to the lens surface of the rear group closest to the image side and the back focus of the entire system in terms of the air-equivalent distance, in a state in which the infinite distance object is in focus at the telephoto end, is denoted by TLt, a focal length of the entire system in a state in which the infinite distance object is in focus at the wide angle end is denoted by fw, and a maximum half angle of view in a state in which the infinite distance object is in focus at the telephoto end is denoted by ωt, Conditional Expressions (1), (2), and (3) are satisfied, which are represented by 0.39<TLw/ft<0.89 (1), 2.2<Fnot×(TLt/ft)<4.5 (2), and 2<fw/(ft×tan ωt)<4.5 (3).

In the variable magnification optical system according to the above-described aspect, it is preferable that Conditional Expression (4) is satisfied, which is represented by 5<TLt/(ft×tan ωt)<10.5 (4).

In the variable magnification optical system according to the above-described aspect, it is preferable that in a case in which a maximum half angle of view in a state in which the infinite distance object is in focus at the wide angle end is denoted by ωw, Conditional Expression (5) is satisfied, which is represented by 7<ft/(fw×tan ωw)<12 (5).

In the variable magnification optical system according to the above-described aspect, it is preferable that Conditional Expressions (1-1) and (2-1) are satisfied, which are represented by 0.43<TLw/ft<0.83 (1-1), and 2.2<Fnot×(TLt/ft)<3.9 (2-1).

In the variable magnification optical system according to the above-described aspect, it is preferable that Conditional Expression (6) is satisfied, which is represented by 3.8<TLw/(ft×tan ωt)<8 (6).

In the variable magnification optical system according to the above-described aspect, it is preferable that in a case in which a distance on the optical axis from an image plane to a paraxial exit pupil position in a state in which the infinite distance object is in focus at the wide angle end is denoted by Dexw, a sign of Dexw is defined with the image plane as a reference such that a distance on the image side is positive and a distance on the object side is negative, and Dexw is calculated by, in a case which an optical member having no refractive power is disposed between the image plane and the paraxial exit pupil position, using the air-equivalent distance for the optical member, Conditional Expression (7) is satisfied, which is represented by −2.5<fw/Dexw<−0.91 (7).

In the variable magnification optical system according to the above-described aspect, it is preferable that an aperture stop is disposed between a lens surface of the intermediate group closest to the image side and the lens surface of the rear group closest to the image side, and in a case in which a distance on the optical axis from the lens surface of the front group closest to the object side to the aperture stop in a state in which the infinite distance object is in focus at the wide angle end is denoted by DDL1STw, Conditional Expression (8) is satisfied, which is represented by 0.1<DDL1STw/TLw<0.6 (8).

In the variable magnification optical system according to the above-described aspect, it is preferable that an aperture stop is disposed between a lens surface of the intermediate group closest to the image side and the lens surface of the rear group closest to the image side, and in a case in which a distance on the optical axis from the lens surface of the front group closest to the object side to the aperture stop in a state in which the infinite distance object is in focus at the wide angle end is denoted by DDL1STw, and a focal length of a lens group of the front group closest to the object side is denoted by fl, Conditional Expression (9) is satisfied, which is represented by 0.09<DDL1STw/fl<0.6 (9).

In the variable magnification optical system according to the above-described aspect, it is preferable that an aperture stop is disposed between a lens surface of the intermediate group closest to the image side and the lens surface of the rear group closest to the image side, and in a case in which a distance on the optical axis from the lens surface of the front group closest to the object side to the aperture stop in a state in which the infinite distance object is in focus at the wide angle end is denoted by DDL1STw, and a maximum half angle of view in a state in which the infinite distance object is in focus at the wide angle end is denoted by ωw, Conditional Expression (10) is satisfied, which is represented by 1<DDL1STw/{(fw×tan ωw)×log(ft/fw)}<10 (10).

In the variable magnification optical system according to the above-described aspect, it is preferable that at least one focusing group that moves along the optical axis during focusing is disposed in the variable magnification optical system, and in a case in which a focusing group in which an absolute value of a lateral magnification in a state in which the infinite distance object is in focus at the telephoto end is greatest, among the focusing groups of the variable magnification optical system, is defined as a maximum focusing group, the lateral magnification of the maximum focusing group in a state in which the infinite distance object is in focus at the telephoto end is denoted by βfoc, and a composite lateral magnification of all lenses closer to the image side than the maximum focusing group in a state in which the infinite distance object is in focus at the telephoto end is denoted by βfocR, Conditional Expression (11) is satisfied, which is represented by 1.5<|(1−βfoc²)×βfocR²|<10 (11).

In the variable magnification optical system according to the above-described aspect, it is preferable that only two focusing groups that move along the optical axis during focusing are disposed in the variable magnification optical system, and in a case in which a lateral magnification of the focusing group on the object side among the two focusing groups in a state in which the infinite distance object is in focus at the telephoto end is denoted by βfocA, a composite lateral magnification of all lenses closer to the image side than the focusing group on the object side in a state in which the infinite distance object is in focus at the telephoto end is denoted by βfocAR, a lateral magnification of the focusing group on the image side among the two focusing groups in a state in which the infinite distance object is in focus at the telephoto end is denoted by βfocB, and a composite lateral magnification of all lenses closer to the image side than the focusing group on the image side in a state in which the infinite distance object is in focus at the telephoto end is denoted by βfocBR, Conditional Expression (12) is satisfied, which is represented by 0.1<|(1−βfocA²)×βfocAR²|/|(1−βfocB²)×βfocBR²|<0.8 (12).

In the variable magnification optical system according to the above-described aspect, it is preferable that an anti-vibration group that moves in a direction intersecting with the optical axis during image shake correction is disposed closer to the image side than the front group, and in a case in which a lateral magnification of the anti-vibration group in a state in which the infinite distance object is in focus at the telephoto end is denoted by βOIS, and a composite lateral magnification of all lenses closer to the image side than the anti-vibration group in a state in which the infinite distance object is in focus at the telephoto end is denoted by βOISR, Conditional Expression (13) is satisfied, which is represented by 1<|(1−βOIS)×βOISR1<4.5 (13).

In the variable magnification optical system according to the above-described aspect, it is preferable that at least one focusing group that moves along the optical axis during focusing is disposed in the variable magnification optical system, and the anti-vibration group is disposed closer to the object side than at least one focusing group. The anti-vibration group may be disposed in the intermediate group. Alternatively, the anti-vibration group may be disposed in the rear group.

In the variable magnification optical system according to the above-described aspect, it is preferable that an aperture stop is disposed between a lens surface of the intermediate group closest to the image side and the lens surface of the rear group closest to the image side, and in a case in which a distance on the optical axis from the lens surface of the front group closest to the object side to the aperture stop in a state in which the infinite distance object is in focus at the telephoto end is denoted by DDL1STt, Conditional Expression (14) is satisfied, which is represented by 0.2<DDL1STt/TLt<0.8 (14).

In the variable magnification optical system according to the above-described aspect, it is preferable that an aperture stop is disposed between a lens surface of the intermediate group closest to the image side and the lens surface of the rear group closest to the image side, and in a case in which a distance on the optical axis from the lens surface of the front group closest to the object side to the aperture stop in a state in which the infinite distance object is in focus at the telephoto end is denoted by DDL1STt, and a focal length of a lens group of the front group closest to the object side is denoted by fl, Conditional Expression (15) is satisfied, which is represented by 0.015<DDL1STt/fl<0.3 (15).

In the variable magnification optical system according to the above-described aspect, it is preferable that in a case in which a distance on the optical axis from the lens surface of the front group closest to the object side to a paraxial entrance pupil position in a state in which the infinite distance object is in focus at the wide angle end is denoted by Denw, and a maximum half angle of view in a state in which the infinite distance object is in focus at the wide angle end is denoted by ωw, Conditional Expression (16) is satisfied, which is represented by 1.5<Denw/{(fw×tan ωw)×log(ft/fw)}<8 (16).

In the variable magnification optical system according to the above-described aspect, it is preferable that in a case in which a distance on the optical axis from the lens surface of the front group closest to the object side to a paraxial entrance pupil position in a state in which the infinite distance object is in focus at the wide angle end is denoted by Denw, Conditional Expression (17) is satisfied, which is represented by 0.1<Denw/(fw×ft)^{1/2}<0.65 (17).

In the variable magnification optical system according to the above-described aspect, it is preferable that Conditional Expression (18) is satisfied, which is represented by 0.8<Fnot/(ft/fw)<2 (18).

In the variable magnification optical system according to the above-described aspect, it is preferable that Conditional Expression (19) is satisfied, which is represented by 0.45<TLt/ft<1.3 (19).

In the variable magnification optical system according to the above-described aspect, it is preferable that in a case in which the back focus of the entire system in terms of the air-equivalent distance in a state in which the infinite distance object is in focus at the wide angle end is denoted by Bfw, Conditional Expression (20) is satisfied, which is represented by 0.25<Bfw/(ft×tan ωt)<1.8 (20).

In the variable magnification optical system according to the above-described aspect, it is preferable that a lens group of the front group closest to the object side includes at least one negative lens, and in a case in which a focal length of the lens group of the front group closest to the object side is denoted by fl, and a focal length of a negative lens closest to the object side among the negative lenses included in the lens group of the front group closest to the object side is denoted by fLn1, Conditional Expression (21) is satisfied, which is represented by −1.6<fl/fLn1<−0.1 (21).

In the variable magnification optical system according to the above-described aspect, it is preferable that in a case in which a focal length of a lens group of the front group closest to the object side is denoted by fl, Conditional Expression (22) is satisfied, which is represented by 1<fl/(ft/Fnot)<5.5 (22).

In the variable magnification optical system according to the above-described aspect, it is preferable that in a case in which a focal length of a lens group of the front group closest to the object side is denoted by fl, Conditional Expression (23) is satisfied, which is represented by 0.5<fl/(fw×ft)^{1/2}<3.5 (23).

In the variable magnification optical system according to the above-described aspect, it is preferable that in a case in which a focal length of a lens group of the front group closest to the object side is denoted by fl, Conditional Expression (24) is satisfied, which is represented by 0.8<fl/fw<5 (24).

In the variable magnification optical system according to the above-described aspect, it is preferable that a lens group of the front group closest to the object side includes at least one negative lens, and in a case in which an average value of Abbe numbers of all positive lenses in the lens group of the front group closest to the object side based on a d line is denoted by v1pave, Conditional Expression (25) is satisfied, which is represented by 58<v1pave<96 (25).

In the variable magnification optical system according to the above-described aspect, it is preferable that in a case in which a thickness on the optical axis of a lens group of the front group closest to the object side is denoted by dF1, Conditional Expression (26) is satisfied, which is represented by 0.1<dF1/(ft/Fnot)<0.45 (26).

In the variable magnification optical system according to the above-described aspect, it is preferable that in a case in which an effective diameter of the lens surface of the front group closest to the object side is denoted by EDf, Conditional Expression (27) is satisfied, which is represented by 0<EDf/TLt<0.5 (27).

In the variable magnification optical system according to the above-described aspect, it is preferable that in a case in which an effective diameter of the lens surface of the front group closest to the object side is denoted by EDf, and an effective diameter of the lens surface of the rear group closest to the image side is denoted by EDr, Conditional Expression (28) is satisfied, which is represented by 1<EDf/EDr<2.5 (28).

In the variable magnification optical system according to the above-described aspect, it is preferable that in a case in which a focal length of the front group in a state in which the infinite distance object is in focus at the wide angle end is denoted by fFw, and a focal length of the intermediate group in a state in which the infinite distance object is in focus at the wide angle end is denoted by fMw, Conditional Expression (29) is satisfied, which is represented by 0.6<fFw/(−fMw)<5 (29).

In the variable magnification optical system according to the above-described aspect, it is preferable that in a case in which a spacing on the optical axis between a lens group of the front group closest to the object side and a lens group of the intermediate group closest to the image side in a state in which the infinite distance object is in focus at the wide angle end is denoted by dFMw, and a spacing on the optical axis between the lens group of the front group closest to the object side and the lens group of the intermediate group closest to the image side in a state in which the infinite distance object is in focus at the telephoto end is denoted by dFMt, Conditional Expression (30) is satisfied, which is represented by 0.15<dFMw−dFMt|/TLt<0.6 (30).

In the variable magnification optical system according to the above-described aspect, it is preferable that in a case in which a focal length of the rear group in a state in which the infinite distance object is in focus at the wide angle end is denoted by fRw, Conditional Expression (31) is satisfied, which is represented by 0.7<fw/fRw<4 (31).

In the variable magnification optical system according to the above-described aspect, it is preferable that in a case in which a focal length of the rear group in a state in which the infinite distance object is in focus at the telephoto end is denoted by fRt, Conditional Expression (32) is satisfied, which is represented by 0.5<ft/fRt<6.5 (32).

The rear group may consist of a first subsequent lens group having a positive refractive power, a second subsequent lens group having a negative refractive power, a third subsequent lens group having a positive refractive power, a fourth subsequent lens group having a negative refractive power, and a fifth subsequent lens group having a negative refractive power, in this order from the object side to the image side. With such a configuration, in the variable magnification optical system according to the above-described aspect, it is preferable that in a case in which a focal length of the first subsequent lens group is denoted by fRA1, a focal length of the second subsequent lens group is denoted by fRA2, a focal length of the third subsequent lens group is denoted by fRA3, a focal length of the fourth subsequent lens group is denoted by fRA4, and a focal length of the fifth subsequent lens group is denoted by fRA5, at least one of Conditional Expression (33), (34), or (35) is satisfied, Conditional Expressions (33), (34), and (35) being represented by 0.5<fRA1/fRA3<4 (33), 0.5<fRA2/fRA4<8 (34), and 0.05<fRA4/fRA5<3 (35).

The rear group may consist of a first subsequent lens group having a positive refractive power, a second subsequent lens group having a positive refractive power, a third subsequent lens group having a negative refractive power, a fourth subsequent lens group having a positive refractive power, and a fifth subsequent lens group having a negative refractive power, in this order from the object side to the image side. With such a configuration, in the variable magnification optical system according to the above-described aspect, it is preferable that in a case in which a focal length of the first subsequent lens group is denoted by fRB1, a focal length of the second subsequent lens group is denoted by fRB2, a focal length of the third subsequent lens group is denoted by fRB3, a focal length of the fourth subsequent lens group is denoted by fRB4, and a focal length of the fifth subsequent lens group is denoted by fRB5, at least one of Conditional Expression (36), (37), or (38) is satisfied, Conditional Expressions (36), (37), and (38) being represented by 0.1<fRB1/fRB2<9 (36), 0.2<fRB1/fRB4<9 (37), and 0.1<fRB3/fRB5<3 (38).

The rear group may consist of a first subsequent lens group having a positive refractive power, a second subsequent lens group having a positive refractive power, and a third subsequent lens group having a negative refractive power, in this order from the object side to the image side. With such a configuration, in the variable magnification optical system according to the above-described aspect, it is preferable that in a case in which a focal length of the first subsequent lens group is denoted by fRC1, and a focal length of the second subsequent lens group is denoted by fRC2, Conditional Expression (39) is satisfied, which is represented by 0.1<fRC1/fRC2<2 (39)

The rear group may consist of a first subsequent lens group having a positive refractive power, a second subsequent lens group having a positive refractive power, a third subsequent lens group having a negative refractive power, and a fourth subsequent lens group having a negative refractive power, in this order from the object side to the image side. With such a configuration, in the variable magnification optical system according to the above-described aspect, it is preferable that in a case in which a focal length of the first subsequent lens group is denoted by fRD1, a focal length of the second subsequent lens group is denoted by fRD2, a focal length of the third subsequent lens group is denoted by fRD3, and a focal length of the fourth subsequent lens group is denoted by fRD4, at least one of Conditional Expression (40) or (41) is satisfied, Conditional Expressions (40) and (41) being represented by 0.2<fRD1/fRD2<3.5 (40), and 0.05<fRD3/fRD4<2 (41).

The rear group may consist of a first subsequent lens group having a positive refractive power, a second subsequent lens group having a negative refractive power, a third subsequent lens group having a positive refractive power, a fourth subsequent lens group having a negative refractive power, a fifth subsequent lens group having a positive refractive power, and a sixth subsequent lens group having a negative refractive power, in this order from the object side to the image side. With such a configuration, in the variable magnification optical system according to the above-described aspect, it is preferable that in a case in which a focal length of the first subsequent lens group is denoted by fRE1, a focal length of the second subsequent lens group is denoted by fRE2, a focal length of the third subsequent lens group is denoted by fRE3, a focal length of the fourth subsequent lens group is denoted by fRE4, a focal length of the fifth subsequent lens group is denoted by fRE5, and a focal length of the sixth subsequent lens group is denoted by fRE6, at least one of Conditional Expression (42), (43), (44), or (45) is satisfied, Conditional Expressions (42), (43), (44), and (45) being represented by 0.1<fRE1/fRE3<3.5 (42), 0.1<fRE3/fRE5<3.5 (43), 0.2<fRE2/fRE4<15 (44), and 0.05<fRE4/fRE6<3 (45).

The rear group may consist of a first subsequent lens group having a positive refractive power, a second subsequent lens group having a negative refractive power, a third subsequent lens group having a positive refractive power, and a fourth subsequent lens group having a negative refractive power, in this order from the object side to the image side. With such a configuration, in the variable magnification optical system according to the above-described aspect, it is preferable that in a case in which a focal length of the first subsequent lens group is denoted by fRF1, a focal length of the second subsequent lens group is denoted by fRF2, a focal length of the third subsequent lens group is denoted by fRF3, a focal length of the fourth subsequent lens group is denoted by fRF4, at least one of Conditional Expression (46) or (47) is satisfied, Conditional Expressions (46) and (47) being represented by 0.1<fRF1/fRF3<2 (46), and 0.1<fRF2/fRF4<2.5 (47).

The rear group may consist of a first subsequent lens group having a positive refractive power, a second subsequent lens group having a positive refractive power, a third subsequent lens group having a positive refractive power, a fourth subsequent lens group having a negative refractive power, and a fifth subsequent lens group having a negative refractive power, in this order from the object side to the image side. With such a configuration, in the variable magnification optical system according to the above-described aspect, it is preferable that in a case in which a focal length of the first subsequent lens group is denoted by fRG1, a focal length of the second subsequent lens group is denoted by fRG2, a focal length of the third subsequent lens group is denoted by fRG3, a focal length of the fourth subsequent lens group is denoted by fRG4, and a focal length of the fifth subsequent lens group is denoted by fRG5, at least one of Conditional Expression (48), (49), or (50) is satisfied, Conditional Expressions (48), (49), and (50) being represented by 0.01<fRG1/fRG2<1 (48), 0.01<fRG3/fRG2<1 (49), and 0.5<fRG4/fRG5<5 (50).

The rear group may consist of a first subsequent lens group having a positive refractive power, a second subsequent lens group having a positive refractive power, a third subsequent lens group having a negative refractive power, and a fourth subsequent lens group having a positive refractive power, in this order from the object side to the image side. With such a configuration, in the variable magnification optical system according to the above-described aspect, it is preferable that in a case in which a focal length of the first subsequent lens group is denoted by fRH1, a focal length of the second subsequent lens group is denoted by fRH2, and a focal length of the fourth subsequent lens group is denoted by fRH4, at least one of Conditional Expression (51) or (52) is satisfied, the Conditional Expressions (51) and (52) being represented by 0.1<fRH1/fRH2<2.5 (51), and 0.1<fRH2/fRH4<2 (52).

The rear group may consist of a first subsequent lens group having a positive refractive power, a second subsequent lens group having a negative refractive power, and a third subsequent lens group having a positive refractive power, in this order from the object side to the image side. With such a configuration, in the variable magnification optical system according to the above-described aspect, it is preferable that in a case in which a focal length of the first subsequent lens group is denoted by fRI1, and a focal length of the third subsequent lens group is denoted by fRI3, Conditional Expression (53) is satisfied, which is represented by 0.1<fRI1/fRI3<2 (53).

Another aspect of the present disclosure relates to an imaging apparatus comprising: the variable magnification optical system according to the above-described aspect of the present disclosure.

It should be noted that, in the present specification, the expressions “consists of” and “consisting of” indicate that a lens substantially not having a refractive power, an optical element other than a lens, such as a stop, a filter, and a cover glass, a mechanism part such as a lens flange, a lens barrel, an imaging element, and a camera shake correction mechanism may be included in addition to the shown constituents.

The expression “ . . . group having a positive refractive power” in the present specification means that the entire group has a positive refractive power. The expression “ . . . group having a negative refractive power” means that the entire group has a negative refractive power. The expression “ . . . group” in the present specification is not limited to a configuration consisting of a plurality of lenses and may be a configuration consisting of only one lens.

A compound aspherical lens (a lens in which a lens (for example, a spherical lens) and a film of an aspherical shape formed on the lens are integrally formed and that functions as one aspherical lens as a whole) is not regarded as a cemented lens and is regarded as one lens. Unless otherwise noted, a curvature radius, a sign of a refractive power, and a surface shape related to a lens including an aspherical surface in a paraxial region are used.

The expression “entire system” in the present specification means the variable magnification optical system. The expression “back focus in terms of an air-equivalent distance” means an air-equivalent distance on the optical axis from a lens surface of the entire system closest to the image side to the image plane. The expression “focal length” used in the conditional expressions means a paraxial focal length. Unless otherwise noted, the expression “distance on the optical axis” used in the conditional expressions means a geometrical distance. Unless otherwise noted, values used in the conditional expressions are values based on the d line in a state in which the infinite distance object is in focus.

The expressions “d line”, “C line”, and “F line” described in the present specification mean bright lines. A wavelength of the d line is taken as 587.56 nanometers (nm), a wavelength of the C line is taken as 656.27 nanometers (nm), and a wavelength of the F line is taken as 486.13 nanometers (nm).

According to the present disclosure, it is possible to provide the variable magnification optical system that is compactly configured, that has a small F-number over the entire magnification change range, and that maintains good optical performance throughout the magnification change range, and the imaging apparatus comprising the variable magnification optical system.

### BRIEF DESCRIPTION OF THE DRAWINGS

FIG. 1 is a diagram showing a cross-sectional view of a configuration and a movement trajectory of a variable magnification optical system according to one embodiment, which corresponds to a variable magnification optical system according to Example 1.

FIG. 2 is a diagram showing symbols of conditional expressions.

FIG. 3 is a diagram showing an effective diameter.

FIG. 4 is each aberration diagram of the variable magnification optical system according to Example 1.

FIG. 5 is a diagram showing a cross-sectional view of a configuration and a movement trajectory of a variable magnification optical system according to Example 2.

FIG. 6 is each aberration diagram of the variable magnification optical system according to Example 2.

FIG. 7 is a diagram showing a cross-sectional view of a configuration and a movement trajectory of a variable magnification optical system according to Example 3.

FIG. 8 is each aberration diagram of the variable magnification optical system according to Example 3.

FIG. 9 is a diagram showing a cross-sectional view of a configuration and a movement trajectory of a variable magnification optical system according to Example 4.

FIG. 10 is each aberration diagram of the variable magnification optical system according to Example 4.

FIG. 11 is a diagram showing a cross-sectional view of a configuration and a movement trajectory of a variable magnification optical system according to Example 5.

FIG. 12 is each aberration diagram of the variable magnification optical system according to Example 5.

FIG. 13 is a diagram showing a cross-sectional view of a configuration and a movement trajectory of a variable magnification optical system according to Example 6.

FIG. 14 is each aberration diagram of the variable magnification optical system according to Example 6.

FIG. 15 is a diagram showing a cross-sectional view of a configuration and a movement trajectory of a variable magnification optical system according to Example 7.

FIG. 16 is each aberration diagram of the variable magnification optical system according to Example 7.

FIG. 17 is a diagram showing a cross-sectional view of a configuration and a movement trajectory of a variable magnification optical system according to Example 8.

FIG. 18 is each aberration diagram of the variable magnification optical system according to Example 8.

FIG. 19 is a diagram showing a cross-sectional view of a configuration and a movement trajectory of a variable magnification optical system according to Example 9.

FIG. 20 is each aberration diagram of the variable magnification optical system according to Example 9.

FIG. 21 is a diagram showing a cross-sectional view of a configuration and a movement trajectory of a variable magnification optical system according to Example 10.

FIG. 22 is each aberration diagram of the variable magnification optical system according to Example 10.

FIG. 23 is a diagram showing a cross-sectional view of a configuration and a movement trajectory of a variable magnification optical system according to Example 11.

FIG. 24 is each aberration diagram of the variable magnification optical system according to Example 11.

FIG. 25 is a diagram showing a cross-sectional view of a configuration and a movement trajectory of a variable magnification optical system according to Example 12.

FIG. 26 is each aberration diagram of the variable magnification optical system according to Example 12.

FIG. 27 is a diagram showing a cross-sectional view of a configuration and a movement trajectory of a variable magnification optical system according to Example 13.

FIG. 28 is each aberration diagram of the variable magnification optical system according to Example 13.

FIG. 29 is a diagram showing a cross-sectional view of a configuration and a movement trajectory of a variable magnification optical system according to Example 14.

FIG. 30 is each aberration diagram of the variable magnification optical system according to Example 14.

FIG. 31 is a diagram showing a cross-sectional view of a configuration and a movement trajectory of a variable magnification optical system according to Example 15.

FIG. 32 is each aberration diagram of the variable magnification optical system according to Example 15.

FIG. 33 is a diagram showing a cross-sectional view of a configuration and a movement trajectory of a variable magnification optical system according to Example 16.

FIG. 34 is each aberration diagram of the variable magnification optical system according to Example 16.

FIG. 35 is a diagram showing a cross-sectional view of a configuration and a movement trajectory of a variable magnification optical system according to Example 17.

FIG. 36 is each aberration diagram of the variable magnification optical system according to Example 17.

FIG. 37 is a diagram showing a cross-sectional view of a configuration and a movement trajectory of a variable magnification optical system according to Example 18.

FIG. 38 is each aberration diagram of the variable magnification optical system according to Example 18.

FIG. 39 is a diagram showing a cross-sectional view of a configuration and a movement trajectory of a variable magnification optical system according to Example 19.

FIG. 40 is each aberration diagram of the variable magnification optical system according to Example 19.

FIG. 41 is a diagram showing a cross-sectional view of a configuration and a movement trajectory of a variable magnification optical system according to Example 20.

FIG. 42 is each aberration diagram of the variable magnification optical system according to Example 20.

FIG. 43 is a diagram showing a cross-sectional view of a configuration and a movement trajectory of a variable magnification optical system according to Example 21.

FIG. 44 is each aberration diagram of the variable magnification optical system according to Example 21.

FIG. 45 is a diagram showing a cross-sectional view of a configuration and a movement trajectory of a variable magnification optical system according to Example 22.

FIG. 46 is each aberration diagram of the variable magnification optical system according to Example 22.

FIG. 47 is a diagram showing a cross-sectional view of a configuration and a movement trajectory of a variable magnification optical system according to Example 23.

FIG. 48 is each aberration diagram of the variable magnification optical system according to Example 23.

FIG. 49 is a diagram showing a cross-sectional view of a configuration and a movement trajectory of a variable magnification optical system according to Example 24.

FIG. 50 is each aberration diagram of the variable magnification optical system according to Example 24.

FIG. 51 is a diagram showing a cross-sectional view of a configuration and a movement trajectory of a variable magnification optical system according to Example 25.

FIG. 52 is each aberration diagram of the variable magnification optical system according to Example 25.

FIG. 53 is a diagram showing a cross-sectional view of a configuration and a movement trajectory of a variable magnification optical system according to Example 26.

FIG. 54 is each aberration diagram of the variable magnification optical system according to Example 26.

FIG. 55 is a diagram showing a cross-sectional view of a configuration and a movement trajectory of a variable magnification optical system according to Example 27.

FIG. 56 is each aberration diagram of the variable magnification optical system according to Example 27.

FIG. 57 is a diagram showing a cross-sectional view of a configuration and a movement trajectory of a variable magnification optical system according to Example 28.

FIG. 58 is each aberration diagram of the variable magnification optical system according to Example 28.

FIG. 59 is a perspective view of a front surface side of an imaging apparatus according to one embodiment.

FIG. 60 is a perspective view of a rear surface side of the imaging apparatus according to one embodiment.

### DETAILED DESCRIPTION

Hereinafter, embodiments of the present disclosure will be described with reference to the accompanying drawings.

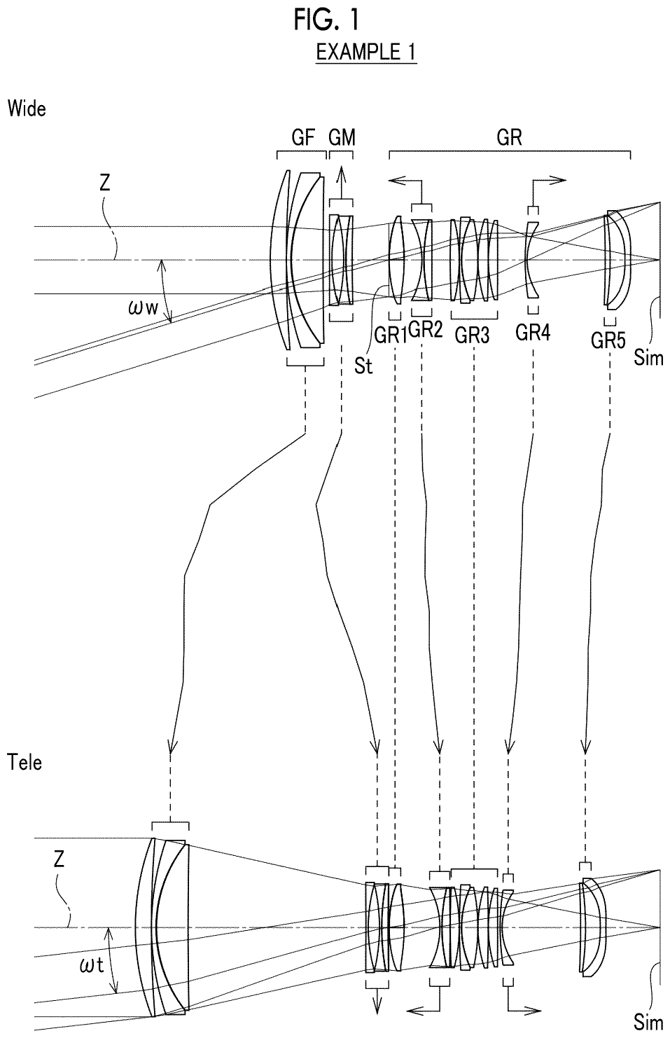

FIG. 1 shows a cross-sectional view of a configuration and a movement trajectory of a variable magnification optical system according to one embodiment of the present disclosure. FIG. 1 shows a wide angle end state in an upper part labeled “Wide”, and a telephoto end state in a lower part labeled “Tele”. The example shown in FIG. 1 corresponds to a variable magnification optical system according to Example 1. In FIG. 1, a state is shown in which an infinite distance object is in focus, a left side is an object side, and a right side is an image side. FIG. 1 also shows an on-axis luminous flux and a luminous flux of a maximum half angle of view ow at the wide angle end and an on-axis luminous flux and a luminous flux of a maximum half angle of view ωt at the telephoto end.

The variable magnification optical system according to the present disclosure consists of a front group GF, an intermediate group GM, and a rear group GR in this order from the object side to the image side along an optical axis Z. The front group GF consists of two or fewer lens groups having a positive refractive power. The intermediate group GM consists of two or fewer lens groups having a negative refractive power. The rear group GR consists of a plurality of lens groups. All spacings between adjacent lens groups are changed during magnification change.

By setting the front group GF as a group having a positive refractive power, it is possible to shorten the total length, and thus there is an advantage in achieving both reduction in size and a high magnification change ratio. In addition, by setting the front group GF as a group having a positive refractive power, a height of a ray incident on the intermediate group GM from the optical axis Z can be decreased, and thus it is advantageous for suppressing fluctuations of aberrations during magnification change. With the configuration in which the front group GF consists of one or two lens groups having a positive refractive power and the intermediate group GM consists of one or two lens groups having a negative refractive power, it is advantageous for changing the magnification while suppressing various aberrations. By changing the spacings between a plurality of groups during magnification change, it is advantageous for suppressing various aberrations in the entire magnification change range.

It should be noted that, in the present specification, a group of which a spacing with an adjacent group in an optical axis direction changes during magnification change is defined as one lens group. During magnification change, a spacing between adjacent lenses is not changed in one lens group. That is, the expression “lens group” means a portion that constitutes the variable magnification optical system and that includes at least one lens divided by an air spacing that is changed during magnification change. During magnification change, each lens group moves or remains stationary in lens group units. The expression “lens group” may include a constituent having no refractive power other than a lens, for example, an aperture stop St.

As an example, each group of the variable magnification optical system shown in FIG. 1 is configured as follows. The front group GF consists of one lens group composed of three lenses. The intermediate group GM consists of one lens group composed of three lenses. The rear group GR consists of five lens groups, that is, a first subsequent lens group GR1 composed of the aperture stop St and one lens, a second subsequent lens group GR2 composed of two lenses, a third subsequent lens group GR3 composed of five lenses, a fourth subsequent lens group GR4 composed of one lens, and a fifth subsequent lens group GR5 composed of two lenses, in this order from the object side to the image side. The aperture stop St shown in FIG. 1 does not indicate a size and a shape, and indicates a position on the optical axis. As in the example in FIG. 1, in a configuration in which the front group GF consists of one lens group, it is advantageous for size reduction. In a configuration in which the intermediate group GM consists of one lens group, it is advantageous for size reduction.

In the example of FIG. 1, during magnification change, the front group GF, the intermediate group GM, the second subsequent lens group GR2, the fourth subsequent lens group GR4, and the fifth subsequent lens group GR5 move along the optical axis Z while changing the spacings between the adjacent lens groups, and the first subsequent lens group GR1 and the third subsequent lens group GR3 remain stationary with respect to the image plane Sim. In FIG. 1, with respect to each group that moves during magnification change, between the diagram of Wide and the diagram of Tele, a solid line arrow indicates a schematic movement trajectory of each group during magnification change from the wide angle end to the telephoto end, and a dotted line in an up-down direction indicates each group that remains stationary with respect to the image plane Sim during magnification change.

Although the example in which the variable magnification optical system is a zoom lens is shown in FIG. 1, the variable magnification optical system according to the present disclosure may be a zoom lens or a varifocal lens.

It is preferable that the variable magnification optical system according to the present disclosure includes at least one focusing group that moves during focusing. Focusing is performed by moving the focusing group. In the example of FIG. 1, the variable magnification optical system includes two focusing groups. In the example of FIG. 1, among the two focusing groups, the focusing group on the object side consists of the second subsequent lens group GR2, and the focusing group on the image side consists of the fourth subsequent lens group GR4. In the example of FIG. 1, during focusing from the infinite distance object to the short range object, the second subsequent lens group GR2 moves to the object side, and the fourth subsequent lens group GR4 moves to the image side. Horizontal arrows attached to the second subsequent lens group GR2 and the fourth subsequent lens group GR4 in FIG. 1 indicate that the second subsequent lens group GR2 and the fourth subsequent lens group GR4 are focusing groups, and indicate directions in which the second subsequent lens group GR2 and the fourth subsequent lens group GR4 move during focusing from the infinite distance object to the short range object.

It is preferable that the variable magnification optical system according to the present disclosure includes an anti-vibration group that moves in a direction intersecting with the optical axis Z during image shake correction. The image shake correction is performed by moving the anti-vibration group. In the example in FIG. 1, the anti-vibration group consists of the intermediate group GM. An upward arrow attached above the intermediate group GM in the diagram of Wide of FIG. 1 and a downward arrow attached below the intermediate group GM in the diagram of Tele of FIG. 1 both indicate that the intermediate group GM is the anti-vibration group.

It is preferable that the anti-vibration group is disposed closer to the image side than the front group GF. In such a case, it is advantageous for reduction in size of the anti-vibration group.

In a case in which the variable magnification optical system includes the anti-vibration group and at least one focusing group, it is preferable that the anti-vibration group is disposed closer to the object side than the at least one focusing group. The amount of fluctuations in aberrations during image shake correction varies depending on the position of the focusing target object, but by disposing the anti-vibration group closer to the object side than the focusing group, the difference in the amount of fluctuations in aberrations during image shake correction for each position of the object to be in focus can be suppressed. In a case in which the variable magnification optical system includes the anti-vibration group and the plurality of focusing groups, in order to obtain the above-described effect more significantly, it is preferable that the anti-vibration group is disposed closer to the object side than all the focusing groups.

The anti-vibration group may be disposed in the intermediate group GM. In such a case, the movement amount of the anti-vibration group during image shake correction can be suppressed. Alternatively, the anti-vibration group may be disposed in the rear group GR. In such a case, the diameter of the moving mechanism of the anti-vibration group can be suppressed, which is advantageous for reduction in size.

Next, preferable configurations and available configurations related to the conditional expressions of the variable magnification optical system according to the present disclosure will be described. It should be noted that, in the following description related to the conditional expressions, duplicate descriptions of symbols will be omitted by using the same symbol for the same definition in order to avoid redundant description. Hereinafter, the term “variable magnification optical system according to the present disclosure” will be simply referred to as the “variable magnification optical system” in order to avoid redundant description.

It is preferable that the variable magnification optical system satisfies Conditional Expression (1). Here, a sum of a distance on the optical axis from the lens surface of the front group GF closest to the object side to the lens surface of the rear group GR closest to the image side and the back focus of the entire system in terms of the air-equivalent distance, in a state in which the infinite distance object is in focus at the wide angle end, is denoted by TLw. A focal length of the entire system in a state in which the infinite distance object is in focus at the telephoto end is denoted by ft. TLw denotes a total length in a state in which the infinite distance object is in focus at the wide angle end. By not allowing the corresponding value of Conditional Expression (1) to be equal to or less than the lower limit, it is easy to suppress various aberrations at the wide angle end. By not allowing the corresponding value of Conditional Expression (1) to be equal to or greater than the upper limit, it is easy to shorten the total length at the wide angle end.

$$0.39 < T L w / ft < 0 \text{.89} \qquad ( 1 )$$

In order to obtain more favorable characteristics, it is preferable that any one of 0.41, 0.43, 0.45, or 0.47 is used instead of 0.39 as the lower limit of Conditional Expression (1). In addition, it is preferable that any one of 0.87, 0.85, 0.83, 0.8, 0.78, 0.76, or 0.7 is used instead of 0.89 as the upper limit of Conditional Expression (1). For example, it is more preferable that the variable magnification optical system satisfies Conditional Expression (1-1).

$$0.43 < T L w / ft < 0 \text{.83} \qquad ( 1 - 1 )$$

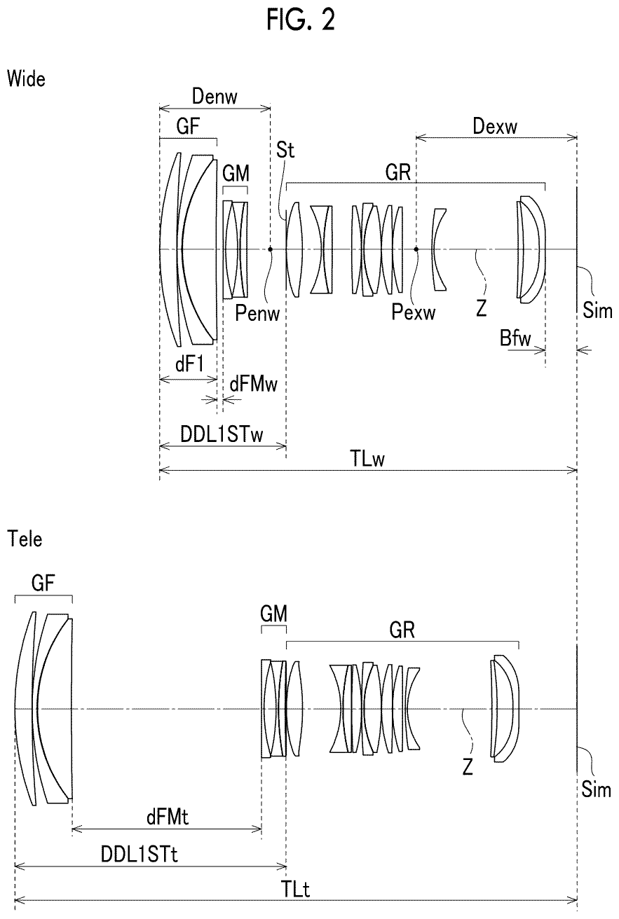

FIG. 2 shows a cross-sectional view of the variable magnification optical system of FIG. 1 and shows, as an example, the total length TLw in the variable magnification optical system. FIG. 2 shows a wide angle end state in an upper part labeled “Wide”, and a telephoto end state in a lower part labeled “Tele”.

It is preferable that the variable magnification optical system satisfies Conditional Expression (2). An open F-number in a state in which the infinite distance object is in focus at the telephoto end is denoted by Fnot. A sum of a distance, on the optical axis, from the lens surface of the front group GF closest to the object side to the lens surface of the rear group GR closest to the image side and the back focus of the entire system in terms of an air-equivalent distance, in a state in which the infinite distance object is in focus at the telephoto end, is denoted by TLt. TLt denotes a total length in a state in which the infinite distance object is in focus at the telephoto end. As an example, FIG. 2 shows the total length TLt. By not allowing the corresponding value of Conditional Expression (2) to be equal to or less than the lower limit, it is easy to suppress various aberrations in the entire magnification change range. By not allowing the corresponding value of Conditional Expression (2) to be equal to or greater than the upper limit, it is advantageous for shortening the total length while decreasing the F-number at the telephoto end.

$$, 2. 2 < Fnot \times ( T L t / ft ) < 4.5 \qquad ( 2 )$$

In order to obtain more favorable characteristics, it is preferable that any one of 2.3, 2.4, or 2.5 is used instead of 2.2 as the lower limit of Conditional Expression (2). In addition, it is preferable that any one of 4.3, 4.1, 3.9, 3.7, 3.5, or 3.3 is used instead of 4.5 as the upper limit of Conditional Expression (2). For example, it is more preferable that the variable magnification optical system satisfies Conditional Expression (2-1).

$$2.2 < Fnot \times ( TLt / ft ) < 3.9 \qquad ( 2 - 1 )$$

It is preferable that the variable magnification optical system satisfies Conditional Expression (3). Here, a focal length of the entire system in a state in which the infinite distance object is in focus at the wide angle end is denoted by fw. A maximum half angle of view in a state in which the infinite distance object is in focus at the telephoto end is denoted by ωt. In Conditional Expression (3), tan is a tangent, and the same applies to the other conditional expressions. By not allowing the corresponding value of Conditional Expression (3) to be equal to or less than the lower limit, it is advantageous for suppressing various aberrations. By not allowing the corresponding value of Conditional Expression (3) to be equal to or greater than the upper limit, it is advantageous for obtaining a wide angle of view at the wide angle end.

$$2 < fw / ( ft \times tan ω t ) < 4.5 \qquad ( 3 )$$

In order to obtain more favorable characteristics, it is preferable that any one of 2.3, 2.6, 2.9, or 3.2 is used instead of 2 as the lower limit of Conditional Expression (3). In addition, it is preferable that any one of 4.3, 4.1, 3.9, or 3.7 is used instead of 4.5 as the upper limit of Conditional Expression (3).

It is preferable that the variable magnification optical system satisfies Conditional Expression (4). By not allowing the corresponding value of Conditional Expression (4) to be equal to or less than the lower limit, the on-axis luminous flux can be gently converged toward the image plane Sim at the telephoto end, and thus it is easy to suppress the axial chromatic aberration occurring during convergence of the luminous flux. By not allowing the corresponding value of Conditional Expression (4) to be equal to or greater than the upper limit, it is easy to shorten the total length at the telephoto end.

$$5 < TLt / ( ft \times tan ω t ) < 10.5 \qquad ( 4 )$$

In order to obtain more favorable characteristics, it is preferable that any one of 5.25, 5.5, 5.75, 6, or 6.25 is used instead of 5 as the lower limit of Conditional Expression (4). In addition, it is preferable that any one of 10.25, 9.95, 9.7, 9.5, or 9.25 is used instead of 10.5 as the upper limit of Conditional Expression (4).

In a case in which a maximum half angle of view in a state in which the infinite distance object is in focus at the wide angle end is denoted by ωw, it is preferable that the variable magnification optical system satisfies Conditional Expression (5). By not allowing the corresponding value of Conditional Expression (5) to be equal to or less than the lower limit, the focal length at the telephoto end is not excessively shortened, so that the value of the variable magnification optical system can be sufficiently exhibited, and particularly, the added value as a telephoto type variable magnification optical system can be ensured. By not allowing the corresponding value of Conditional Expression (5) to be equal to or greater than the upper limit, the magnification change ratio is not excessively increased, so that it is possible to prevent the movement amount of the lens group from being excessively increased, and thus it is advantageous for achieving reduction in size of the entire optical system.

$$7 < ft / ( fw \times tan ω w ) < 12 \qquad ( 5 )$$

In order to obtain more favorable characteristics, it is preferable that any one of 7.25, 7.5, 7.75, 8, or 8.25 is used instead of 7 as the lower limit of Conditional Expression (5). In addition, it is preferable that any one of 11.5, 11, 10.5, or 10 is used instead of 12 as the upper limit of Conditional Expression (5).

It is preferable that the variable magnification optical system satisfies Conditional Expression (6). By not allowing the corresponding value of Conditional Expression (6) to be equal to or less than the lower limit, it is easy to suppress various aberrations in the entire magnification change range. By not allowing the corresponding value of Conditional Expression (6) to be equal to or greater than the upper limit, it is advantageous for achieving reduction in size of the entire optical system.

$$3.8 < TLw / ( ft \times tan ω t ) < 8 \qquad ( 6 )$$

In order to obtain more favorable characteristics, it is preferable that any one of 4, 4.2, or 4.4 is used instead of 3.8 as the lower limit of Conditional Expression (6). In addition, it is preferable that any one of 7.8, 7.6, 7.4, or 7.2 is used instead of 8 as the upper limit of Conditional Expression (6).

It is preferable that the variable magnification optical system satisfies Conditional Expression (7). Here, a distance on the optical axis from the image plane Sim to the paraxial exit pupil position Pexw in a state in which the infinite distance object at the wide angle end is in focus is denoted by Dexw. As an example, FIG. 2 shows the distance Dexw and the paraxial exit pupil position Pexw. A sign of Dexw is defined with the image plane Sim as a reference such that a distance on the image side is positive and a distance on the object side is negative. In a case in which an optical member having no refractive power is disposed between the image plane Sim and the paraxial exit pupil position, Dexw is calculated using the air-equivalent distance for the optical member. By not allowing the corresponding value of Conditional Expression (7) to be equal to or less than the lower limit, it is easy to shorten the total length of the optical system, and thus it is advantageous for reduction in size. By not allowing the corresponding value of Conditional Expression (7) to be equal to or greater than the upper limit, it is easy to reduce the incidence angle of the off-axis principal ray on the image plane Sim, and thus it is advantageous for ensuring the edge part light quantity.

$$- 2 \text{.5} < fw / Dexw < - 0.91 \qquad ( 7 )$$

In order to obtain more favorable characteristics, it is preferable that any one of −2.35, −2.2, or −2 is used instead of −2.5 as the lower limit of Conditional Expression (7). In addition, it is preferable that any one of −0.97, −1.03, −1.09, −1.15, or −1.21 is used instead of −0.91 as the upper limit of Conditional Expression (7).

In a configuration in which the aperture stop St is disposed between the lens surface of the intermediate group GM closest to the image side and the lens surface of the rear group GR closest to the image side, it is preferable that the variable magnification optical system satisfies Conditional Expression (8). Here, a distance on the optical axis from the lens surface of the front group GF closest to the object side to the aperture stop St in a state in which the infinite distance object is in focus at the wide angle end is denoted by DDL1STw. As an example, FIG. 2 shows the distance DDL1STw. By not allowing the corresponding value of Conditional Expression (8) to be equal to or less than the lower limit, the distance between the aperture stop St and the lens group of the front group GF closest to the object side is not excessively shortened, so that the distance from the lens surface of the front group GF closest to the object side to the entrance pupil position is not excessively decreased, and thus it is easy to suppress fluctuations of aberrations during magnification change. By not allowing the corresponding value of Conditional Expression (8) to be equal to or greater than the upper limit, the distance between the aperture stop St and the lens group of the front group GF closest to the object side is not excessively increased, and thus the distance from the lens surface of the front group GF closest to the object side to the entrance pupil position is not excessively increased. Accordingly, it is possible to suppress an increase in diameter of the lens group of the front group GF closest to the object side, and thus it is advantageous for achieving reduction in size.

$$0 \text{.1} < DDL 1 STw / TLw < 0.6 \qquad ( 8 )$$

In order to obtain more favorable characteristics, it is preferable that any one of 0.12, 0.14, 0.16, or 0.18 is used instead of 0.1 as the lower limit of Conditional Expression (8). In addition, it is preferable that any one of 0.58, 0.56, 0.54, or 0.52 is used instead of 0.6 as the upper limit of Conditional Expression (8).

In a configuration in which the aperture stop St is disposed between the lens surface of the intermediate group GM closest to the image side and the lens surface of the rear group GR closest to the image side, it is preferable that the variable magnification optical system satisfies Conditional Expression (9). Here, a focal length of the lens group of the front group GF closest to the object side is denoted by fl. By not allowing the corresponding value of Conditional Expression (9) to be equal to or less than the lower limit, the movable range of the second lens group from the object side during magnification change is not excessively shortened, and thus it is easy to increase the magnification change ratio. Alternatively, since the refractive power of the lens group of the front group GF closest to the object side is not excessively decreased, it is easy to achieve both reduction in size and a high magnification change ratio. By not allowing the corresponding value of Conditional Expression (9) to be equal to or greater than the upper limit, the distance from the lens surface of the front group GF closest to the object side to the entrance pupil position on the wide angle side is not excessively increased, and thus it is possible to prevent the diameter of the lens group of the front group GF closest to the object side from being increased, and it is easy to achieve reduction in size. Alternatively, since the refractive power of the lens group of the front group GF closest to the object side is not excessively increased, it is easy to improve the performance.

$$0.09 < DSDL 1 STw / f 1 < 0.6 \qquad ( 9 )$$

In order to obtain more favorable characteristics, it is preferable that any one of 0.11 or 0.13 is used instead of 0.09 as the lower limit of Conditional Expression (9). In addition, it is preferable that any one of 0.57, 0.54, or 0.51 is used instead of 0.6 as the upper limit of Conditional Expression (9).

In a configuration in which the aperture stop St is disposed between the lens surface of the intermediate group GM closest to the image side and the lens surface of the rear group GR closest to the image side, it is preferable that the variable magnification optical system satisfies Conditional Expression (10). By not allowing the corresponding value of Conditional Expression (10) to be equal to or less than the lower limit, the distance from the lens surface of the front group GF closest to the object side to the entrance pupil position on the wide angle side is not excessively shortened, so that it is easy to suppress fluctuations in aberrations during magnification change. By not allowing the corresponding value of Conditional Expression (10) to be equal to or greater than the upper limit, the distance from the lens surface of the front group GF closest to the object side to the entrance pupil position on the wide angle side is not excessively increased, and thus it is possible to prevent the diameter of the lens group of the front group GF closest to the object side from being increased, and it is easy to achieve reduction in size.

$$1 < DDL 1 STw / \{ ( fw \times tan ω w ) \times log ( ft / fw ) \} < 10 \qquad ( 10 )$$

In order to obtain more favorable characteristics, it is preferable that any one of 1.3, 1.6, 1.9, or 2.2 is used instead of 1 as the lower limit of Conditional Expression (10). In addition, it is preferable that any one of 9.5, 9, 8.5, or 8 is used instead of 10 as the upper limit of Conditional Expression (10).

In a configuration in which at least one focusing group that moves along the optical axis Z during focusing is disposed in the variable magnification optical system, it is preferable that the variable magnification optical system satisfies Conditional Expression (11). Here, among the focusing groups in the variable magnification optical system, the focusing group in which the absolute value of the lateral magnification is greatest in a state in which the infinite distance object is in focus at the telephoto end is defined as a maximum focusing group. A lateral magnification of the maximum focusing group in a state in which the infinite distance object is in focus at the telephoto end is denoted by βfoc. A composite lateral magnification of all lenses closer to the image side than the maximum focusing group in a state in which the infinite distance object is in focus at the telephoto end is denoted by βfocR. In a case in which there is only one focusing group in the variable magnification optical system, the one focusing group is defined as the maximum focusing group. By not allowing the corresponding value of Conditional Expression (11) to be equal to or less than the lower limit, the ratio of the movement amount of the image plane position to the unit movement amount of the focusing group is not excessively decreased, and thus the movement amount of the focusing group during focusing is not excessively increased, and as a result, it is advantageous for achieving both high performance and reduction in size. By not allowing the corresponding value of Conditional Expression (11) to be equal to or greater than the upper limit, the ratio of the movement amount of the image plane position to the unit movement amount of the focusing group is not excessively increased, and thus it is advantageous for achieving both the manufacturing suitability and reduction in size.

$$1. 5 < \vert ( 1 - β {foc}^{2} ) \times β {focR}^{2} \vert < 10 \qquad ( 11 )$$

In order to obtain more favorable characteristics, it is preferable that any one of 1.7, 1.9, 2.1, or 2.3 is used instead of 1.5 as the lower limit of Conditional Expression (11). In addition, it is preferable that any one of 9.6, 9.2, or 8.8 is used instead of 10 as the upper limit of Conditional Expression (11).

In a configuration in which only two focusing groups that move along the optical axis Z during focusing are disposed in the variable magnification optical system, it is preferable that the variable magnification optical system satisfies Conditional Expression (12). Here, a lateral magnification of the focusing group on the object side among the two focusing groups in a state in which the infinite distance object is in focus at the telephoto end is denoted by βfocA. A composite lateral magnification of all lenses closer to the image side than the focusing group on the object side in a state in which the infinite distance object is in focus at the telephoto end is denoted by βfocAR. A lateral magnification of the focusing group on the image side among the two focusing groups in a state in which the infinite distance object is in focus at the telephoto end is denoted by βfocB. A composite lateral magnification of all lenses closer to the image side than the focusing group on the image side in a state in which the infinite distance object is in focus at the telephoto end is denoted by βfocBR. By not allowing the corresponding value of Conditional Expression (12) to be equal to or less than the lower limit, the ratio of the movement amount of the image plane position to the unit movement amount of the focusing group on the object side is not excessively increased, and thus it is advantageous for achieving both high performance and reduction in size. By not allowing the corresponding value of Conditional Expression (12) to be equal to or greater than the upper limit, the ratio of the movement amount of the image plane position to the unit movement amount of the focusing group on the image side is not excessively increased, and thus it is advantageous for achieving both the manufacturing suitability and reduction in size.

$$0 \text{.1} < \vert ( 1 - β {focA}^{2} ) \times β {focAR}^{2} \vert / \vert ( 1 - β {focB}^{2} ) \times β {focBR}^{2} \vert < 0.8 \qquad ( 12 )$$

In order to obtain more favorable characteristics, it is preferable that any one of 0.12, 0.14, 0.16, or 0.18 is used instead of 0.1 as the lower limit of Conditional Expression (12). In addition, it is preferable that any one of 0.75, 0.7, 0.65, or 0.6 is used instead of 0.8 as the upper limit of Conditional Expression (12).

In a configuration in which the anti-vibration group that moves in the direction intersecting with the optical axis Z during image shake correction is disposed closer to the image side than the front group GF, it is preferable that the variable magnification optical system satisfies Conditional Expression (13). Here, a lateral magnification of the anti-vibration group in a state in which the infinite distance object is in focus at the telephoto end is denoted by βOIS. A composite lateral magnification of all lenses closer to the image side than the anti-vibration group in a state in which the infinite distance object is in focus at the telephoto end is denoted by βOISR. By not allowing the corresponding value of Conditional Expression (13) to be equal to or less than the lower limit, the ratio of the movement amount of the image plane position to the unit movement amount of the anti-vibration group is not excessively decreased, and thus the movement amount of the anti-vibration group during image shake correction is not excessively increased, and as a result, it is advantageous for achieving both high performance and reduction in size. By not allowing the corresponding value of Conditional Expression (13) to be equal to or greater than the upper limit, the ratio of the movement amount of the image plane position to the unit movement amount of the anti-vibration group is not excessively increased, and thus it is advantageous for achieving both the manufacturing suitability and reduction in size.

$$1 < \vert ( 1 - β OIS ) \times β OISR \vert < 4.5 \qquad ( 13 )$$

In order to obtain more favorable characteristics, it is preferable that any one of 1.1, 1.2, 1.3, or 1.4 is used instead of 1 as the lower limit of Conditional Expression (13). In addition, it is preferable that any one of 4.2, 3.9, 3.6, or 3.3 is used instead of 4.5 as the upper limit of Conditional Expression (13).

In a configuration in which the aperture stop St is disposed between the lens surface of the intermediate group GM closest to the image side and the lens surface of the rear group GR closest to the image side, it is preferable that the variable magnification optical system satisfies Conditional Expression (14). Here, a distance on the optical axis from the lens surface of the front group GF closest to the object side to the aperture stop St in a state in which the infinite distance object is in focus at the telephoto end is denoted by DDL1STt. As an example, FIG. 2 shows the distance DDL1STt. By not allowing the corresponding value of Conditional Expression (14) to be equal to or less than the lower limit, the distance between the aperture stop St and the lens group of the front group GF closest to the object side is not excessively shortened, so that the distance from the lens surface of the front group GF closest to the object side to the entrance pupil position is not excessively decreased, and thus it is easy to suppress fluctuations of aberrations during magnification change. By not allowing the corresponding value of Conditional Expression (14) to be equal to or greater than the upper limit, the distance between the aperture stop St and the lens group of the front group GF closest to the object side is not excessively increased, and thus the distance from the lens surface of the front group GF closest to the object side to the entrance pupil position is not excessively increased. Therefore, it is easy to shorten the total length, which is advantageous for size reduction.

$$0.2 < DDL 1 STt / TLt < 0.8 \qquad ( 14 )$$

In order to obtain more favorable characteristics, it is preferable that any one of 0.25, 0.3, or 0.35 is used instead of 0.2 as the lower limit of Conditional Expression (14). In addition, it is preferable that any one of 0.75, 0.7, or 0.65 is used instead of 0.8 as the upper limit of Conditional Expression (14).

In a configuration in which the aperture stop St is disposed between the lens surface of the intermediate group GM closest to the image side and the lens surface of the rear group GR closest to the image side, it is preferable that the variable magnification optical system satisfies Conditional Expression (15). By not allowing the corresponding value of Conditional Expression (15) to be equal to or less than the lower limit, the movable range during magnification change is not excessively shortened, and thus it is easy to increase the magnification change ratio. Alternatively, since the refractive power of the lens group of the front group GF closest to the object side is not excessively decreased, it is easy to achieve both reduction in size and a high magnification change ratio. By not allowing the corresponding value of Conditional Expression (15) to be equal to or greater than the upper limit, the distance between the aperture stop St and the lens group of the front group GF closest to the object side is not excessively increased, and thus the distance from the lens surface of the front group GF closest to the object side to the entrance pupil position is not excessively increased. Therefore, it is easy to shorten the total length, which is advantageous for size reduction.

$$0.015 < DDL 1 Tt / f 1 < 0.3 \qquad ( 15 )$$

In order to obtain more favorable characteristics, it is preferable that any one of 0.03 or 0.045 is used instead of 0.015 as the lower limit of Conditional Expression (15). In addition, it is preferable that any one of 0.25 or 0.2 is used instead of 0.3 as the upper limit of Conditional Expression (15).

It is preferable that the variable magnification optical system satisfies Conditional Expression (16). Here, a distance on the optical axis from the lens surface of the front group GF closest to the object side to the paraxial entrance pupil position Penw, in a state in which the infinite distance object is in focus at the wide angle end, is denoted by Denw. As an example, FIG. 2 shows the distance Denw and the paraxial entrance pupil position Penw. By not allowing the corresponding value of Conditional Expression (16) to be equal to or less than the lower limit, the distance from the lens surface of the front group GF closest to the object side to the entrance pupil position on the wide angle side is not excessively shortened, so that it is easy to suppress fluctuations in aberrations during magnification change. By not allowing the corresponding value of Conditional Expression (16) to be equal to or greater than the upper limit, the distance from the lens surface of the front group GF closest to the object side to the entrance pupil position on the wide angle side is not excessively increased, and thus it is possible to prevent the diameter of the lens group of the front group GF closest to the object side from being increased, and it is easy to achieve reduction in size.

$$1.5 < Denw / \{ ( fw \times tan ω w ) \times log ( ft / fw ) \} < 8 \qquad ( 16 )$$

In order to obtain more favorable characteristics, it is preferable that any one of 1.75, 2, 2.25, or 2.5 is used instead of 1.5 as the lower limit of Conditional Expression (16). In addition, it is preferable that any one of 7.75, 7.5, 7.25, or 7 is used instead of 8 as the upper limit of Conditional Expression (16).

It is preferable that the variable magnification optical system satisfies Conditional Expression (17). By not allowing the corresponding value of Conditional Expression (17) to be equal to or less than the lower limit, the distance from the lens surface of the front group GF closest to the object side to the entrance pupil position on the wide angle side is not excessively shortened, so that it is easy to suppress fluctuations in aberrations during magnification change. By not allowing the corresponding value of Conditional Expression (17) to be equal to or greater than the upper limit, the distance from the lens surface of the front group GF closest to the object side to the entrance pupil position on the wide angle side is not excessively increased, and thus it is possible to prevent the diameter of the lens group of the front group GF closest to the object side from being increased, and it is easy to achieve reduction in size.

$$0.1 < Denw / {( fw \times ft )}^{1 / 2} < 0 \text{.65} \qquad ( 17 )$$

In order to obtain more favorable characteristics, it is preferable that any one of 0.13, 0.15, or 0.18 is used instead of 0.1 as the lower limit of Conditional Expression (17). In addition, it is preferable that any one of 0.63, 0.6, 0.58, or 0.55 is used instead of 0.65 as the upper limit of Conditional Expression (17).

It is preferable that the variable magnification optical system satisfies Conditional Expression (18). By not allowing the corresponding value of Conditional Expression (18) to be equal to or less than the lower limit, it is advantageous for reduction in size of the entire optical system. Alternatively, it is advantageous for suppressing various aberrations particularly at the telephoto end. By not allowing the corresponding value of Conditional Expression (18) to be equal to or greater than the upper limit, it is easy to maintain a small F number at the telephoto end, and thus it is advantageous for obtaining sufficient brightness at the telephoto end.

$$0.8 < Fnot / ( ft / fw ) < 2 \qquad ( 18 )$$

In order to obtain more favorable characteristics, it is preferable that any one of 0.85, 0.9, or 0.95 is used instead of 0.8 as the lower limit of Conditional Expression (18). In addition, it is preferable that any one of 1.9, 1.8, or 1.7 is used instead of 2 as the upper limit of Conditional Expression (18).

It is preferable that the variable magnification optical system satisfies Conditional Expression (19). By not allowing the corresponding value of Conditional Expression (19) to be equal to or less than the lower limit, it is easy to suppress various aberrations at the telephoto end. By not allowing the corresponding value of Conditional Expression (19) to be equal to or greater than the upper limit, it is easy to shorten the total length at the telephoto end.

$$0.45 < TLt / ft < 1.3 \qquad ( 19 )$$

In order to obtain more favorable characteristics, it is preferable that any one of 0.5, 0.55, 0.6, or 0.65 is used instead of 0.45 as the lower limit of Conditional Expression (19). In addition, it is preferable that any one of 1.25, 1.2, 1.15, 1.1, or 1.05 is used instead of 1.3 as the upper limit of Conditional Expression (19).

It is preferable that the variable magnification optical system satisfies Conditional Expression (20). Here, the back focus of the entire system in terms of the air-equivalent distance in a state in which the infinite distance object is in focus at the wide angle end is denoted by Bfw. As an example, FIG. 2 shows the back focus Bfw. By not allowing the corresponding value of Conditional Expression (20) to be equal to or less than the lower limit, the back focus is not excessively shortened, and thus it is easy to attach the mount replacement mechanism. By not allowing the corresponding value of Conditional Expression (20) to be equal to or greater than the upper limit, the back focus is not excessively increased, and thus it is easy to achieve reduction in size.

$$0.25 < Bfw / ( ft \times tan ω t ) < 1.8 \qquad ( 20 )$$

In order to obtain more favorable characteristics, it is preferable that any one of 0.3, 0.35, or 0.4 is used instead of 0.25 as the lower limit of Conditional Expression (20). In addition, it is preferable that any one of 1.5, 1.2, 1, 0.85, or 0.7 is used instead of 1.8 as the upper limit of Conditional Expression (20).

The lens group of the front group GF closest to the object side may include at least one negative lens. In a configuration in which the lens group of the front group GF closest to the object side includes at least one negative lens, it is preferable that the variable magnification optical system satisfies Conditional Expression (21). Here, a focal length of a negative lens closest to the object side among the negative lenses included in the lens group closest to the object side in the front group GF is denoted by fLn1. By not allowing the corresponding value of Conditional Expression (21) to be equal to or less than the lower limit, the refractive power of the negative lens closest to the object side is not excessively increased, and thus it is easy to suppress the high-order aberration at the telephoto end. Alternatively, since the refractive power of the lens group of the front group GF closest to the object side is not excessively decreased, it is easy to reduce the size of the lens group of the front group GF closest to the object side. By not allowing the corresponding value of Conditional Expression (21) to be equal to or greater than the upper limit, the refractive power of the lens group of the front group GF closest to the object side is not excessively increased, and thus it is easy to suppress fluctuations in aberrations during magnification change. Alternatively, since the refractive power of the negative lens closest to the object side is not excessively decreased, it is easy to suppress axial chromatic aberration at the telephoto end. It should be noted that, in the present specification, the expression “high-order” related to aberrations means a fifth order or higher.

$$- 1.6 < f 1 / fLn 1 < - 0.1 \qquad ( 21 )$$

In order to obtain more favorable characteristics, it is preferable that any one of −1.5, −1.4, or −1.3 is used instead of −1.6 as the lower limit of Conditional Expression (21). In addition, it is preferable that any one of −0.15, −0.2, or −0.25 is used instead of −0.1 as the upper limit of Conditional Expression (21).

It is preferable that the variable magnification optical system satisfies Conditional Expression (22). By not allowing the corresponding value of Conditional Expression (22) to be equal to or less than the lower limit, it is advantageous for high performance. By not allowing the corresponding value of Conditional Expression (22) to be equal to or greater than the upper limit, the refractive power of the lens group of the front group GF closest to the object side is not excessively decreased, and thus it is easy to reduce the size of the lens group of the front group GF closest to the object side.

$$1 < f 1 / ( ft / Fnot ) < 5.5 \qquad ( 22 )$$

In order to obtain more favorable characteristics, it is preferable that any one of 1.25, 1.5, or 1.75 is used instead of 1 as the lower limit of Conditional Expression (22). In addition, it is preferable that any one of 5, 4.5, or 4 is used instead of 5.5 as the upper limit of Conditional Expression (22).

It is preferable that the variable magnification optical system satisfies Conditional Expression (23). By not allowing the corresponding value of Conditional Expression (23) to be equal to or less than the lower limit, the refractive power of the lens group of the front group GF closest to the object side is not excessively increased, and thus it is easy to suppress fluctuations in aberrations during magnification change. By not allowing the corresponding value of Conditional Expression (23) to be equal to or greater than the upper limit, the refractive power of the lens group of the front group GF closest to the object side is not excessively decreased, and thus it is advantageous for achieving reduction in size.

$$0.5 < f 1 / {( fw \times ft )}^{1 / 2} < 3.5 \qquad ( 23 )$$

In order to obtain more favorable characteristics, it is preferable that any one of 0.6, 0.7, or 0.8 is used instead of 0.5 as the lower limit of Conditional Expression (23). In addition, it is preferable that any one of 3.25, 3, 2.75, or 2.5 is used instead of 3.5 as the upper limit of Conditional Expression (23).

It is preferable that the variable magnification optical system satisfies Conditional Expression (24). By not allowing the corresponding value of Conditional Expression (24) to be equal to or less than the lower limit, the refractive power of the lens group of the front group GF closest to the object side is not excessively increased, and thus it is easy to suppress fluctuations in aberrations during magnification change. By not allowing the corresponding value of Conditional Expression (24) to be equal to or greater than the upper limit, the refractive power of the lens group of the front group GF closest to the object side is not excessively decreased, and thus it is easy to reduce the size of the lens group of the front group GF closest to the object side.

$$0.8 < f 1 / fw < 5 \qquad ( 24 )$$

In order to obtain more favorable characteristics, it is preferable that any one of 1 or 1.2 is used instead of 0.8 as the lower limit of Conditional Expression (24). In addition, it is preferable that any one of 4.6, 4.2, or 3.8 is used instead of 5 as the upper limit of Conditional Expression (24).

In a configuration in which the lens group of the front group GF closest to the object side includes at least one negative lens, it is preferable that the variable magnification optical system satisfies Conditional Expression (25). Here, an average value of Abbe numbers of all positive lenses of the lens group of the front group GF closest to the object side based on the d line is denoted by v1pave. By not allowing the corresponding value of Conditional Expression (25) to be equal to or less than the lower limit, it is possible to prevent insufficient correction of axial chromatic aberration at the telephoto end. Alternatively, since a difference between the Abbe number of the positive lens and the Abbe number of the negative lens in the lens group of the front group GF closest to the object side is not excessively decreased, the refractive power of each lens constituting the lens group of the front group GF closest to the object side is not excessively increased. As a result, an increase in high-order aberration of spherical aberration at the telephoto end can be suppressed, so that it is easy to improve the performance. By not allowing the corresponding value of Conditional Expression (25) to be equal to or greater than the upper limit, it is possible to prevent the axial chromatic aberration at the telephoto end from being excessively corrected. Alternatively, since a difference between the Abbe number of the positive lens and the Abbe number of the negative lens in the lens group of the front group GF closest to the object side is not excessively increased, the refractive power of the negative lens is not excessively decreased. As a result, it is easy to correct the lateral chromatic aberration at the wide angle end.

$$58 < v 1 pave < 96 \qquad ( 25 )$$

In order to obtain more favorable characteristics, it is preferable that any one of 60, 62, or 64 is used instead of 58 as the lower limit of Conditional Expression (25). In addition, it is preferable that any one of 91 or 86 is used instead of 96 as the upper limit of Conditional Expression (25).

In a case in which a thickness of the lens group of the front group GF closest to the object side on the optical axis is denoted by dF1, it is preferable that the variable magnification optical system satisfies Conditional Expression (26). As an example, FIG. 2 shows the thickness dF1. By not allowing the corresponding value of Conditional Expression (26) to be equal to or less than the lower limit, it is advantageous for ensuring the mechanical strength of the front group GF. By not allowing the corresponding value of Conditional Expression (26) to be equal to or greater than the upper limit, it is advantageous for reducing the weight of the front group GF.

$$0.1 < dF 1 / ( ft / Fnot ) < 0.45 \qquad ( 26 )$$

In order to obtain more favorable characteristics, it is preferable that any one of 0.12, 0.14, or 0.16 is used instead of 0.1 as the lower limit of Conditional Expression (26). In addition, it is preferable that any one of 0.4, 0.35, or 0.3 is used instead of 0.45 as the upper limit of Conditional Expression (26).

In a case in which an effective diameter of the lens surface of the front group GF closest to the object side is denoted by EDf, it is preferable that the variable magnification optical system satisfies Conditional Expression (27). By not allowing the corresponding value of Conditional Expression (27) to be equal to or less than the lower limit, it is advantageous for shortening the total length of the optical system. By not allowing the corresponding value of Conditional Expression (27) to be equal to or greater than the upper limit, it is easy to reduce the diameter of the lens of the front group GF closest to the object side.

$$0 < EDf / TLt < 0.5 \qquad ( 27 )$$

In order to obtain more favorable characteristics, it is preferable that any one of 0.23 or 0.25 is used instead of 0 as the lower limit of Conditional Expression (27). In addition, it is preferable that any one of 0.48, 0.45, 0.43, or 0.4 is used instead of 0.5 as the upper limit of Conditional Expression (27).

It should be noted that, in the present specification, the “effective diameter” of the lens surface is twice a distance from an intersection between the lens surface and an outermost ray, among rays that are incident on a lens surface from the object side and that are emitted to the image side, to the optical axis Z. The term “outer side” means an outer side in a radial direction centered on the optical axis Z, that is, a side away from the optical axis Z. The “ray passing through the outermost side” is determined by considering the entire magnification change range.

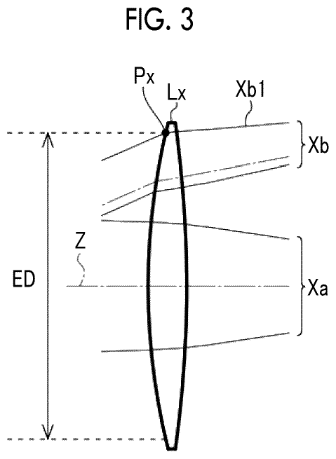

FIG. 3 shows an example of an effective diameter ED as a diagram for description. In FIG. 3, a left side is the object side, and a right side is the image side. FIG. 3 shows an on-axis luminous flux Xa and an off-axis luminous flux Xb that pass through a lens Lx. In the example in FIG. 3, a ray Xbl that is an upper ray of the off-axis luminous flux Xb is the ray passing through the outermost side. A position of an intersection between the ray that passes through the outermost side and the lens surface is a position Px of the maximum effective diameter. In the example in FIG. 3, the effective diameter ED of the surface of the lens Lx on the object side is twice a distance from an intersection between a surface of the lens Lx on the object side and the ray Xbl to the optical axis Z. It should be noted that the upper ray of the off-axis luminous flux Xb is the ray passing through the outermost side in the example in FIG. 3, but which ray is the ray passing through the outermost side varies depending on the optical system.

In a case in which an effective diameter of the lens surface of the rear group GR closest to the image side is denoted by EDr, it is preferable that the variable magnification optical system satisfies Conditional Expression (28). By not allowing the corresponding value of Conditional Expression (28) to be equal to or less than the lower limit, the diameter of the lens of the front group GF closest to the object side is not excessively decreased, and thus it is easy to ensure the peripheral light amount ratio at the maximum image height. Alternatively, since the refractive power of the lens group of the front group GF closest to the object side is not excessively increased in order to reduce the diameter of the lens of the front group GF closest to the object side, it is easy to suppress fluctuations in aberrations during magnification change. By not allowing the corresponding value of Conditional Expression (28) to be equal to or greater than the upper limit, the diameter of the lens of the front group GF closest to the object side is not excessively increased, and thus it is easy to achieve reduction in size.

$$1 < EDf / EDr < 2.5 \qquad ( 28 )$$

In order to obtain more favorable characteristics, it is preferable that any one of 1.1, 1.2, or 1.3 is used instead of 1 as the lower limit of Conditional Expression (28). In addition, it is preferable that any one of 2.3, 2.1, or 1.9 is used instead of 2.5 as the upper limit of Conditional Expression (28).

It is preferable that the variable magnification optical system satisfies Conditional Expression (29). Here, a focal length of the front group GF in a state in which the infinite distance object is in focus at the wide angle end is denoted by fFw. A focal length of the intermediate group GM in a state in which the infinite distance object is in focus at the wide angle end is denoted by fMw. By not allowing the corresponding value of Conditional Expression (29) to be equal to or less than the lower limit, the refractive power of the intermediate group GM is not excessively decreased, and thus it is easy to suppress the movement amount of the intermediate group GM during magnification change. By not allowing the corresponding value of Conditional Expression (29) to be equal to or greater than the upper limit, the refractive power of the front group GF is not excessively decreased, and thus it is easy to prevent the size of the front group GF from being increased.

$$0.6 < fFw / ( - fMw ) < 5 \qquad ( 29 )$$

In order to obtain more favorable characteristics, it is preferable that any one of 0.7, 0.8, or 0.9 is used instead of 0.6 as the lower limit of Conditional Expression (29). In addition, it is preferable that any one of 4.7, 4.4, or 4.1 is used instead of 5 as the upper limit of Conditional Expression (29).

It is preferable that the variable magnification optical system satisfies Conditional Expression (30). Here, a spacing on the optical axis between the lens group of the front group GF closest to the object side and the lens group of the intermediate group GM closest to the image side in a state in which the infinite distance object is in focus at the wide angle end is denoted by dFMw. A spacing on the optical axis between the lens group of the front group GF closest to the object side and the lens group of the intermediate group GM closest to the image side in a state in which the infinite distance object is is in focus at the telephoto end is denoted by dFMt. As an example, FIG. 2 shows the spacing dFMw and the spacing dFMt. By not allowing the corresponding value of Conditional Expression (30) to be equal to or less than the lower limit, the movement amounts of the lens groups of the front group GF and the intermediate group GM during magnification change are not excessively decreased, and thus it is easy to suppress fluctuations in aberrations during magnification change. By not allowing the corresponding value of Conditional Expression (30) to be equal to or greater than the upper limit, the movement amounts of the lens groups of the front group GF and the intermediate group GM during magnification change are not excessively increased, and thus it is easy to achieve reduction in size.

$$0.15 < \vert dFMw - dFMt \vert / TLt < 0.6 \qquad ( 30 )$$

In order to obtain more favorable characteristics, it is preferable that any one of 0.18, 0.21, or 0.24 is used instead of 0.15 as the lower limit of Conditional Expression (30). In addition, it is preferable that any one of 0.55, 0.5, or 0.45 is used instead of 0.6 as the upper limit of Conditional Expression (30).

In a case in which a focal length of the rear group GR in a state in which the infinite distance object is in focus at the wide angle end is denoted by fRw, it is preferable that the variable magnification optical system satisfies Conditional Expression (31). By not allowing the corresponding value of Conditional Expression (31) to be equal to or less than the lower limit, it is easy to shorten the total length of the optical system at the wide angle end, and thus it is advantageous for reduction in size. By not allowing the corresponding value of Conditional Expression (31) to be equal to or greater than the upper limit, it is advantageous for correcting the spherical aberration at the wide angle end.

$$0.7 < fw / fRw < 4 \qquad ( 31 )$$

In order to obtain more favorable characteristics, it is preferable that any one of 0.8, 0.9, or 1 is used instead of 0.7 as the lower limit of Conditional Expression (31). In addition, it is preferable that any one of 3.5, 3, or 2.5 is used instead of 4 as the upper limit of Conditional Expression (31).

In a case in which the focal length of the rear group GR in a state in which the infinite distance object is in focus at the telephoto end is denoted by fRt, it is preferable that the variable magnification optical system satisfies Conditional Expression (32). By not allowing the corresponding value of Conditional Expression (32) to be equal to or less than the lower limit, it is easy to shorten the total length of the optical system at the telephoto end, and thus it is advantageous for reduction in size. By not allowing the corresponding value of Conditional Expression (32) to be equal to or greater than the upper limit, an advantage in correcting the spherical aberration at the telephoto end.

$$0.5 < ft / fRt < 6.5 \qquad ( 32 )$$

In order to obtain more favorable characteristics, it is preferable that any one of 0.6, 0.7, or 0.8 is used instead of 0.5 as the lower limit of Conditional Expression (32). In addition, it is preferable that any one of 6, 5.5, or 5 is used instead of 6.5 as the upper limit of Conditional Expression (32).

It should be noted that the example shown in FIG. 1 is merely an example, and various modifications can be made without departing from the gist of the technology of the present disclosure. For example, the number of lens groups included in each group of the front group GF, the intermediate group GM, and the rear group GR, the number of lenses included in each lens group, the number of lenses included in the focusing group, and the number of lenses included in the anti-vibration group may be different from the numbers in the example of FIG. 1. Further, the number of focusing groups included in the variable magnification optical system may be different from the number in the example of FIG. 1.

The front group GF may be configured to consist of two lens groups. In such a case, it is advantageous for suppressing fluctuations of aberrations during magnification change.

The intermediate group GM may be configured to consist of two lens groups. In such a case, it is advantageous for suppressing fluctuations of aberrations during magnification change.

The rear group GR may consist of the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, and the fifth subsequent lens group GR5 having a negative refractive power, in this order from the object side to the image side. It is easy to suppress fluctuations in aberrations during magnification change by setting the number of lens groups included in the rear group GR to five.

In a configuration in which the rear group GR consists of the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, and the fifth subsequent lens group GR5 having a negative refractive power, in this order from the object side to the image side, it is preferable that the variable magnification optical system satisfies at least one of Conditional Expression (33), (34), or (35). Symbols in Conditional Expressions (33), (34), and (35) are defined as described below. A focal length of the first subsequent lens group GR1 is denoted by fRA1. A focal length of the second subsequent lens group GR2 is denoted by fRA2. A focal length of the third subsequent lens group GR3 is denoted by fRA3. A focal length of the fourth subsequent lens group GR4 is denoted by fRA4. A focal length of the fifth subsequent lens group GR5 is denoted by fRA5.

$$0.5 < fRA 1 / fRA 3 < 4 \qquad ( 33 )$$

$$0.5 < fRA 2 / fRA 4 < 8 \qquad ( 34 )$$

$$0.05 < fRA 4 / fRA 5 < 3 \qquad ( 35 )$$

By not allowing the corresponding value of Conditional Expression (33) to be equal to or less than the lower limit, the refractive power of the third subsequent lens group GR3 is not excessively decreased, so that it is advantageous for suppressing aberrations during magnification change. By not allowing the corresponding value of Conditional Expression (33) to be equal to or greater than the upper limit, the refractive power of the third subsequent lens group GR3 is not excessively increased, and thus it is possible to prevent the spherical aberration at the wide angle end from being excessively corrected.

In order to obtain more favorable characteristics, it is preferable that any one of 0.6, 0.7, 0.8, or 0.9 is used instead of 0.5 as the lower limit of Conditional Expression (33). In addition, it is preferable that any one of 3.7, 3.4, 3.1, or 2.8 is used instead of 4 as the upper limit of Conditional Expression (33).

By not allowing the corresponding value of Conditional Expression (34) to be equal to or less than the lower limit, the refractive power of the fourth subsequent lens group GR4 is not excessively decreased, and thus it is advantageous for preventing insufficient correction of aberrations during magnification change. By not allowing the corresponding value of Conditional Expression (34) to be equal to or greater than the upper limit, the refractive power of the fourth subsequent lens group GR4 is not excessively increased, and thus it is possible to prevent aberrations during magnification change from being excessively corrected.

In order to obtain more favorable characteristics, it is preferable that any one of 0.6, 0.7, 0.8, or 0.9 is used instead of 0.5 as the lower limit of Conditional Expression (34). In addition, it is preferable that any one of 7.2, 6.4, 5.6, or 4.4 is used instead of 8 as the upper limit of Conditional Expression (34).

By not allowing the corresponding value of Conditional Expression (35) to be equal to or less than the lower limit, the refractive power of the fifth subsequent lens group GR5 is not excessively decreased, and thus it is advantageous for correcting distortion. By not allowing the corresponding value of Conditional Expression (35) to be equal to or greater than the upper limit, the refractive power of the fourth subsequent lens group GR4 is not excessively decreased, and thus it is advantageous for correcting aberrations during magnification change.

In order to obtain more favorable characteristics, it is preferable that any one of 0.07, 0.09, 0.11, or 0.13 is used instead of 0.05 as the lower limit of Conditional Expression (35). In addition, it is preferable that any one of 2.6, 2.2, 1.8, or 1.4 is used instead of 3 as the upper limit of Conditional Expression (35).

The rear group GR may consist of the first subsequent lens group GR1 having a positive refractive power, the second subsequent lens group GR2 having a positive refractive power, the third subsequent lens group GR3 having a negative refractive power, the fourth subsequent lens group GR4 having a positive refractive power, and the fifth subsequent lens group GR5 having a negative refractive power, in this order from the object side to the image side. It is easy to suppress fluctuations in aberrations during magnification change by setting the number of lens groups included in the rear group GR to five.

In a configuration in which the rear group GR consists of the first subsequent lens group GR1 having a positive refractive power, the second subsequent lens group GR2 having a positive refractive power, the third subsequent lens group GR3 having a negative refractive power, the fourth subsequent lens group GR4 having a positive refractive power, and the fifth subsequent lens group GR5 having a negative refractive power, in this order from the object side to the image side, it is preferable that the variable magnification optical system satisfies at least one of Conditional Expression (36), (37), or (38). Symbols in Conditional Expressions (36), (37), and (38) are defined as described below. A focal length of the first subsequent lens group GR1 is denoted by fRB1. A focal length of the second subsequent lens group GR2 is denoted by fRB2. A focal length of the third subsequent lens group GR3 is denoted by fRB3. A focal length of the fourth subsequent lens group GR4 is denoted by fRB4. A focal length of the fifth subsequent lens group GR5 is denoted by fRB5.

$$0.1 < fRB 1 / fRB 2 < 9 \qquad ( 36 )$$

$$0.2 < fRB 1 / fRB 4 < 9 \qquad ( 37 )$$

$$0.1 < fRB 3 / fRB 5 < 3 \qquad ( 38 )$$

By not allowing the corresponding value of Conditional Expression (36) to be equal to or less than the lower limit, the refractive power of the second subsequent lens group GR2 is not excessively decreased, and thus it is advantageous for suppressing the spherical aberration at the wide angle end. By not allowing the corresponding value of Conditional Expression (36) to be equal to or greater than the upper limit, the refractive power of the first subsequent lens group GR1 is not excessively decreased, and thus it is advantageous for correcting aberrations during magnification change.

In order to obtain more favorable characteristics, it is preferable that any one of 0.18, 0.26, 0.34, or 0.42 is used instead of 0.1 as the lower limit of Conditional Expression (36). In addition, it is preferable that any one of 8.5, 8, 7.5, or 7 is used instead of 9 as the upper limit of Conditional Expression (36).

By not allowing the corresponding value of Conditional Expression (37) to be equal to or less than the lower limit, the refractive power of the fourth subsequent lens group GR4 is not excessively decreased, and thus it is advantageous for correcting distortion. By not allowing the corresponding value of Conditional Expression (37) to be equal to or greater than the upper limit, the refractive power of the first subsequent lens group GR1 is not excessively decreased, and thus it is advantageous for correcting aberrations during magnification change.

In order to obtain more favorable characteristics, it is preferable that any one of 0.3, 0.4, 0.5, or 0.6 is used instead of 0.2 as the lower limit of Conditional Expression (37). In addition, it is preferable that any one of 8.5, 8, 7.5, or 7 is used instead of 9 as the upper limit of Conditional Expression (37).

By not allowing the corresponding value of Conditional Expression (38) to be equal to or less than the lower limit, the refractive power of the fifth subsequent lens group GR5 is not excessively decreased, and thus it is advantageous for correcting distortion. By not allowing the corresponding value of Conditional Expression (38) to be equal to or greater than the upper limit, the refractive power of the third subsequent lens group GR3 is not excessively decreased, and thus it is advantageous for correcting aberrations during magnification change.

In order to obtain more favorable characteristics, it is preferable that any one of 0.18, 0.26, 0.34, or 0.42 is used instead of 0.1 as the lower limit of Conditional Expression (38). In addition, it is preferable that any one of 2.7, 2.4, 2.1, or 1.8 is used instead of 3 as the upper limit of Conditional Expression (38).

The rear group GR may consist of the first subsequent lens group GR1 having a positive refractive power, the second subsequent lens group GR2 having a positive refractive power, and the third subsequent lens group GR3 having a negative refractive power, in this order from the object side to the image side. By limiting the number of lens groups included in the rear group GR to three, it is easy to shorten the total length.

In a configuration in which the rear group GR consists of the first subsequent lens group GR1 having a positive refractive power, the second subsequent lens group GR2 having a positive refractive power, and the third subsequent lens group GR3 having a negative refractive power, in this order from the object side to the image side, it is preferable that the variable magnification optical system satisfies Conditional Expression (39). Symbols in Conditional Expression (39) are defined as described below. A focal length of the first subsequent lens group GR1 is denoted by fRC1. A focal length of the second subsequent lens group GR2 is denoted by fRC2.

$$0.1 < fRC 1 / fRC 2 < 2 \qquad ( 39 )$$

By not allowing the corresponding value of Conditional Expression (39) to be equal to or less than the lower limit, the refractive power of the second subsequent lens group GR2 is not excessively decreased, so that it is advantageous for correcting aberrations during magnification change. By not allowing the corresponding value of Conditional Expression (39) to be equal to or greater than the upper limit, the refractive power of the first subsequent lens group GR1 is not excessively decreased, and thus it is advantageous for suppressing the spherical aberration at the wide angle end.

In order to obtain more favorable characteristics, it is preferable that any one of 0.15, 0.2, 0.25, or 0.3 is used instead of 0.1 as the lower limit of Conditional Expression (39). In addition, it is preferable that any one of 1.7, 1.4, 1.1, or 0.8 is used instead of 2 as the upper limit of Conditional Expression (39).

The rear group GR may consist of the first subsequent lens group GR1 having a positive refractive power, the second subsequent lens group GR2 having a positive refractive power, the third subsequent lens group GR3 having a negative refractive power, and the fourth subsequent lens group GR4 having a negative refractive power, in this order from the object side to the image side. By limiting the number of lens groups included in the rear group GR to four, it is easy to shorten the total length.

In a configuration in which the rear group GR consists of the first subsequent lens group GR1 having a positive refractive power, the second subsequent lens group GR2 having a positive refractive power, the third subsequent lens group GR3 having a negative refractive power, and the fourth subsequent lens group GR4 having a negative refractive power, in this order from the object side to the image side, it is preferable that the variable magnification optical system satisfies at least one of Conditional Expression (40) or (41). Symbols in Conditional Expressions (40) and (41) are defined as described below. Afocal length of the first subsequent lens group GR1 is denoted by fRD1. A focal length of the second subsequent lens group GR2 is denoted by fRD2. Afocal length of the third subsequent lens group GR3 is denoted by fRD3. A focal length of the fourth subsequent lens group GR4 is denoted by fRD4.

$$0.2 < fRD 1 / fRD 2 < 3.5 \qquad ( 40 )$$

$$0.05 < fRD 3 / fRD 4 < 2 \qquad ( 41 )$$

By not allowing the corresponding value of Conditional Expression (40) to be equal to or less than the lower limit, the refractive power of the second subsequent lens group GR2 is not excessively decreased, so that it is advantageous for correcting aberrations during magnification change. By not allowing the corresponding value of Conditional Expression (40) to be equal to or greater than the upper limit, the refractive power of the first subsequent lens group GR1 is not excessively decreased, and thus it is advantageous for suppressing the spherical aberration at the wide angle end.

In order to obtain more favorable characteristics, it is preferable that any one of 0.4, 0.6, 0.8, or 1 is used instead of 0.2 as the lower limit of Conditional Expression (40). In addition, it is preferable that any one of 3.1, 2.7, 2.3, or 1.9 is used instead of 3.5 as the upper limit of Conditional Expression (40).

By not allowing the corresponding value of Conditional Expression (41) to be equal to or less than the lower limit, the refractive power of the fourth subsequent lens group GR4 is not excessively decreased, and thus it is advantageous for correcting distortion. By not allowing the corresponding value of Conditional Expression (41) to be equal to or greater than the upper limit, the refractive power of the third subsequent lens group GR3 is not excessively decreased, and thus it is advantageous for correcting aberrations during magnification change.

In order to obtain more favorable characteristics, it is preferable that any one of 0.07, 0.09, 0.11, or 0.13 is used instead of 0.05 as the lower limit of Conditional Expression (41). In addition, it is preferable that any one of 1.7, 1.4, 1.1, or 0.8 is used instead of 2 as the upper limit of Conditional Expression (41).

The rear group GR may consist of the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, the fifth subsequent lens group GR5 having a positive refractive power, and the sixth subsequent lens group GR6 having a negative refractive power, in this order from the object side to the image side. It is easy to suppress fluctuations in aberrations during magnification change by setting the number of lens groups included in the rear group GR to six.

In a configuration in which the rear group GR consists of the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, the fifth subsequent lens group GR5 having a positive refractive power, and the sixth subsequent lens group GR6 having a negative refractive power, in this order from the object side to the image side, it is preferable that the variable magnification optical system satisfies at least one of Conditional Expression (42), (43), (44), or (45). Symbols in Conditional Expressions (42), (43), (44), and (45) are defined as described below. A focal length of the first subsequent lens group GR1 is denoted by fRE1. A focal length of the second subsequent lens group GR2 is denoted by fRE2. A focal length of the third subsequent lens group GR3 is denoted by fRE3. A focal length of the fourth subsequent lens group GR4 is denoted by fRE4. A focal length of the fifth subsequent lens group GR5 is denoted by fRE5. A focal length of the sixth subsequent lens group GR6 is denoted by fRE6.

$$0.1 < fRE 1 / fRE 3 < 3.5 \qquad ( 42 )$$

$$0.1 < fRE 3 / fRE 5 < 3.5 \qquad ( 43 )$$

$$0.2 < fRE 2 / fRE 4 < 15 \qquad ( 44 )$$

$$0.05 < fRE 4 / fRE 6 < 3 \qquad ( 45 )$$

By not allowing the corresponding value of Conditional Expression (42) to be equal to or less than the lower limit, the refractive power of the third subsequent lens group GR3 is not excessively decreased, and thus it is advantageous for suppressing the spherical aberration at the wide angle end. By not allowing the corresponding value of Conditional Expression (42) to be equal to or greater than the upper limit, the refractive power of the first subsequent lens group GR1 is not excessively decreased, and thus it is advantageous for correcting aberrations during magnification change.

In order to obtain more favorable characteristics, it is preferable that any one of 0.18, 0.26, 0.34, or 0.42 is used instead of 0.1 as the lower limit of Conditional Expression (42). In addition, it is preferable that any one of 3.1, 2.7, 2.3, or 1.9 is used instead of 3.5 as the upper limit of Conditional Expression (42).

By not allowing the corresponding value of Conditional Expression (43) to be equal to or less than the lower limit, the refractive power of the fifth subsequent lens group GR5 is not excessively decreased, and thus it is advantageous for correcting distortion. By not allowing the corresponding value of Conditional Expression (43) to be equal to or greater than the upper limit, the refractive power of the third subsequent lens group GR3 is not excessively decreased, and thus it is advantageous for suppressing the spherical aberration at the wide angle end.

In order to obtain more favorable characteristics, it is preferable that any one of 0.18, 0.26, 0.34, or 0.42 is used instead of 0.1 as the lower limit of Conditional Expression (43). In addition, it is preferable that any one of 3.1, 2.7, 2.3, or 1.9 is used instead of 3.5 as the upper limit of Conditional Expression (43).

By not allowing the corresponding value of Conditional Expression (44) to be equal to or less than the lower limit, the refractive power of the fourth subsequent lens group GR4 is not excessively decreased, and thus it is advantageous for preventing insufficient correction of aberrations during magnification change. By not allowing the corresponding value of Conditional Expression (44) to be equal to or greater than the upper limit, the refractive power of the fourth subsequent lens group GR4 is not excessively increased, and thus it is possible to prevent aberrations during magnification change from being excessively corrected.

In order to obtain more favorable characteristics, it is preferable that any one of 0.3, 0.4, 0.5, or 0.6 is used instead of 0.2 as the lower limit of Conditional Expression (44). In addition, it is preferable that any one of 13, 11, 9, or 7 is used instead of 15 as the upper limit of Conditional Expression (44).

By not allowing the corresponding value of Conditional Expression (45) to be equal to or less than the lower limit, the refractive power of the sixth subsequent lens group GR6 is not excessively decreased, and thus it is advantageous for correcting distortion. By not allowing the corresponding value of Conditional Expression (45) to be equal to or greater than the upper limit, the refractive power of the fourth subsequent lens group GR4 is not excessively decreased, and thus it is advantageous for correcting aberrations during magnification change.

In order to obtain more favorable characteristics, it is preferable that any one of 0.07, 0.09, 0.11, or 0.13 is used instead of 0.05 as the lower limit of Conditional Expression (45). In addition, it is preferable that any one of 2.7, 2.4, 2.1, or 1.8 is used instead of 3 as the upper limit of Conditional Expression (45).

The rear group GR may consist of the first subsequent lens group GR1 having a positive refractive power, the second subsequent lens group GR2 having a negative refractive power, the third subsequent lens group GR3 having a positive refractive power, and the fourth subsequent lens group GR4 having a negative refractive power, in this order from the object side to the image side. By limiting the number of lens groups included in the rear group GR to four, it is easy to shorten the total length.

In a configuration in which the rear group GR consists of the first subsequent lens group GR1 having a positive refractive power, the second subsequent lens group GR2 having a negative refractive power, the third subsequent lens group GR3 having a positive refractive power, and the fourth subsequent lens group GR4 having a negative refractive power, in this order from the object side to the image side, it is preferable that the variable magnification optical system satisfies at least one of Conditional Expression (46) or (47). Symbols in Conditional Expressions (46) and (47) are defined as described below. A focal length of the first subsequent lens group GR1 is denoted by fRF1. A focal length of the second subsequent lens group GR2 is denoted by fRF2. A focal length of the third subsequent lens group GR3 is denoted by fRF3. A focal length of the fourth subsequent lens group GR4 is denoted by fRF4.

$$0.1 < fRF 1 / RF 3 < 2 \qquad ( 46 )$$

$$0.1 < fRF 2 / RF 4 < 2.5 \qquad ( 47 )$$

By not allowing the corresponding value of Conditional Expression (46) to be equal to or less than the lower limit, the refractive power of the third subsequent lens group GR3 is not excessively decreased, so that it is advantageous for correcting aberrations during magnification change. By not allowing the corresponding value of Conditional Expression (46) to be equal to or greater than the upper limit, the refractive power of the first subsequent lens group GR1 is not excessively decreased, and thus it is advantageous for suppressing the spherical aberration at the wide angle end.

In order to obtain more favorable characteristics, it is preferable that any one of 0.15, 0.2, 0.25, or 0.3 is used instead of 0.1 as the lower limit of Conditional Expression (46). In addition, it is preferable that any one of 1.7, 1.4, 1.1, or 0.8 is used instead of 2 as the upper limit of Conditional Expression (46).

By not allowing the corresponding value of Conditional Expression (47) to be equal to or less than the lower limit, the refractive power of the fourth subsequent lens group GR4 is not excessively decreased, and thus it is advantageous for correcting distortion. By not allowing the corresponding value of Conditional Expression (47) to be equal to or greater than the upper limit, the refractive power of the second subsequent lens group GR2 is not excessively decreased, and thus it is advantageous for correcting aberrations during magnification change.

In order to obtain more favorable characteristics, it is preferable that any one of 0.18, 0.26, 0.34, or 0.42 is used instead of 0.1 as the lower limit of Conditional Expression (47). In addition, it is preferable that any one of 2.2, 1.9, 1.5, or 1.2 is used instead of 2.5 as the upper limit of Conditional Expression (47).

The rear group GR may consist of the first subsequent lens group GR1 having a positive refractive power, the second subsequent lens group GR2 having a positive refractive power, the third subsequent lens group GR3 having a positive refractive power, the fourth subsequent lens group GR4 having a negative refractive power, and the fifth subsequent lens group GR5 having a negative refractive power, in this order from the object side to the image side. It is easy to suppress fluctuations in aberrations during magnification change by setting the number of lens groups included in the rear group GR to five.

In a configuration in which the rear group GR consists of the first subsequent lens group GR1 having a positive refractive power, the second subsequent lens group GR2 having a positive refractive power, the third subsequent lens group GR3 having a positive refractive power, the fourth subsequent lens group GR4 having a negative refractive power, and the fifth subsequent lens group GR5 having a negative refractive power, in this order from the object side to the image side, it is preferable that the variable magnification optical system satisfies at least one of Conditional Expression (48), (49), or (50). Symbols in Conditional Expressions (48), (49), and (50) are defined as described below. A focal length of the first subsequent lens group GR1 is denoted by fRG1. Afocal length of the second subsequent lens group GR2 is denoted by fRG2. A focal length of the third subsequent lens group GR3 is denoted by fRG3. A focal length of the fourth subsequent lens group GR4 is denoted by fRG4. A focal length of the fifth subsequent lens group GR5 is denoted by fRG5.

$$0.01 < fRG 1 / fRG 2 < 1 \qquad ( 48 )$$

$$0.01 < fRG 3 / fRG 2 < 1 \qquad ( 49 )$$

$$0.5 < fRG 4 / fRG 5 < 5 \qquad ( 50 )$$

By not allowing the corresponding value of Conditional Expression (48) to be equal to or less than the lower limit, the refractive power of the second subsequent lens group GR2 is not excessively decreased, and thus it is advantageous for suppressing the spherical aberration at the wide angle end. By not allowing the corresponding value of Conditional Expression (48) to be equal to or greater than the upper limit, the refractive power of the first subsequent lens group GR1 is not excessively decreased, and thus it is advantageous for correcting aberrations during magnification change.

In order to obtain more favorable characteristics, it is preferable that any one of 0.02 or 0.03 is used instead of 0.01 as the lower limit of Conditional Expression (48). In addition, it is preferable that any one of 0.9, 0.8, 0.7, or 0.6 is used instead of 1 as the upper limit of Conditional Expression (48).

By not allowing the corresponding value of Conditional Expression (49) to be equal to or less than the lower limit, the refractive power of the second subsequent lens group GR2 is not excessively decreased, and thus it is advantageous for suppressing the spherical aberration at the wide angle end. By not allowing the corresponding value of Conditional Expression (49) to be equal to or greater than the upper limit, the refractive power of the third subsequent lens group GR3 is not excessively decreased, and thus it is advantageous for correcting aberrations during magnification change.

In order to obtain more favorable characteristics, it is preferable that any one of 0.02 or 0.03 is used instead of 0.01 as the lower limit of Conditional Expression (49). In addition, it is preferable that any one of 0.9, 0.8, 0.7, or 0.6 is used instead of 1 as the upper limit of Conditional Expression (49).

By not allowing the corresponding value of Conditional Expression (50) to be equal to or less than the lower limit, the refractive power of the fifth subsequent lens group GR5 is not excessively decreased, and thus it is advantageous for correcting distortion. By not allowing the corresponding value of Conditional Expression (50) to be equal to or greater than the upper limit, the refractive power of the fourth subsequent lens group GR4 is not excessively decreased, and thus it is advantageous for correcting aberrations during magnification change.

In order to obtain more favorable characteristics, it is preferable that any one of 0.6, 0.7, 0.8, or 0.9 is used instead of 0.5 as the lower limit of Conditional Expression (50). In addition, it is preferable that any one of 4.5, 4, 3.5, or 3 is used instead of 5 as the upper limit of Conditional Expression (50).

The rear group GR may consist of the first subsequent lens group GR1 having a positive refractive power, the second subsequent lens group GR2 having a positive refractive power, the third subsequent lens group GR3 having a negative refractive power, and the fourth subsequent lens group GR4 having a positive refractive power, in this order from the object side to the image side. By limiting the number of lens groups included in the rear group GR to four, it is easy to shorten the total length.

In a configuration in which the rear group GR consists of the first subsequent lens group GR1 having a positive refractive power, the second subsequent lens group GR2 having a positive refractive power, the third subsequent lens group GR3 having a negative refractive power, and the fourth subsequent lens group GR4 having a positive refractive power, in this order from the object side to the image side, it is preferable that the variable magnification optical system satisfies at least one of Conditional Expression (51) or (52). Symbols in Conditional Expressions (51) and (52) are defined as described below. Afocal length of the first subsequent lens group GR1 is denoted by fRH1. A focal length of the second subsequent lens group GR2 is denoted by fRH2. A focal length of the fourth subsequent lens group GR4 is denoted by fRH4.

$$0.1 < fRH 1 / fRH 2 < 2.5 \qquad ( 51 )$$

$$0.1 < fRH 2 / fRH4 < 2 \qquad ( 52 )$$

By not allowing the corresponding value of Conditional Expression (51) to be equal to or less than the lower limit, the refractive power of the second subsequent lens group GR2 is not excessively decreased, so that it is advantageous for correcting aberrations during magnification change. By not allowing the corresponding value of Conditional Expression (51) to be equal to or greater than the upper limit, the refractive power of the first subsequent lens group GR1 is not excessively decreased, and thus it is advantageous for suppressing the spherical aberration at the wide angle end.

In order to obtain more favorable characteristics, it is preferable that any one of 0.18, 0.26, 0.34, or 0.42 is used instead of 0.1 as the lower limit of Conditional Expression (51). In addition, it is preferable that any one of 2.2, 1.9, 1.5, or 1.2 is used instead of 2.5 as the upper limit of Conditional Expression (51).

By not allowing the corresponding value of Conditional Expression (52) to be equal to or less than the lower limit, the refractive power of the fourth subsequent lens group GR4 is not excessively decreased, and thus it is advantageous for correcting distortion. By not allowing the corresponding value of Conditional Expression (52) to be equal to or greater than the upper limit, the refractive power of the second subsequent lens group GR2 is not excessively decreased, and thus it is advantageous for correcting aberrations during magnification change.

In order to obtain more favorable characteristics, it is preferable that any one of 0.15, 0.2, 0.25, or 0.3 is used instead of 0.1 as the lower limit of Conditional Expression (52). In addition, it is preferable that any one of 1.7, 1.4, 1.1, or 0.8 is used instead of 2 as the upper limit of Conditional Expression (52).

The rear group GR may be configured to consist of the first subsequent lens group GR1 having a positive refractive power, the second subsequent lens group GR2 having a negative refractive power, and the third subsequent lens group GR3 having a positive refractive power, in this order from the object side to the image side. By limiting the number of lens groups included in the rear group GR to three, it is easy to shorten the total length.

In a configuration in which the rear group GR consists of the first subsequent lens group GR1 having a positive refractive power, the second subsequent lens group GR2 having a negative refractive power, and the third subsequent lens group GR3 having a positive refractive power, in this order from the object side to the image side, it is preferable that the variable magnification optical system satisfies Conditional Expression (53). Symbols in Conditional Expression (53) are defined as described below. A focal length of the first subsequent lens group GR1 is denoted by fRI1. A focal length of the third subsequent lens group GR3 is denoted by fRI3.

$$0 \text{.1} < fRI 1 / fRI 3 < 2 \qquad ( 53 )$$

By not allowing the corresponding value of Conditional Expression (53) to be equal to or less than the lower limit, the refractive power of the third subsequent lens group GR3 is not excessively decreased, and thus it is advantageous for correcting distortion. By not allowing the corresponding value of Conditional Expression (53) to be equal to or greater than the upper limit, the refractive power of the first subsequent lens group GR1 is not excessively decreased, and thus it is advantageous for suppressing the spherical aberration at the wide angle end.

In order to obtain more favorable characteristics, it is preferable that any one of 0.15, 0.2, 0.25, or 0.3 is used instead of 0.1 as the lower limit of Conditional Expression (53). In addition, it is preferable that any one of 1.7, 1.4, 1.1, or 0.8 is used instead of 2 as the upper limit of Conditional Expression (53).

The preferred configurations and the available configurations described above can be combined in any manner without inconsistency, and it is preferable that the preferred configurations and available configurations described above are selectively adopted as appropriate in accordance with required specifications.

As an example, in a preferred aspect of the variable magnification optical system according to the present disclosure, the variable magnification optical system consists of a front group GF, an intermediate group GM, and a rear group GR in this order from the object side to the image side, the front group GF consists of two or fewer lens groups having a positive refractive power, the intermediate group GM consists of two or fewer lens groups having a negative refractive power, the rear group GR consists of a plurality of lens groups, during magnification change, all spacings between adjacent lens groups change, and Conditional Expressions (1), (2), and (3) are satisfied.

Next, examples of the variable magnification optical system according to the present disclosure will be described with reference to the accompanying drawings. It should be noted that reference numerals provided to the groups in the cross-sectional view of each example are independently used for each example in order to avoid complication of description and the drawings caused by an increasing number of digits of the reference numerals. Therefore, even in a case in which a common reference numeral is provided in the drawings of different examples, the common reference numeral does not always indicate a common configuration.

### Example 1

A configuration and a movement trajectory of the variable magnification optical system according to Example 1 are shown in FIG. 1, and its showing method and its configuration are described above, and thus the duplicate description will be partially omitted here. The variable magnification optical system according to Example 1 consists of the front group GF, the intermediate group GM, and the rear group GR in this order from the object side to the image side. The front group GF consists of one lens group having a positive refractive power. The intermediate group GM consists of one lens group having a negative refractive power. The rear group GR consists of, in this order from the object side to the image side, the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, and the fifth subsequent lens group GR5 having a negative refractive power.

During magnification change from the wide angle end to the telephoto end, the first subsequent lens group GR1 and the third subsequent lens group GR3 remain stationary with respect to the image plane Sim, and the other lens groups move while changing the spacings between the adjacent lens groups. The variable magnification optical system includes two focusing groups. The focusing group on the object side consists of the second subsequent lens group GR2, and the focusing group on the image side consists of the fourth subsequent lens group GR4. During focusing from the infinite distance object to the short range object, the second subsequent lens group GR2 moves to the object side, the fourth subsequent lens group GR4 moves to the image side, and other lens groups remain stationary with respect to the image plane Sim. The anti-vibration group consists of the intermediate group GM.

With respect to the variable magnification optical system according to Example 1, basic lens data is shown in Table 1, specifications and variable surface spacings are shown in Table 2, and aspherical coefficients are shown in Table 3.

The table of the basic lens data is described as below. The column of Sn shows surface numbers in a case in which the number is increased by one at a time toward the image side from a surface closest to the object side as a first surface. The column of R shows the curvature radius of each surface. The column of D shows the surface spacing on the optical axis between each surface and its adjacent surface on the image side. The column of Nd shows a refractive index at the d line for each constituent. The column of vd shows the Abbe number based on the d line for each constituent. The column of ED shows the effective diameter of each lens surface.

In the table of the basic lens data, a sign of a curvature radius of a surface having a convex shape facing the object side is positive, and a sign of a curvature radius of a surface having a convex shape facing the image side is negative. In Table 1, the field of a surface number of the surface corresponding to the aperture stop St has the term of the surface number (St). A value in the lowermost field of the column of D in the table indicates a spacing between a surface closest to the image side in the table and the image plane Sim. The symbol DD[ ] is used for the variable surface spacings during magnification change, and the surface number on the object side of the spacing is provided inside [ ] and is described in the column of the surface spacings.

Table 2 shows a magnification change ratio Zr, a focal length f, an open F-number FNo., a maximum full angle of view 2ω, and variable surface spacings, based on the d line. In a case in which the variable magnification optical system is a zoom lens, the magnification change ratio is synonymous with a zoom magnification. In the field of 2ω, [° ] indicates a degree unit. Table 2 shows each value of the wide angle end state, a middle focal length state, and the telephoto end state in the columns labeled “Wide”, “Middle”, and “Tele”, respectively.

In the basic lens data, a surface number of an aspherical surface is marked with *, and a value of a paraxial curvature radius is shown in the field of the curvature radius of the aspherical surface. In Table 3, the column of Sn shows the surface numbers of the aspherical surfaces, and the columns of KA and Am show numerical values of the aspherical coefficients for each aspherical surface. It should be noted that m of Am is an integer equal to or more than 3, and varies depending on the surface. For example, m=4, 6, 8, 10, 12, 16, 18, 20 for the seventh surface according to Example 1. In Table 3, “E±n” (n: integer) of the numerical value of the aspherical coefficient means “×10^{±n}”. KA and Am are aspherical coefficients in an aspheric equation represented by the following equation.

$$Zd = C \times {h}^{2} / \{ 1 + {( 1 - KA \times {C}^{2} \times {h}^{2} )}^{1 / 2} \} + \sum Am \times {h}^{m}$$

Here,
Zd: aspherical surface depth (a length of a perpendicular line drawn from a point on the aspheric surface at height h to a plane perpendicular to the optical axis Z in which the apex of the aspheric surface is in contact),
h: height (distance from optical axis Z to lens surface),
C: reciprocal of paraxial curvature radius, and
KA, Am: aspherical coefficients,
and Σ means the sum with respect to m in aspherical surface equation.

Although, in the data of each table, a degree unit is used for angles, and a millimeter unit is used for lengths, since the optical system can also be proportionally enlarged or proportionally reduced to be used, other appropriate units can also be used. Further, numerical values rounded to predetermined digits are described in each table shown below.

TABLE 1
Example 1

| Sn | R | D | Nd | νd | ED |
|---|---|---|---|---|---|
| 1 | 93.9331 | 5.9589 | 1.55032 | 75.50 | 67.00 |
| 2 | 410.6246 | 0.0499 | | | 66.70 |
| 3 | 101.9917 | 1.6659 | 1.61340 | 44.27 | 65.38 |
| 4 | 50.0703 | 0.2139 | | | 62.14 |
| 5 | 50.6650 | 11.7419 | 1.43700 | 95.10 | 62.15 |
| 6 | 1622.8945 | DD[6] | | | 61.71 |
| *7 | −554.9292 | 0.8697 | 1.76413 | 52.73 | 33.78 |
| *8 | 63.8462 | 4.1547 | | | 32.00 |
| 9 | −70.4202 | 0.8539 | 1.60808 | 64.58 | 32.00 |
| 10 | 90.8447 | 2.3211 | 1.88238 | 20.88 | 32.76 |
| 11 | 585.9651 | DD[11] | | | 32.87 |
| 12(St) | ∞ | 0.0998 | | | 32.00 |
| *13 | 51.9302 | 5.5629 | 1.49710 | 81.56 | 32.62 |
| *14 | −74.3430 | DD[14] | | | 32.20 |
| 15 | −31.4167 | 0.7839 | 1.50105 | 54.80 | 29.33 |
| 16 | 63.9018 | 2.9650 | 1.84842 | 30.36 | 29.98 |
| 17 | −1641.5665 | DD[17] | | | 29.97 |
| 18 | 322.2347 | 3.3739 | 1.54598 | 60.27 | 30.00 |
| 19 | −61.3164 | 0.0497 | | | 30.17 |
| 20 | 243.5209 | 0.7997 | 1.99992 | 28.61 | 30.08 |
| 21 | 36.8141 | 6.0585 | 1.49700 | 81.61 | 29.80 |
| 22 | −72.4042 | 0.0499 | | | 30.05 |
| 23 | 49.0744 | 3.7813 | 1.52811 | 63.31 | 30.37 |
| 24 | −561.9594 | 0.0499 | | | 30.17 |
| 25 | 49.0438 | 3.4832 | 1.49637 | 60.38 | 29.46 |
| 26 | −1600.7938 | DD[26] | | | 29.00 |
| *27 | 97.7085 | 0.7271 | 1.60411 | 65.20 | 28.12 |
| *28 | 23.1089 | DD[28] | | | 26.66 |
| 29 | −356.8284 | 1.8395 | 2.00000 | 15.00 | 33.00 |
| 30 | −117.8563 | 5.5050 | | | 33.30 |
| *31 | −87.9119 | 2.0867 | 1.75689 | 53.47 | 33.38 |
| *32 | 136.3183 | DD[32] | | | 36.86 |

TABLE 2
Example 1

| | Wide | Middle | Tele |
|---|---|---|---|
| Zr | 1.0 | 1.7 | 2.7 |
| f | 72.10 | 124.96 | 194.02 |
| FNo. | 2.88 | 2.89 | 2.90 |
| 2ω[°] | 34.4 | 20.2 | 13.0 |
| DD[6] | 2.43 | 46.74 | 65.94 |
| DD[11] | 13.65 | 14.52 | 0.34 |
| DD[14] | 6.60 | 9.45 | 13.30 |
| DD[17] | 6.80 | 3.95 | 0.10 |
| DD[26] | 10.24 | 5.15 | 0.94 |
| DD[28] | 29.06 | 26.94 | 29.18 |
| DD[32] | 10.99 | 18.21 | 20.17 |

TABLE 3
Example 1

| Sn | 7 | 8 | 27 | 28 |
|---|---|---|---|---|
| KA | 1.0000000E+00 | 1.0000000E+00 | 1.0000000E+00 | 1.0000000E+00 |
| A4 | 5.6810896E−06 | 5.4334010E−06 | −2.3544017E−07 | −2.8092069E−06 |
| A6 | −2.5596111E−08 | −2.3924486E−08 | 4.5748768E−08 | 5.4899541E−08 |
| A8 | 1.1600696E−10 | 1.1665291E−10 | −5.2692549E−10 | −7.8412635E−10 |
| A10 | −3.4435417E−13 | −4.6118908E−13 | 3.0703131E−12 | 6.2065826E−12 |
| A12 | −9.2136424E−17 | 1.2990161E−15 | −4.8685615E−15 | −1.7560192E−14 |
| A14 | 6.9832525E−18 | −1.0478201E−18 | −2.9369210E−17 | −1.2237148E−16 |
| A16 | −3.5171807E−20 | −1.4374927E−20 | −5.0065972E−20 | 1.0013806E−18 |
| A18 | 8.2897199E−23 | 7.5284545E−23 | 1.4470342E−21 | −1.7713086E−21 |
| A20 | −8.0288170E−26 | −1.2072662E−25 | −3.6271430E−24 | −1.0749529E−24 |

| Sn | 13 | 14 | 31 | 32 |
|---|---|---|---|---|
| KA | 0.0000000E+00 | 0.0000000E+00 | −1.5302500E+00 | 0.0000000E+00 |
| A3 | 0.0000000E+00 | 0.0000000E+00 | 0.0000000E+00 | 0.0000000E+00 |
| A4 | 3.1013346E−07 | 8.0442058E−07 | −1.5330420E−04 | −1.6172630E−04 |
| A5 | −1.7458114E−07 | 4.3526037E−07 | 7.5624593E−06 | 7.7274392E−06 |
| A6 | 3.8294757E−08 | −4.8001123E−08 | −3.1168998E−08 | 6.1365104E−08 |
| A7 | −1.1073609E−09 | 2.6528127E−10 | −8.5290091E−09 | −1.2310449E−08 |
| A8 | −1.0845784E−10 | 1.6056477E−10 | 5.8478409E−10 | 1.4179535E−10 |
| A9 | 7.8695750E−13 | 4.7243066E−12 | −8.8902206E−12 | 2.5960787E−12 |
| A10 | 2.0183656E−13 | −9.0558452E−13 | −8.6789052E−13 | 4.0646194E−15 |
| A11 | 2.7291616E−14 | 2.8274245E−14 | −5.6393232E−14 | −6.9367249E−15 |
| A12 | 5.5850678E−16 | 4.1709338E−15 | 3.5029623E−15 | −3.5249536E−16 |
| A13 | 8.5364463E−17 | −4.7689274E−16 | −2.0164596E−16 | 3.2806621E−17 |
| A14 | −4.3086597E−18 | −7.0407774E−18 | 6.4750257E−18 | −3.5215562E−18 |
| A15 | −1.5824275E−18 | 1.4724837E−18 | 5.7733255E−19 | 9.0658440E−20 |
| A16 | 7.7215477E−20 | 7.2797499E−20 | −2.2837320E−20 | 3.5766217E−21 |
| A17 | 7.8989816E−22 | −2.9382427E−21 | −1.3784231E−22 | 6.0911850E−22 |
| A18 | −1.3513836E−23 | 1.7321821E−22 | 7.6800271E−23 | −2.8366087E−23 |
| A19 | −1.1513517E−23 | −5.7478748E−23 | 3.0989592E−24 | −2.5616454E−25 |
| A20 | 6.3207358E−25 | 2.4808068E−24 | −4.1061480E−25 | −2.9758705E−27 |

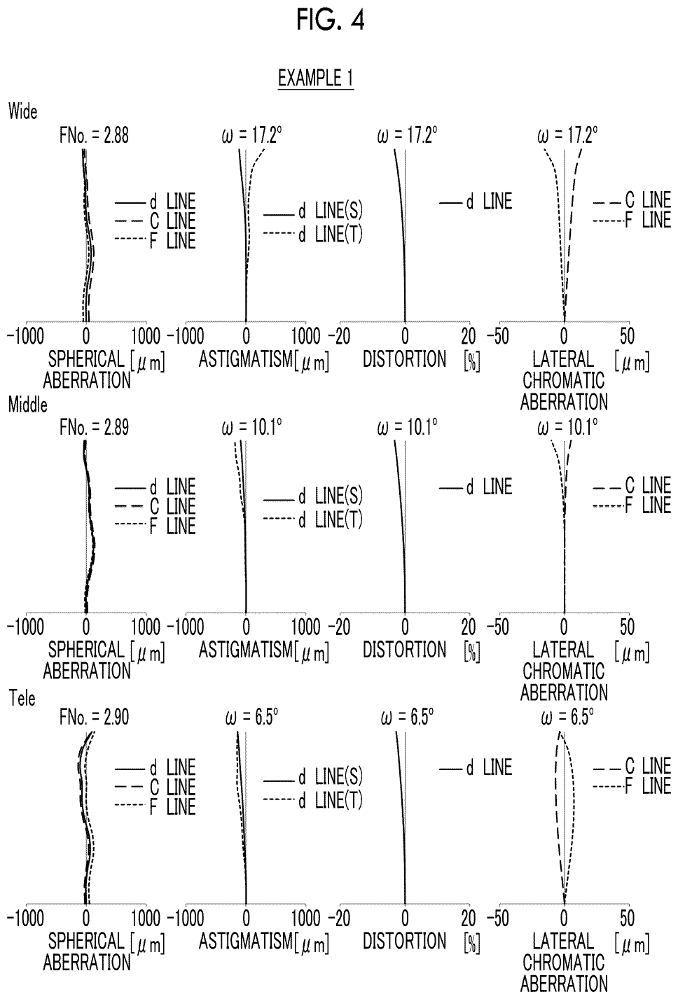

FIG. 4 shows each aberration diagram of the variable magnification optical system according to Example 1 in a state in which the infinite distance object is in focus. In FIG. 4, the spherical aberration, the astigmatism, the distortion, and the lateral chromatic aberration are shown in this order from the left. FIG. 4 shows aberrations in the wide angle end state in an upper part labeled “Wide”, aberrations in the middle focal length state in a middle part labeled “Middle”, and aberrations in the telephoto end state in a lower part labeled “Tele”. In the spherical aberration diagram, the aberrations on the d line, the C line, and the F line are shown by a solid line, a long broken line, and a short broken line, respectively. In the astigmatism diagram, the aberration on the d line in a sagittal direction is shown by a solid line, and the aberration on the d line in a tangential direction is shown by a short broken line. In the distortion diagram, the aberration on the d line is shown by a solid line. In the lateral chromatic aberration diagram, the aberrations on the C line and the F line are shown by a long broken line and a short broken line, respectively. In the spherical aberration diagram, a value of the open F-number is shown after FNo. =. In other aberration diagrams, a value of the maximum half angle of view is shown after ω=.

Symbols, meanings, description methods, and showing methods of each data related to Example 1 are basically the same in the following examples unless otherwise noted, and thus the duplicate description will be omitted below.

### Example 2

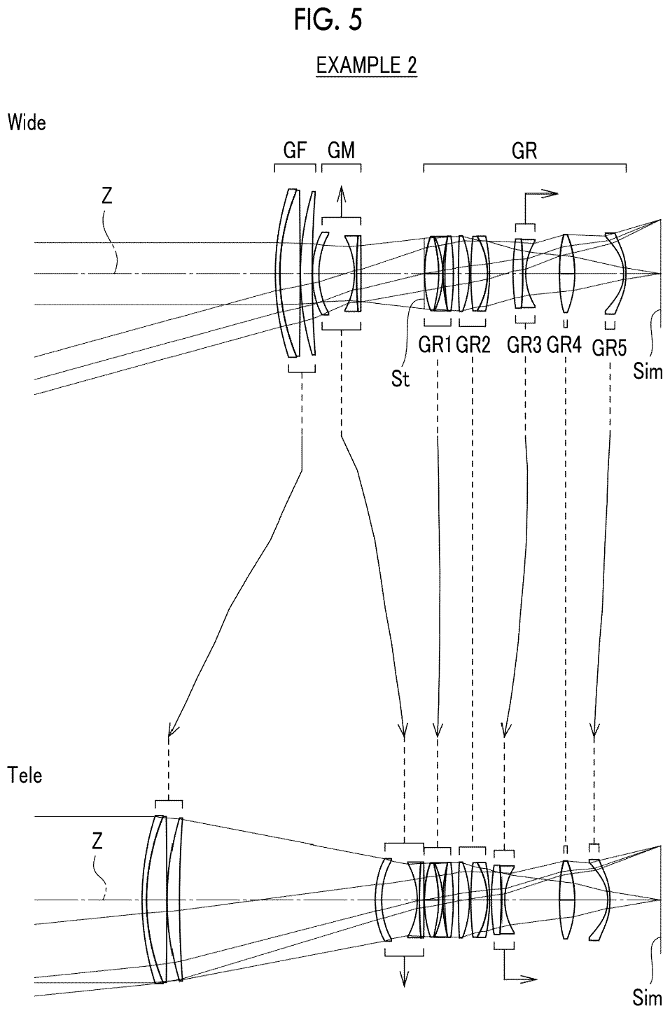

A configuration and a movement trajectory of a variable magnification optical system according to Example 2 are shown in FIG. 5. The variable magnification optical system according to Example 2 consists of the front group GF, the intermediate group GM, and the rear group GR in this order from the object side to the image side. The front group GF consists of one lens group having a positive refractive power. The intermediate group GM consists of one lens group having a negative refractive power. The rear group GR consists of the first subsequent lens group GR1 having a positive refractive power, the second subsequent lens group GR2 having a positive refractive power, the third subsequent lens group GR3 having a negative refractive power, the fourth subsequent lens group GR4 having a positive refractive power, and the fifth subsequent lens group GR5 having a negative refractive power, in this order from the object side to the image side.

During magnification change from the wide angle end to the telephoto end, the second subsequent lens group GR2 and the fourth subsequent lens group GR4 remain stationary with respect to the image plane Sim, and the other lens groups move while changing the spacings between the adjacent lens groups. The variable magnification optical system includes one focusing group, and the focusing group consists of the third subsequent lens group GR3. During focusing from the infinite distance object to the short range object, the third subsequent lens group GR3 moves to the image side, and the other lens groups remain stationary with respect to the image plane Sim. The anti-vibration group consists of the intermediate group GM.

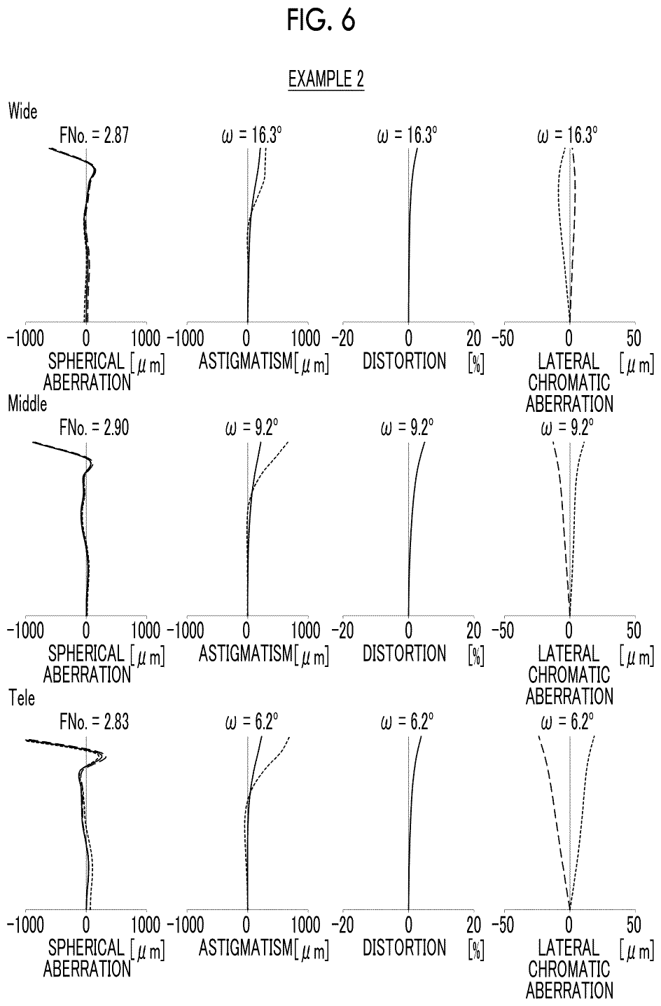

With respect to the variable magnification optical system according to Example 2, basic lens data is shown in Table 4, specifications and variable surface spacings are shown in Table 5, aspherical coefficients are shown in Table 6, and each aberration diagram is shown in FIG. 6.

TABLE 4
Example 2

| Sn | R | D | Nd | νd | ED |
|---|---|---|---|---|---|
| 1 | 114.8413 | 1.6782 | 2.00069 | 25.46 | 67.00 |
| 2 | 90.7641 | 7.5902 | 1.43700 | 95.10 | 66.11 |
| 3 | −2704.7008 | 0.1001 | | | 65.97 |
| 4 | 120.0408 | 4.4083 | 1.55032 | 75.50 | 65.06 |
| 5 | 464.2965 | DD[5] | | | 64.72 |
| *6 | 44.4313 | 2.4385 | 1.71773 | 56.83 | 33.00 |
| *7 | 37.4184 | 12.7713 | | | 31.12 |
| 8 | −31.9084 | 0.7759 | 1.57319 | 67.09 | 28.49 |
| 9 | 200.5436 | 1.5921 | 1.95848 | 17.08 | 29.01 |
| 10 | −1398.1203 | DD[10] | | | 29.07 |
| 11(St) | ∞ | 0.1002 | | | 29.25 |
| *12 | 50.6615 | 5.0877 | 1.49710 | 81.56 | 29.50 |
| *13 | −50.7558 | 1.4449 | | | 29.22 |
| 14 | −37.3900 | 0.7488 | 1.66367 | 38.00 | 29.19 |
| 15 | 103.5118 | 2.1467 | | | 29.74 |
| 16 | 63.3577 | 3.8215 | 1.49700 | 81.61 | 30.92 |
| 17 | −122.9706 | DD[17] | | | 31.00 |
| 18 | 375.8578 | 4.1075 | 1.81101 | 47.93 | 31.00 |
| 19 | −44.4426 | 0.5951 | | | 31.22 |
| 20 | 140.7501 | 6.2755 | 1.56580 | 51.96 | 30.41 |
| 21 | −30.3908 | 0.7675 | 1.98634 | 30.00 | 30.12 |
| 22 | −78.0804 | DD[22] | | | 30.41 |
| 23 | 96.7339 | 3.6854 | 1.92169 | 18.92 | 27.84 |
| 24 | −193.9700 | 1.1645 | 1.84900 | 44.05 | 27.28 |
| 25 | 25.8618 | DD[25] | | | 25.90 |
| *26 | 114.3054 | 5.4090 | 1.49710 | 81.56 | 31.00 |
| *27 | −48.3749 | DD[27] | | | 31.03 |
| *28 | −18.3009 | 0.8226 | 1.85805 | 43.12 | 29.85 |
| *29 | −35.5611 | DD[29] | | | 31.96 |

TABLE 5
Example 2

| | Wide | Middle | Tele |
|---|---|---|---|
| Zr | 1.0 | 1.8 | 2.7 |
| f | 72.12 | 126.73 | 192.64 |
| FNo. | 2.87 | 2.90 | 2.83 |
| 2ω[°] | 32.6 | 18.4 | 12.4 |
| DD[5] | 0.10 | 44.24 | 73.80 |
| DD[10] | 23.45 | 7.97 | 0.11 |
| DD[17] | 0.94 | 0.10 | 0.59 |
| DD[22] | 8.73 | 6.96 | 0.89 |
| DD[25] | 11.80 | 13.58 | 19.64 |
| DD[27] | 18.42 | 15.43 | 12.51 |
| DD[29] | 14.03 | 17.03 | 19.94 |

TABLE 6
Example 2

| Sn | 6 | 7 | 12 | 13 |
|---|---|---|---|---|
| KA | 1.0000000E+00 | 1.0000000E+00 | 1.0000000E+00 | 1.0000000E+00 |
| A4 | 2.4215590E−06 | 5.6838607E−07 | −3.1183691E−06 | 5.1602381E−06 |
| A6 | 3.7803829E−09 | −6.8372180E−09 | 8.0135829E−09 | 1.7151792E−08 |
| A8 | 3.5507976E−11 | 1.5952733E−10 | 2.2615555E−10 | −1.0494963E−10 |
| A10 | 3.6529520E−13 | −6.9980506E−14 | −3.3539479E−12 | 1.4366342E−12 |
| A12 | −2.7535240E−15 | −3.4946190E−15 | 2.2338429E−14 | −7.7160263E−15 |
| A14 | 1.1473706E−17 | 1.9333527E−17 | −4.1587634E−17 | 1.2433315E−17 |
| A16 | −3.6758507E−20 | −3.2088113E−20 | −6.0063164E−20 | 1.9880507E−19 |
| A18 | 1.0288702E−22 | 3.0512855E−23 | 9.6408933E−23 | −1.1199126E−21 |
| A20 | −1.2804377E−25 | −4.3064598E−26 | 6.9300965E−25 | 1.9663135E−24 |
| Sn | 26 | 27 | 28 | 29 |
| KA | 1.0000000E+00 | 1.0000000E+00 | 1.0000000E+00 | 1.0000000E+00 |
| A4 | 7.8904203E−06 | −1.0316122E−06 | −4.5357454E−05 | −5.3790867E−05 |
| A6 | −1.6831054E−08 | −2.5909953E−08 | 2.7824767E−07 | 2.9643605E−07 |
| A8 | 1.5480188E−11 | 1.0057892E−10 | 4.3257670E−10 | −3.2299448E−10 |
| A10 | 8.5132116E−13 | −9.4857977E−14 | −1.5036354E−12 | −4.6564722E−14 |
| A12 | −1.6730671E−15 | 3.8932454E−15 | 6.1023185E−15 | 2.1809124E−15 |
| A14 | −1.1805434E−18 | −1.0046453E−17 | −3.3691680E−17 | −1.1478003E−17 |
| A16 | −1.5661029E−20 | −2.0738022E−20 | −1.7862943E−20 | 6.0695465E−21 |
| A18 | 7.0948640E−23 | −2.1398485E−23 | 1.8686227E−22 | −1.8585743E−23 |
| A20 | 1.2694740E−25 | 4.7954134E−25 | 2.7478355E−25 | 1.5242049E−25 |

### Example 3

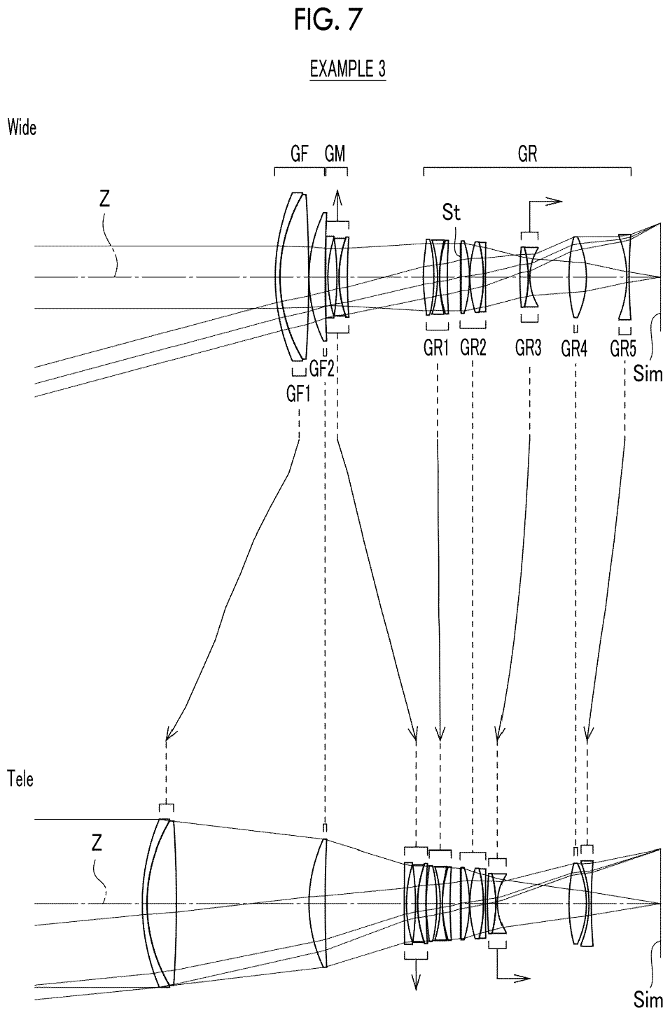

A configuration and a movement trajectory of a variable magnification optical system according to Example 3 are shown in FIG. 7. The variable magnification optical system according to Example 3 consists of the front group GF, the intermediate group GM, and the rear group GR in this order from the object side to the image side. The front group GF consists of the first front side lens group GF1 having a positive refractive power and the second front side lens group GF2 having a positive refractive power, in this order from the object side to the image side. The intermediate group GM consists of one lens group having a negative refractive power. The rear group GR consists of the first subsequent lens group GR1 having a positive refractive power, the second subsequent lens group GR2 having a positive refractive power, the third subsequent lens group GR3 having a negative refractive power, the fourth subsequent lens group GR4 having a positive refractive power, and the fifth subsequent lens group GR5 having a negative refractive power, in this order from the object side to the image side.

During magnification change from the wide angle end to the telephoto end, the second front side lens group GF2, the second subsequent lens group GR2, and the fourth subsequent lens group GR4 remain stationary with respect to the image plane Sim, and the other lens groups move while changing the spacings between the adjacent lens groups. The variable magnification optical system includes one focusing group, and the focusing group consists of the third subsequent lens group GR3. During focusing from the infinite distance object to the short range object, the third subsequent lens group GR3 moves to the image side, and the other lens groups remain stationary with respect to the image plane Sim. The anti-vibration group consists of the intermediate group GM.

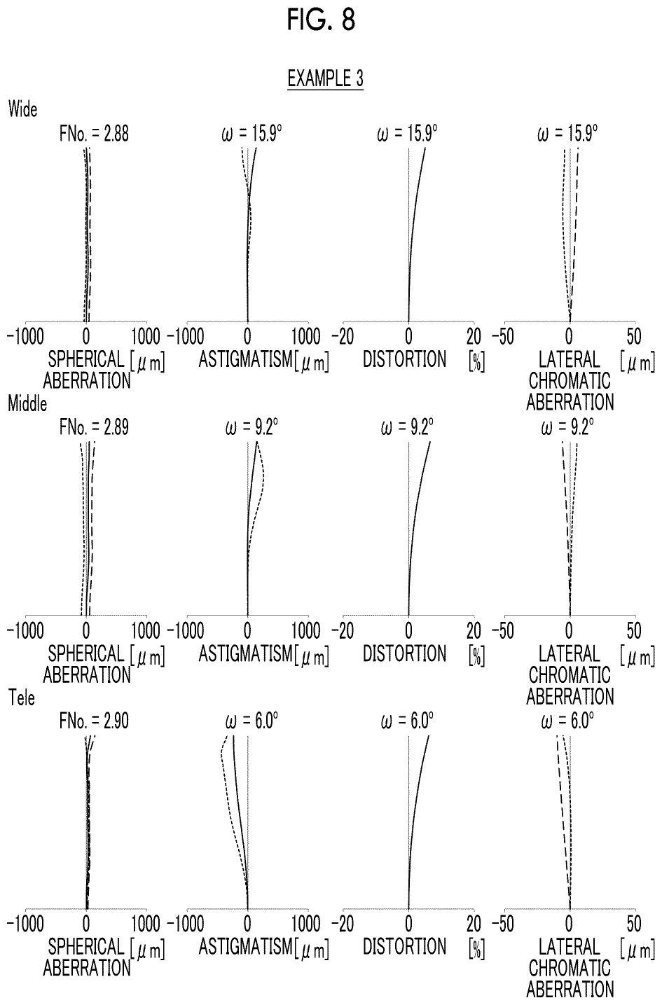

With respect to the variable magnification optical system according to Example 3, basic lens data is shown in Table 7, specifications and variable surface spacings are shown in Table 8, aspherical coefficients are shown in Table 9, and each aberration diagram is shown in FIG. 8.

TABLE 7
Example 3

| Sn | R | D | Nd | νd | ED |
|---|---|---|---|---|---|
| 1 | 90.1953 | 1.7788 | 1.95375 | 32.32 | 67.00 |
| 2 | 67.5126 | 10.8415 | 1.43700 | 95.10 | 65.54 |
| 3 | −522.6556 | DD[3] | | | 65.36 |
| 4 | 62.7273 | 6.0792 | 1.49700 | 81.61 | 51.04 |
| 5 | 555.1550 | DD[5] | | | 50.48 |
| *6 | 631.6008 | 0.8410 | 1.81813 | 47.20 | 32.66 |
| *7 | 53.5666 | 3.3987 | | | 31.00 |
| 8 | −116.7441 | 0.8090 | 1.58110 | 61.73 | 30.98 |
| 9 | 48.9309 | 3.1281 | 1.85296 | 22.35 | 31.01 |
| 10 | 223.4825 | DD[10] | | | 30.91 |
| *11 | 76.0303 | 3.9616 | 1.75878 | 53.28 | 30.36 |
| *12 | −83.0692 | 1.3445 | | | 30.32 |
| 13 | −54.5871 | 0.7656 | 1.80466 | 27.66 | 29.68 |
| 14 | 63.0592 | 0.0519 | | | 29.28 |
| 15 | 50.2030 | 2.9014 | 1.82060 | 46.95 | 29.41 |
| 16 | 251.1882 | DD[16] | | | 29.26 |
| 17(St) | ∞ | 0.4458 | | | 28.77 |
| 18 | −1352.3849 | 3.0982 | 1.88246 | 40.49 | 28.84 |
| 19 | −52.5447 | 0.1569 | | | 28.96 |
| 20 | 49.9167 | 5.1231 | 1.59282 | 68.62 | 28.18 |
| 21 | −58.9999 | 0.7180 | 1.93271 | 32.89 | 27.77 |
| 22 | 643.5877 | DD[22] | | | 27.42 |
| 23 | 143.1136 | 3.1347 | 1.87399 | 23.54 | 24.00 |
| 24 | −49.5769 | 0.6286 | 1.80046 | 47.68 | 23.86 |
| *25 | 23.1932 | DD[25] | | | 23.12 |
| *26 | 74.2984 | 6.5722 | 1.59201 | 67.02 | 32.00 |
| *27 | −39.4839 | DD[27] | | | 32.35 |
| *28 | −46.8243 | 0.8776 | 1.81454 | 39.73 | 32.57 |
| 29 | 222.7125 | DD[29] | | | 34.14 |

TABLE 8
Example 3

| | Wide | Middle | Tele |
|---|---|---|---|
| Zr | 1.0 | 1.7 | 2.7 |
| f | 72.11 | 124.99 | 194.06 |
| FNo. | 2.88 | 2.89 | 2.90 |
| 2ω[°] | 31.8 | 18.4 | 12.0 |
| DD[3] | 0.10 | 27.73 | 49.97 |
| DD[5] | 0.20 | 16.51 | 29.81 |
| DD[10] | 28.65 | 12.79 | 0.10 |
| DD[16] | 4.81 | 4.37 | 3.75 |
| DD[22] | 12.77 | 8.26 | 0.77 |
| DD[25] | 14.72 | 19.23 | 26.72 |
| DD[27] | 15.22 | 8.00 | 0.97 |
| DD[29] | 11.89 | 19.10 | 26.14 |

TABLE 9
Example 3

| Sn | 6 | 7 | 11 | 12 |
|---|---|---|---|---|
| KA | 1.0000000E+00 | 1.0000000E+00 | 1.0000000E+00 | 1.0000000E+00 |
| A4 | −1.8513011E−06 | −1.8575529E−06 | −2.9221863E−06 | −5.1233919E−07 |
| A6 | 5.3265906E−10 | 1.3630763E−09 | −1.4615006E−08 | −1.9513351E−08 |
| A8 | 4.2089629E−11 | 1.1524149E−11 | 3.2752056E−11 | 1.0595500E−10 |
| A10 | −2.2621281E−13 | 4.4800984E−14 | −2.7895380E−13 | −4.3852633E−13 |
| A12 | 5.2224256E−16 | −2.7841975E−16 | 1.9414433E−15 | −7.0360369E−16 |
| A14 | 7.3263702E−19 | −4.2292252E−19 | −1.1497832E−17 | 7.0162977E−18 |
| A16 | −9.2032119E−21 | 6.3971073E−21 | 6.5497998E−21 | −2.0142121E−21 |
| A18 | 2.1021061E−23 | −3.0075641E−23 | 1.6248850E−22 | −7.6104912E−23 |
| A20 | −1.1978403E−26 | 5.4715224E−26 | −5.7332326E−25 | −1.5710629E−27 |

| Sn | 25 | 26 | 27 | 28 |
|---|---|---|---|---|
| KA | 1.0000000E+00 | 1.0000000E+00 | 1.0000000E+00 | 1.0000000E+00 |
| A4 | 3.7323774E−07 | −1.3091922E−06 | −7.4854306E−07 | 9.1741095E−07 |
| A6 | −2.3290786E−08 | 3.1795347E−08 | 1.7521775E−08 | −1.2584449E−08 |
| A8 | 7.3535980E−10 | −2.4077082E−10 | −6.6262736E−11 | 8.3596058E−11 |
| A10 | −1.3693550E−11 | 9.4977980E−13 | −4.1641678E−13 | −6.8564754E−13 |
| A12 | 1.4069040E−13 | 6.0191555E−16 | 3.8822911E−15 | 4.2351030E−15 |
| A14 | −6.3319981E−16 | −1.3527528E−17 | 3.0358307E−18 | −1.3033741E−17 |
| A16 | −1.3487108E−18 | 7.6182553E−21 | −1.0094608E−19 | 1.8283660E−21 |
| A18 | 2.6093029E−20 | 9.2774403E−23 | 2.6296336E−22 | 8.2304925E−23 |
| A20 | −7.8006957E−23 | −8.3372756E−26 | −9.0299676E−26 | −1.3331897E−25 |

### Example 4

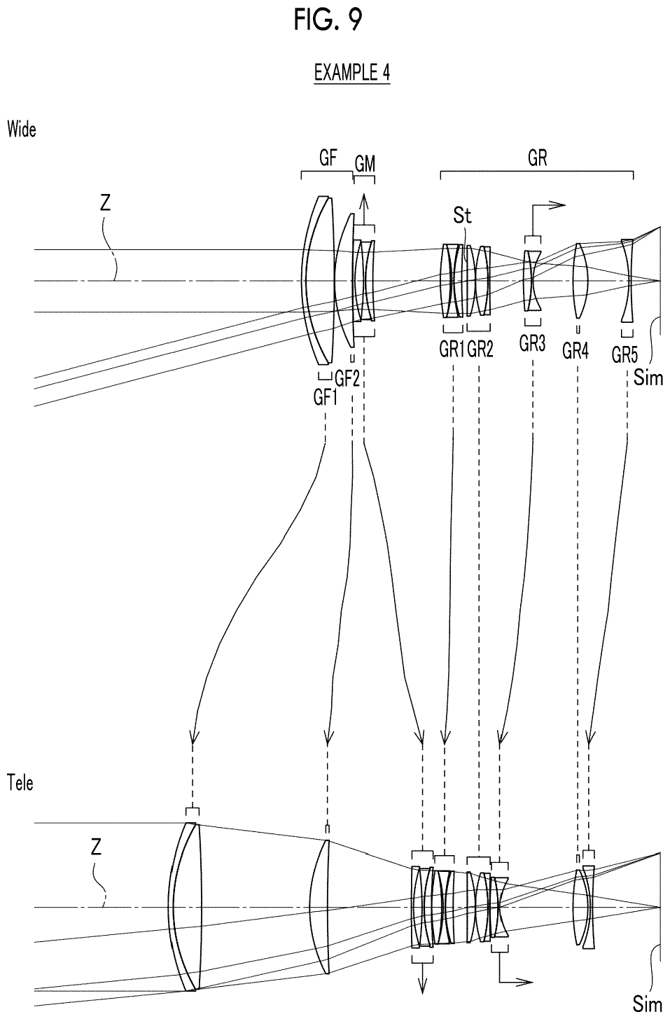

A configuration and a movement trajectory of a variable magnification optical system according to Example 4 are shown in FIG. 9. The variable magnification optical system according to Example 4 consists of the front group GF, the intermediate group GM, and the rear group GR in this order from the object side to the image side. The front group GF consists of the first front side lens group GF1 having a positive refractive power and the second front side lens group GF2 having a positive refractive power, in this order from the object side to the image side. The intermediate group GM consists of one lens group having a negative refractive power. The rear group GR consists of the first subsequent lens group GR1 having a positive refractive power, the second subsequent lens group GR2 having a positive refractive power, the third subsequent lens group GR3 having a negative refractive power, the fourth subsequent lens group GR4 having a positive refractive power, and the fifth subsequent lens group GR5 having a negative refractive power, in this order from the object side to the image side.

During magnification change from the wide angle end to the telephoto end, the second subsequent lens group GR2 and the fourth subsequent lens group GR4 remain stationary with respect to the image plane Sim, and the other lens groups move while changing the spacings between the adjacent lens groups. The variable magnification optical system includes one focusing group, and the focusing group consists of the third subsequent lens group GR3. During focusing from the infinite distance object to the short range object, the third subsequent lens group GR3 moves to the image side, and the other lens groups remain stationary with respect to the image plane Sim. The anti-vibration group consists of the intermediate group GM.

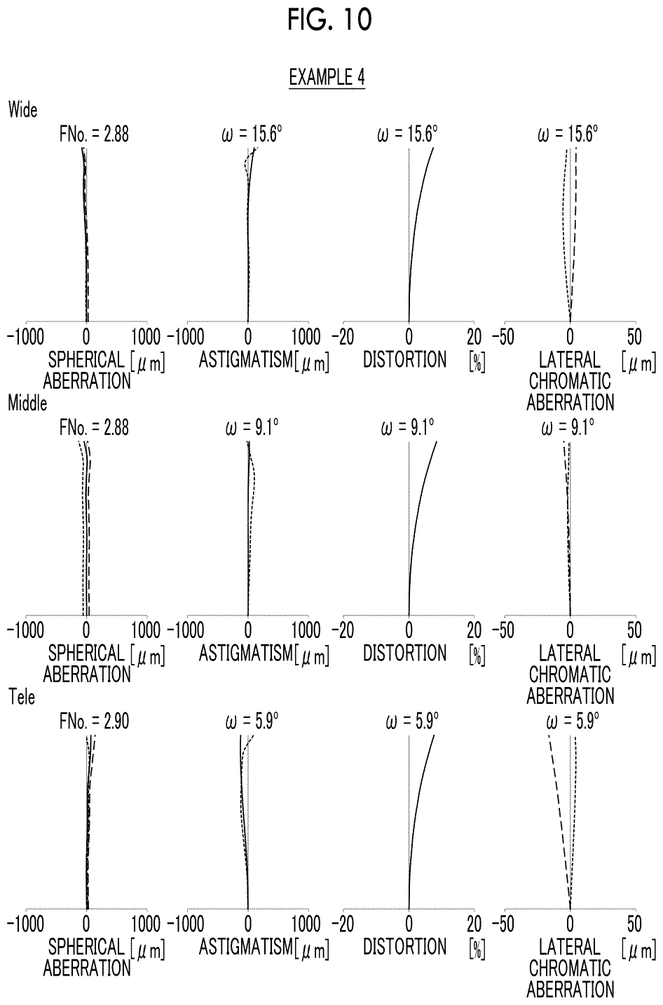

For the variable magnification optical system according to Example 4, basic lens data is shown in Table 10, specifications and variable surface spacings are shown in Table 11, aspherical coefficients are shown in Table 12, and each aberration diagram is shown in FIG. 10.

TABLE 10
Example 4

| Sn | R | D | Nd | νd | ED |
|---|---|---|---|---|---|
| 1 | 89.8332 | 1.6743 | 1.95375 | 32.32 | 67.00 |
| 2 | 68.0231 | 10.7067 | 1.43700 | 95.10 | 65.60 |
| 3 | −562.5585 | DD[3] | | | 65.42 |
| 4 | 60.9428 | 6.7367 | 1.49700 | 81.61 | 53.11 |
| 5 | 582.3484 | DD[5] | | | 52.51 |
| *6 | 508.6577 | 0.8403 | 1.84694 | 42.14 | 32.61 |
| *7 | 55.3027 | 3.1980 | | | 31.00 |
| 8 | −132.3639 | 0.8094 | 1.59896 | 66.00 | 30.98 |
| 9 | 54.8550 | 2.7427 | 1.91315 | 19.34 | 30.77 |
| 10 | 205.5312 | DD[10] | | | 30.62 |
| *11 | 75.6724 | 3.7598 | 1.75107 | 54.06 | 29.39 |
| *12 | −82.9052 | 0.5711 | | | 29.24 |
| 13 | −54.4722 | 0.7554 | 1.81111 | 24.44 | 29.24 |
| 14 | 63.7028 | 0.1157 | | | 28.82 |
| 15 | 49.7539 | 2.8673 | 1.81262 | 47.77 | 28.94 |
| 16 | 254.0339 | DD[16] | | | 28.76 |
| 17(St) | ∞ | 0.1001 | | | 28.17 |
| 18 | −1509.7874 | 3.0210 | 1.88186 | 37.01 | 28.18 |
| 19 | −52.2758 | 0.0500 | | | 28.29 |
| 20 | 49.7404 | 4.7040 | 1.59282 | 68.62 | 27.51 |
| 21 | −62.0404 | 0.6979 | 1.91958 | 36.83 | 27.17 |
| 22 | 786.7545 | DD[22] | | | 26.84 |
| 23 | 135.3731 | 2.9900 | 1.85347 | 22.34 | 24.00 |
| 24 | −54.4286 | 0.6243 | 1.80419 | 48.63 | 23.64 |
| *25 | 22.5823 | DD[25] | | | 22.41 |
| *26 | 79.8036 | 5.6237 | 1.59201 | 67.02 | 29.50 |
| *27 | −35.7844 | DD[27] | | | 29.89 |
| *28 | −46.7783 | 0.8424 | 1.87939 | 40.94 | 31.34 |
| 29 | 208.7877 | DD[29] | | | 33.06 |

TABLE 11
Example 4

| | Wide | Middle | Tele |
|---|---|---|---|
| Zr | 1.0 | 1.7 | 2.7 |
| f | 72.12 | 124.99 | 194.07 |
| FNo. | 2.88 | 2.88 | 2.90 |
| 2ω[°] | 31.2 | 18.2 | 11.8 |
| DD[3] | 0.10 | 29.43 | 40.70 |
| DD[5] | 0.10 | 16.33 | 31.59 |
| DD[10] | 25.42 | 12.15 | 0.10 |
| DD[16] | 2.01 | 3.24 | 5.25 |
| DD[22] | 12.44 | 7.63 | 0.10 |
| DD[25] | 15.05 | 19.86 | 27.39 |
| DD[27] | 15.45 | 8.26 | 0.92 |
| DD[29] | 11.01 | 18.20 | 25.54 |

TABLE 12
Example 4

| Sn | 6 | 7 | 11 | 12 |
|---|---|---|---|---|
| KA | 1.0000000E+00 | 1.0000000E+00 | 1.0000000E+00 | 1.0000000E+00 |
| A4 | −8.8962925E−07 | −6.7064046E−07 | −2.7091476E−06 | −1.6612426E−07 |
| A6 | 1.5867462E−09 | 3.3711671E−09 | −1.5460135E−08 | −1.4381791E−08 |
| A8 | 3.3163585E−11 | 2.4120663E−11 | 1.0392793E−10 | 7.8173955E−11 |
| A10 | −2.7687366E−13 | −3.0693520E−13 | −6.3260226E−13 | −1.1192522E−13 |
| A12 | 1.0825149E−16 | 9.4104542E−16 | 1.5618012E−15 | −2.7544227E−15 |
| A14 | 5.3772486E−18 | −1.1685270E−18 | −3.1955661E−18 | 1.4837758E−17 |
| A16 | −1.9832814E−20 | 5.9572553E−21 | −5.7965397E−21 | −2.0918683E−20 |
| A18 | 2.5896296E−23 | −1.6372022E−23 | 1.3565048E−22 | −2.0240794E−23 |
| A20 | −1.1464715E−26 | −5.6475295E−28 | −5.2583412E−25 | −1.1163616E−25 |

| Sn | 25 | 26 | 27 | 28 |
|---|---|---|---|---|
| KA | 1.0000000E+00 | 1.0000000E+00 | 1.0000000E+00 | 1.0000000E+00 |
| A4 | −6.1982846E−07 | 3.7682785E−07 | 3.1559692E−06 | 2.5774396E−07 |
| A6 | −1.8691752E−08 | 1.1035989E−09 | −2.1431028E−08 | −1.3322529E−08 |
| A8 | 5.7610977E−10 | −6.0486835E−11 | 1.3664187E−10 | 8.7005300E−11 |
| A10 | −8.0363144E−12 | 3.0433366E−13 | −9.0330582E−13 | −4.9794996E−13 |
| A12 | 2.1831250E−14 | 2.5958400E−15 | 5.1038612E−15 | 2.1118959E−15 |
| A14 | 5.4475261E−16 | −1.7854285E−17 | −8.2431308E−18 | −4.7767039E−18 |
| A16 | −4.9765232E−18 | −2.4825902E−20 | −6.8015931E−20 | −1.5291138E−20 |
| A18 | 1.0075100E−20 | 3.3928316E−22 | 3.0977026E−22 | 1.2344391E−22 |
| A20 | 1.5212120E−23 | −5.3555971E−25 | −3.2024356E−25 | −2.1129873E−25 |

### Example 5

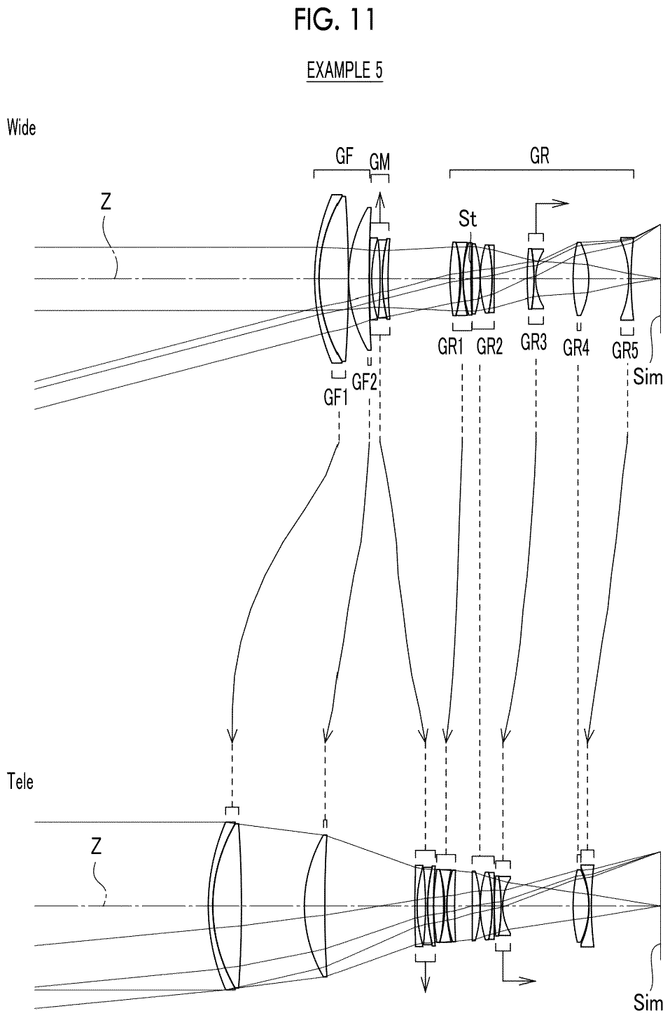

A configuration and a movement trajectory of a variable magnification optical system according to Example 5 are shown in FIG. 11. The variable magnification optical system according to Example 5 consists of the front group GF, the intermediate group GM, and the rear group GR in this order from the object side to the image side. The front group GF consists of the first front side lens group GF1 having a positive refractive power and the second front side lens group GF2 having a positive refractive power, in this order from the object side to the image side. The intermediate group GM consists of one lens group having a negative refractive power. The rear group GR consists of the first subsequent lens group GR1 having a positive refractive power, the second subsequent lens group GR2 having a positive refractive power, the third subsequent lens group GR3 having a negative refractive power, the fourth subsequent lens group GR4 having a positive refractive power, and the fifth subsequent lens group GR5 having a negative refractive power, in this order from the object side to the image side.

During magnification change from the wide angle end to the telephoto end, the second subsequent lens group GR2 and the fourth subsequent lens group GR4 remain stationary with respect to the image plane Sim, and the other lens groups move while changing the spacings between the adjacent lens groups. The variable magnification optical system includes one focusing group, and the focusing group consists of the third subsequent lens group GR3. During focusing from the infinite distance object to the short range object, the third subsequent lens group GR3 moves to the image side, and the other lens groups remain stationary with respect to the image plane Sim. The anti-vibration group consists of the intermediate group GM.

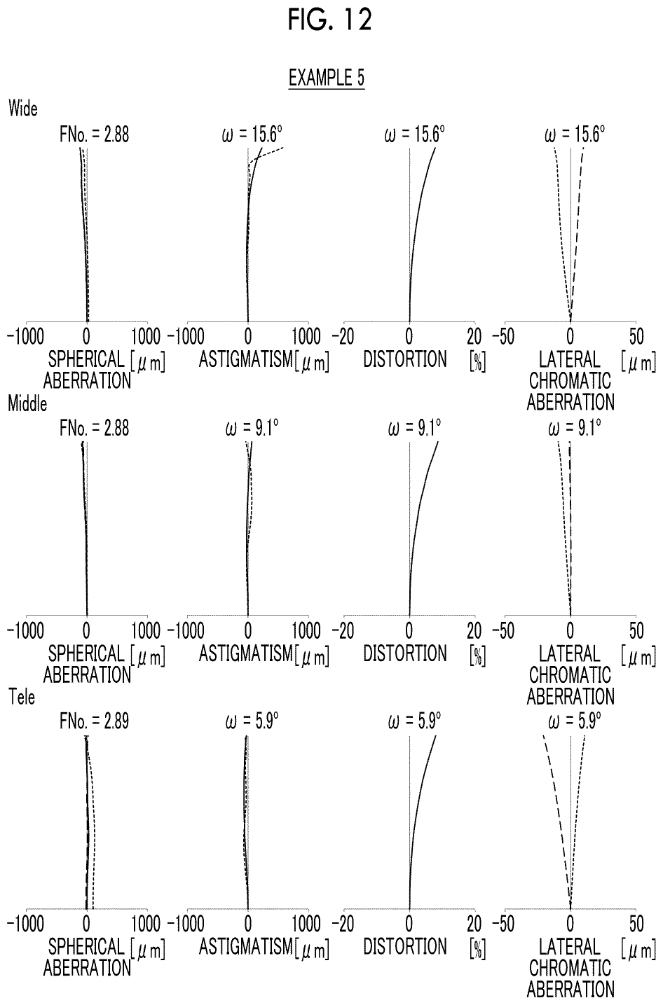

With respect to the variable magnification optical system according to Example 5, basic lens data is shown in Table 13, specifications and variable surface spacings are shown in Table 14, aspherical coefficients are shown in Table 15, and each aberration diagram is shown in FIG. 12.

TABLE 13
Example 5

| Sn | R | D | Nd | νd | ED |
|---|---|---|---|---|---|
| 1 | 88.9645 | 1.6737 | 1.95375 | 32.32 | 67.00 |
| 2 | 68.1206 | 10.8139 | 1.43700 | 95.10 | 65.62 |
| 3 | −501.4863 | DD[3] | | | 65.42 |
| 4 | 59.4246 | 7.6897 | 1.49700 | 81.61 | 56.68 |
| 5 | 512.6387 | DD[5] | | | 56.01 |
| *6 | 440.9315 | 0.8384 | 1.89718 | 39.12 | 32.53 |
| *7 | 57.8498 | 3.1577 | | | 31.00 |
| 8 | −156.4151 | 0.8079 | 1.62382 | 62.12 | 30.92 |
| 9 | 69.1082 | 2.1744 | 2.00004 | 15.00 | 30.61 |
| 10 | 188.5496 | DD[10] | | | 30.44 |
| *11 | 74.9109 | 3.7455 | 1.73842 | 55.36 | 29.12 |
| *12 | −80.6743 | 0.4436 | | | 28.97 |
| 13 | −54.8665 | 0.7481 | 1.83582 | 23.21 | 28.98 |
| 14 | 64.6946 | 0.0500 | | | 28.54 |
| 15 | 48.9186 | 2.8929 | 1.79205 | 49.87 | 28.66 |
| 16 | 270.7988 | DD[16] | | | 28.48 |
| 17(St) | ∞ | 0.0998 | | | 27.58 |
| 18 | −1905.7028 | 2.9371 | 1.86532 | 30.69 | 27.59 |
| 19 | −52.6120 | 0.0500 | | | 27.73 |
| 20 | 48.2268 | 4.4753 | 1.59282 | 68.62 | 27.00 |
| 21 | −68.6787 | 0.6908 | 1.91635 | 37.16 | 26.69 |
| 22 | 2133.1839 | DD[22] | | | 26.41 |
| 23 | 134.7283 | 2.5500 | 1.88616 | 20.69 | 24.00 |
| 24 | −77.2960 | 0.6220 | 1.83007 | 45.98 | 23.59 |
| *25 | 21.8528 | DD[25] | | | 21.85 |
| *26 | 67.5358 | 5.9229 | 1.59201 | 67.02 | 28.50 |
| *27 | −34.4649 | DD[27] | | | 28.94 |
| *28 | −40.3863 | 0.8417 | 1.77004 | 52.12 | 30.64 |
| 29 | 140.1712 | DD[29] | | | 32.69 |

TABLE 14
Example 5

| | Wide | Middle | Tele |
|---|---|---|---|
| Zr | 1.0 | 1.7 | 2.7 |
| f | 72.11 | 124.99 | 194.06 |
| FNo. | 2.88 | 2.88 | 2.89 |
| 2ω[°] | 31.2 | 18.2 | 11.8 |
| DD[3] | 0.10 | 25.05 | 23.68 |
| DD[5] | 0.17 | 16.80 | 33.68 |
| DD[10] | 23.28 | 12.48 | 0.10 |
| DD[16] | 0.47 | 2.70 | 6.58 |
| DD[22] | 12.52 | 7.68 | 0.10 |
| DD[25] | 14.09 | 18.93 | 26.51 |
| DD[27] | 15.06 | 7.77 | 0.10 |
| DD[29] | 11.08 | 18.37 | 26.04 |

TABLE 15
Example 5

| Sn | 6 | 7 | 11 | 12 |
|---|---|---|---|---|
| KA | 1.0000000E+00 | 1.0000000E+00 | 1.0000000E+00 | 1.0000000E+00 |
| A4 | 2.4810564E−07 | 5.2753667E−07 | −4.1176095E−06 | −1.4396562E−06 |
| A6 | −5.4275437E−09 | −2.0839311E−09 | −5.4097709E−09 | −1.9193187E−09 |
| A8 | 3.6065654E−11 | 1.0753900E−11 | 1.7792556E−11 | −2.9311811E−11 |
| A10 | −2.9071920E−13 | −2.2258275E−13 | −3.2189938E−13 | 2.7084826E−13 |
| A12 | 9.9663359E−16 | 9.8597154E−16 | −1.5311040E−18 | −3.9757204E−15 |
| A14 | 1.4048496E−18 | 7.0399947E−19 | −4.6527373E−20 | 1.6099198E−17 |
| A16 | −1.9828668E−20 | −1.0321146E−20 | 2.3072006E−20 | −7.7814166E−22 |
| A18 | 5.2730898E−23 | 5.9309205E−24 | 2.9218506E−23 | −6.6851358E−23 |
| A20 | −4.8142065E−26 | 2.3639292E−26 | −6.2217178E−25 | −2.7488433E−25 |

| Sn | 25 | 26 | 27 | 28 |
|---|---|---|---|---|
| KA | 1.0000000E+00 | 1.0000000E+00 | 1.0000000E+00 | 1.0000000E+00 |
| A4 | −5.7364656E−07 | 4.6672321E−07 | 2.7566424E−06 | 1.3910750E−06 |
| A6 | −5.6397398E−08 | −1.3632439E−08 | −6.4695765E−09 | −1.7709668E−08 |
| A8 | 1.0695369E−09 | 7.9199003E−11 | −1.4118861E−11 | 1.4021364E−10 |
| A10 | −9.0129611E−12 | −1.4765389E−13 | −4.2844588E−13 | −8.7389443E−13 |
| A12 | 1.4310921E−14 | 3.5147304E−15 | 8.3240519E−15 | 2.4146868E−15 |
| A14 | −3.1595834E−16 | −1.9330991E−17 | −3.0393527E−17 | 5.8397848E−18 |
| A16 | 1.1704070E−17 | −2.9894585E−20 | 4.6221182E−20 | −6.5356936E−20 |
| A18 | −1.0281841E−19 | 2.3662455E−22 | −5.7337565E−22 | 1.8377230E−22 |
| A20 | 2.8460557E−22 | 2.9233334E−25 | 2.3438929E−24 | −1.8517955E−25 |

### Example 6

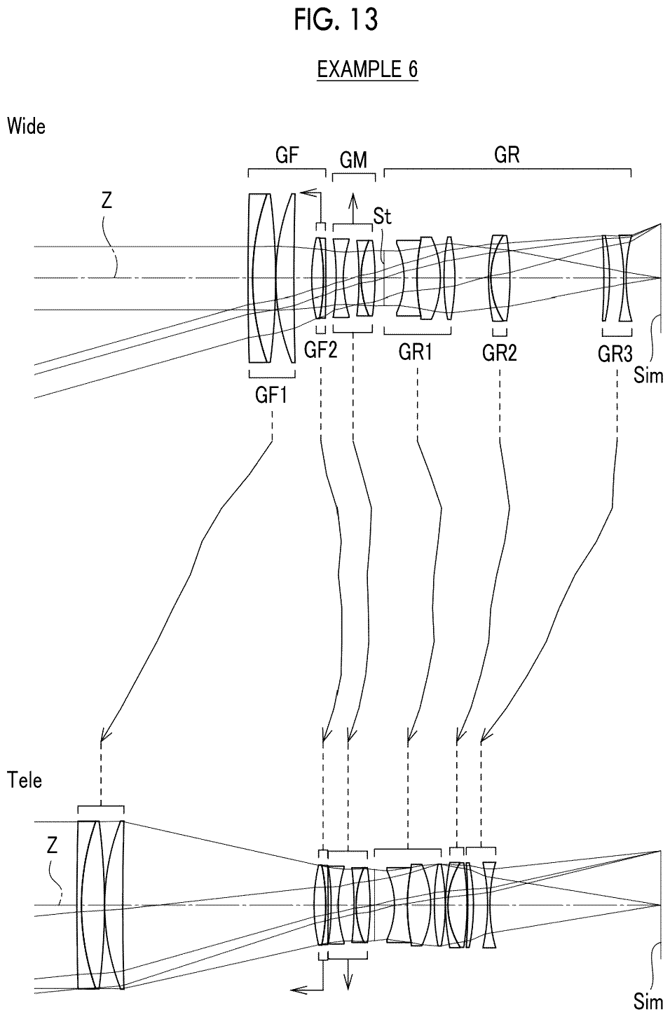

A configuration and a movement trajectory of a variable magnification optical system according to Example 6 are shown in FIG. 13. The variable magnification optical system according to Example 6 consists of the front group GF, the intermediate group GM, and the rear group GR in this order from the object side to the image side. The front group GF consists of the first front side lens group GF1 having a positive refractive power and the second front side lens group GF2 having a positive refractive power, in this order from the object side to the image side. The intermediate group GM consists of one lens group having a negative refractive power. The rear group GR consists of the first subsequent lens group GR1 having a positive refractive power, the second subsequent lens group GR2 having a positive refractive power, and the third subsequent lens group GR3 having a negative refractive power, in this order from the object side to the image side.

During magnification change from the wide angle end to the telephoto end, all the lens groups move while changing the spacings between the adjacent lens groups. The variable magnification optical system includes one focusing group, and the focusing group consists of the second front side lens group GF2. During focusing from the infinite distance object to the short range object, the second front side lens group GF2 moves to the object side, and other lens groups remain stationary with respect to the image plane Sim. The anti-vibration group consists of the intermediate group GM.

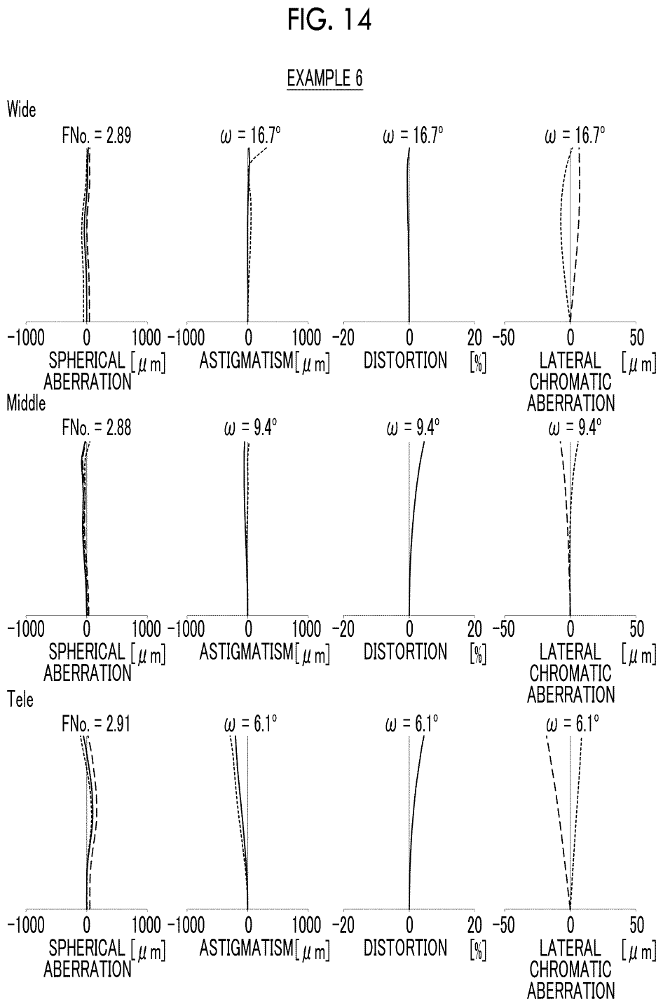

With respect to the variable magnification optical system according to Example 6, basic lens data is shown in Table 16, specifications and variable surface spacings are shown in Table 17, aspherical coefficients are shown in Table 18, and each aberration diagram is shown in FIG. 14.

TABLE 16
Example 6

| Sn | R | D | Nd | νd | ED |
|---|---|---|---|---|---|
| 1 | 1325.6020 | 1.7030 | 1.80100 | 34.97 | 67.00 |
| 2 | 106.3042 | 8.6566 | 1.49700 | 81.61 | 66.84 |
| 3 | −278.5467 | 0.1002 | | | 66.97 |
| 4 | 961234 | 6.7906 | 1.75500 | 52.32 | 67.28 |
| 5 | 1292.4677 | DD[5] | | | 66.93 |
| 6 | 75.1907 | 4.4255 | 1.72394 | 56.52 | 32.00 |
| 7 | −85.0238 | 0.8926 | 1.89321 | 27.20 | 31.65 |
| 8 | −736.6929 | DD[8] | | | 31.16 |
| *9 | −167.7623 | 2.4467 | 1.83092 | 45.90 | 31.05 |
| *10 | 43.0676 | 5.9364 | | | 29.53 |
| 11 | −134.5363 | 0.7823 | 1.72062 | 43.23 | 29.50 |
| 12 | 39.2513 | 5.2360 | 1.87432 | 21.28 | 29.89 |
| 13 | −112.5572 | DD[13] | | | 29.90 |
| 14(St) | ∞ | 7.5284 | | | 28.42 |
| *15 | −35.7549 | 4.8451 | 1.89086 | 32.29 | 27.36 |
| 16 | 77.1210 | 8.7925 | 1.59282 | 68.62 | 29.92 |
| 17 | −41.0916 | 1.3747 | | | 31.65 |
| *18 | 122.2072 | 4.1037 | 1.86099 | 39.23 | 32.73 |
| *19 | −75.6971 | DD[19] | | | 32.60 |
| 20 | 91.6622 | 0.8802 | 1.92111 | 25.65 | 34.00 |
| 21 | 33.1610 | 7.1863 | 1.61905 | 54.71 | 33.64 |
| 22 | −117.6090 | DD[22] | | | 33.79 |
| 23 | −253.1546 | 2.1270 | 1.92286 | 18.90 | 33.70 |
| 24 | −89.0745 | 5.3410 | | | 33.86 |
| *25 | −73.3658 | 0.8779 | 1.81052 | 47.98 | 33.50 |
| *26 | 79.1232 | DD[26] | | | 34.11 |

TABLE 17
Example 6

| | Wide | Middle | Tele |
|---|---|---|---|
| Zr | 1.0 | 1.7 | 2.7 |
| f | 72.1 | 124.97 | 194.04 |
| FNo. | 2.89 | 2.88 | 2.91 |
| 2ω[°] | 33.4 | 18.8 | 12.2 |
| DD[5] | 6.69 | 51.56 | 71.93 |
| DD[8] | 3.86 | 1.94 | 1.12 |
| DD[13] | 3.40 | 3.36 | 1.66 |
| DD[19] | 12.63 | 3.58 | 0.10 |
| DD[22] | 35.34 | 16.90 | 0.30 |
| DD[26] | 13.06 | 34.87 | 64.25 |

TABLE 18
Example 6

| Sn | 9 | 10 | 15 | 18 |
|---|---|---|---|---|
| KA | 1.0000000E+00 | 1.0000000E+00 | 1.0000000E+00 | 1.0000000E+00 |
| A4 | −2.4625023E−05 | −2.8723936E−05 | −6.3407565E−06 | 6.4082693E−06 |
| A6 | 1.6869807E−07 | 1.9914536E−07 | 4.7389156E−08 | −1.1943392E−08 |
| A8 | −5.1007438E−10 | −7.2932233E−10 | −3.4055920E−10 | 6.5901918E−12 |
| A10 | −3.5697227E−13 | 4.1246156E−13 | 1.9241029E−12 | 5.8450339E−14 |
| A12 | 3.9332923E−15 | 4.1753658E−15 | −3.6866275E−15 | −1.0016817E−16 |
| A14 | 1.2078628E−17 | −1.8840512E−19 | −1.5563098E−17 | −4.5787792E−19 |
| A16 | −5.2251311E−20 | 9.5246828E−21 | 5.0551201E−20 | 3.2186403E−22 |
| A18 | −1.3673880E−22 | −3.5115537E−22 | 1.3763549E−22 | 5.3765310E−24 |
| A20 | 4.8309674E−25 | 8.3588998E−25 | −4.5210657E−25 | 2.5908842E−27 |

| Sn | 19 | 25 | 26 |
|---|---|---|---|
| KA | 1.0000000E+00 | 1.0000000E+00 | 1.0000000E+00 |
| A4 | 4.4065567E−06 | 7.1707365E−06 | 7.7011081E−06 |
| A6 | −3.5379879E−09 | −3.2708811E−08 | −2.8595941E−08 |
| A8 | 4.4857013E−12 | 3.5437489E−11 | 1.1633979E−11 |
| A10 | −3.8769485E−14 | 9.7281423E−14 | 1.9727294E−13 |
| A12 | 7.1022261E−17 | 1.8984999E−16 | 4.4906396E−17 |
| A14 | 3.7401414E−19 | −9.6033561E−20 | −9.1335773E−19 |
| A16 | 6.3228157E−23 | −3.4158493E−21 | −1.7776322E−21 |
| A18 | −9.5299410E−24 | −9.4336165E−24 | 4.5366046E−24 |
| A20 | 3.1440269E−26 | 4.0531300E−26 | 5.6042401E−27 |

### Example 7

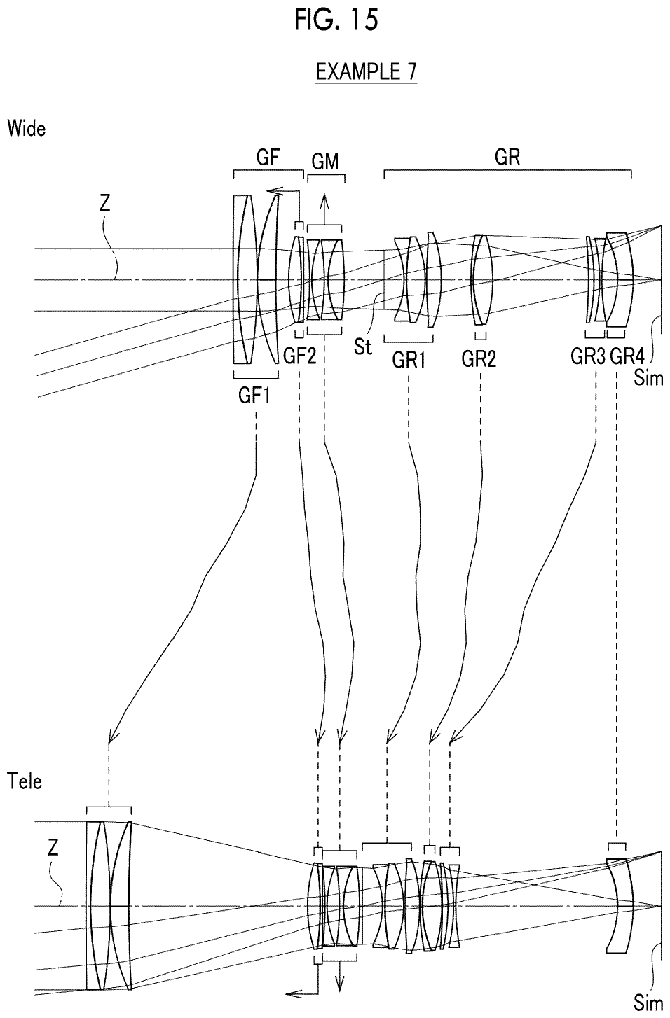

A configuration and a movement trajectory of a variable magnification optical system according to Example 7 are shown in FIG. 15. The variable magnification optical system according to Example 7 consists of the front group GF, the intermediate group GM, and the rear group GR in this order from the object side to the image side. The front group GF consists of the first front side lens group GF1 having a positive refractive power and the second front side lens group GF2 having a positive refractive power, in this order from the object side to the image side. The intermediate group GM consists of one lens group having a negative refractive power. The rear group GR consists of the first subsequent lens group GR1 having a positive refractive power, the second subsequent lens group GR2 having a positive refractive power, the third subsequent lens group GR3 having a negative refractive power, and the fourth subsequent lens group GR4 having a negative refractive power, in this order from the object side to the image side.

During magnification change from the wide angle end to the telephoto end, the fourth subsequent lens group GR4 remains stationary with respect to the image plane Sim, and the other lens groups move while changing the spacings between the adjacent lens groups. The variable magnification optical system includes one focusing group, and the focusing group consists of the second front side lens group GF2. During focusing from the infinite distance object to the short range object, the second front side lens group GF2 moves to the object side, and other lens groups remain stationary with respect to the image plane Sim. The anti-vibration group consists of the intermediate group GM.

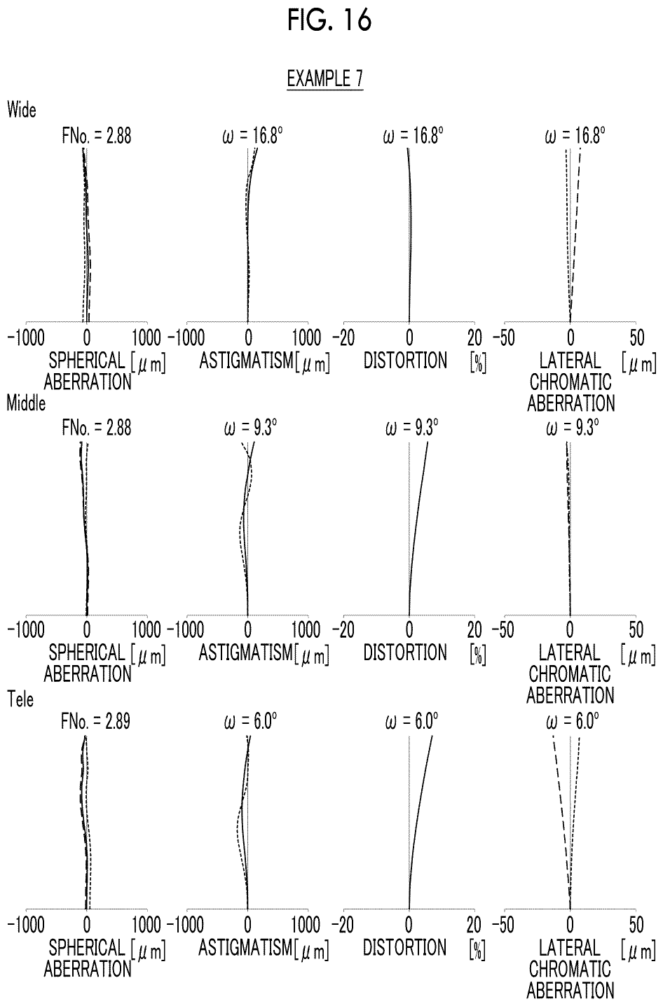

With respect to the variable magnification optical system according to Example 7, basic lens data is shown in Table 19, specifications and variable surface spacings are shown in Table 20, aspherical coefficients are shown in Table 21, and each aberration diagram is shown in FIG. 16.

TABLE 19
Example 7

| Sn | R | D | Nd | νd | ED |
|---|---|---|---|---|---|
| 1 | 2688.8938 | 1.7062 | 1.72047 | 34.71 | 67.00 |
| 2 | 152.2113 | 7.3998 | 1.49700 | 81.61 | 66.95 |
| 3 | −228.9905 | 0.0500 | | | 67.01 |
| *4 | 86.9914 | 6.9432 | 1.59282 | 68.62 | 66.42 |
| *5 | 676.2509 | DD[5] | | | 66.03 |
| 6 | 62.3554 | 4.7542 | 1.67062 | 59.16 | 34.50 |
| 7 | −132.4441 | 0.8787 | 1.99353 | 18.78 | 34.05 |
| 8 | −1175.1436 | DD[8] | | | 33.56 |
| 9 | −143.2044 | 0.8212 | 1.85632 | 43.30 | 31.87 |
| 10 | 43.5639 | 4.6694 | | | 30.57 |
| 11 | −109.6711 | 1.4823 | 1.71740 | 56.85 | 30.65 |
| 12 | 37.0764 | 6.0344 | 1.86193 | 21.90 | 31.72 |
| 13 | −128.9488 | DD[13] | | | 31.85 |
| 14(St) | ∞ | 7.4923 | | | 30.72 |
| 15 | −35.1315 | 0.9582 | 1.84660 | 30.14 | 30.59 |
| 16 | 97.7009 | 7.0056 | 1.55032 | 75.50 | 33.08 |
| 17 | −42.6452 | 0.5416 | | | 34.26 |
| *18 | 172.0172 | 5.5239 | 1.79417 | 49.65 | 36.33 |
| *19 | −61.6701 | DD[19] | | | 36.95 |
| 20 | 100.4647 | 0.9150 | 1.85764 | 39.39 | 36.00 |
| 21 | 48.4171 | 7.3005 | 1.59282 | 68.62 | 35.57 |
| 22 | −62.9139 | DD[22] | | | 35.50 |
| 23 | −192.1559 | 2.0689 | 1.88200 | 23.29 | 34.50 |
| 24 | −83.7008 | 2.1243 | | | 34.37 |
| *25 | −78.6854 | 0.8498 | 1.79582 | 49.49 | 32.98 |
| *26 | 90.8553 | DD[26] | | | 32.41 |
| *27 | −37.2539 | 5.9096 | 1.49710 | 81.56 | 34.00 |
| *28 | −51.3352 | 10.5000 | | | 37.66 |

TABLE 20
Example 7

| | Wide | Middle | Tele |
|---|---|---|---|
| Zr | 1.0 | 1.7 | 2.7 |
| f | 72.11 | 124.98 | 194.05 |
| FNo. | 2.88 | 2.88 | 2.89 |
| 2ω[°] | 33.6 | 18.6 | 12.0 |
| DD[5] | 4.82 | 35.22 | 67.06 |
| DD[8] | 2.26 | 5.24 | 0.90 |
| DD[13] | 15.03 | 9.07 | 1.14 |
| DD[19] | 11.15 | 2.10 | 0.10 |
| DD[22] | 35.80 | 14.64 | 0.23 |
| DD[26] | 5.92 | 33.01 | 60.67 |

TABLE 21
Example 7

| Sn | 4 | 5 | 18 | 19 |
|---|---|---|---|---|
| KA | 1.0106125E+00 | 1.0000000E+00 | 1.0000000E+00 | 1.0000000E+00 |
| A4 | 3.4013752E−07 | 4.3420240E−07 | −1.1248841E−06 | 1.9015993E−07 |
| A6 | −4.1391394E−10 | −5.7201858E−10 | 8.2131423E−10 | −3.3283783E−09 |
| A8 | 2.3872892E−13 | 3.6080102E−13 | −9.9060388E−12 | 3.3189578E−11 |
| A10 | −3.2044540E−18 | 5.6229239E−17 | 2.8982294E−14 | −1.7940871E−13 |
| A12 | 4.2032399E−22 | −1.1654096E−19 | −3.6367527E−16 | 4.7840884E−17 |
| A14 | −2.5811017E−23 | −5.7111675E−23 | 5.4975384E−20 | 4.9784661E−19 |
| A16 | −3.9041251E−26 | 8.5847806E−27 | 2.9309911E−21 | 6.3607815E−22 |
| A18 | −1.5685597E−29 | 2.4125443E−29 | 3.0145783E−24 | 4.7040007E−25 |
| A20 | 2.1477142E−32 | −6.1966898E−33 | −2.4392049E−26 | −1.2200968E−26 |

| Sn | 25 | 26 | 27 | 28 |
|---|---|---|---|---|
| KA | 1.0000000E+00 | 1.0000000E+00 | 1.0000000E+00 | 1.0000000E+00 |
| A4 | −1.7609918E−06 | −2.6434277E−06 | 7.2992838E−06 | 2.1980955E−05 |
| A6 | 2.2707218E−08 | 3.0482744E−08 | −1.7719619E−08 | −9.4436806E−08 |
| A8 | −9.3102794E−11 | −1.6141833E−10 | −1.5180244E−10 | 2.9696020E−10 |
| A10 | −2.3225705E−13 | −2.6378571E−14 | 6.5069826E−13 | −6.8208193E−13 |
| A12 | 1.0870776E−15 | 1.5902012E−15 | −7.9440767E−17 | 3.7778030E−16 |
| A14 | 6.5370207E−18 | 2.4258582E−18 | −3.1968477E−18 | 1.8118014E−18 |
| A16 | −1.1060572E−20 | −7.6180501E−21 | −2.6185381E−21 | 5.2276415E−23 |
| A18 | −1.0456349E−22 | −8.7335273E−23 | 2.1087815E−23 | −1.5349251E−23 |
| A20 | 2.3884609E−25 | 2.1341128E−25 | −8.8316243E−27 | 2.1286971E−26 |

### Example 8

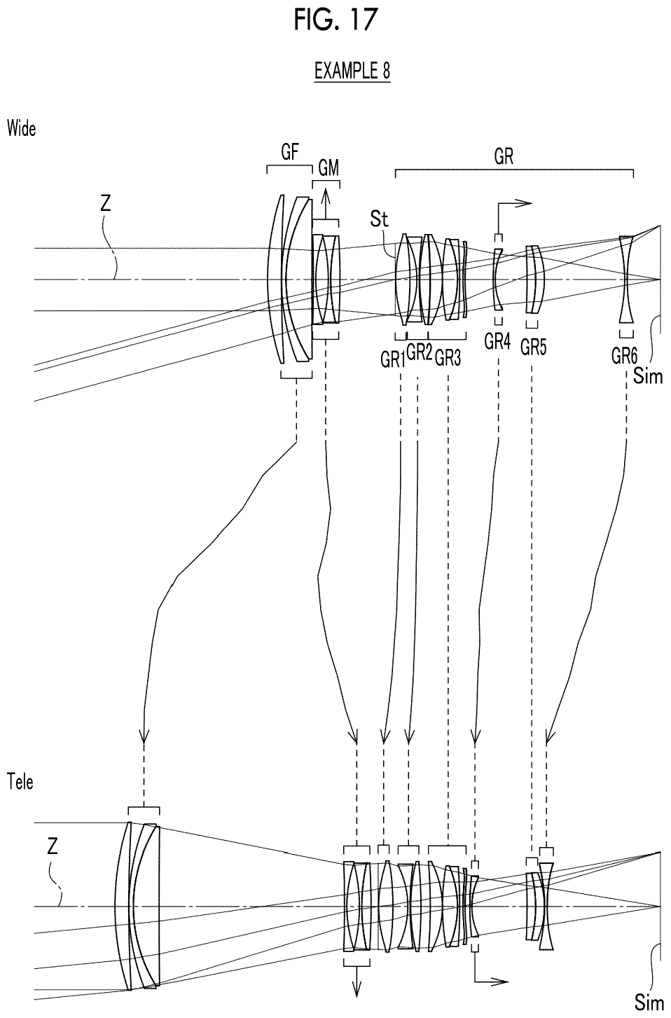

A configuration and a movement trajectory of a variable magnification optical system according to Example 8 are shown in FIG. 17. The variable magnification optical system according to Example 8 consists of the front group GF, the intermediate group GM, and the rear group GR in this order from the object side to the image side. The front group GF consists of one lens group having a positive refractive power. The intermediate group GM consists of one lens group having a negative refractive power. The rear group GR consists of the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, the fifth subsequent lens group GR5 having a positive refractive power, and the sixth subsequent lens group GR6 having a negative refractive power, in this order from the object side to the image side.

During magnification change from the wide angle end to the telephoto end, the third subsequent lens group GR3 and the fifth subsequent lens group GR5 remain stationary with respect to the image plane Sim, and the other lens groups move while changing the spacings between the adjacent lens groups. The variable magnification optical system includes one focusing group, and the focusing group consists of the fourth subsequent lens group GR4. During focusing from the infinite distance object to the short range object, the fourth subsequent lens group GR4 moves to the image side, and the other lens groups remain stationary with respect to the image plane Sim. The anti-vibration group consists of the intermediate group GM.

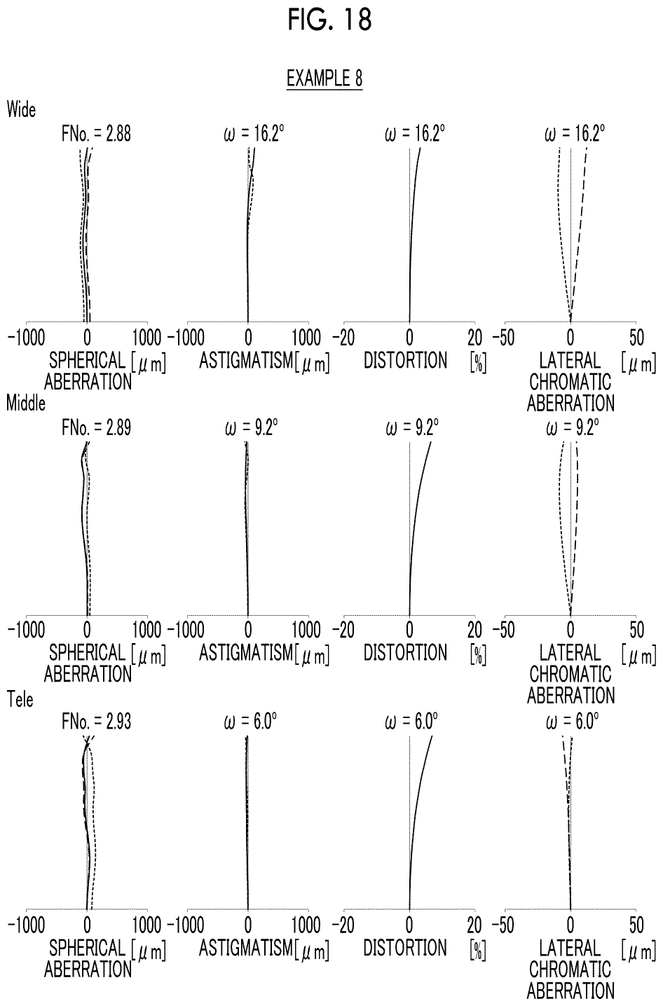

With respect to the variable magnification optical system according to Example 8, basic lens data is shown in Table 22, specifications and variable surface spacings are shown in Table 23, aspherical coefficients are shown in Table 24, and each aberration diagram is shown in FIG. 18.

TABLE 22
Example 8

| Sn | R | D | Nd | νd | ED |
|---|---|---|---|---|---|
| 1 | 114.2753 | 5.2077 | 1.49700 | 81.61 | 67.00 |
| 2 | 594.3632 | 0.0500 | | | 66.77 |
| 3 | 94.5367 | 1.6687 | 1.80100 | 34.97 | 65.50 |
| 4 | 63.2346 | 9.7246 | 1.43700 | 95.10 | 63.48 |
| 5 | 3811.3763 | DD[5] | | | 63.08 |
| 6 | −620.8941 | 0.9212 | 1.72108 | 49.17 | 35.82 |
| 7 | 56.7895 | 4.7069 | | | 34.00 |
| 8 | −73.3832 | 0.9030 | 1.60233 | 37.77 | 33.97 |
| 9 | 82.1614 | 3.4890 | 1.90123 | 19.94 | 34.69 |
| 10 | −303.9856 | DD[10] | | | 34.81 |
| 11(St) | ∞ | 0.1998 | | | 34.56 |
| *12 | 54.4608 | 5.3517 | 1.75258 | 53.91 | 34.88 |
| *13 | −134.7203 | DD[13] | | | 34.79 |
| 14 | −38.3494 | 0.8727 | 1.88858 | 20.57 | 32.50 |
| 15 | 130.5362 | 0.2304 | | | 33.86 |
| 16 | 80.7459 | 3.8539 | 1.97399 | 18.09 | 34.62 |
| 17 | −191.3579 | DD[17] | | | 34.77 |
| 18 | −228.5994 | 4.5418 | 1.67885 | 55.10 | 35.05 |
| 19 | −40.9036 | 0.0500 | | | 35.19 |
| 20 | 98.1757 | 5.6442 | 1.55032 | 75.50 | 32.45 |
| 21 | −43.8329 | 0.8224 | 1.90215 | 38.61 | 31.87 |
| 22 | −247.0819 | 1.2567 | | | 31.21 |
| *23 | 92.5169 | 0.7866 | 1.49710 | 81.56 | 30.25 |
| *24 | 99.6208 | DD[24] | | | 30.05 |
| *25 | 151.9016 | 0.7778 | 1.43700 | 95.10 | 24.32 |
| *26 | 30.2027 | DD[26] | | | 23.00 |
| 27 | −291.3702 | 3.2226 | 1.47324 | 60.02 | 26.28 |
| 28 | −59.6559 | 3.3125 | 1.49538 | 55.87 | 26.62 |
| 29 | −37.1389 | DD[29] | | | 27.00 |
| *30 | −60.0748 | 0.9843 | 1.45427 | 88.12 | 33.00 |
| *31 | 96.4270 | DD[31] | | | 34.58 |

TABLE 23
Example 8

| | Wide | Middle | Tele |
|---|---|---|---|
| Zr | 1.0 | 1.7 | 2.7 |
| f | 72.10 | 124.97 | 194.03 |
| FNo. | 2.88 | 2.89 | 2.93 |
| 2ω[°] | 32.4 | 18.4 | 12.0 |
| DD[5] | 0.59 | 50.59 | 69.57 |
| DD[10] | 20.79 | 21.17 | 2.68 |
| DD[13] | 2.62 | 3.36 | 5.62 |
| DD[17] | 0.10 | 0.84 | 3.51 |
| DD[24] | 10.61 | 3.36 | 1.80 |
| DD[26] | 11.72 | 18.97 | 20.53 |
| DD[29] | 30.24 | 16.71 | 0.10 |
| DD[31] | 12.49 | 26.02 | 42.63 |

TABLE 24
Example 8

| Sn | 12 | 13 | 23 | 24 |
|---|---|---|---|---|
| KA | 1.0000000E+00 | 1.0000000E+00 | 1.0000000E+00 | 1.0000000E+00 |
| A4 | −2.0884671E−07 | −1.0694619E−06 | 4.0261928E−06 | 9.9205285E−06 |
| A6 | 2.4415564E−09 | 1.1931735E−09 | −1.3967257E−07 | −1.3772892E−07 |
| A8 | −3.0155335E−11 | −5.0445325E−11 | −2.8172103E−11 | 2.6896540E−10 |
| A10 | −1.4853888E−13 | 5.1542914E−14 | 1.8500977E−12 | −2.3719984E−12 |
| A12 | 1.6534605E−15 | 1.0966599E−15 | −8.4581484E−15 | 1.5592928E−14 |
| A14 | −2.5482675E−18 | −2.5321712E−18 | 1.0555048E−17 | −5.2349789E−17 |
| A16 | −9.1850822E−21 | −7.4565200E−21 | −8.7804782E−21 | 9.3494252E−20 |
| A18 | 2.2741974E−23 | 1.7701605E−23 | 8.8719021E−23 | −2.3346788E−22 |
| A20 | −2.1886720E−26 | −9.0300473E−27 | 7.6353148E−26 | 7.7751793E−25 |

| Sn | 25 | 26 | 30 | 31 |
|---|---|---|---|---|
| KA | 1.0000000E+00 | 1.0000000E+00 | 1.0000000E+00 | 1.0000000E+00 |
| A4 | 2.3446556E−05 | 2.6663423E−05 | 1.7784009E−05 | 2.0012626E−05 |
| A6 | −1.6766793E−07 | −1.7277260E−07 | −9.6843922E−08 | −8.3972320E−08 |
| A8 | 4.4406437E−10 | 2.3372939E−10 | 2.5979904E−10 | 5.2388632E−11 |
| A10 | −7.1907702E−13 | 1.1283587E−12 | −2.9244149E−13 | 1.7398313E−12 |
| A12 | −6.0737630E−15 | 9.8566273E−15 | 1.0253734E−15 | −1.0225596E−14 |
| A14 | 1.2442740E−16 | −1.3990016E−16 | −3.7049449E−18 | 2.5731719E−17 |
| A16 | −2.9209062E−19 | 2.7915966E−19 | −3.5336926E−20 | −3.1437583E−20 |
| A18 | −2.1797822E−21 | 3.5479817E−21 | 2.3239181E−22 | 3.0322448E−23 |
| A20 | 7.5154946E−24 | −1.6148744E−23 | −3.5174446E−25 | −3.1871639E−26 |

### Example 9

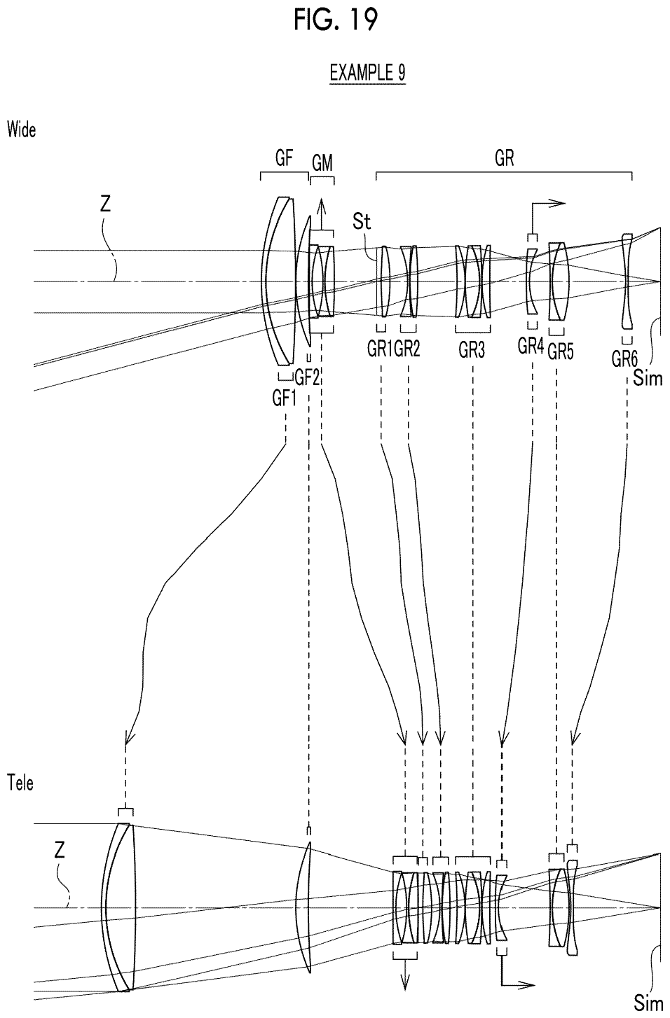

A configuration and a movement trajectory of a variable magnification optical system according to Example 9 are shown in FIG. 19. The variable magnification optical system according to Example 9 consists of the front group GF, the intermediate group GM, and the rear group GR in this order from the object side to the image side. The front group GF consists of the first front side lens group GF1 having a positive refractive power and the second front side lens group GF2 having a positive refractive power, in this order from the object side to the image side. The intermediate group GM consists of one lens group having a negative refractive power. The rear group GR consists of the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, the fifth subsequent lens group GR5 having a positive refractive power, and the sixth subsequent lens group GR6 having a negative refractive power, in this order from the object side to the image side.

During magnification change from the wide angle end to the telephoto end, the second front side lens group GF2, the third subsequent lens group GR3, and the fifth subsequent lens group GR5 remain stationary with respect to the image plane Sim, and the other lens groups move while changing the spacings between the adjacent lens groups. The variable magnification optical system includes one focusing group, and the focusing group consists of the fourth subsequent lens group GR4. During focusing from the infinite distance object to the short range object, the fourth subsequent lens group GR4 moves to the image side, and the other lens groups remain stationary with respect to the image plane Sim. The anti-vibration group consists of the intermediate group GM.

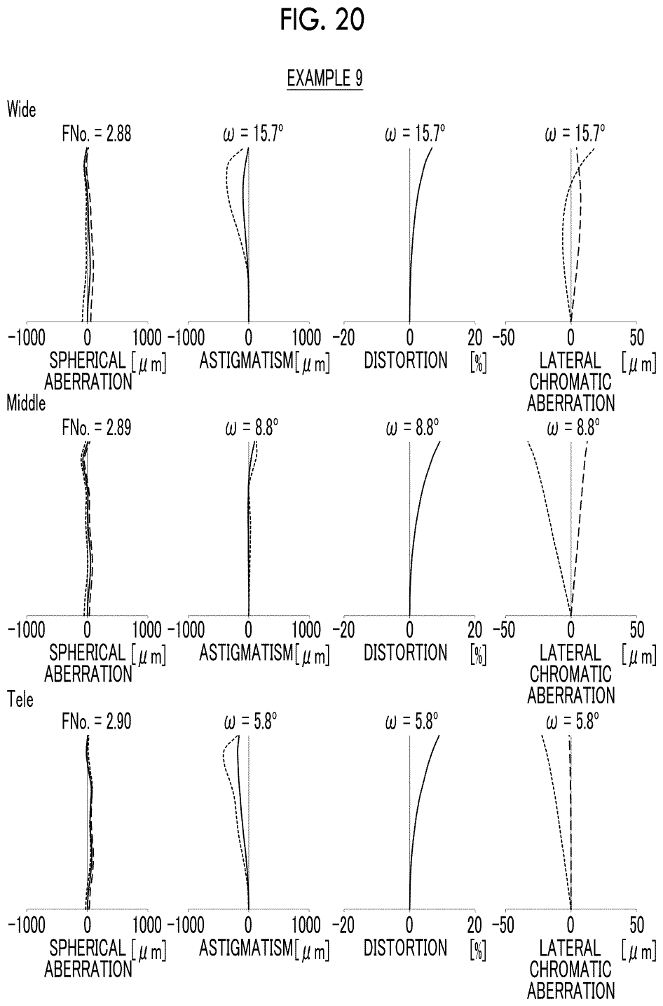

With respect to the variable magnification optical system according to Example 9, basic lens data is shown in Table 25, specifications and variable surface spacings are shown in Table 26, aspherical coefficients are shown in Table 27, and each aberration diagram is shown in FIG. 20.

TABLE 25
Example 9

| Sn | R | D | Nd | νd | ED |
|---|---|---|---|---|---|
| 1 | 90.8928 | 1.6846 | 1.78590 | 44.20 | 67.00 |
| 2 | 65.6633 | 11.1760 | 1.43700 | 95.10 | 65.60 |
| 3 | −576.8230 | DD[3] | | | 65.37 |
| 4 | 66.8518 | 4.7160 | 1.49700 | 81.61 | 47.16 |
| 5 | 331.8810 | DD[5] | | | 46.62 |
| *6 | 2319.6327 | 1.0444 | 1.77197 | 26.40 | 29.26 |
| *7 | 43.7743 | 4.0844 | | | 27.50 |
| 8 | −55.4010 | 0.7343 | 1.59359 | 52.54 | 27.48 |
| 9 | 49.7794 | 3.5416 | 1.89530 | 20.24 | 27.99 |
| 10 | −275.5226 | DD[10] | | | 28.00 |
| 11(St) | ∞ | 1.6947 | | | 28.14 |
| *12 | 129.6029 | 3.3049 | 1.77524 | 51.59 | 28.25 |
| *13 | −72.7985 | DD[13] | | | 28.27 |
| 14 | −36.6511 | 0.7398 | 1.84258 | 25.03 | 27.40 |
| 15 | 160.4992 | 0.1276 | | | 28.01 |
| 16 | 82.8283 | 2.9228 | 1.87899 | 21.05 | 28.33 |
| 17 | −172.5816 | DD[17] | | | 28.41 |
| 18 | −190.0246 | 3.0079 | 1.77580 | 26.21 | 28.42 |
| 19 | −43.2224 | 0.1112 | | | 28.50 |
| 20 | 91.1657 | 5.4069 | 1.59282 | 68.62 | 28.50 |
| 21 | −35.3805 | 0.7786 | 1.90211 | 19.89 | 28.43 |
| 22 | −191.3492 | 0.0659 | | | 28.75 |
| 23 | 52.5537 | 2.9599 | 1.43700 | 95.10 | 28.88 |
| 24 | 529.8195 | DD[24] | | | 28.72 |
| *25 | 268.5844 | 1.1537 | 1.90445 | 38.37 | 26.00 |
| *26 | 31.0935 | DD[26] | | | 25.31 |
| 27 | −273.2938 | 0.8054 | 1.51628 | 78.67 | 29.67 |
| 28 | 40.3653 | 6.3181 | 1.72255 | 28.87 | 30.82 |
| 29 | −63.3081 | DD[29] | | | 31.00 |
| *30 | −52.0981 | 0.9499 | 1.59203 | 62.50 | 33.44 |
| *31 | −494.0470 | DD[31] | | | 34.00 |

TABLE 26
Example 9

| | Wide | Middle | Tele |
|---|---|---|---|
| Zr | 1.0 | 1.8 | 2.7 |
| f | 72.10 | 127.71 | 194.03 |
| FNo. | 2.88 | 2.89 | 2.90 |
| 2ω[°] | 31.4 | 17.6 | 11.6 |
| DD[3] | 0.10 | 51.81 | 60.10 |
| DD[5] | 0.38 | 15.46 | 31.91 |
| DD[10] | 15.94 | 10.51 | 0.09 |
| DD[13] | 6.66 | 4.25 | 3.13 |
| DD[17] | 14.80 | 7.58 | 2.65 |
| DD[24] | 13.53 | 8.39 | 2.07 |
| DD[26] | 7.80 | 12.94 | 19.25 |
| DD[29] | 21.31 | 14.61 | 0.66 |
| DD[31] | 12.15 | 18.85 | 32.80 |

TABLE 27
Example 9

| Sn | 6 | 7 | 12 | 13 |
|---|---|---|---|---|
| KA | 1.0000000E+00 | 1.0000000E+00 | 1.0000000E+00 | 1.0000000E+00 |
| A4 | −8.0015316E−06 | −9.3149614E−06 | −6.5360933E−06 | −4.7640522E−06 |
| A6 | 6.9219075E−08 | 6.5041964E−08 | 1.6697086E−08 | 9.7323152E−09 |
| A8 | −1.1342524E−10 | −3.5152797E−11 | −2.8324617E−10 | −1.5023545E−10 |
| A10 | −1.1316038E−12 | −1.0996254E−12 | 2.1086705E−12 | 8.2305087E−13 |
| A12 | 8.2811862E−15 | 6.3514831E−15 | −1.0479856E−14 | −3.9398447E−15 |
| A14 | −2.0563240E−17 | −5.4947213E−17 | 2.5217906E−17 | 1.1147137E−17 |
| A16 | −2.7180332E−20 | 4.5592734E−19 | −2.7366038E−20 | −4.8092402E−20 |
| A18 | 2.8181256E−22 | −1.8069963E−21 | 1.6145576E−22 | 3.5070729E−22 |
| A20 | −4.6205013E−25 | 2.6839042E−24 | −5.5304245E−25 | −8.7911997E−25 |

| Sn | 25 | 26 | 30 | 31 |
|---|---|---|---|---|
| KA | 1.0000000E+00 | 1.0000000E+00 | 1.0000000E+00 | 1.0000000E+00 |
| A4 | 2.2404793E−05 | 2.4241999E−05 | 4.1474502E−05 | 4.2934823E−05 |
| A6 | −1.9636754E−07 | −2.1817038E−07 | −1.2674880E−07 | −1.2155125E−07 |
| A8 | 8.3163191E−10 | 1.3235437E−09 | −1.0221786E−10 | 7.9466688E−11 |
| A10 | 2.8903477E−12 | −4.7070964E−12 | 2.2391800E−12 | −9.3261687E−14 |
| A12 | −4.3111075E−14 | 2.4605194E−14 | −5.3541521E−15 | 5.8978009E−15 |
| A14 | 1.3423812E−16 | −6.4964335E−17 | −6.9170384E−18 | −1.9613801E−17 |
| A16 | −9.9695327E−20 | −1.6371854E−18 | 7.3214019E−20 | −1.3997712E−20 |
| A18 | 8.9904213E−22 | 1.5074820E−20 | −2.3641770E−22 | 1.1000366E−22 |
| A20 | −4.1494120E−24 | −3.6928287E−23 | 3.3116810E−25 | −6.5226302E−26 |

### Example 10

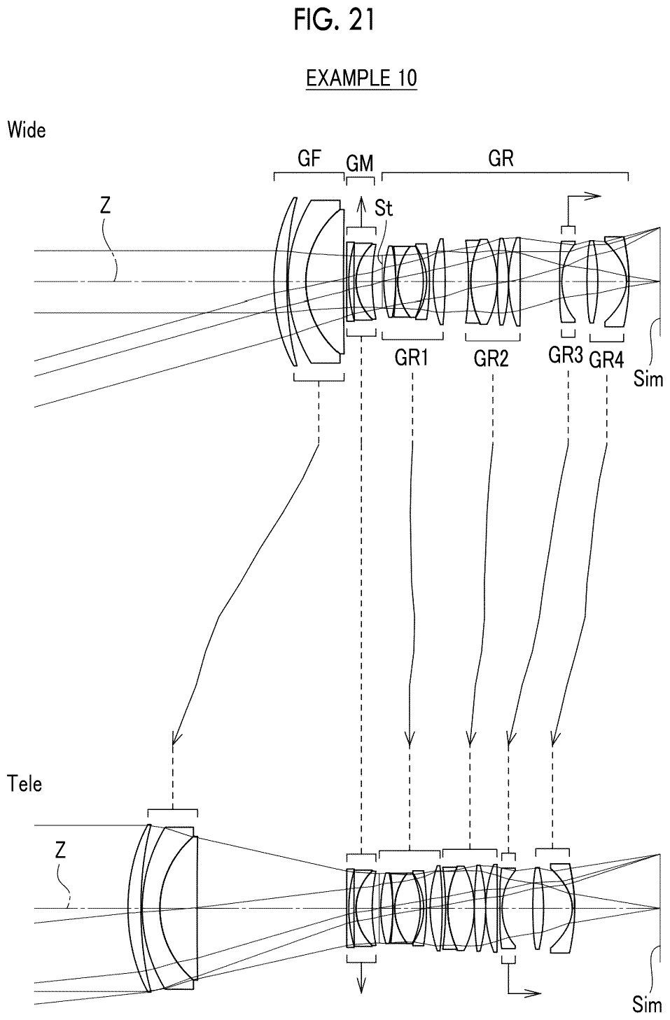

A configuration and a movement trajectory of a variable magnification optical system according to Example 10 are shown in FIG. 21. The variable magnification optical system according to Example 10 consists of the front group GF, the intermediate group GM, and the rear group GR in this order from the object side to the image side. The front group GF consists of one lens group having a positive refractive power. The intermediate group GM consists of one lens group having a negative refractive power. The rear group GR consists of the first subsequent lens group GR1 having a positive refractive power, the second subsequent lens group GR2 having a positive refractive power, the third subsequent lens group GR3 having a negative refractive power, and the fourth subsequent lens group GR4 having a negative refractive power, in this order from the object side to the image side.

During magnification change from the wide angle end to the telephoto end, the intermediate group GM remains stationary with respect to the image plane Sim, and the other lens groups move while changing the spacings between the adjacent lens groups. The variable magnification optical system includes one focusing group, and the focusing group consists of the third subsequent lens group GR3. During focusing from the infinite distance object to the short range object, the third subsequent lens group GR3 moves to the image side, and the other lens groups remain stationary with respect to the image plane Sim. The anti-vibration group consists of the intermediate group GM.

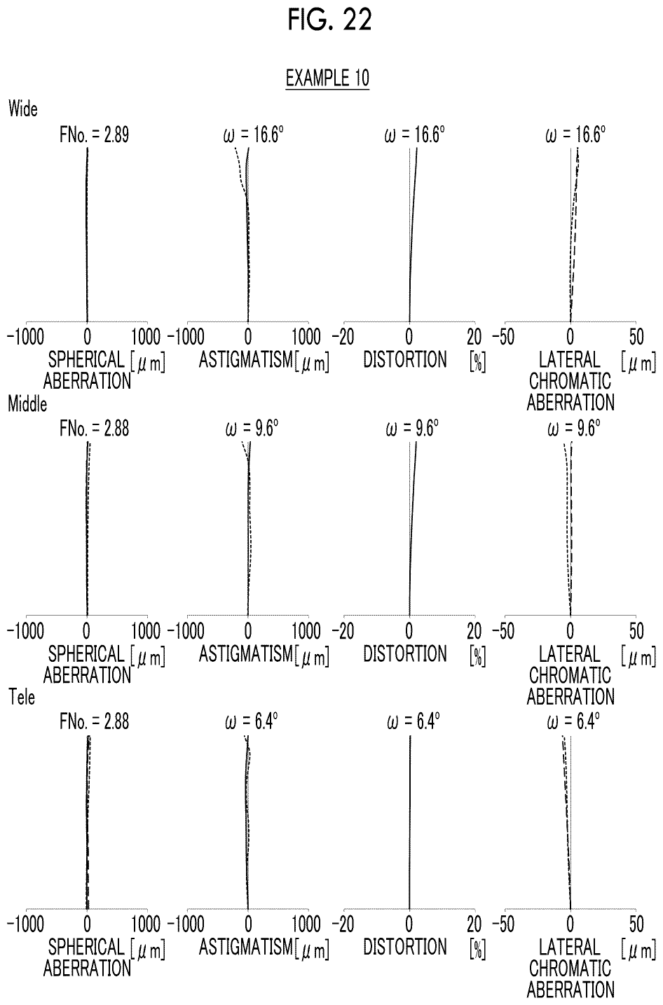

With respect to the variable magnification optical system according to Example 10, basic lens data is shown in Table 28, specifications and variable surface spacings are shown in Table 29, aspherical coefficients are shown in Table 30, and each aberration diagram is shown in FIG. 22.

TABLE 28
Example 10

| Sn | R | D | Nd | νd | ED |
|---|---|---|---|---|---|
| *1 | 85.4152 | 4.8764 | 1.67003 | 47.14 | 67.00 |
| *2 | 173.6547 | 0.4946 | | | 66.53 |
| 3 | 64.8568 | 6.6429 | 1.88300 | 40.69 | 64.78 |
| 4 | 38.9281 | 13.9704 | 1.45860 | 90.19 | 57.42 |
| 5 | 1774.5322 | DD[5] | | | 56.88 |
| 6 | 3630.0382 | 0.8087 | 1.45214 | 88.44 | 31.36 |
| 7 | 58.7649 | 1.9348 | | | 30.50 |
| 8 | 915.4440 | 0.7965 | 1.95059 | 25.47 | 30.48 |
| 9 | 21.1712 | 6.0653 | 1.95596 | 20.63 | 29.65 |
| 10 | 78.2188 | DD[10] | | | 29.47 |
| 11(St) | ∞ | 0.6083 | | | 27.81 |
| 12 | 53.4052 | 4.4614 | 1.51906 | 51.43 | 28.29 |
| 13 | −76.0735 | 0.0500 | | | 28.22 |
| 14 | −126.8339 | 0.7249 | 1.88122 | 40.74 | 28.04 |
| 15 | 23.3821 | 9.6353 | 1.61668 | 44.72 | 27.75 |
| 16 | −34.9334 | 1.2610 | | | 28.18 |
| 17 | −26.3339 | 1.0484 | 1.85674 | 43.25 | 28.15 |
| 18 | −103.5283 | 1.3936 | | | 29.98 |
| 19 | 55.1325 | 4.5178 | 1.92549 | 20.11 | 32.97 |
| 20 | −172.2821 | DD[20] | | | 32.95 |
| 21 | −128.9549 | 0.8450 | 1.94464 | 20.97 | 32.73 |
| 22 | 40.3901 | 9.9399 | 1.45793 | 87.56 | 32.82 |
| 23 | −39.0884 | 0.0425 | | | 33.70 |
| 24 | 145.9022 | 4.2346 | 1.71096 | 57.17 | 34.00 |
| 25 | −72.2323 | 0.0297 | | | 34.34 |
| 26 | 51.4398 | 4.3820 | 1.52455 | 77.41 | 35.10 |
| 27 | −1378.7069 | DD[27] | | | 34.92 |
| *28 | 38494.6289 | 0.8267 | 1.61412 | 63.63 | 32.14 |
| *29 | 27.9968 | DD[29] | | | 29.97 |
| *30 | 142.7990 | 4.0633 | 1.87607 | 24.72 | 32.71 |
| *31 | −92.7010 | 10.8067 | | | 32.63 |
| *32 | −15.4392 | 0.9173 | 1.49009 | 82.66 | 31.80 |
| *33 | −72.2062 | DD[33] | | | 35.65 |

TABLE 29
Example 10

| | Wide | Middle | Tele |
|---|---|---|---|
| Zr | 1.0 | 1.8 | 2.7 |
| f | 70.99 | 125.62 | 191.96 |
| FNo. | 2.89 | 2.88 | 2.88 |
| 2ω[°] | 33.2 | 19.2 | 12.8 |
| DD[5] | 1.20 | 38.81 | 56.13 |
| DD[10] | 3.76 | 4.49 | 2.64 |
| DD[20] | 8.80 | 4.94 | 1.28 |
| DD[27] | 14.85 | 7.10 | 0.97 |
| DD[29] | 9.46 | 12.16 | 11.56 |
| DD[33] | 11.74 | 19.92 | 32.16 |

TABLE 30
Example 10

| Sn | 1 | 2 | 30 | 31 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 4.4332180E−07 | 4.1706845E−07 | −7.1675596E−06 | −8.2173330E−06 |
| A5 | −8.1288953E−10 | 8.1541420E−10 | 3.4099510E−07 | −1.7020965E−09 |
| A6 | 8.7884717E−11 | −4.2882697E−11 | 2.5615366E−09 | 1.6927984E−08 |
| A7 | −6.8418950E−13 | 1.8451238E−13 | 2.7098158E−10 | −1.2207213E−10 |
| A8 | −1.3869901E−14 | 1.6211818E−14 | −2.0531971E−11 | −4.0481913E−11 |
| A9 | 6.4022530E−16 | 7.8594804E−16 | 2.6335327E−12 | 1.0571686E−12 |
| A10 | 1.9920342E−17 | −2.9713020E−18 | −1.4720477E−15 | 1.4681780E−13 |
| A11 | 1.7814871E−19 | −6.5683668E−19 | 3.8960759E−15 | 1.0421279E−14 |
| A12 | 1.0002672E−22 | 1.8272542E−20 | −2.0016340E−17 | −3.2843174E−16 |
| A13 | 2.6521122E−22 | 3.3408632E−22 | −8.0201431E−18 | −1.4132679E−17 |
| A14 | 5.4335677E−24 | 5.1482211E−24 | −3.4232521E−19 | −2.8657433E−19 |
| A15 | −2.2355854E−25 | 8.3437136E−26 | 1.7437116E−20 | −5.4219408E−20 |
| A16 | 2.9101182E−27 | −6.7270040E−27 | 1.5439058E−21 | 4.9455665E−21 |

| Sn | 28 | 29 | 32 | 33 |
|---|---|---|---|---|
| KA | 1.0000000E+00 | 1.0000000E+00 | −1.2051000E−01 | 1.0000000E+00 |
| A3 | 0.0000000E+00 | 0.0000000E+00 | 0.0000000E+00 | 0.0000000E+00 |
| A4 | 9.8994908E−06 | 5.0190982E−06 | 1.6901190E−06 | 2.4769000E−06 |
| A5 | 2.1476921E−07 | 3.7520089E−07 | −1.7557998E−06 | 2.7644573E−08 |
| A6 | 2.5980483E−09 | 5.4152379E−09 | 7.3105124E−08 | −5.7978589E−08 |
| A7 | −3.7710335E−10 | 3.7757029E−10 | −6.9422471E−11 | 3.8046658E−10 |
| A8 | −2.2723988E−11 | 1.7925283E−10 | 2.2418493E−10 | 4.8868236E−10 |
| A9 | −4.5597806E−12 | −1.0994449E−11 | 2.5906975E−11 | 6.0010557E−12 |
| A10 | 3.4075405E−13 | −1.0863841E−12 | −2.9556116E−12 | −1.3636148E−12 |
| A11 | −2.9497272E−15 | 7.0498344E−14 | 3.2095763E−14 | −2.3680274E−14 |
| A12 | −5.1832454E−16 | −1.7871274E−15 | 1.2825373E−14 | −2.6461699E−15 |
| A13 | −7.0232998E−18 | 2.6644613E−16 | −6.7970428E−16 | 5.0110859E−17 |
| A14 | −4.1393138E−18 | −8.5294730E−18 | −3.1874378E−17 | 2.1793613E−17 |
| A15 | 2.3422411E−19 | −9.8381939E−19 | −5.6307940E−19 | −6.4330038E−19 |
| A16 | 3.0273569E−20 | 3.1685225E−20 | 1.2742025E−19 | 4.0461619E−20 |
| A17 | −2.5370490E−22 | 2.9039734E−22 | 1.8931263E−21 | −4.1258775E−21 |
| A18 | −6.7260190E−23 | 5.6376290E−23 | 2.9170029E−22 | 2.8119322E−24 |
| A19 | −2.9145406E−24 | 1.6502633E−23 | −2.1527659E−23 | 9.0311410E−24 |
| A20 | 1.6385700E−25 | −1.0789096E−24 | −2.8135489E−26 | −2.1478587E−25 |

### Example 11

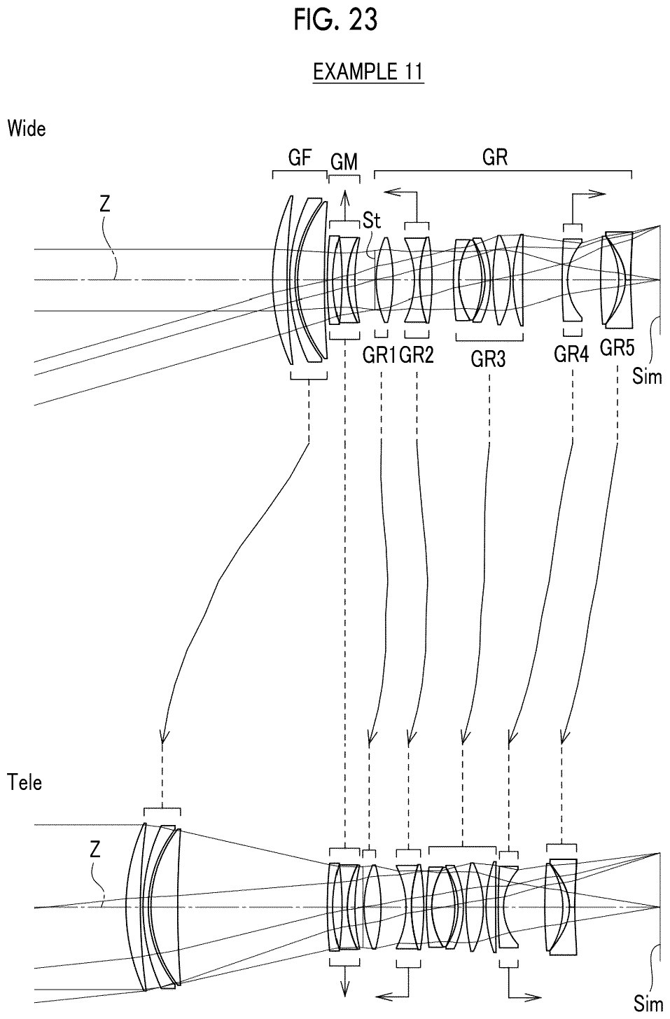

A configuration and a movement trajectory of a variable magnification optical system according to Example 11 are shown in FIG. 23. The variable magnification optical system according to Example 11 consists of the front group GF, the intermediate group GM, and the rear group GR in this order from the object side to the image side. The front group GF consists of one lens group having a positive refractive power. The intermediate group GM consists of one lens group having a negative refractive power. The rear group GR consists of, in this order from the object side to the image side, the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, and the fifth subsequent lens group GR5 having a negative refractive power.

During magnification change from the wide angle end to the telephoto end, the intermediate group GM remains stationary with respect to the image plane Sim, and the other lens groups move while changing the spacings between the adjacent lens groups. The variable magnification optical system includes two focusing groups. The focusing group on the object side consists of the second subsequent lens group GR2, and the focusing group on the image side consists of the fourth subsequent lens group GR4. During focusing from the infinite distance object to the short range object, the second subsequent lens group GR2 moves to the object side, the fourth subsequent lens group GR4 moves to the image side, and other lens groups remain stationary with respect to the image plane Sim. The anti-vibration group consists of the intermediate group GM.

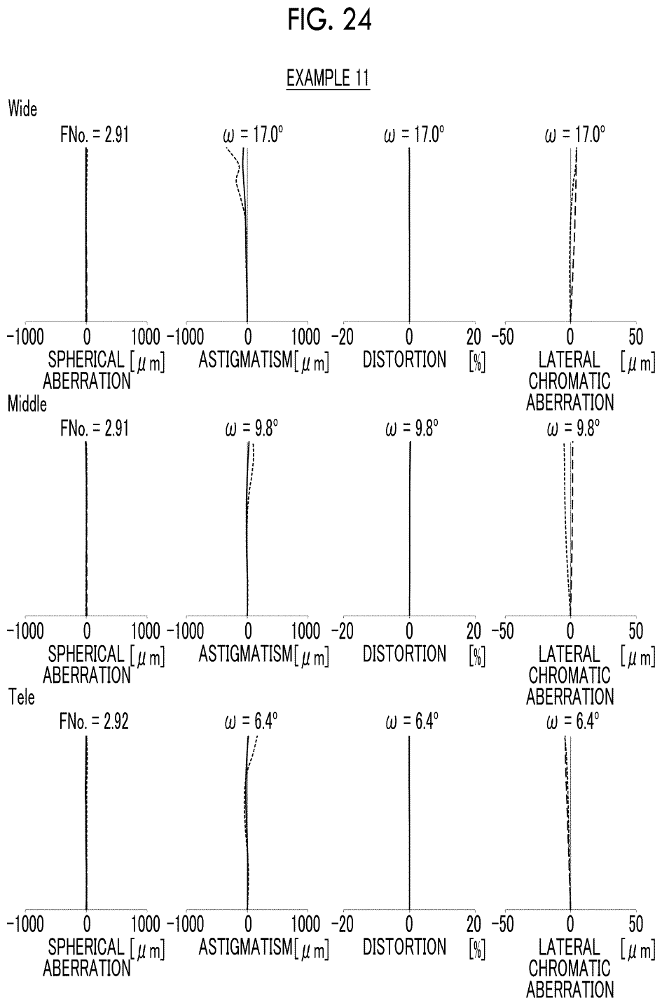

With respect to the variable magnification optical system according to Example 11, basic lens data is shown in Table 31, specifications and variable surface spacings are shown in Table 32, aspherical coefficients are shown in Table 33, and each aberration diagram is shown in FIG. 24.

TABLE 31
Example 11

| Sn | R | D | Nd | νd | ED |
|---|---|---|---|---|---|
| 1 | 85.8047 | 5.4212 | 1.49782 | 82.57 | 67.00 |
| 2 | 255.7518 | 0.9998 | | | 66.77 |
| 3 | 80.1457 | 1.9998 | 1.83400 | 37.18 | 65.11 |
| 4 | 53.2479 | 0.9998 | | | 62.26 |
| 5 | 53.2153 | 10.0499 | 1.49700 | 81.54 | 62.40 |
| 6 | 447.2013 | DD[6] | | | 62.01 |
| 7 | 173.0936 | 1.9998 | 1.58405 | 68.33 | 35.04 |
| 8 | 63.7632 | 3.3258 | | | 33.80 |
| 9 | −146.1757 | 2.0098 | 1.78770 | 50.32 | 33.78 |
| 10 | 39.2608 | 2.8207 | 1.86444 | 21.78 | 33.51 |
| 11 | 78.7213 | DD[11] | | | 33.45 |
| 12(St) | ∞ | 0.4829 | | | 32.33 |
| *13 | 43.0025 | 6.3657 | 1.50935 | 59.55 | 33.56 |
| 14 | −68.7943 | DD[14] | | | 33.51 |
| 15 | −38.2233 | 2.0098 | 1.62084 | 38.58 | 32.41 |
| 16 | 57.9111 | 4.6374 | 1.81586 | 33.64 | 33.30 |
| 17 | −115.6249 | DD[17] | | | 33.34 |
| 18 | 132.8135 | 1.9998 | 1.95083 | 33.63 | 32.00 |
| 19 | 31.6803 | 8.6860 | 1.44327 | 89.79 | 31.37 |
| 20 | −39.1311 | 1.2070 | | | 31.67 |
| 21 | −29.9254 | 1.9998 | 1.88617 | 40.24 | 31.66 |
| 22 | −41.3675 | 0.9998 | | | 33.32 |
| 23 | 84.1253 | 6.5416 | 1.51778 | 78.44 | 35.00 |
| 24 | −43.3880 | 1.0000 | | | 35.35 |
| 25 | 57.3620 | 3.6269 | 1.60405 | 65.21 | 36.30 |
| 26 | 1211.3119 | DD[26] | | | 36.16 |
| 27 | 277.6498 | 1.9998 | 1.57011 | 70.47 | 32.53 |
| 28 | 23.0768 | DD[28] | | | 29.77 |
| 29 | 210.6842 | 6.8063 | 1.62938 | 35.06 | 34.46 |
| 30 | −33.3929 | 2.4857 | | | 34.84 |
| *31 | −19.2679 | 1.9998 | 1.48298 | 83.74 | 34.83 |
| *32 | 152.3964 | DD[32] | | | 38.27 |

TABLE 32
Example 11

| | Wide | Middle | Tele |
|---|---|---|---|
| Zr | 1.0 | 1.8 | 2.7 |
| f | 70.86 | 125.41 | 191.65 |
| FNo. | 2.91 | 2.91 | 2.92 |
| 2ω[°] | 34.0 | 19.6 | 12.8 |
| DD[6] | 1.12 | 40.49 | 56.33 |
| DD[11] | 7.51 | 9.17 | 2.98 |
| DD[14] | 8.04 | 9.86 | 9.43 |
| DD[17] | 8.06 | 1.32 | 1.03 |
| DD[26] | 14.87 | 6.55 | 0.96 |
| DD[28] | 12.49 | 13.61 | 15.52 |
| DD[32] | 11.10 | 21.54 | 32.13 |

TABLE 33
Example 11

| Sn | 13 | 31 | 32 |
|---|---|---|---|
| KA | 0.0000000E+00 | −9.2030100E−01 | 0.0000000E+00 |
| A3 | 0.0000000E+00 | 0.0000000E+00 | 0.0000000E+00 |
| A4 | −1.2357435E−06 | −6.1657878E−06 | 3.2237747E−06 |
| A5 | 2.5133230E−08 | −8.2625320E−07 | −1.5343742E−06 |
| A6 | −1.5943761E−09 | 2.9793791E−08 | 7.8345347E−08 |
| A7 | 8.2419849E−11 | 1.5794372E−09 | 1.1011656E−10 |
| A8 | −6.9894050E−12 | −2.8370367E−11 | −4.5820030E−11 |
| A9 | 9.4143301E−13 | 1.0563495E−11 | 1.6026049E−12 |
| A10 | 7.2433465E−15 | −8.2153632E−14 | 5.3043772E−14 |
| A11 | −2.9277572E−15 | −2.9894092E−14 | 5.7278062E−15 |
| A12 | −2.8744633E−16 | −1.9071870E−15 | −1.1765053E−15 |
| A13 | 3.2342278E−17 | 3.6033024E−17 | −3.6676147E−18 |
| A14 | −4.6437466E−19 | 1.9829214E−18 | −7.4662965E−19 |
| A15 | −1.4761450E−20 | 6.8455861E−20 | 2.2756922E−20 |
| A16 | −9.4220609E−22 | 1.5327180E−20 | 6.9106689E−21 |
| A17 | −1.2228428E−22 | −1.0385936E−21 | 2.2226517E−22 |
| A18 | 6.5282120E−24 | 2.3716843E−23 | −1.3547552E−23 |
| A19 | 8.6261022E−25 | 1.1490647E−24 | −2.6176168E−25 |
| A20 | −3.9671494E−26 | −8.3531572E−26 | 2.3288708E−27 |

### Example 12

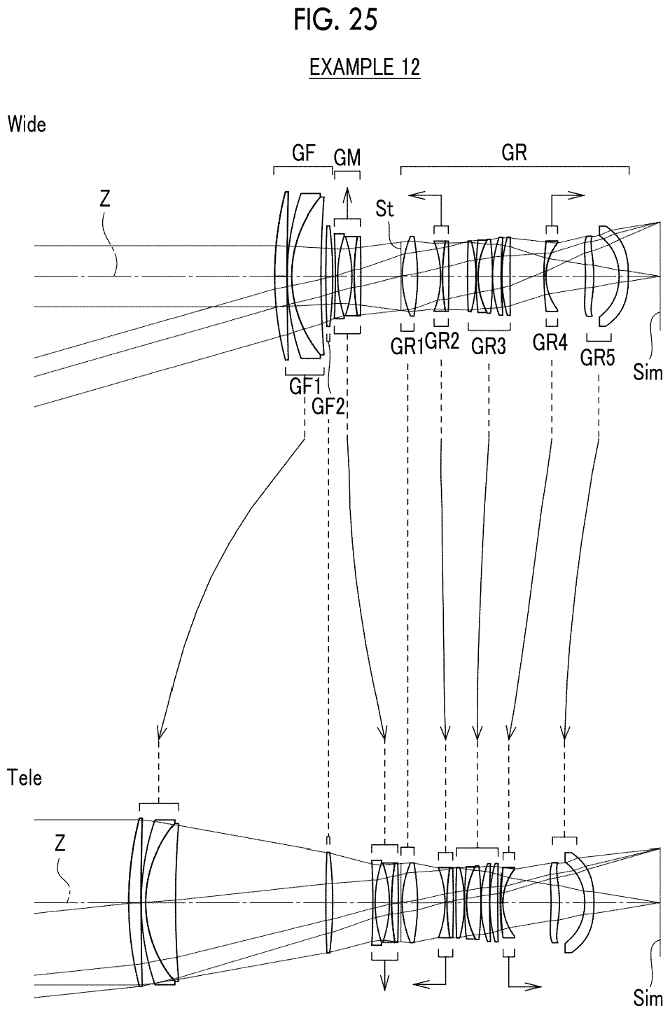

A configuration and a movement trajectory of a variable magnification optical system according to Example 12 are shown in FIG. 25. The variable magnification optical system according to Example 12 consists of the front group GF, the intermediate group GM, and the rear group GR in this order from the object side to the image side. The front group GF consists of the first front side lens group GF1 having a positive refractive power and the second front side lens group GF2 having a positive refractive power, in this order from the object side to the image side. The intermediate group GM consists of one lens group having a negative refractive power. The rear group GR consists of, in this order from the object side to the image side, the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, and the fifth subsequent lens group GR5 having a negative refractive power.

During magnification change from the wide angle end to the telephoto end, the second front side lens group GF2 and the first subsequent lens group GR1 remain stationary with respect to the image plane Sim, and the other lens groups move while changing the spacings between the adjacent lens groups. The variable magnification optical system includes two focusing groups. The focusing group on the object side consists of the second subsequent lens group GR2, and the focusing group on the image side consists of the fourth subsequent lens group GR4. During focusing from the infinite distance object to the short range object, the second subsequent lens group GR2 moves to the object side, the fourth subsequent lens group GR4 moves to the image side, and other lens groups remain stationary with respect to the image plane Sim. The anti-vibration group consists of the intermediate group GM.

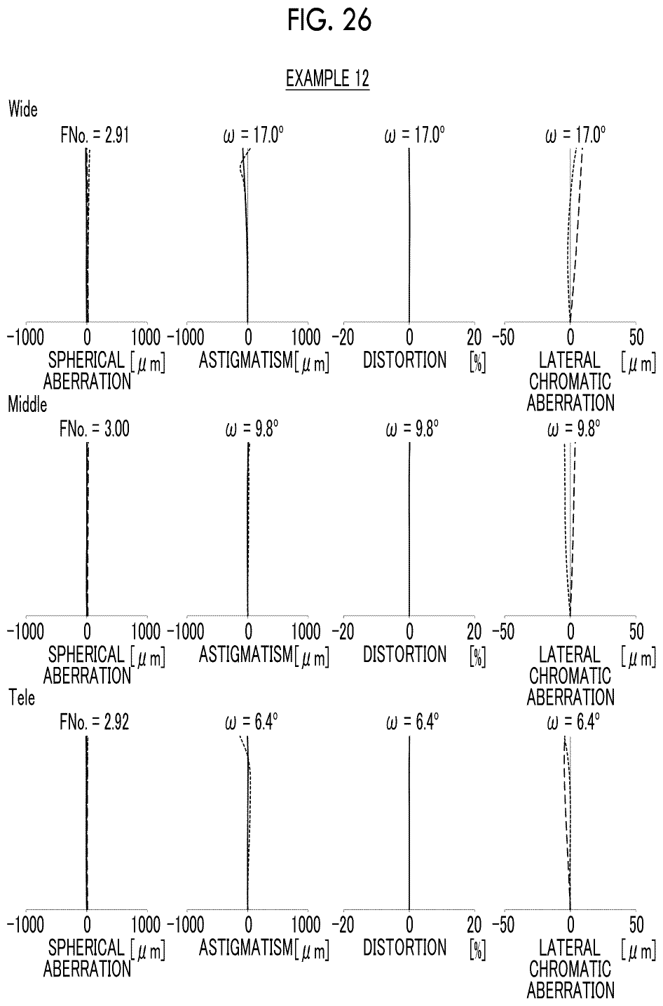

With respect to the variable magnification optical system according to Example 12, basic lens data is shown in Table 34, specifications and variable surface spacings are shown in Table 35, aspherical coefficients are shown in Table 36A and Table 36B, and each aberration diagram is shown in FIG. 26.

TABLE 34
Example 12

| Sn | R | D | Nd | νd | ED |
|---|---|---|---|---|---|
| *1 | 142.9461 | 4.6590 | 1.52841 | 76.45 | 67.00 |
| *2 | 1324.4676 | 0.0464 | | | 66.81 |
| 3 | 105.8930 | 1.7072 | 1.60562 | 43.48 | 65.69 |
| 4 | 51.1597 | 11.0084 | 1.49782 | 82.57 | 62.86 |
| 5 | 422.7959 | DD[5] | | | 62.43 |
| 6 | 519.3622 | 2.5883 | 1.50249 | 77.30 | 40.25 |
| 7 | −179.1324 | DD[7] | | | 39.94 |
| 8 | −364.2350 | 0.8739 | 1.76583 | 40.50 | 33.96 |
| 9 | 54.1409 | 5.3850 | | | 31.93 |
| 10 | −51.2288 | 0.8273 | 1.60431 | 46.51 | 31.70 |
| 11 | 102.8493 | 2.5106 | 1.97294 | 16.61 | 31.66 |
| 12 | −658.7355 | DD[12] | | | 31.79 |
| 13(St) | ∞ | 0.5000 | | | 31.28 |
| *14 | 41.3448 | 5.7640 | 1.52126 | 79.04 | 31.92 |
| *15 | −86.1052 | DD[15] | | | 31.68 |
| 16 | −40.8408 | 0.7363 | 1.59940 | 38.06 | 27.87 |
| 17 | 90.7223 | 2.3793 | 1.85150 | 22.43 | 28.07 |
| 18 | −514.8711 | DD[18] | | | 28.09 |
| 19 | 366.5451 | 3.1861 | 1.58056 | 64.83 | 27.86 |
| 20 | −56.8657 | 0.0332 | | | 28.25 |
| 21 | 141.2991 | 0.7482 | 2.04829 | 24.61 | 28.91 |
| 22 | 32.7181 | 5.4511 | 1.51957 | 51.33 | 28.97 |
| 23 | −142.8291 | 0.0347 | | | 29.48 |
| 24 | 50.4871 | 3.2299 | 1.64148 | 59.43 | 31.08 |
| 25 | 350.6283 | 0.0268 | | | 31.11 |
| 26 | 60.1719 | 3.0592 | 1.59530 | 53.98 | 31.29 |
| 27 | 1042.7041 | DD[27] | | | 31.14 |
| *28 | 136.8610 | 0.7273 | 1.57598 | 68.86 | 28.13 |
| *29 | 22.7416 | DD[29] | | | 26.81 |
| *30 | −95.1986 | 3.1278 | 1.88953 | 20.72 | 32.00 |
| *31 | −52.5097 | 9.5331 | | | 31.59 |
| *32 | −27.4128 | 3.4967 | 1.58524 | 66.89 | 32.69 |
| *33 | −64.4869 | DD[33] | | | 36.77 |

TABLE 35
Example 12

| | Wide | Middle | Tele |
|---|---|---|---|
| Zr | 1.0 | 1.8 | 2.7 |
| f | 70.99 | 125.65 | 192.01 |
| FNo. | 2.91 | 3.00 | 2.92 |
| 2ω[°] | 34.0 | 19.6 | 12.8 |
| DD[5] | 1.85 | 42.62 | 56.64 |
| DD[7] | 1.01 | 6.00 | 15.12 |
| DD[12] | 15.11 | 10.11 | 0.99 |
| DD[15] | 8.69 | 9.44 | 10.35 |
| DD[18] | 7.03 | 2.86 | 1.00 |
| DD[27] | 12.83 | 7.34 | 0.96 |
| DD[29] | 14.90 | 14.08 | 18.18 |
| DD[33] | 11.97 | 21.69 | 24.92 |

TABLE 36A
Example 12

| Sn | 1 | 2 | 28 | 29 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 4.2009885E−08 | 5.0741983E−08 | 1.1481464E−05 | 1.0692837E−05 |
| A5 | 8.5541933E−10 | 7.4231743E−10 | −6.0683111E−07 | −4.7078321E−07 |
| A6 | −1.7507685E−11 | −1.8245244E−11 | −4.3529363E−08 | −4.7849932E−08 |
| A7 | −9.4065720E−13 | −3.5618444E−13 | −2.4205837E−10 | −6.6714027E−10 |
| A8 | 4.1925615E−15 | −1.8748705E−14 | 1.6589034E−10 | 9.9033522E−11 |
| A9 | 3.2458374E−16 | −3.4820459E−16 | 1.3281472E−11 | 1.0504360E−11 |
| A10 | −1.1337191E−17 | −6.1645155E−18 | 2.8558833E−13 | 4.3547612E−13 |
| A11 | 4.0467905E−19 | 1.3900927E−18 | −3.8535812E−14 | 7.4557916E−15 |
| A12 | 1.5960972E−20 | 3.7845129E−20 | −4.4496578E−15 | −8.8812988E−16 |
| A13 | 5.3489731E−22 | 2.4900618E−22 | −1.5620792E−16 | −1.5836475E−16 |
| A14 | 1.2315424E−23 | −1.8585986E−23 | 9.5326383E−18 | −1.9241970E−17 |
| A15 | −4.2763755E−26 | −5.1687247E−25 | 1.7768823E−18 | −9.5724469E−19 |
| A16 | −3.1188391E−26 | −9.1472986E−27 | −6.9010390E−20 | 1.3963696E−19 |

| Sn | 14 | 15 | 32 | 33 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −2.2918123E−06 | 1.2035232E−06 | −3.4322476E−05 | −4.5362290E−05 |
| A5 | 8.6006935E−08 | 9.8862310E−08 | −4.8047905E−07 | 2.5514580E−07 |
| A6 | −1.9732787E−09 | −2.1752670E−09 | 8.9268448E−08 | 5.2812039E−08 |
| A7 | −7.1239050E−11 | −1.3982173E−10 | −4.5872897E−10 | 6.7985767E−10 |
| A8 | 4.1423389E−14 | −6.0440672E−12 | −1.7165179E−10 | −1.4912103E−10 |
| A9 | −2.5765371E−13 | 7.2735108E−14 | 2.4123044E−12 | −1.3004346E−12 |
| A10 | −1.1192773E−14 | 8.4388540E−15 | 2.7976770E−13 | 1.3367973E−13 |
| A11 | 1.4008670E−15 | 2.2699144E−15 | −9.0972792E−15 | −5.9621224E−16 |
| A12 | 1.0915858E−16 | 1.1771985E−16 | −1.1766578E−15 | −4.6365407E−17 |
| A13 | 6.4720944E−18 | 1.8428315E−18 | −5.4009103E−17 | −1.0871834E−18 |
| A14 | 1.8648115E−19 | −1.8605307E−19 | −1.2180944E−18 | −2.9530926E−19 |
| A15 | 1.8833263E−21 | −1.1465196E−20 | 1.0589453E−19 | −2.0773480E−20 |
| A16 | −1.1938086E−21 | −1.0894670E−21 | 9.4307785E−21 | −1.4110679E−22 |
| A17 | −1.0670324E−22 | −1.7065605E−23 | 7.1941482E−22 | 6.2218465E−23 |
| A18 | −4.1822883E−24 | 4.9218920E−25 | 2.9458272E−23 | 9.6726565E−24 |
| A19 | −6.4500896E−26 | 2.4523773E−25 | 6.6376176E−25 | 2.6817757E−25 |
| A20 | 4.4260969E−26 | 1.1927153E−26 | −9.6864128E−26 | −2.9278189E−26 |

TABLE 36B
Example 12

| Sn | 30 | 31 |
|---|---|---|
| KA | 1.0000000E+00 | 1.0000000E+00 |
| A3 | 0.0000000E+00 | 0.0000000E+00 |
| A4 | 1.6265564E−05 | 1.6462302E−05 |
| A5 | 3.2644239E−07 | 1.0275850E−07 |
| A6 | −1.9517312E−10 | 3.8975953E−09 |
| A7 | −4.9693924E−11 | 4.8826210E−10 |
| A8 | 1.4672896E−11 | 1.6450030E−11 |
| AS | 1.2312119E−12 | 7.0853755E−13 |
| A10 | 6.1341489E−14 | 6.7935651E−14 |
| A11 | 3.4096908E−15 | 4.7954676E−15 |
| A12 | 2.6590956E−16 | 2.0438961E−16 |
| A13 | 2.3005809E−17 | 2.2654797E−18 |
| A14 | 1.4186972E−18 | −1.8303985E−19 |
| A15 | 2.7710707E−20 | 3.2648004E−20 |
| A16 | −7.4965593E−21 | 1.1160686E−20 |

### Example 13

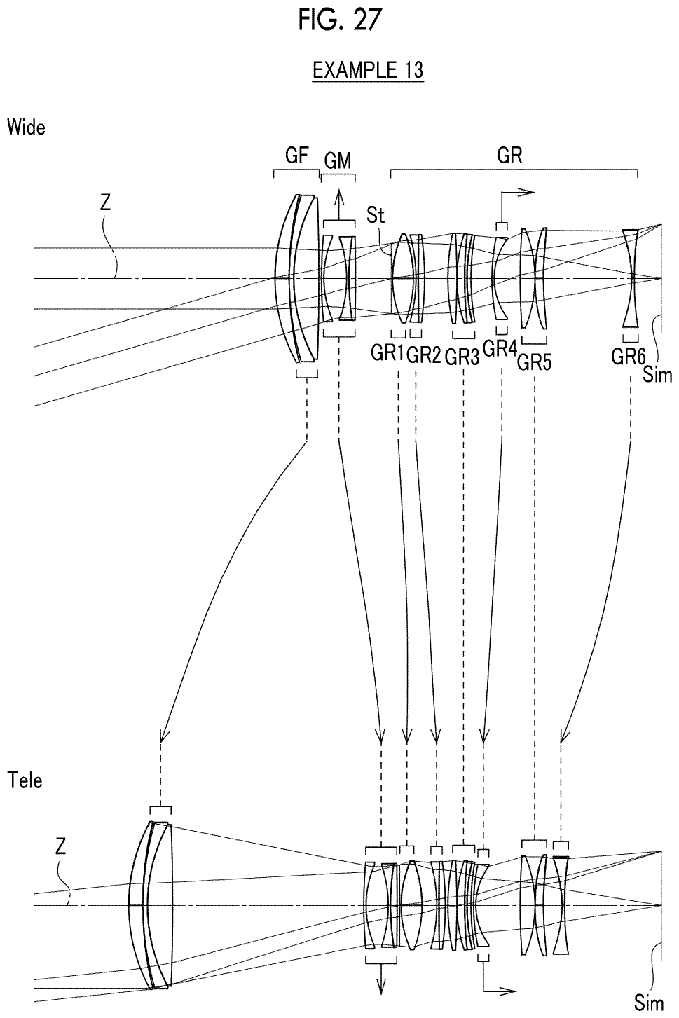

A configuration and a movement trajectory of a variable magnification optical system according to Example 13 are shown in FIG. 27. The variable magnification optical system according to Example 13 consists of the front group GF, the intermediate group GM, and the rear group GR in this order from the object side to the image side. The front group GF consists of one lens group having a positive refractive power. The intermediate group GM consists of one lens group having a negative refractive power. The rear group GR consists of the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, the fifth subsequent lens group GR5 having a positive refractive power, and the sixth subsequent lens group GR6 having a negative refractive power, in this order from the object side to the image side.

During magnification change from the wide angle end to the telephoto end, the third subsequent lens group GR3 and the fifth subsequent lens group GR5 remain stationary with respect to the image plane Sim, and the other lens groups move while changing the spacings between the adjacent lens groups. The variable magnification optical system includes one focusing group, and the focusing group consists of the fourth subsequent lens group GR4. During focusing from the infinite distance object to the short range object, the fourth subsequent lens group GR4 moves to the image side, and the other lens groups remain stationary with respect to the image plane Sim. The anti-vibration group consists of the intermediate group GM.

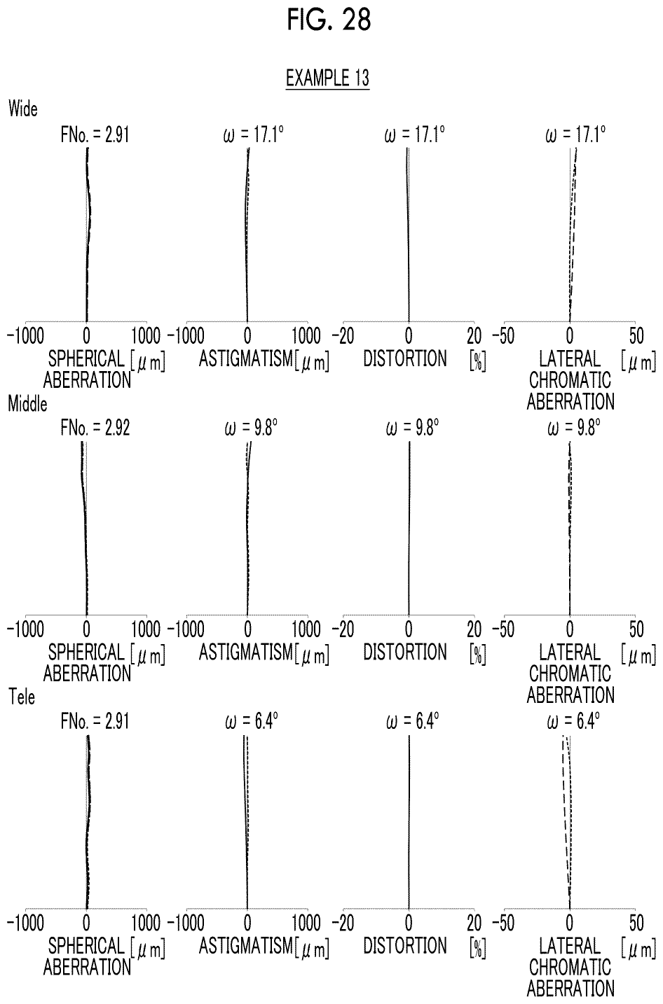

With respect to the variable magnification optical system according to Example 13, basic lens data is shown in Table 37, specifications and variable surface spacings are shown in Table 38, aspherical coefficients are shown in Table 39, and each aberration diagram is shown in FIG. 28.

TABLE 37
Example 13

| Sn | R | D | Nd | νd | ED |
|---|---|---|---|---|---|
| *1 | 74.0777 | 5.2998 | 1.53775 | 74.70 | 67.00 |
| *2 | 155.0978 | 0.0359 | | | 66.61 |
| 3 | 124.4509 | 1.6915 | 1.85026 | 32.35 | 66.41 |
| 4 | 71.8823 | 9.4679 | 1.49782 | 82.57 | 64.48 |
| 5 | −931.7262 | DD[5] | | | 64.13 |
| 6 | 208.4785 | 0.8889 | 1.71960 | 56.74 | 34.54 |
| 7 | 43.4077 | 8.3133 | | | 32.54 |
| 8 | −53.3495 | 0.8682 | 1.59836 | 66.10 | 32.12 |
| 9 | 113.7184 | 2.4761 | 2.00000 | 15.00 | 33.32 |
| 10 | −821.3236 | DD[10] | | | 33.48 |
| 11(St) | ∞ | 0.4760 | | | 32.38 |
| *12 | 43.5721 | 7.8734 | 1.57712 | 69.40 | 35.25 |
| *13 | −49.3809 | DD[13] | | | 35.45 |
| 14 | −67.3895 | 0.8439 | 2.00000 | 15.00 | 34.23 |
| 15 | 1038.1858 | 2.3565 | 1.55080 | 73.41 | 34.78 |
| 16 | −135.1800 | DD[16] | | | 35.05 |
| 17 | 91.8893 | 3.3594 | 2.00001 | 15.00 | 36.00 |
| 18 | −344.4815 | 0.0379 | | | 35.98 |
| 19 | 59.0320 | 2.9009 | 1.57701 | 69.42 | 35.53 |
| 20 | 164.5046 | 0.9046 | 1.91202 | 19.40 | 35.18 |
| 21 | 80.5002 | 1.4743 | 1.50617 | 80.21 | 34.63 |
| 22 | 103.4592 | DD[22] | | | 34.37 |
| 23 | 84.1761 | 0.8424 | 1.96715 | 31.96 | 32.73 |
| 24 | 27.5238 | DD[24] | | | 31.39 |
| 25 | 292.2609 | 5.5514 | 1.70488 | 57.48 | 38.99 |
| 26 | −54.7050 | 0.0500 | | | 39.44 |
| *27 | 85.2343 | 3.1359 | 1.43601 | 90.90 | 40.27 |
| *28 | 134.1094 | DD[28] | | | 40.04 |
| *29 | −44.6072 | 0.9988 | 1.50658 | 80.15 | 38.00 |
| *30 | 246.9665 | DD[30] | | | 38.92 |

TABLE 38
Example 13

| | Wide | Middle | Tele |
|---|---|---|---|
| Zr | 1.0 | 1.8 | 2.7 |
| f | 70.89 | 125.57 | 192.00 |
| FNo. | 2.91 | 2.92 | 2.91 |
| 2ω[°] | 34.2 | 19.6 | 12.8 |
| DD[5] | 0.99 | 49.02 | 71.64 |
| DD[10] | 13.43 | 6.57 | 1.00 |
| DD[13] | 0.97 | 2.58 | 5.55 |
| DD[16] | 8.78 | 3.88 | 0.98 |
| DD[22] | 7.88 | 4.12 | 0.99 |
| DD[24] | 9.78 | 13.55 | 16.67 |
| DD[28] | 33.20 | 22.78 | 7.01 |
| DD[30] | 10.13 | 20.55 | 36.33 |

TABLE 39
Example 13

| Sn | 1 | 2 | 12 | 13 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −4.3471675E−07 | −2.8014748E−07 | −2.4828332E−06 | 3.0328154E−06 |
| A5 | 1.9835363E−08 | 1.3205953E−08 | −8.6288098E−08 | −2.0035626E−07 |
| A6 | −1.2761743E−10 | 5.2447208E−10 | 1.3224601E−08 | 2.6470208E−08 |
| A7 | 5.3694878E−12 | −7.3698824E−12 | 2.1290098E−10 | 1.5519612E−10 |
| A8 | 1.4222324E−14 | −2.3723488E−13 | −1.6276502E−11 | −6.0093142E−11 |
| A9 | −5.7166341E−15 | −1.8101984E−15 | −1.5699917E−12 | −3.2362602E−12 |
| A10 | −1.5764585E−16 | −2.8065778E−18 | −8.3749591E−14 | −3.5574914E−14 |
| A11 | −7.7472931E−19 | −3.6723009E−19 | −2.8287226E−15 | 6.9062457E−15 |
| A12 | 5.9452164E−20 | −4.3532378E−21 | 7.9435459E−17 | 5.7977542E−16 |
| A13 | 2.3950490E−21 | 1.0573382E−21 | 2.1842864E−17 | 1.9113343E−17 |
| A14 | 3.4719629E−23 | 6.0429034E−23 | 1.7944723E−18 | −4.0638413E−19 |
| A15 | −3.7447497E−25 | 1.1684608E−24 | 5.2987797E−20 | −8.0702624E−20 |
| A16 | −2.3350302E−26 | −5.7254173E−26 | −8.5085923E−21 | −4.8739391E−22 |

| Sn | 27 | 28 | 29 | 30 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 5.4123936E−06 | 1.2409056E−06 | 1.8303482E−05 | 1.3759477E−05 |
| A5 | −2.7770796E−07 | −1.4268776E−07 | −1.8537167E−07 | −1.2825388E−08 |
| A6 | 2.0048777E−10 | −1.2291030E−08 | −3.5092351E−08 | −4.0288781E−08 |
| A7 | 1.7074202E−10 | 3.6943492E−11 | −4.2323814E−10 | −8.0312302E−10 |
| A8 | 5.9543503E−12 | 2.1864211E−11 | 7.5919864E−12 | 1.5373342E−11 |
| A9 | 5.2367677E−13 | 5.4958693E−13 | 8.5876341E−13 | 3.0354200E−12 |
| A10 | 2.7241715E−14 | −3.1152419E−14 | 6.7707672E−14 | 1.8919956E−13 |
| A11 | −2.9819125E−16 | −2.1395348E−15 | 7.2647438E−15 | −2.7850736E−15 |
| A12 | −1.3154818E−16 | 4.5852826E−17 | 2.7559357E−16 | −1.2708319E−16 |
| A13 | −4.7188888E−18 | 1.0073899E−17 | −6.0523665E−18 | −1.5802111E−17 |
| A14 | 4.5737373E−19 | 2.6353064E−19 | −1.3152337E−18 | −5.0642624E−20 |
| A15 | 4.4580221E−20 | −1.7588522E−20 | −9.9025533E−20 | 9.7065087E−21 |
| A16 | −2.1775321E−21 | −3.9477428E−22 | 5.5472658E−21 | 7.0443584E−22 |

### Example 14

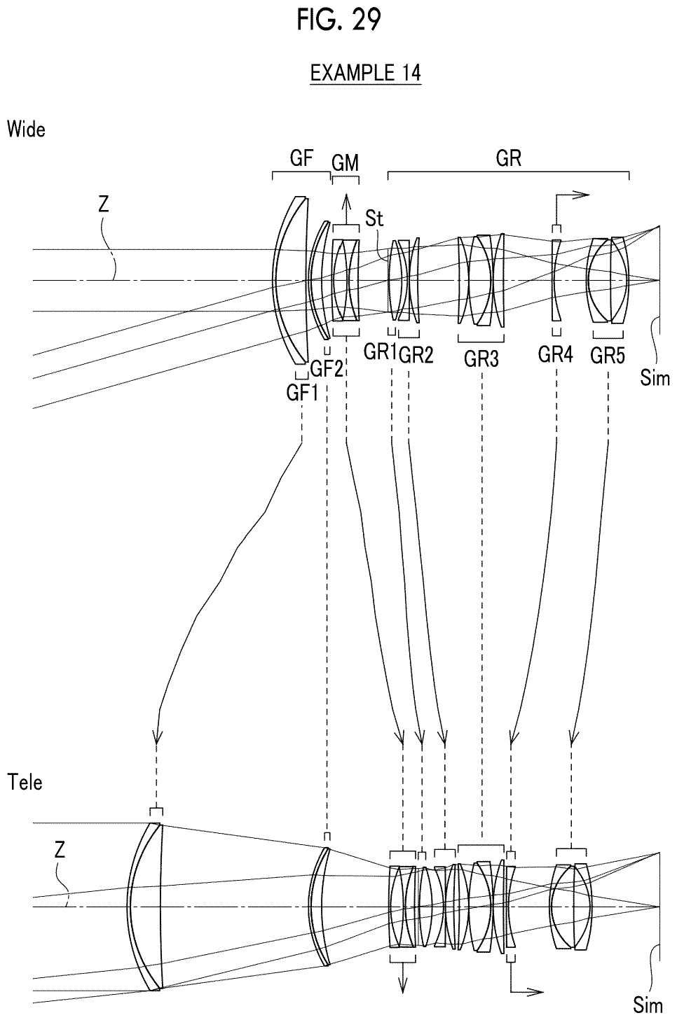

A configuration and a movement trajectory of a variable magnification optical system according to Example 14 are shown in FIG. 29. The variable magnification optical system according to Example 14 consists of the front group GF, the intermediate group GM, and the rear group GR in this order from the object side to the image side. The front group GF consists of the first front side lens group GF1 having a positive refractive power and the second front side lens group GF2 having a positive refractive power, in this order from the object side to the image side. The intermediate group GM consists of one lens group having a negative refractive power. The rear group GR consists of, in this order from the object side to the image side, the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, and the fifth subsequent lens group GR5 having a negative refractive power.

During magnification change from the wide angle end to the telephoto end, the second front side lens group GF2 and the third subsequent lens group GR3 remain stationary with respect to the image plane Sim, and the other lens groups move while changing the spacings between the adjacent lens groups. The variable magnification optical system includes one focusing group, and the focusing group consists of the fourth subsequent lens group GR4. During focusing from the infinite distance object to the short range object, the fourth subsequent lens group GR4 moves to the image side, and the other lens groups remain stationary with respect to the image plane Sim. The anti-vibration group consists of the intermediate group GM.

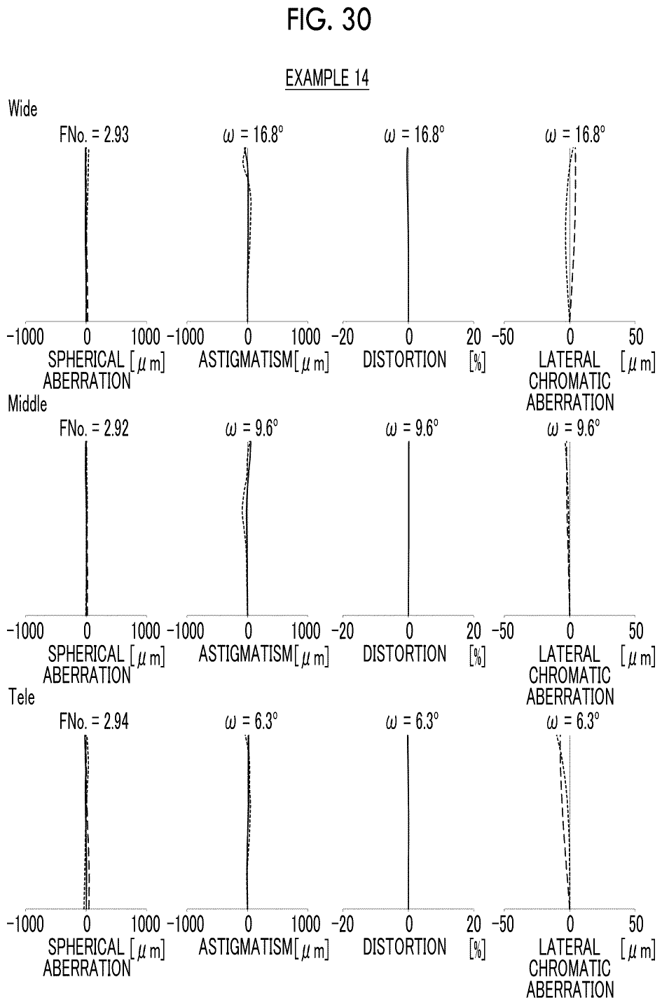

With respect to the variable magnification optical system according to Example 14, basic lens data is shown in Table 40, specifications and variable surface spacings are shown in Table 41, aspherical coefficients are shown in Table 42, and each aberration diagram is shown in FIG. 30.

TABLE 40
Example 14

| Sn | R | D | Nd | νd | ED |
|---|---|---|---|---|---|
| 1 | 69.0102 | 1.2647 | 1.83400 | 37.18 | 67.00 |
| 2 | 531064 | 0.0000 | | | 65.23 |
| 3 | 53.2292 | 11.2871 | 1.43700 | 95.10 | 65.28 |
| 4 | 609.1580 | DD[4] | | | 65.06 |
| 5 | 49.1086 | 0.9823 | 1.98698 | 15.65 | 47.25 |
| 6 | 44.9679 | 3.9764 | 1.77022 | 50.98 | 46.33 |
| 7 | 85.8907 | DD[7] | | | 45.92 |
| 8 | 261.5447 | 0.7418 | 1.95231 | 32.77 | 32.52 |
| 9 | 40.2789 | 4.7638 | | | 31.22 |
| 10 | −80.9139 | 0.7752 | 1.68856 | 38.59 | 31.22 |
| 11 | 44.6466 | 3.4248 | 1.96784 | 18.88 | 32.17 |
| 12 | 331.5080 | DD[12] | | | 32.21 |
| 13(St) | ∞ | 0.4496 | | | 30.78 |
| *14 | 84.3961 | 4.7491 | 1.67533 | 33.50 | 31.63 |
| *15 | −53.9597 | DD[15] | | | 31.70 |
| 16 | −37.1228 | 0.7438 | 1.97244 | 30.76 | 30.78 |
| 17 | −1612.2204 | 0.0000 | | | 32.01 |
| 18 | 51.5892 | 3.1543 | 1.67876 | 31.87 | 33.78 |
| 19 | 262.9282 | DD[19] | | | 33.82 |
| 20 | −330.8800 | 3.5238 | 1.79888 | 48.11 | 34.00 |
| 21 | −48.0118 | 0.0500 | | | 34.32 |
| 22 | 76.9861 | 8.2625 | 1.49042 | 83.65 | 34.96 |
| 23 | −32.2608 | 0.8474 | 1.99999 | 28.00 | 34.88 |
| 24 | −139.2665 | 0.0500 | | | 36.16 |
| 25 | 57.8824 | 3.8483 | 1.81206 | 48.77 | 37.33 |
| 26 | 801.0344 | DD[26] | | | 37.17 |
| 27 | 1429.1333 | 0.7891 | 1.80358 | 42.70 | 32.26 |
| 28 | 50.2959 | DD[28] | | | 31.40 |
| 29 | 53.5966 | 0.8174 | 1.94878 | 33.12 | 33.45 |
| 30 | 21.7245 | 8.3433 | 1.78998 | 25.50 | 32.34 |
| 31 | 413.5143 | 6.1038 | | | 32.28 |
| *32 | −24.0541 | 0.7931 | 1.77860 | 50.14 | 32.28 |
| *33 | −79.5475 | DD[33] | | | 34.39 |

TABLE 41
Example 14

| | Wide | Middle | Tele |
|---|---|---|---|
| Zr | 1.0 | 1.8 | 2.7 |
| f | 72.08 | 127.66 | 195.19 |
| FNo. | 2.93 | 2.92 | 2.94 |
| 2ω[°] | 33.6 | 19.2 | 12.6 |
| DD[4] | 0.96 | 40.52 | 55.66 |
| DD[7] | 3.78 | 14.66 | 24.99 |
| DD[12] | 11.21 | 5.93 | 1.38 |
| DD[15] | 2.09 | 3.11 | 4.26 |
| DD[19] | 15.64 | 9.02 | 2.06 |
| DD[26] | 18.28 | 11.33 | 1.12 |
| DD[28] | 12.03 | 12.86 | 15.35 |
| DD[33] | 11.58 | 17.70 | 25.41 |

TABLE 42
Example 14

| Sn | 14 | 15 | 32 | 33 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −1.4249573E−06 | −1.6128928E−06 | 1.6811428E−05 | 6.0555739E−06 |
| A5 | 1.6511806E−07 | 1.3749273E−07 | −1.8543847E−06 | −1.1892037E−06 |
| A6 | −6.1418523E−09 | −4.3393658E−09 | 3.5422956E−08 | −1.9218869E−08 |
| A7 | 3.9150806E−10 | 1.6665701E−10 | 2.7672869E−09 | 4.0171304E−10 |
| A8 | −1.4893505E−11 | 2.0254073E−11 | −1.7186728E−10 | 3.1959619E−10 |
| A9 | −1.3365063E−12 | −2.6398965E−12 | 1.7912702E−11 | 1.1008429E−12 |
| A10 | 1.6413780E−13 | 2.9254118E−14 | −1.9071453E−13 | −6.8199641E−13 |
| A11 | 2.2020042E−15 | −8.2813831E−16 | −3.2629943E−14 | 3.9542265E−14 |
| A12 | −5.4709383E−16 | 4.8807412E−16 | 9.8161246E−16 | −4.9291902E−15 |
| A13 | −9.9450019E−18 | −2.0268050E−18 | 2.4281629E−16 | 5.0830535E−17 |
| A14 | −1.0027543E−18 | −9.8681725E−19 | −2.4166238E−17 | 9.5663365E−18 |
| A15 | 1.4627263E−19 | −1.5515356E−19 | −9.1940824E−20 | 9.8284730E−21 |
| A16 | −6.1539125E−22 | 1.0206580E−20 | 4.3263421E−20 | −8.7255241E−21 |

### Example 15

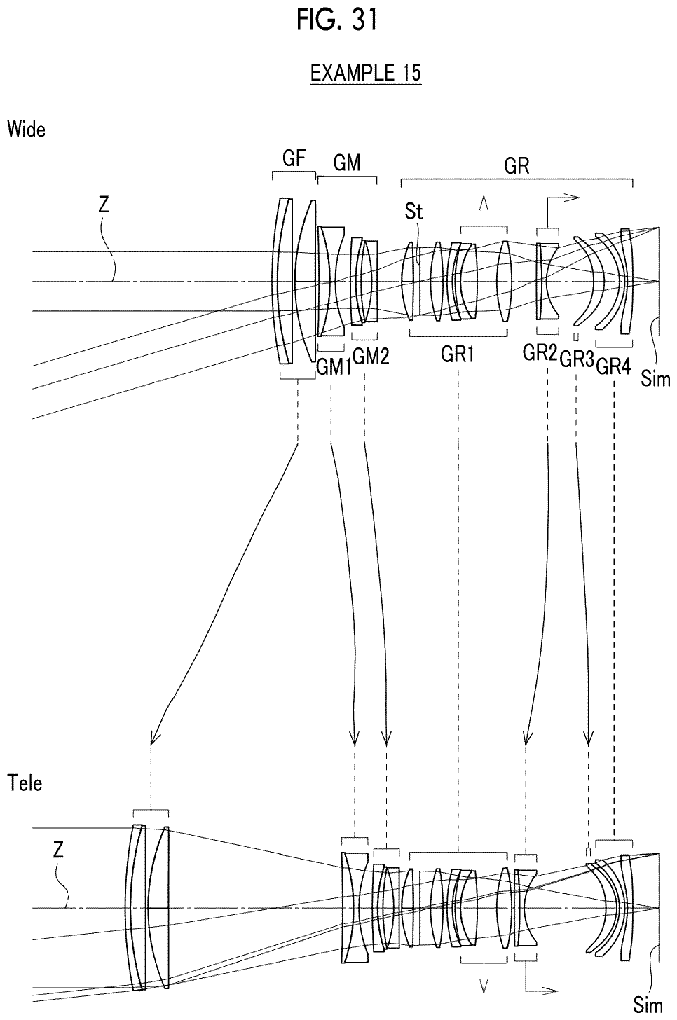

A configuration and a movement trajectory of a variable magnification optical system according to Example 15 are shown in FIG. 31. The variable magnification optical system according to Example 15 consists of the front group GF, the intermediate group GM, and the rear group GR in this order from the object side to the image side. The front group GF consists of one lens group having a positive refractive power. The intermediate group GM consists of a first intermediate lens group GM1 having a negative refractive power and a second intermediate lens group GM2 having a negative refractive power in this order from the object side to the image side. The rear group GR consists of the first subsequent lens group GR1 having a positive refractive power, the second subsequent lens group GR2 having a negative refractive power, the third subsequent lens group GR3 having a positive refractive power, and the fourth subsequent lens group GR4 having a negative refractive power, in this order from the object side to the image side.

During magnification change from the wide angle end to the telephoto end, the first subsequent lens group GR1 and the fourth subsequent lens group GR4 remain stationary with respect to the image plane Sim, and the other lens groups move while changing the spacings between the adjacent lens groups. The variable magnification optical system includes one focusing group, and the focusing group consists of the second subsequent lens group GR2. During focusing from the infinite distance object to the short range object, the second subsequent lens group GR2 moves to the image side, and the other lens groups remain stationary with respect to the image plane Sim. The anti-vibration group consists of three lenses, that is, a first lens, a second lens, and a third lens, which are arranged in this order from the image side in the first subsequent lens group GR1.

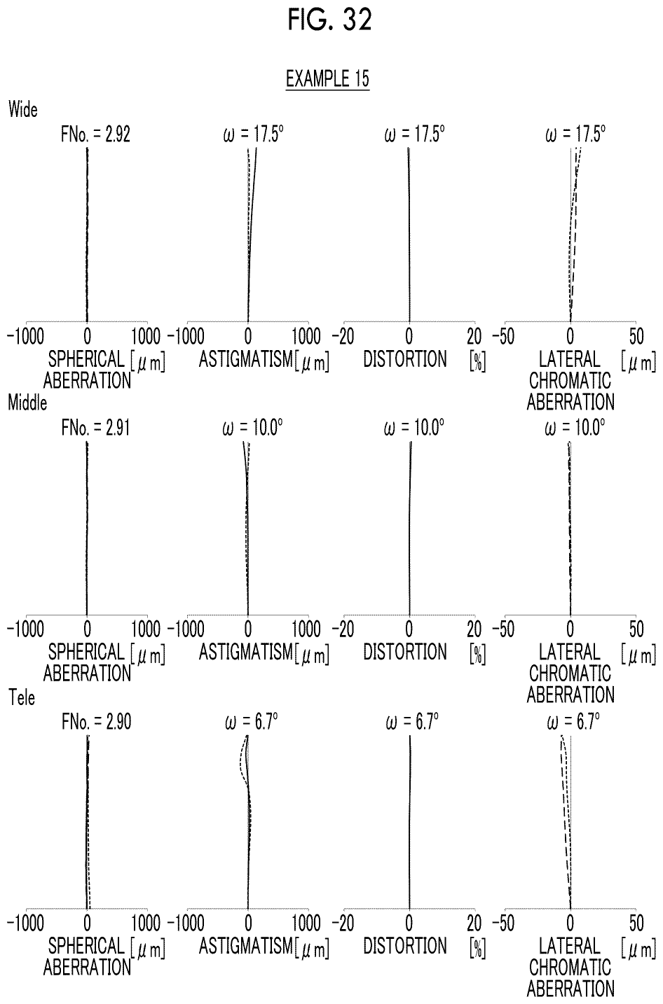

With respect to the variable magnification optical system according to Example 15, basic lens data is shown in Table 43, specifications and variable surface spacings are shown in Table 44, aspherical coefficients are shown in Table 45A and Table 45B, and each aberration diagram is shown in FIG. 32.

TABLE 43
Example 15

| Sn | R | D | Nd | νd | ED |
|---|---|---|---|---|---|
| 1 | 178.5139 | 1.9998 | 1.92286 | 20.88 | 66.00 |
| 2 | 124.3145 | 5.6430 | 1.49782 | 82.57 | 65.38 |
| 3 | 32353.1264 | 0.9998 | | | 65.26 |
| *4 | 83.1729 | 7.6667 | 1.43700 | 95.10 | 64.28 |
| *5 | 3669.4153 | DD[5] | | | 63.85 |
| 6 | −620.2531 | 4.1198 | 1.99943 | 26.53 | 40.73 |
| 7 | −72.4528 | 2.0102 | 1.63699 | 59.65 | 40.02 |
| 8 | 52.3751 | DD[8] | | | 34.59 |
| 9 | 286.3188 | 2.0098 | 1.43700 | 95.10 | 32.98 |
| 10 | 57.0087 | 2.0000 | 1.99849 | 15.08 | 31.09 |
| 11 | 88.8743 | 4.0520 | | | 30.48 |
| 12 | −53.7187 | 1.9999 | 1.91208 | 36.79 | 30.06 |
| 13 | 1452.6834 | DD[13] | | | 29.82 |
| *14 | 40.4276 | 4.3982 | 1.51163 | 74.02 | 29.86 |
| *15 | −212.0632 | 2.4600 | | | 29.78 |
| 16(St) | ∞ | 4.0000 | | | 29.60 |
| 17 | 55.6753 | 4.6915 | 1.43700 | 95.10 | 31.27 |
| 18 | −102.7848 | 1.5140 | | | 31.30 |
| 19 | 63.7189 | 1.9998 | 1.86935 | 23.00 | 30.81 |
| 20 | 37.1213 | 1.0572 | | | 29.89 |
| 21 | 53.6376 | 1.9998 | 1.94586 | 32.14 | 29.90 |
| 22 | 27.8312 | 6.3448 | 1.43700 | 95.10 | 29.25 |
| 23 | −142.2341 | 7.3098 | | | 29.57 |
| 24 | 52.6152 | 5.3714 | 1.75463 | 52.38 | 32.00 |
| 25 | −80.1958 | DD[25] | | | 32.01 |
| 26 | 861.0859 | 2.0000 | 1.95893 | 17.05 | 30.41 |
| 27 | −182.4921 | 1.7428 | 1.59150 | 65.92 | 30.06 |
| 28 | 22.4467 | DD[28] | | | 27.35 |
| *29 | −30.5305 | 4.0462 | 1.83985 | 44.02 | 34.00 |
| *30 | −20.3876 | DD[30] | | | 35.52 |
| 31 | −22.3997 | 1.9998 | 1.71887 | 30.38 | 35.86 |
| 32 | −26.1530 | 0.9999 | | | 38.49 |
| *33 | −37.9804 | 1.9998 | 1.61202 | 62.77 | 41.39 |
| *34 | −1080.5052 | 10.0100 | | | 41.93 |

TABLE 44
Example 15

| | Wide | Middle | Tele |
|---|---|---|---|
| Zr | 1.0 | 1.8 | 2.7 |
| f | 68.70 | 121.33 | 185.12 |
| FNo. | 2.92 | 2.91 | 2.90 |
| 2ω[°] | 35.0 | 20.0 | 13.4 |
| DD[5] | 1.37 | 40.93 | 65.31 |
| DD[8] | 5.69 | 4.18 | 5.03 |
| DD[13] | 9.25 | 2.23 | 0.99 |
| DD[25] | 9.31 | 7.98 | 1.01 |
| DD[28] | 17.77 | 22.92 | 30.72 |
| DD[30] | 5.70 | 1.87 | 1.05 |

TABLE 45A
Example 15

| Sn | 4 | 5 |
|---|---|---|
| KA | 1.0000000E+00 | 1.0000000E+00 |
| A3 | 0.0000000E+00 | 0.0000000E+00 |
| A4 | −4.4447403E−08 | −3.4692440E−08 |
| A5 | −2.2661286E−09 | −1.2077438E−10 |
| A6 | 3.8223932E−11 | −6.9661980E−11 |
| A7 | 8.6620994E−13 | 2.2864765E−12 |
| A8 | −4.7783264E−14 | −3.3199544E−14 |
| A9 | −1.9443591E−15 | 8.8762248E−16 |
| A10 | 6.7852097E−17 | −1.0511119E−16 |
| A11 | −3.3027777E−18 | 5.0992599E−18 |
| A12 | 3.1323029E−20 | −4.6070765E−20 |
| A13 | 7.7296515E−21 | −2.2400065E−22 |
| A14 | −4.1969668E−23 | 2.9124498E−23 |
| A15 | 6.8845259E−25 | 3.2281995E−24 |
| A16 | −1.9244495E−25 | −1.9310663E−25 |

| Sn | 14 | 15 |
|---|---|---|
| KA | 1.0000000E+00 | 1.0000000E+00 |
| A3 | 0.0000000E+00 | 0.0000000E+00 |
| A4 | −2.1850799E−06 | 5.7604475E−06 |
| A5 | 2.4767574E−09 | 1.8055734E−08 |
| A6 | −1.9705375E−09 | −2.0386051E−09 |
| A7 | 3.8543513E−11 | −5.4552966E−11 |
| A8 | 1.1475916E−11 | 1.3722314E−11 |
| A9 | 1.4256014E−12 | 1.0965744E−12 |
| A10 | 1.9206323E−14 | 2.1026415E−14 |
| A11 | −2.2161380E−15 | −3.0860739E−15 |
| A12 | −3.2235889E−16 | −3.4350922E−17 |
| A13 | 2.2703700E−18 | 3.7591227E−18 |
| A14 | 1.0068745E−19 | 1.6296177E−19 |
| A15 | −1.5951733E−20 | −3.1747999E−20 |
| A16 | −1.2158956E−21 | −2.9269519E−21 |
| A17 | 4.3605118E−23 | −9.0065964E−23 |
| A18 | −1.0816711E−24 | −8.2529449E−24 |
| A19 | −3.2969120E−25 | −1.7220731E−26 |
| A20 | 5.0670533E−26 | 8.9762882E−26 |

TABLE 45B
Example 15

| Sn | 29 | 30 | 33 | 34 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −3.0253479E−05 | −1.5569230E−06 | 2.2083753E−05 | −1.6205663E−05 |
| A5 | 2.5622440E−07 | −4.3973286E−07 | −3.2141815E−07 | 5.5418569E−07 |
| A6 | −7.7734626E−08 | 5.8650791E−09 | 1.5776479E−09 | −5.2570568E−09 |
| A7 | 3.6879564E−09 | 2.0489612E−10 | 6.9074629E−10 | −1.8139296E−10 |
| A8 | −6.4311535E−11 | −5.2571580E−11 | 1.9344907E−12 | 1.6566854E−11 |
| A9 | −7.6148878E−12 | 2.6394525E−12 | 3.1367073E−13 | −3.2569612E−13 |
| A10 | 5.4298955E−13 | 3.7592169E−14 | −5.2105715E−14 | −5.1747399E−14 |
| A11 | −2.1901991E−14 | 1.8186742E−14 | −1.5436013E−15 | 3.4983000E−15 |
| A12 | 3.4265114E−15 | −4.1273580E−16 | 7.8079912E−17 | −9.2209811E−17 |
| A13 | −3.1304668E−17 | −2.1815074E−17 | 1.8604159E−18 | 3.4916387E−19 |
| A14 | −2.7959692E−19 | 2.0636247E−18 | 9.8695183E−21 | 2.9148319E−19 |
| A15 | 3.3693306E−20 | 7.9917592E−20 | 3.1487363E−21 | 1.0011495E−20 |
| A16 | −8.0316504E−21 | −2.2507173E−21 | −2.8110906E−22 | −8.6770512E−22 |

### Example 16

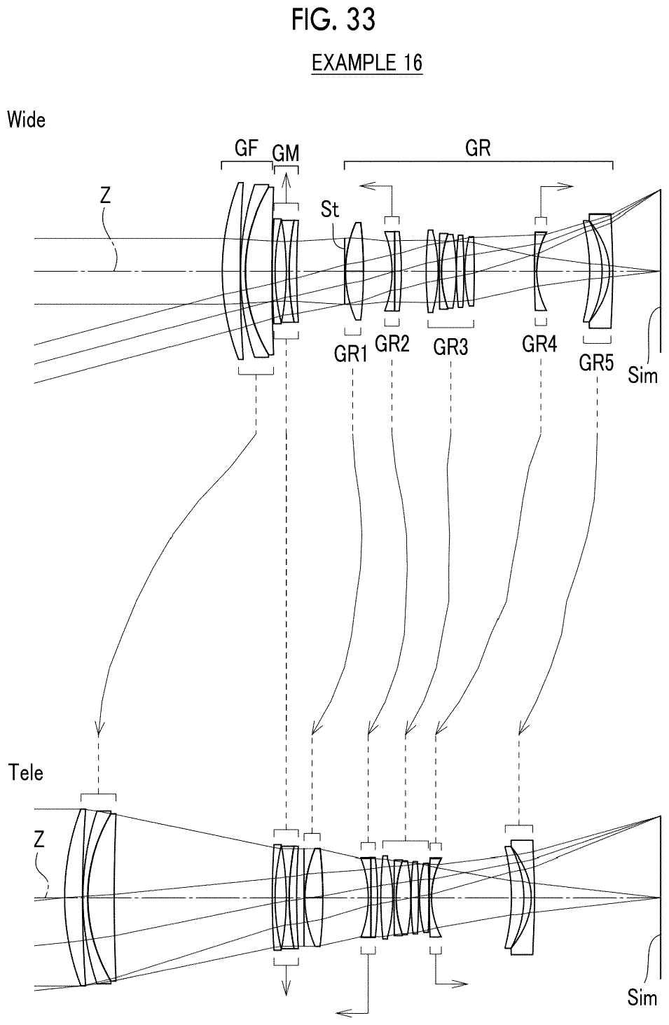

A configuration and a movement trajectory of a variable magnification optical system according to Example 16 are shown in FIG. 33. The variable magnification optical system according to Example 16 consists of the front group GF, the intermediate group GM, and the rear group GR in this order from the object side to the image side. The front group GF consists of one lens group having a positive refractive power. The intermediate group GM consists of one lens group having a negative refractive power. The rear group GR consists of, in this order from the object side to the image side, the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, and the fifth subsequent lens group GR5 having a negative refractive power.

During magnification change from the wide angle end to the telephoto end, the intermediate group GM remains stationary with respect to the image plane Sim, and the other lens groups move while changing the spacings between the adjacent lens groups. The variable magnification optical system includes two focusing groups. The focusing group on the object side consists of the second subsequent lens group GR2, and the focusing group on the image side consists of the fourth subsequent lens group GR4. During focusing from the infinite distance object to the short range object, the second subsequent lens group GR2 moves to the object side, the fourth subsequent lens group GR4 moves to the image side, and other lens groups remain stationary with respect to the image plane Sim. The anti-vibration group consists of the intermediate group GM.

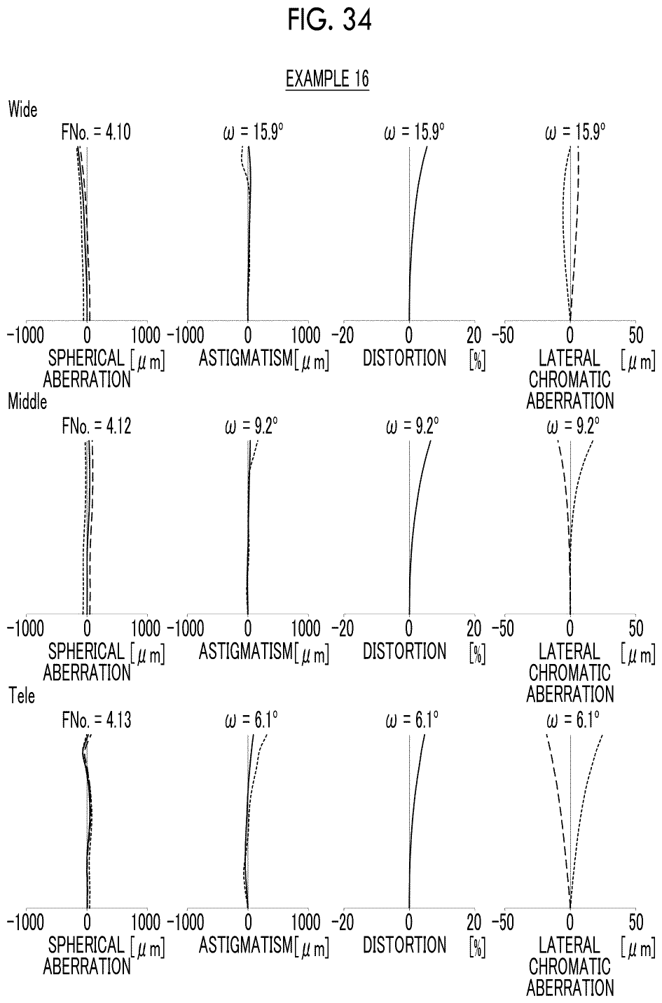

With respect to the variable magnification optical system according to Example 16, basic lens data is shown in Table 46, specifications and variable surface spacings are shown in Table 47, aspherical coefficients are shown in Table 48, and each aberration diagram is shown in FIG. 34.

TABLE 46
Example 16

| Sn | R | D | Nd | νd | ED |
|---|---|---|---|---|---|
| 1 | 69.4579 | 4.4880 | 1.49700 | 81.61 | 47.00 |
| 2 | 354.7523 | 0.0982 | | | 46.73 |
| 3 | 76.1769 | 1.1747 | 1.60342 | 38.03 | 45.90 |
| 4 | 45.0646 | 0.0950 | | | 44.45 |
| 5 | 45.6972 | 6.5867 | 1.43700 | 95.10 | 44.45 |
| 6 | 544.1259 | DD[6] | | | 44.03 |
| 7 | 220.6335 | 0.7040 | 1.56793 | 42.26 | 27.70 |
| 8 | 60.8275 | 2.8142 | | | 27.13 |
| 9 | −78.3302 | 0.7429 | 1.73367 | 55.84 | 27.11 |
| 10 | 75.8390 | 1.8607 | 1.91681 | 20.15 | 27.15 |
| 11 | 213.2596 | DD[11] | | | 27.13 |
| 12(St) | ∞ | 0.2270 | | | 25.88 |
| *13 | 33.4662 | 4.4932 | 1.49710 | 81.56 | 25.98 |
| 14 | −121.2636 | DD[14] | | | 25.68 |
| 15 | −30.8659 | 0.6857 | 1.67180 | 59.10 | 21.00 |
| 16 | −1339.7701 | 1.6295 | 1.82489 | 23.76 | 21.12 |
| 17 | −104.8189 | DD[17] | | | 21.18 |
| 18 | 115.8300 | 2.9918 | 1.48623 | 57.58 | 21.03 |
| 19 | −42.4858 | 0.3371 | | | 20.89 |
| 20 | 1048.8963 | 0.5260 | 1.99987 | 27.46 | 20.15 |
| 21 | 31.7113 | 3.6782 | 1.43644 | 66.92 | 19.69 |
| 22 | −57.4944 | 0.0500 | | | 19.62 |
| 23 | 89.9233 | 1.8792 | 1.43700 | 95.10 | 19.28 |
| 24 | −163.0756 | 0.2585 | | | 19.03 |
| 25 | 40.4902 | 2.3322 | 1.58777 | 39.22 | 18.46 |
| 26 | −335.0193 | DD[26] | | | 18.00 |
| 27 | 265.8591 | 0.5749 | 1.56030 | 71.97 | 20.74 |
| 28 | 23.4732 | DD[28] | | | 20.89 |
| 29 | −55.7873 | 3.1253 | 1.84494 | 22.75 | 26.23 |
| 30 | −29.5320 | 1.8448 | | | 26.98 |
| *31 | −17.7438 | 0.8320 | 1.59201 | 67.02 | 26.98 |
| *32 | −144.7942 | DD[32] | | | 30.35 |

TABLE 47
Example 16

| | Wide | Middle | Tele |
|---|---|---|---|
| Zr | 1.0 | 1.7 | 2.7 |
| f | 72.11 | 124.97 | 194.04 |
| FNo. | 4.10 | 4.12 | 4.13 |
| 2ω[°] | 31.8 | 18.4 | 12.2 |
| DD[6] | 0.10 | 30.04 | 39.53 |
| DD[11] | 12.05 | 12.82 | 1.85 |
| DD[14] | 7.18 | 9.92 | 11.40 |
| DD[17] | 6.25 | 2.23 | 0.84 |
| DD[26] | 14.98 | 6.85 | 0.10 |
| DD[28] | 13.29 | 14.26 | 19.91 |
| DD[32] | 12.01 | 19.67 | 31.65 |

TABLE 48
Example 16

| Sn | 13 | 31 | 32 |
|---|---|---|---|
| KA | 1.0000000E+00 | 3.1428200E−01 | 1.0000000E+00 |
| A3 | 0.0000000E+00 | 0.0000000E+00 | 0.0000000E+00 |
| A4 | −3.5219250E−06 | −1.0717689E−05 | −2.6720449E−05 |
| A5 | 6.6758390E−07 | 6.0228363E−06 | 1.1768310E−05 |
| A6 | −1.8424219E−07 | −1.1801163E−07 | −1.0429758E−06 |
| A7 | 2.2144514E−08 | −4.5472096E−08 | 2.1787641E−09 |
| A8 | −1.0165348E−09 | 8.6925397E−10 | 1.8670874E−09 |
| A9 | 2.1684523E−11 | −9.8282972E−11 | 7.6378831E−11 |
| A10 | −4.6351081E−12 | 2.9863770E−11 | −6.2173178E−12 |
| A11 | 2.4295560E−13 | −3.0018489E−13 | 6.2322962E−14 |
| A12 | 2.4335405E−14 | −5.9425029E−14 | −9.0549290E−15 |
| A13 | −2.3009097E−15 | 9.2879367E−16 | 1.2652822E−15 |
| A14 | 4.8027164E−17 | −1.1997596E−16 | −4.7729352E−17 |
| A15 | 1.0921743E−17 | 7.6231735E−18 | −2.4381379E−18 |
| A16 | −1.0778297E−18 | −3.7441415E−18 | −2.8911072E−19 |
| A17 | −1.1768457E−20 | 2.5725592E−19 | 1.5014232E−20 |
| A18 | −2.0024594E−22 | 1.0812763E−20 | 2.9124740E−21 |
| A19 | 4.5116692E−22 | −1.0021587E−21 | −1.6343105E−22 |
| A20 | −1.8507979E−23 | 1.2108026E−23 | 1.4959098E−24 |

### Example 17

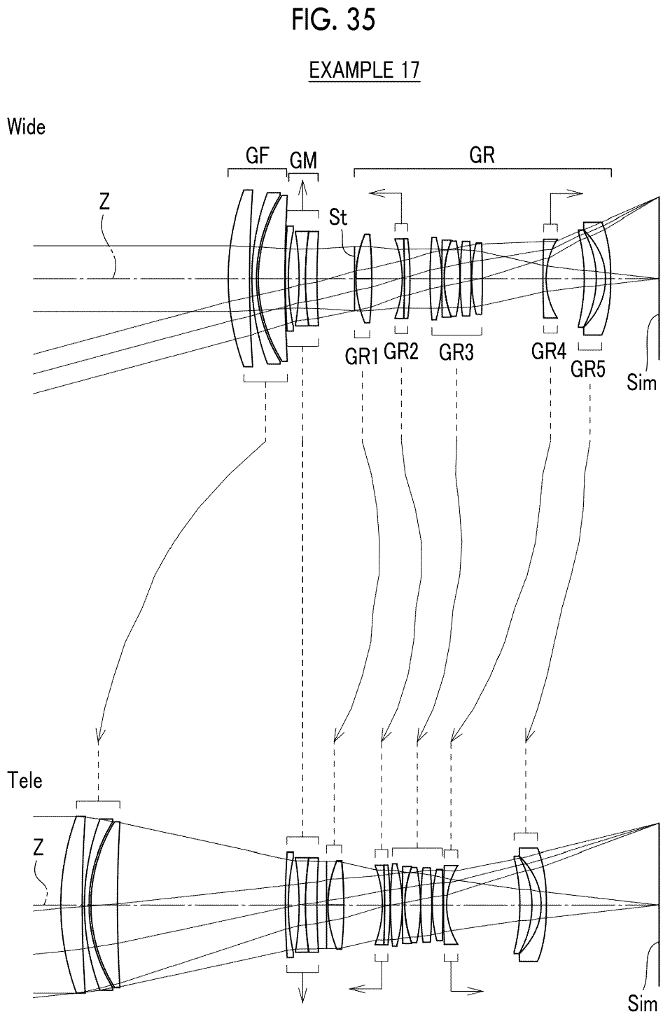

A configuration and a movement trajectory of a variable magnification optical system according to Example 17 are shown in FIG. 35. The variable magnification optical system according to Example 17 consists of the front group GF, the intermediate group GM, and the rear group GR in this order from the object side to the image side. The front group GF consists of one lens group having a positive refractive power. The intermediate group GM consists of one lens group having a negative refractive power. The rear group GR consists of, in this order from the object side to the image side, the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, and the fifth subsequent lens group GR5 having a negative refractive power.

During magnification change from the wide angle end to the telephoto end, the intermediate group GM remains stationary with respect to the image plane Sim, and the other lens groups move while changing the spacings between the adjacent lens groups. The variable magnification optical system includes two focusing groups. The focusing group on the object side consists of the second subsequent lens group GR2, and the focusing group on the image side consists of the fourth subsequent lens group GR4. During focusing from the infinite distance object to the short range object, the second subsequent lens group GR2 moves to the object side, the fourth subsequent lens group GR4 moves to the image side, and other lens groups remain stationary with respect to the image plane Sim. The anti-vibration group consists of the intermediate group GM.

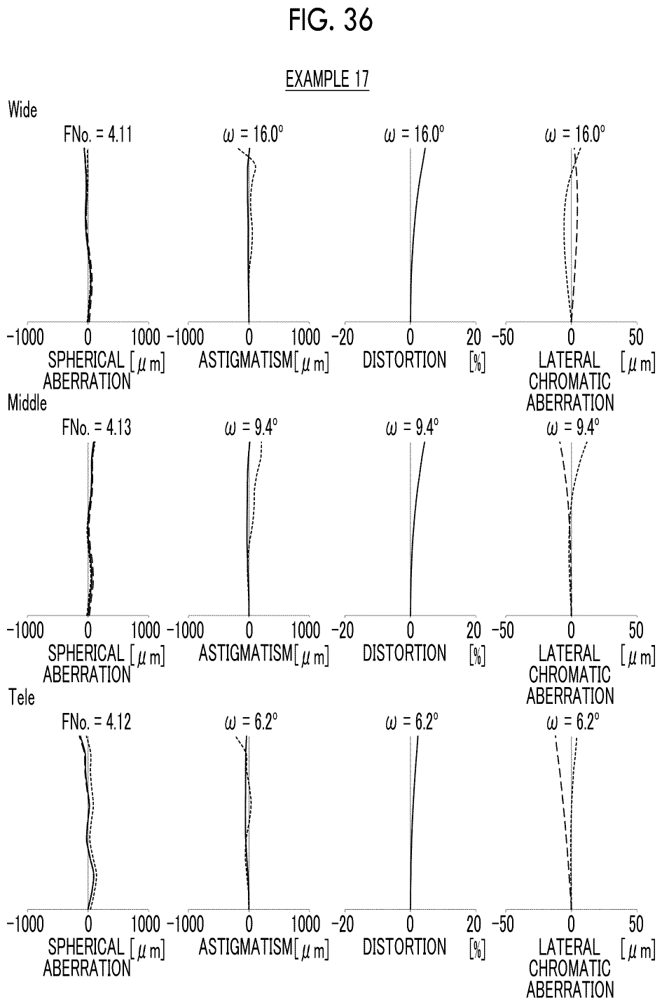

With respect to the variable magnification optical system according to Example 17, basic lens data is shown in Table 49, specifications and variable surface spacings are shown in Table 50, aspherical coefficients are shown in Table 51, and each aberration diagram is shown in FIG. 36.

TABLE 49
Example 17

| Sn | R | D | Nd | νd | ED |
|---|---|---|---|---|---|
| 1 | 72.0438 | 5.3740 | 1.49700 | 81.61 | 47.00 |
| 2 | 356.1108 | 0.5686 | | | 46.50 |
| 3 | 67.9147 | 1.1640 | 1.62004 | 36.26 | 45.48 |
| 4 | 43.8985 | 0.4700 | | | 44.09 |
| 5 | 43.6838 | 6.6603 | 1.43700 | 95.10 | 44.08 |
| 6 | 392.8390 | DD[6] | | | 43.62 |
| 7 | 217.3667 | 0.7486 | 1.64047 | 60.64 | 25.84 |
| 8 | 65.5896 | 2.7169 | | | 25.33 |
| 9 | −83.6495 | 1.5808 | 1.76700 | 52.43 | 25.19 |
| 10 | 94.6301 | 2.9007 | 1.98258 | 15.87 | 25.13 |
| 11 | 207.8569 | DD[11] | | | 25.03 |
| 12(St) | ∞ | 0.3415 | | | 23.29 |
| *13 | 31.5964 | 3.9819 | 1.49710 | 81.56 | 23.60 |
| 14 | −128.5557 | DD[14] | | | 23.39 |
| 15 | −31.1440 | 0.5602 | 1.67028 | 59.18 | 21.00 |
| 16 | −305.9683 | 1.3903 | 1.82411 | 23.79 | 21.17 |
| 17 | −102.5266 | DD[17] | | | 21.25 |
| 18 | 120.6068 | 2.9488 | 1.48383 | 58.03 | 21.10 |
| 19 | −42.4437 | 0.0501 | | | 21.02 |
| 20 | 877.4549 | 0.5680 | 1.99574 | 27.60 | 20.50 |
| 21 | 30.2178 | 3.9634 | 1.43765 | 66.69 | 20.08 |
| 22 | −53.1299 | 0.0501 | | | 20.10 |
| 23 | 85.3532 | 2.7562 | 1.43700 | 95.10 | 19.85 |
| 24 | −138.8537 | 0.1496 | | | 19.53 |
| 25 | 40.2427 | 2.6603 | 1.59646 | 38.94 | 19.02 |
| 26 | −293.1669 | DD[26] | | | 18.50 |
| 27 | 295.8027 | 0.7935 | 1.66534 | 59.42 | 20.88 |
| 28 | 21.0913 | DD[28] | | | 21.03 |
| 29 | −54.5490 | 3.0172 | 1.90635 | 21.04 | 25.10 |
| 30 | −27.4984 | 2.3125 | | | 25.96 |
| *31 | −19.0422 | 1.3046 | 1.59201 | 67.02 | 26.00 |
| *32 | −130.7524 | DD[32] | | | 30.08 |

TABLE 50
Example 17

| | Wide | Middle | Tele |
|---|---|---|---|
| Zr | 1.0 | 1.7 | 2.7 |
| f | 72.10 | 124.96 | 194.02 |
| FNo. | 4.11 | 4.13 | 4.12 |
| 2ω[°] | 32.0 | 18.8 | 12.4 |
| DD[6] | 0.13 | 31.01 | 42.03 |
| DD[11] | 9.45 | 12.25 | 2.41 |
| DD[14] | 7.64 | 8.48 | 9.69 |
| DD[17] | 5.02 | 0.46 | 0.10 |
| DD[26] | 15.08 | 6.99 | 0.16 |
| DD[28] | 9.58 | 11.51 | 18.26 |
| DD[32] | 12.17 | 19.25 | 28.32 |

TABLE 51
Example 17

| Sn | 13 | 31 | 32 |
|---|---|---|---|
| KA | 1.0000000E+00 | 3.1428200E−01 | 1.0000000E+00 |
| A3 | 0.0000000E+00 | 0.0000000E+00 | 0.0000000E+00 |
| A4 | −8.6471963E−06 | −1.2437330E−04 | −1.2396040E−04 |
| A5 | 1.9773414E−06 | 1.1628733E−05 | 1.0278458E−05 |
| A6 | −1.4750210E−07 | −5.7947787E−07 | −1.3290856E−07 |
| A7 | −2.5652946E−08 | 6.5431115E−08 | −6.5008299E−09 |
| A8 | 3.1127989E−09 | −7.7382912E−09 | 6.2691869E−10 |
| A9 | 3.8962030E−11 | 6.9593695E−10 | −7.3289927E−11 |
| A10 | 3.8684845E−12 | −3.0766090E−11 | −3.6147174E−12 |
| A11 | −1.6956774E−12 | 6.5754097E−13 | 3.4152751E−13 |
| A12 | −5.0381516E−15 | −1.9439650E−13 | 1.4282104E−14 |
| A13 | −2.7191312E−15 | 9.7239638E−16 | −1.5120559E−15 |
| A14 | 7.0110592E−16 | 1.6218948E−15 | 8.6880472E−17 |
| A15 | 2.7771307E−17 | 3.0343011E−17 | 2.9945741E−18 |
| A16 | −2.9683286E−18 | −1.1383841E−17 | −1.2596551E−18 |
| A17 | 2.9734540E−19 | 1.9661489E−19 | 5.3017090E−20 |
| A18 | −3.7471149E−20 | −8.7729660E−22 | 4.0621066E−21 |
| A19 | 5.9652634E−22 | 2.5082593E−21 | −3.6382064E−22 |
| A20 | 4.1785728E−23 | −1.2251589E−22 | 7.3165974E−24 |

### Example 18

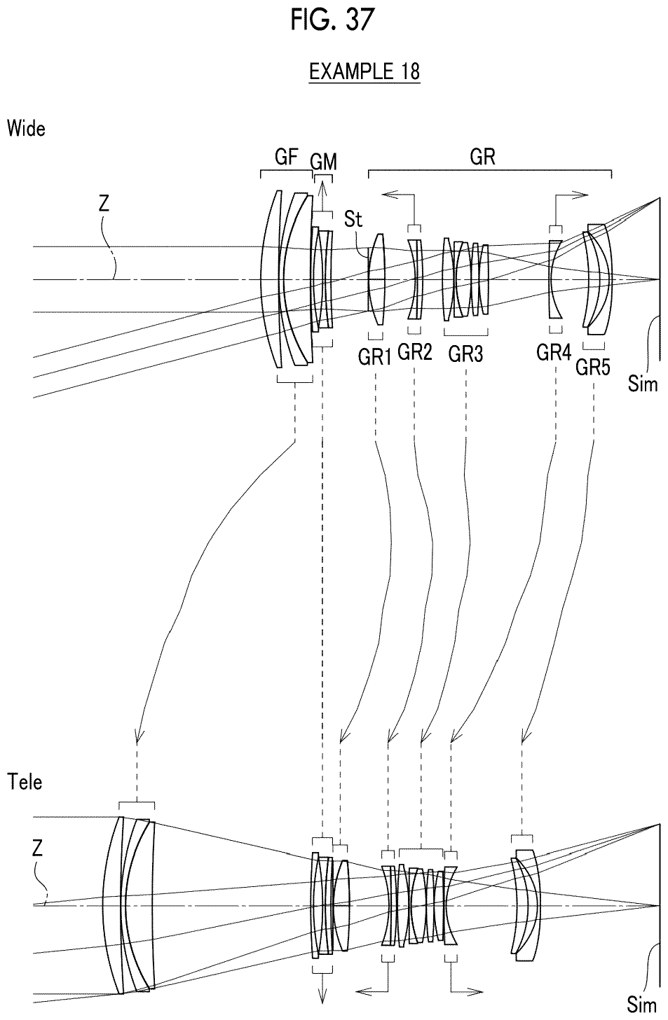

A configuration and a movement trajectory of a variable magnification optical system according to Example 18 are shown in FIG. 37. The variable magnification optical system according to Example 18 consists of the front group GF, the intermediate group GM, and the rear group GR in this order from the object side to the image side. The front group GF consists of one lens group having a positive refractive power. The intermediate group GM consists of one lens group having a negative refractive power. The rear group GR consists of, in this order from the object side to the image side, the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, and the fifth subsequent lens group GR5 having a negative refractive power.

During magnification change from the wide angle end to the telephoto end, the intermediate group GM remains stationary with respect to the image plane Sim, and the other lens groups move while changing the spacings between the adjacent lens groups. The variable magnification optical system includes two focusing groups. The focusing group on the object side consists of the second subsequent lens group GR2, and the focusing group on the image side consists of the fourth subsequent lens group GR4. During focusing from the infinite distance object to the short range object, the second subsequent lens group GR2 moves to the object side, the fourth subsequent lens group GR4 moves to the image side, and other lens groups remain stationary with respect to the image plane Sim. The anti-vibration group consists of the intermediate group GM.

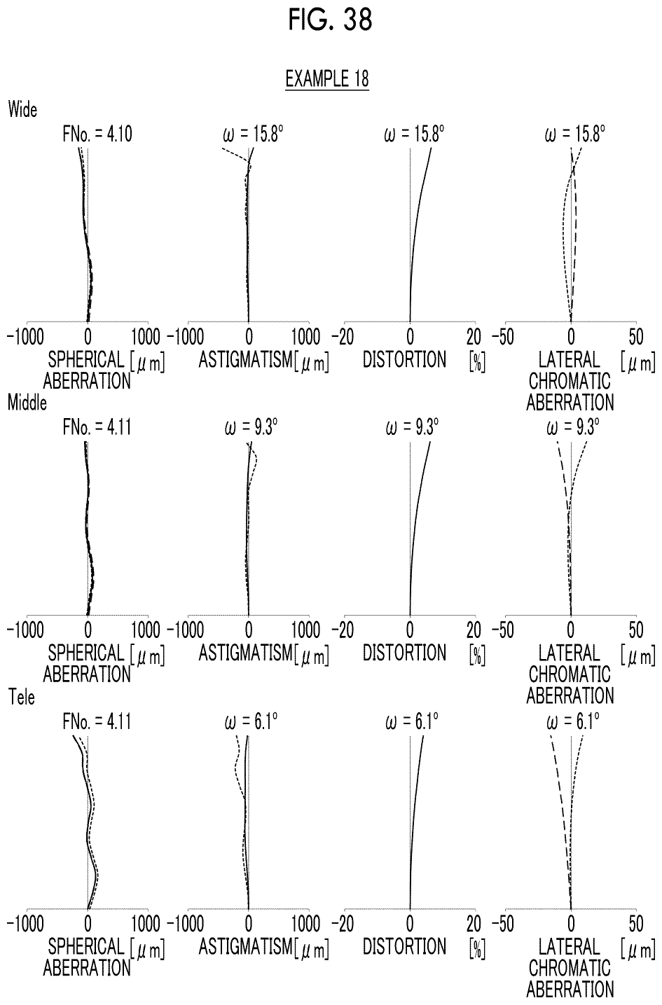

With respect to the variable magnification optical system according to Example 18, basic lens data is shown in Table 52, specifications and variable surface spacings are shown in Table 53, aspherical coefficients are shown in Table 54, and each aberration diagram is shown in FIG. 38.

TABLE 52
Example 18

| Sn | R | D | Nd | νd | ED |
|---|---|---|---|---|---|
| 1 | 69.1438 | 4.4896 | 1.49700 | 81.61 | 47.00 |
| 2 | 366.8318 | 0.0500 | | | 46.74 |
| 3 | 67.2815 | 1.1685 | 1.62709 | 35.29 | 45.77 |
| 4 | 44.0219 | 0.0500 | | | 44.34 |
| 5 | 43.6959 | 6.6769 | 1.43700 | 95.10 | 44.34 |
| 6 | 399.5320 | DD[6] | | | 43.88 |
| 7 | 208.3516 | 0.6992 | 1.60776 | 64.63 | 26.38 |
| 8 | 68.3471 | 2.2992 | | | 25.87 |
| 9 | −81.2461 | 0.6788 | 1.76743 | 52.39 | 25.86 |
| 10 | 105.2187 | 1.3882 | 1.99999 | 15.00 | 25.77 |
| 11 | 207.9998 | DD[11] | | | 25.72 |
| 12(St) | ∞ | 0.0998 | | | 23.92 |
| *13 | 31.6447 | 4.0491 | 1.49710 | 81.56 | 24.14 |
| 14 | −137.4415 | DD[14] | | | 23.91 |
| 15 | −31.2020 | 0.5538 | 1.66954 | 59.21 | 21.00 |
| 16 | −312.3943 | 1.3397 | 1.82338 | 23.83 | 21.07 |
| 17 | −102.4021 | DD[17] | | | 21.10 |
| 18 | 120.3097 | 2.8470 | 1.48482 | 57.85 | 20.76 |
| 19 | −42.2331 | 0.0500 | | | 20.65 |
| 20 | 858.6177 | 0.5206 | 1.99511 | 27.51 | 20.08 |
| 21 | 30.2006 | 3.7651 | 1.43794 | 66.64 | 19.63 |
| 22 | −52.8025 | 0.0500 | | | 19.59 |
| 23 | 85.2884 | 1.9234 | 1.43700 | 95.10 | 19.26 |
| 24 | −137.3807 | 0.0500 | | | 19.02 |
| 25 | 40.2907 | 2.3234 | 1.59682 | 38.32 | 18.46 |
| 26 | −290.8226 | DD[26] | | | 18.00 |
| 27 | 323.3342 | 0.5522 | 1.66986 | 59.20 | 20.52 |
| 28 | 20.8983 | DD[28] | | | 20.68 |
| 29 | −53.3962 | 2.7792 | 1.90673 | 19.66 | 24.62 |
| 30 | −27.7760 | 2.3332 | | | 25.42 |
| *31 | −18.8148 | 0.7589 | 1.59201 | 67.02 | 25.47 |
| *32 | −140.3627 | DD[32] | | | 29.37 |

TABLE 53
Example 18

| | Wide | Middle | Tele |
|---|---|---|---|
| Zr | 1.0 | 1.7 | 2.7 |
| f | 72.10 | 124.96 | 194.02 |
| FNo. | 4.10 | 4.11 | 4.11 |
| 2ω[°] | 31.6 | 18.6 | 12.2 |
| DD[6] | 0.10 | 28.79 | 39.60 |
| DD[11] | 9.38 | 11.21 | 0.51 |
| DD[14] | 7.62 | 8.52 | 9.91 |
| DD[17] | 4.94 | 0.41 | 0.24 |
| DD[26] | 15.02 | 6.95 | 0.15 |
| DD[28] | 9.44 | 11.47 | 17.60 |
| DD[32] | 12.00 | 19.84 | 29.99 |

TABLE 54
Example 18

| Sn | 13 | 31 | 32 |
|---|---|---|---|
| KA | 1.0000000E+00 | 3.1428200E−01 | 1.0000000E+00 |
| A3 | 0.0000000E+00 | 0.0000000E+00 | 0.0000000E+00 |
| A4 | −9.7158952E−06 | −1.2044579E−04 | −1.1902852E−04 |
| A5 | 2.3273866E−06 | 1.2158490E−05 | 1.0849513E−05 |
| A6 | −1.6793256E−07 | −7.1663292E−07 | −2.2065931E−07 |
| A7 | −2.8053929E−08 | 6.6699231E−08 | −3.3765502E−09 |
| A8 | 3.2349881E−09 | −6.5145953E−09 | 6.8252400E−10 |
| A9 | 4.7142853E−11 | 6.4124282E−10 | −7.7784775E−11 |
| A10 | 4.3104386E−12 | −3.0504089E−11 | −3.7615787E−12 |
| A11 | −1.7197694E−12 | 6.8593017E−13 | 3.5727609E−13 |
| A12 | 5.0860323E−15 | −2.4263362E−13 | 7.1843051E−15 |
| A13 | −3.6558316E−15 | 3.0044198E−15 | −1.1763844E−15 |
| A14 | 6.3438183E−16 | 1.7355295E−15 | 8.2017595E−17 |
| A15 | 2.9050169E−17 | 2.1538878E−17 | 3.5128474E−18 |
| A16 | −2.8755609E−18 | −1.3085253E−17 | −1.1618515E−18 |
| A17 | 3.1457427E−19 | 3.9251966E−19 | 4.6617373E−20 |
| A18 | −3.7483207E−20 | 1.5899763E−21 | 4.1952890E−21 |
| A19 | 7.2158782E−22 | 3.1807935E−21 | −3.4511429E−22 |
| A20 | 3.1332100E−23 | −2.0708302E−22 | 5.4454040E−24 |

### Example 19

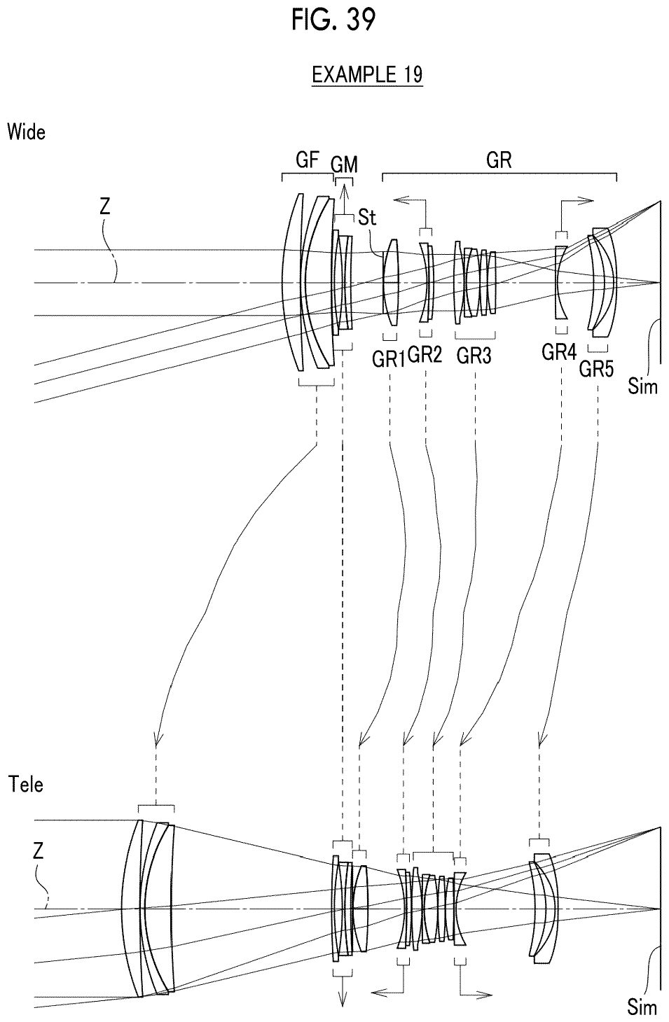

A configuration and a movement trajectory of a variable magnification optical system according to Example 19 are shown in FIG. 39. The variable magnification optical system according to Example 19 consists of the front group GF, the intermediate group GM, and the rear group GR in this order from the object side to the image side. The front group GF consists of one lens group having a positive refractive power. The intermediate group GM consists of one lens group having a negative refractive power. The rear group GR consists of, in this order from the object side to the image side, the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, and the fifth subsequent lens group GR5 having a negative refractive power.

During magnification change from the wide angle end to the telephoto end, the intermediate group GM remains stationary with respect to the image plane Sim, and the other lens groups move while changing the spacings between the adjacent lens groups. The variable magnification optical system includes two focusing groups. The focusing group on the object side consists of the second subsequent lens group GR2, and the focusing group on the image side consists of the fourth subsequent lens group GR4. During focusing from the infinite distance object to the short range object, the second subsequent lens group GR2 moves to the object side, the fourth subsequent lens group GR4 moves to the image side, and other lens groups remain stationary with respect to the image plane Sim. The anti-vibration group consists of the intermediate group GM.

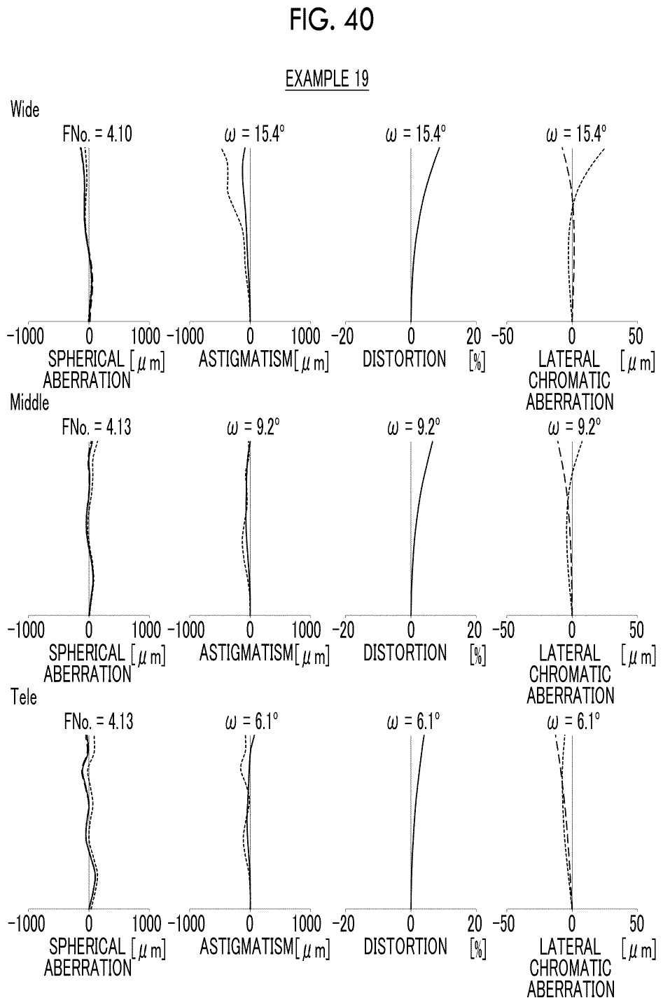

With respect to the variable magnification optical system according to Example 19, basic lens data is shown in Table 55, specifications and variable surface spacings are shown in Table 56, aspherical coefficients are shown in Table 57, and each aberration diagram is shown in FIG. 40.

TABLE 55
Example 19

| Sn | R | D | Nd | νd | ED |
|---|---|---|---|---|---|
| 1 | 68.0203 | 4.5859 | 1.49700 | 81.61 | 47.00 |
| 2 | 388.8596 | 0.0500 | | | 46.73 |
| 3 | 62.6158 | 1.1662 | 1.67270 | 32.10 | 45.63 |
| 4 | 44.0839 | 0.0500 | | | 44.25 |
| 5 | 43.8333 | 6.4754 | 1.43700 | 95.10 | 44.25 |
| 6 | 319.2975 | DD[6] | | | 43.77 |
| 7 | 235.6570 | 0.6996 | 1.66239 | 53.73 | 25.35 |
| 8 | 77.2940 | 1.9765 | | | 24.90 |
| 9 | −84.7940 | 0.6546 | 1.78009 | 51.10 | 24.88 |
| 10 | 93.8370 | 1.4704 | 2.00001 | 15.00 | 24.75 |
| 11 | 218.4439 | DD[11] | | | 24.67 |
| 12(St) | ∞ | 0.1000 | | | 22.87 |
| *13 | 31.2551 | 3.7544 | 1.49710 | 81.56 | 22.87 |
| 14 | −144.5351 | DD[14] | | | 22.58 |
| 15 | −30.9358 | 0.5303 | 1.67254 | 59.07 | 19.54 |
| 16 | −174.6386 | 1.1699 | 1.81324 | 24.34 | 19.54 |
| 17 | −102.5181 | DD[17] | | | 19.54 |
| 18 | 121.6289 | 2.5777 | 1.48725 | 57.39 | 19.04 |
| 19 | −41.7263 | 0.0500 | | | 18.87 |
| 20 | 748.1819 | 0.4977 | 1.99762 | 27.41 | 18.31 |
| 21 | 29.6667 | 3.4033 | 1.43998 | 66.25 | 17.87 |
| 22 | −50.4014 | 0.0500 | | | 17.75 |
| 23 | 82.9360 | 1.8197 | 1.43700 | 95.10 | 17.35 |
| 24 | −125.3178 | 0.0500 | | | 17.05 |
| 25 | 40.1755 | 2.0791 | 1.60208 | 37.79 | 16.49 |
| 26 | −263.5566 | DD[26] | | | 16.00 |
| 27 | 569.9941 | 0.5027 | 1.73010 | 56.21 | 19.09 |
| 28 | 20.0053 | DD[28] | | | 19.31 |
| 29 | −52.3251 | 2.7265 | 1.95183 | 17.41 | 24.27 |
| 30 | −27.8047 | 2.2962 | | | 25.17 |
| *31 | −19.4764 | 0.7503 | 1.59201 | 67.02 | 25.23 |
| *32 | −130.8171 | DD[32] | | | 29.00 |

TABLE 56
Example 19

| | Wide | Middle | Tele |
|---|---|---|---|
| Zr | 1.0 | 1.7 | 2.7 |
| f | 72.10 | 124.96 | 194.02 |
| FNo. | 4.10 | 4.13 | 4.13 |
| 2ω[°] | 30.8 | 18.4 | 12.2 |
| DD[6] | 0.10 | 27.99 | 40.24 |
| DD[11] | 8.12 | 10.13 | 0.46 |
| DD[14] | 7.15 | 7.03 | 9.19 |
| DD[17] | 5.05 | 0.24 | 0.10 |
| DD[26] | 14.82 | 7.25 | 0.10 |
| DD[28] | 9.10 | 11.88 | 19.68 |
| DD[32] | 11.03 | 18.74 | 25.74 |

TABLE 57
Example 19

| Sn | 13 | 31 | 32 |
|---|---|---|---|
| KA | 1.0000000E+00 | 3.1428200E−01 | 1.0000000E+00 |
| A3 | 0.0000000E+00 | 0.0000000E+00 | 0.0000000E+00 |
| A4 | −9.4977720E−06 | −1.5181221E−04 | −1.4844128E−04 |
| A5 | 2.2731918E−06 | 1.3133343E−05 | 1.2360147E−05 |
| A6 | −1.7041889E−07 | −6.5569075E−07 | −3.5924081E−07 |
| A7 | −2.3304665E−08 | 1.1501556E−07 | −3.5951668E−09 |
| A8 | 1.9840886E−09 | −2.0548539E−08 | 4.8700851E−09 |
| A9 | 1.1424486E−10 | 1.8761530E−09 | −2.0806339E−10 |
| A10 | 1.7366139E−11 | −2.4165410E−11 | −2.3533414E−11 |
| A11 | −3.2363421E−12 | 2.9398890E−12 | 4.6924493E−13 |
| A12 | 2.7039389E−14 | −1.2897640E−12 | 3.9021042E−14 |
| A13 | 1.3021033E−16 | 2.6562008E−14 | −8.0850123E−17 |
| A14 | 1.9497188E−16 | 4.1172932E−15 | 3.0920529E−16 |
| A15 | 3.5647855E−17 | 1.7883267E−16 | 3.0776542E−18 |
| A16 | −2.0711834E−18 | −2.7336418E−17 | −2.2188646E−18 |
| A17 | 4.5700699E−19 | 6.2841199E−19 | 1.1825870E−20 |
| A18 | −3.2253453E−20 | −4.3528433E−20 | 4.2942168E−21 |
| A19 | −1.3140539E−21 | 2.9948937E−21 | −1.1897680E−22 |
| A20 | 9.9551400E−23 | −4.4803277E−23 | 1.9508887E−24 |

### Example 20

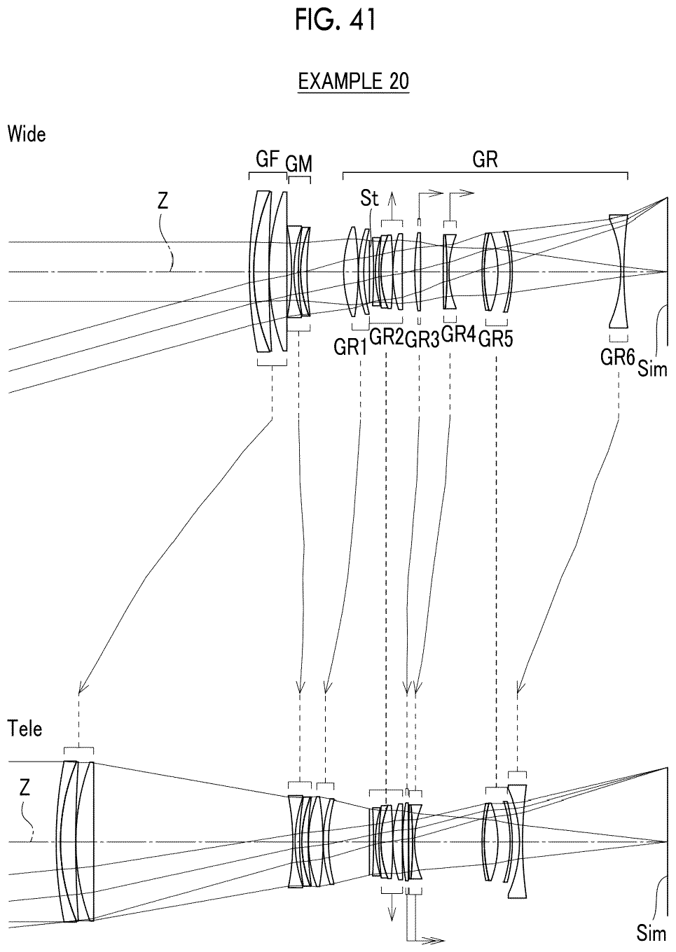

A configuration and a movement trajectory of a variable magnification optical system according to Example 20 are shown in FIG. 41. The variable magnification optical system according to Example 20 consists of the front group GF, the intermediate group GM, and the rear group GR in this order from the object side to the image side. The front group GF consists of one lens group having a positive refractive power. The intermediate group GM consists of one lens group having a negative refractive power. The rear group GR consists of the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, the fifth subsequent lens group GR5 having a positive refractive power, and the sixth subsequent lens group GR6 having a negative refractive power, in this order from the object side to the image side.

During magnification change from the wide angle end to the telephoto end, the second subsequent lens group GR2 and the fifth subsequent lens group GR5 remain stationary with respect to the image plane Sim, and the other lens groups move while changing the spacings between the adjacent lens groups. The variable magnification optical system includes two focusing groups. The focusing group on the object side consists of the third subsequent lens group GR3, and the focusing group on the image side consists of the fourth subsequent lens group GR4. During focusing from the infinite distance object to the short range object, the third subsequent lens group GR3 and the fourth subsequent lens group GR4 move to the image side while changing the spacing therebetween, and the other lens groups remain stationary with respect to the image plane Sim. The anti-vibration group consists of three lenses, that is, a first lens, a second lens, and a third lens, which are arranged in this order from the image side in the second subsequent lens group GR2.

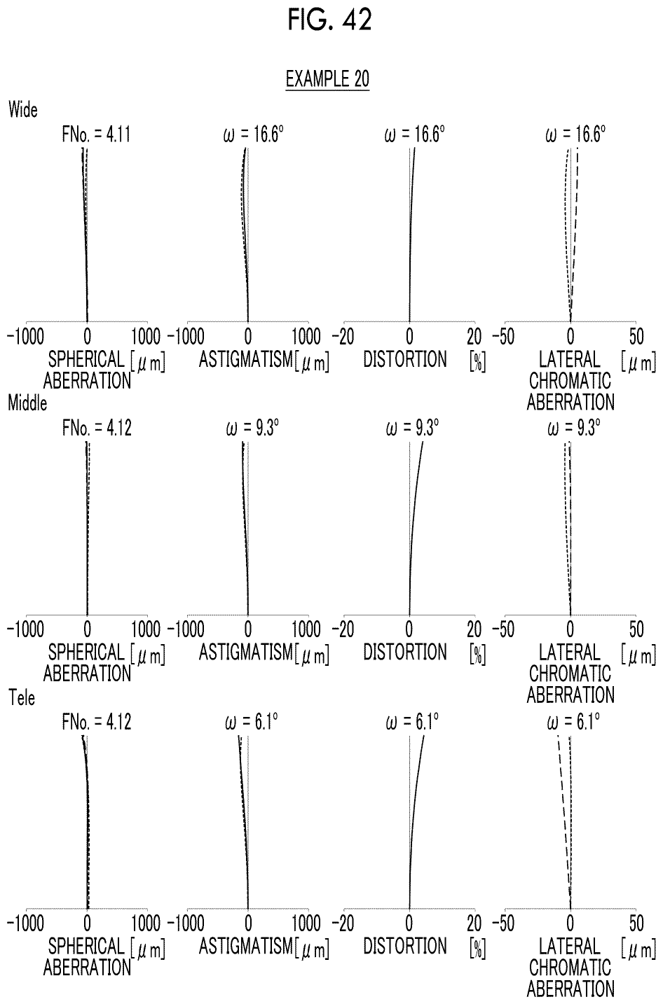

With respect to the variable magnification optical system according to Example 20, basic lens data is shown in Table 58, specifications and variable surface spacings are shown in Table 59, and each aberration diagram is shown in FIG. 42.

TABLE 58
Example 20

| Sn | R | D | Nd | νd | ED |
|---|---|---|---|---|---|
| 1 | 126.8577 | 1.1792 | 1.72825 | 28.46 | 47.00 |
| 2 | 63.4499 | 4.1953 | 1.45860 | 90.19 | 46.46 |
| 3 | 365.4207 | 0.0484 | | | 46.43 |
| 4 | 71.1806 | 4.9220 | 1.53775 | 74.70 | 46.40 |
| 5 | −21816.0524 | DD[5] | | | 46.16 |
| 6 | −74.1138 | 0.6424 | 1.73230 | 55.98 | 26.81 |
| 7 | 40.9695 | 1.2214 | | | 25.70 |
| 8 | 80.4908 | 0.6307 | 1.54086 | 74.93 | 25.70 |
| 9 | 37.2431 | 1.7293 | 1.99518 | 22.02 | 25.97 |
| 10 | 95.9347 | DD[10] | | | 25.95 |
| 11 | 38.5022 | 4.0155 | 1.51383 | 79.04 | 26.16 |
| 12 | −88.7789 | 0.0493 | | | 26.05 |
| 13 | 41.3651 | 1.4722 | 1.85461 | 41.53 | 24.90 |
| 14 | 51.0691 | DD[14] | | | 24.39 |
| 15(St) | ∞ | 1.1335 | | | 19.97 |
| 16 | −204.8137 | 0.5173 | 1.85860 | 24.40 | 19.88 |
| 17 | 36.0347 | 0.9772 | | | 19.98 |
| 18 | 84.6974 | 0.5455 | 1.89550 | 31.77 | 21.07 |
| 19 | 30.7985 | 3.2582 | 1.51055 | 79.53 | 21.20 |
| 20 | −143.5342 | 0.0484 | | | 21.48 |
| 21 | 39.5418 | 2.5818 | 1.90067 | 38.76 | 22.21 |
| 22 | 790.1367 | DD[22] | | | 22.23 |
| 23 | 77.5244 | 1.6016 | 1.89999 | 23.25 | 22.84 |
| 24 | −1023.7391 | DD[24] | | | 22.79 |
| 25 | 474.2137 | 1.0559 | 1.71660 | 29.17 | 21.73 |
| 26 | −124.9344 | 0.5486 | 1.80522 | 48.52 | 21.70 |
| 27 | 30.2113 | DD[27] | | | 21.52 |
| 28 | 62.3552 | 0.6208 | 1.91000 | 19.50 | 22.40 |
| 29 | 50.2520 | 3.7745 | 1.51519 | 52.47 | 22.55 |
| 30 | −35.0411 | 3.2036 | | | 22.76 |
| 31 | −40.7708 | 0.6053 | 1.64327 | 34.05 | 23.35 |
| 32 | −51.1072 | DD[32] | | | 23.66 |
| 33 | −39.7263 | 0.8451 | 1.55969 | 72.06 | 30.69 |
| 34 | 127.5419 | DD[34] | | | 32.96 |

TABLE 59
Example 20

| | Wide | Middle | Tele |
|---|---|---|---|
| Zr | 1.0 | 1.8 | 2.7 |
| f | 71.63 | 126.50 | 193.01 |
| FNo. | 4.11 | 4.12 | 4.12 |
| 2ω[°] | 33.2 | 18.6 | 12.2 |
| DD[5] | 1.30 | 37.00 | 54.74 |
| DD[10] | 10.12 | 5.47 | 0.10 |
| DD[14] | 1.57 | 5.09 | 11.27 |
| DD[22] | 3.45 | 0.42 | 0.10 |
| DD[24] | 6.23 | 4.38 | 0.10 |
| DD[27] | 9.10 | 13.98 | 18.58 |
| DD[32] | 29.90 | 14.17 | 1.97 |
| DD[34] | 12.07 | 27.80 | 39.99 |

### Example 21

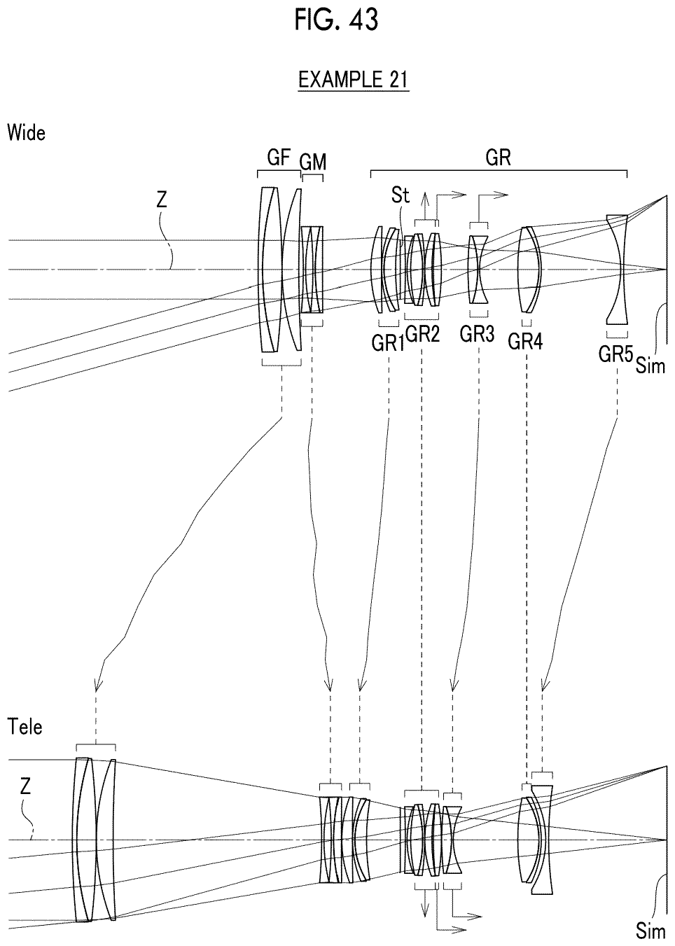

A configuration and a movement trajectory of a variable magnification optical system according to Example 21 are shown in FIG. 43. The variable magnification optical system according to Example 21 consists of the front group GF, the intermediate group GM, and the rear group GR in this order from the object side to the image side. The front group GF consists of one lens group having a positive refractive power. The intermediate group GM consists of one lens group having a negative refractive power. The rear group GR consists of the first subsequent lens group GR1 having a positive refractive power, the second subsequent lens group GR2 having a positive refractive power, the third subsequent lens group GR3 having a negative refractive power, the fourth subsequent lens group GR4 having a positive refractive power, and the fifth subsequent lens group GR5 having a negative refractive power, in this order from the object side to the image side.

During magnification change from the wide angle end to the telephoto end, the second subsequent lens group GR2 and the fourth subsequent lens group GR4 remain stationary with respect to the image plane Sim, and the other lens groups move while changing the spacings between the adjacent lens groups. The variable magnification optical system includes two focusing groups. The focusing group on the object side consists of a lens of the second subsequent lens group GR2 closest to the image side, and the focusing group on the image side consists of the third subsequent lens group GR3. During focusing from the infinite distance object to the short range object, the focusing group on the object side and the focusing group on the image side move to the image side while changing the spacing therebetween, and the other lenses remain stationary with respect to the image plane Sim. The anti-vibration group consists of three lenses, that is, a second lens, a third lens, and a fourth lens, which are arranged in this order from the object side in the second subsequent lens group GR2.

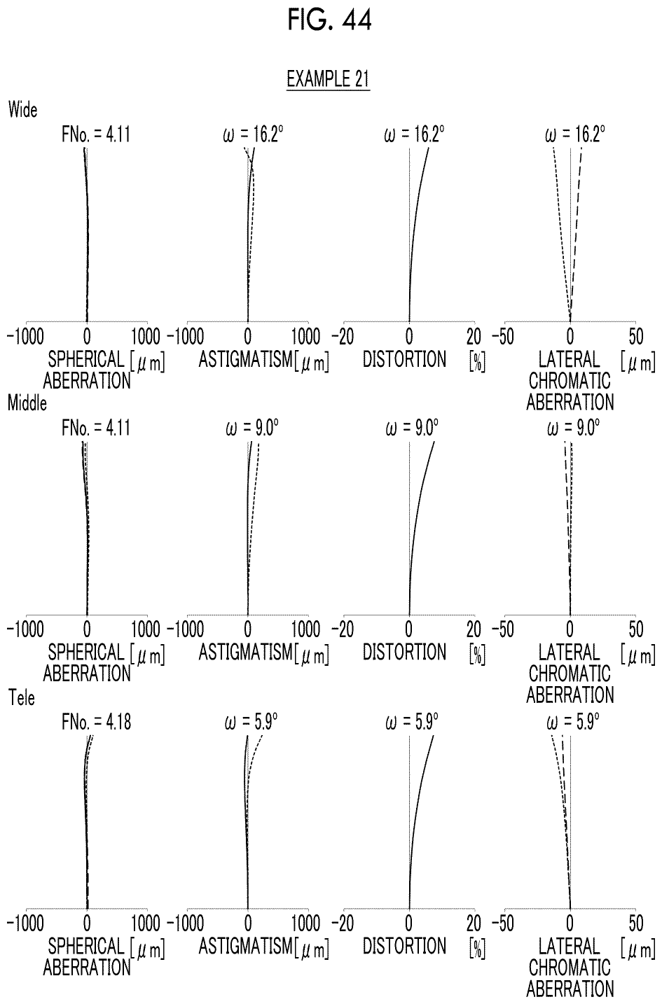

With respect to the variable magnification optical system according to Example 21, basic lens data is shown in Table 60, specifications and variable surface spacings are shown in Table 61, aspherical coefficients are shown in Table 62, and each aberration diagram is shown in FIG. 44.

TABLE 60
Example 21

| Sn | R | D | Nd | νd | ED |
|---|---|---|---|---|---|
| 1 | 258.8445 | 1.2185 | 1.80610 | 33.27 | 48.00 |
| 2 | 90.2893 | 5.3534 | 1.52841 | 76.45 | 47.71 |
| 3 | −223.0540 | 0.0482 | | | 47.70 |
| 4 | 69.1293 | 4.6152 | 1.43700 | 95.10 | 47.03 |
| 5 | 416.9319 | DD[5] | | | 46.69 |
| 6 | −141.3685 | 0.6404 | 1.73179 | 56.04 | 25.03 |
| 7 | 55.8110 | 2.0008 | | | 24.71 |
| 8 | −125.6606 | 0.6589 | 1.49719 | 82.91 | 24.71 |
| 9 | 61.6269 | 2.0002 | 1.95296 | 22.02 | 25.07 |
| 10 | 1844.3965 | DD[10] | | | 25.07 |
| 11 | 37.3234 | 2.9154 | 1.54218 | 72.39 | 25.15 |
| 12 | 611.7496 | 0.0496 | | | 24.96 |
| 13 | 32.7246 | 0.6484 | 1.80529 | 26.10 | 24.23 |
| 14 | 23.7272 | 3.2038 | 1.51175 | 79.36 | 23.47 |
| 15 | 73.9630 | DD[15] | | | 23.05 |
| 16(St) | ∞ | 1.4195 | | | 19.44 |
| *17 | −407.6384 | 0.5099 | 1.63477 | 58.49 | 19.45 |
| 18 | 29.1393 | 0.9870 | | | 19.54 |
| 19 | 47.5648 | 3.2934 | 1.52548 | 77.27 | 20.57 |
| 20 | −40.0885 | 0.5524 | 1.90000 | 20.01 | 20.63 |
| 21 | −80.4985 | 0.0494 | | | 20.82 |
| 22 | 31.8409 | 1.9629 | 1.53121 | 76.40 | 21.07 |
| 23 | 60.3255 | 0.4142 | | | 20.90 |
| 24 | 109.6156 | 2.1887 | 1.65697 | 59.83 | 20.90 |
| 25 | −72.9694 | DD[25] | | | 20.93 |
| 26 | 93.0776 | 2.6839 | 1.69413 | 30.42 | 19.57 |
| 27 | −32.9202 | 0.5095 | 1.76240 | 52.90 | 19.45 |
| *28 | 20.4722 | DD[28] | | | 18.92 |
| *29 | 67.6128 | 5.8385 | 1.53623 | 50.13 | 24.47 |
| 30 | −23.5640 | 0.6380 | 1.89669 | 39.16 | 24.59 |
| 31 | −29.7723 | DD[31] | | | 25.00 |
| 32 | −29.0057 | 0.8179 | 1.55772 | 72.36 | 28.83 |
| 33 | 117.6864 | DD[33] | | | 31.76 |

TABLE 61
Example 21

| | Wide | Middle | Tele |
|---|---|---|---|
| Zr | 1.0 | 1.8 | 2.8 |
| f | 70.36 | 126.78 | 196.34 |
| FNo. | 4.11 | 4.11 | 4.18 |
| 2ω[°] | 32.4 | 18.0 | 11.8 |
| DD[5] | 1.25 | 36.80 | 57.52 |
| DD[10] | 13.18 | 8.87 | 0.17 |
| DD[15] | 1.24 | 5.20 | 9.27 |
| DD[25] | 7.34 | 4.80 | 0.09 |
| DD[28] | 10.53 | 13.07 | 17.78 |
| DD[31] | 21.90 | 9.25 | 1.22 |
| DD[33] | 11.95 | 24.60 | 32.64 |

TABLE 62
Example 21

| Sn | 17 | 28 | 29 |
|---|---|---|---|
| KA | 1.0000000E+00 | 1.0000000E+00 | 1.0000000E+00 |
| A4 | −6.3880008E−06 | −5.3359837E−06 | 2.0939544E−06 |
| A6 | 6.7387329E−09 | −2.3359592E−08 | 7.2921653E−09 |
| A8 | −1.2310533E−11 | 1.5615685E−10 | −2.1476840E−11 |
| A10 | 0.0000000E+00 | −9.3500000E−13 | 5.8000000E−14 |

### Example 22

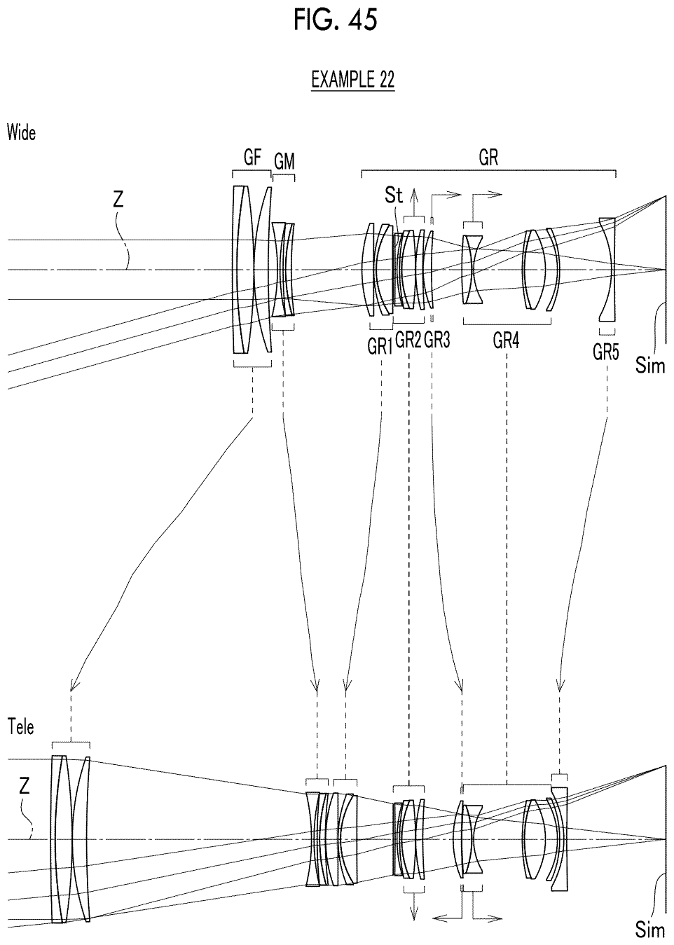

A configuration and a movement trajectory of a variable magnification optical system according to Example 22 are shown in FIG. 45. The variable magnification optical system according to Example 22 consists of the front group GF, the intermediate group GM, and the rear group GR in this order from the object side to the image side. The front group GF consists of one lens group having a positive refractive power. The intermediate group GM consists of one lens group having a negative refractive power. The rear group GR consists of the first subsequent lens group GR1 having a positive refractive power, the second subsequent lens group GR2 having a positive refractive power, the third subsequent lens group GR3 having a positive refractive power, the fourth subsequent lens group GR4 having a negative refractive power, and the fifth subsequent lens group GR5 having a negative refractive power, in this order from the object side to the image side.

During magnification change from the wide angle end to the telephoto end, the second subsequent lens group GR2 and the fourth subsequent lens group GR4 remain stationary with respect to the image plane Sim, and the other lens groups move while changing the spacings between the adjacent lens groups. The variable magnification optical system includes two focusing groups. The focusing group on the object side consists of the third subsequent lens group GR3, and the focusing group on the image side consists of two lenses, that is, a first lens and a second lens, among the lenses of the fourth subsequent lens group GR4 on the object side. During focusing from the infinite distance object to the short range object at the wide angle end, the focusing group on the object side and the focusing group on the image side move to the image side while changing the spacing therebetween, and the other lenses remain stationary with respect to the image plane Sim. During focusing from the infinite distance object to the short range object at the telephoto end, the focusing group on the object side moves to the object side, the focusing group on the image side moves to the image side, and the other lenses remain stationary with respect to the image plane Sim. The anti-vibration group consists of three lenses, that is, a first lens, a second lens, and a third lens, which are arranged in this order from the image side in the second subsequent lens group GR2.

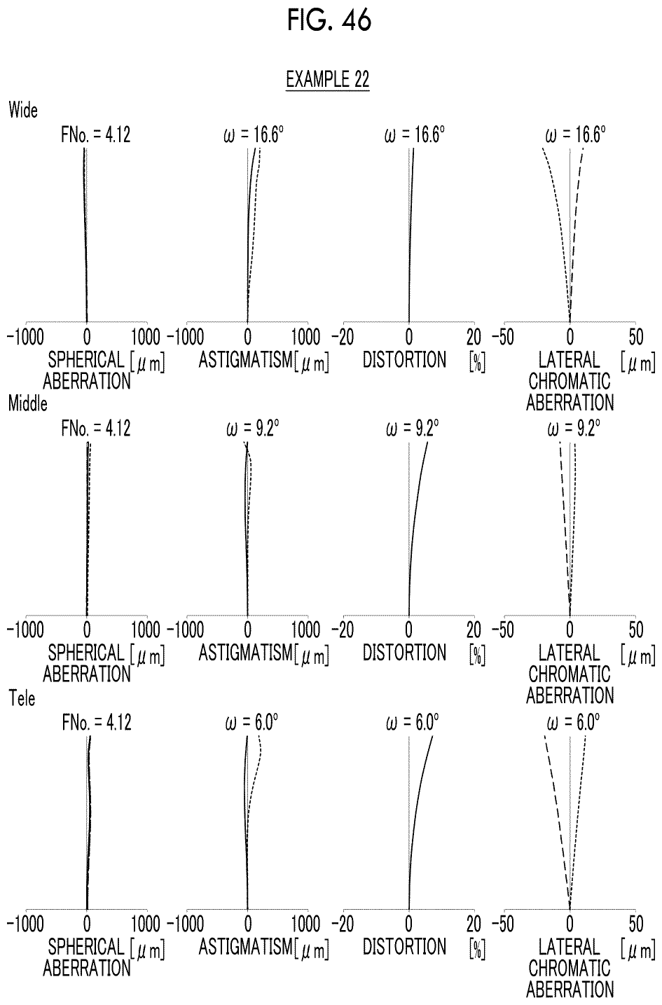

With respect to the variable magnification optical system according to Example 22, basic lens data is shown in Table 63, specifications and variable surface spacings are shown in Table 64, aspherical coefficients are shown in Table 65, and each aberration diagram is shown in FIG. 46.

TABLE 63
Example 22

| Sn | R | D | Nd | νd | ED |
|---|---|---|---|---|---|
| 1 | 732.4824 | 1.2405 | 1.79360 | 37.09 | 49.00 |
| 2 | 150.2032 | 4.6956 | 1.49700 | 81.54 | 48.89 |
| 3 | −175.2149 | 0.0483 | | | 48.91 |
| 4 | 78.1935 | 3.9340 | 1.49700 | 81.54 | 48.28 |
| 5 | 325.5823 | DD[5] | | | 48.00 |
| *6 | −63.0656 | 0.6939 | 1.68038 | 58.68 | 27.50 |
| *7 | 61.5347 | 0.8656 | | | 26.89 |
| 8 | 138.8834 | 0.7034 | 1.52510 | 77.33 | 26.89 |
| 9 | 50.7599 | 1.5393 | 1.94527 | 19.53 | 26.91 |
| 10 | 113.2355 | DD[10] | | | 26.89 |
| 11 | 42.8728 | 3.2157 | 1.53141 | 76.37 | 27.14 |
| 12 | 3162.6344 | 0.0488 | | | 27.01 |
| 13 | 38.2924 | 0.6869 | 1.90000 | 20.00 | 26.55 |
| 14 | 25.2197 | 4.5054 | 1.56121 | 64.24 | 25.73 |
| 15 | 1269.0763 | DD[15] | | | 25.42 |
| 16(St) | ∞ | 0.5262 | | | 21.26 |
| 17 | −761.4148 | 0.5473 | 1.78758 | 50.33 | 21.24 |
| 18 | 39.9897 | 0.6911 | | | 21.27 |
| 19 | 55.5960 | 0.5864 | 1.87355 | 38.63 | 22.75 |
| 20 | 30.7332 | 3.8125 | 1.51800 | 78.41 | 22.76 |
| 21 | 103.8107 | 0.0485 | | | 22.96 |
| 22 | 49.2502 | 1.9605 | 1.84055 | 44.91 | 23.34 |
| 23 | 163.2153 | DD[23] | | | 23.22 |
| 24 | 30.9423 | 2.2905 | 1.56491 | 71.26 | 22.54 |
| 25 | 148.5986 | DD[25] | | | 22.39 |
| 26 | 116.5510 | 2.7349 | 1.85547 | 23.77 | 20.00 |
| 27 | −31.2915 | 0.5208 | 1.82364 | 46.64 | 19.79 |
| 28 | 19.1283 | DD[28] | | | 18.52 |
| 29 | 54.6069 | 0.5857 | 1.90300 | 38.52 | 22.50 |
| 30 | 35.6353 | 5.8094 | 1.50788 | 53.52 | 22.72 |
| 31 | −24.5950 | 3.2977 | | | 23.15 |
| *32 | −26.1893 | 0.6245 | 1.90000 | 29.21 | 23.44 |
| *33 | −36.3325 | DD[33] | | | 24.12 |
| *34 | −32.5533 | 0.7790 | 1.58613 | 68.01 | 27.84 |
| *35 | 212.2024 | DD[35] | | | 30.23 |

TABLE 64
Example 22

| | Wide | Middle | Tele |
|---|---|---|---|
| Zr | 1.0 | 1.8 | 2.7 |
| f | 71.82 | 126.82 | 193.48 |
| FNo. | 4.12 | 4.12 | 4.12 |
| 2ω[°] | 33.2 | 18.4 | 12.0 |
| DD[5] | 2.54 | 40.72 | 62.05 |
| DD[10] | 19.34 | 9.74 | 0.10 |
| DD[15] | 0.17 | 4.81 | 10.02 |
| DD[23] | 0.10 | 2.29 | 8.38 |
| DD[25] | 8.38 | 6.19 | 0.10 |
| DD[28] | 13.42 | 13.42 | 13.42 |
| DD[33] | 14.30 | 5.32 | 1.16 |
| DD[35] | 14.27 | 23.26 | 27.42 |

TABLE 65
Example 22

| Sn | 6 | 7 | 32 | 33 |
|---|---|---|---|---|
| KA | 1.0000000E+00 | 1.0000000E+00 | 1.0000000E+00 | 1.0000000E+00 |
| A4 | −1.5032308E−06 | −1.7727332E−06 | −3.6004283E−05 | −3.6697900E−05 |
| A6 | 2.3668681E−08 | 2.3260220E−08 | 2.7650291E−07 | 2.4716839E−07 |
| A8 | −9.7690685E−11 | −9.6731933E−11 | −8.3870677E−10 | −7.5098200E−10 |
| A10 | 1.5361282E−13 | 1.5489449E−13 | 7.3877443E−13 | 5.5588295E−13 |

| Sn | 34 | 35 |
|---|---|---|
| KA | 1.0000000E+00 | 1.0000000E+00 |
| A4 | −1.4797232E−05 | −1.7990817E−05 |
| A6 | 3.6715120E−08 | 7.7361272E−08 |
| A8 | 2.6154401E−10 | −1.0219911E−10 |
| A10 | −1.1435346E−12 | −1.0007570E−13 |

### Example 23

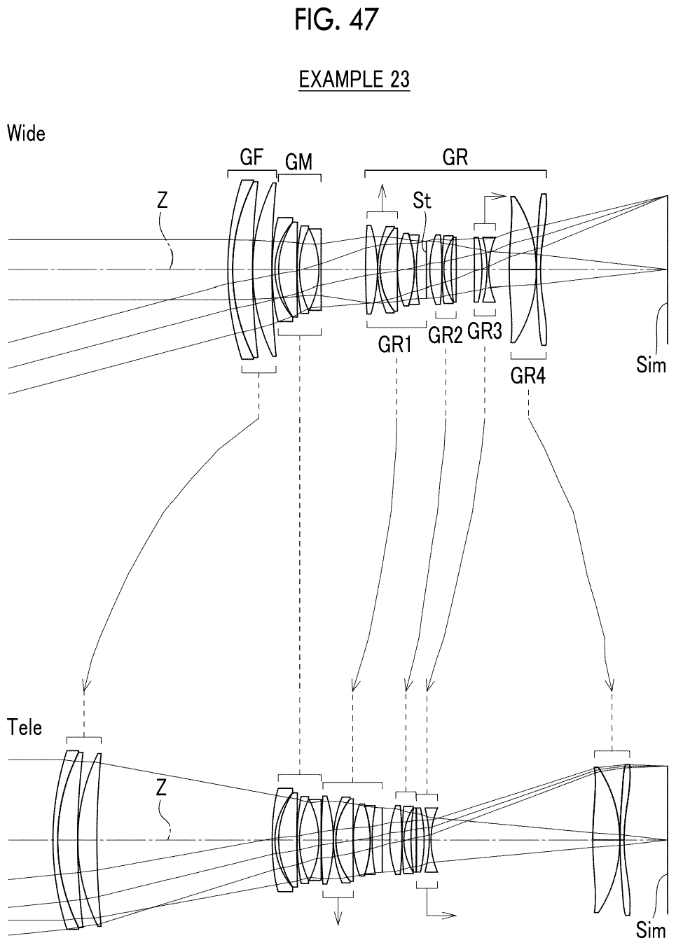

A configuration and a movement trajectory of a variable magnification optical system according to Example 23 are shown in FIG. 47. The variable magnification optical system according to Example 23 consists of the front group GF, the intermediate group GM, and the rear group GR in this order from the object side to the image side. The front group GF consists of one lens group having a positive refractive power. The intermediate group GM consists of one lens group having a negative refractive power. The rear group GR consists of the first subsequent lens group GR1 having a positive refractive power, the second subsequent lens group GR2 having a positive refractive power, the third subsequent lens group GR3 having a negative refractive power, and the fourth subsequent lens group GR4 having a positive refractive power, in this order from the object side to the image side.

During magnification change from the wide angle end to the telephoto end, the intermediate group GM remains stationary with respect to the image plane Sim, and the other lens groups move while changing the spacings between the adjacent lens groups. The variable magnification optical system includes one focusing group, and the focusing group consists of the third subsequent lens group GR3. During focusing from the infinite distance object to the short range object, the third subsequent lens group GR3 moves to the image side, and the other lens groups remain stationary with respect to the image plane Sim. The anti-vibration group consists of three lenses, that is, a first lens, a second lens, and a third lens, which are arranged in this order from the object side in the first subsequent lens group GR1.

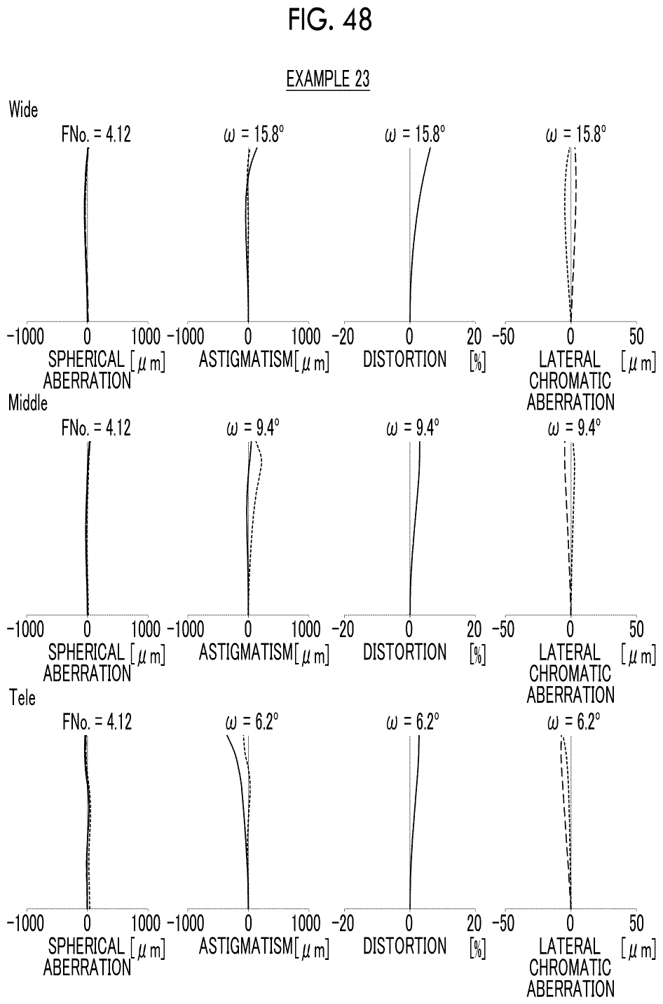

With respect to the variable magnification optical system according to Example 23, basic lens data is shown in Table 66, specifications and variable surface spacings are shown in Table 67, aspherical coefficients are shown in Table 68, and each aberration diagram is shown in FIG. 48.

TABLE 66
Example 23

| Sn | R | D | Nd | νd | ED |
|---|---|---|---|---|---|
| 1 | 90.7956 | 1.3102 | 1.90366 | 31.34 | 52.25 |
| 2 | 59.8355 | 5.4878 | 1.55397 | 71.76 | 51.27 |
| 3 | 220.6199 | 0.0499 | | | 51.08 |
| 4 | 60.4518 | 5.2669 | 1.49700 | 81.54 | 50.57 |
| 5 | 271.7801 | DD[5] | | | 50.23 |
| *6 | 89.7975 | 0.7562 | 1.62662 | 35.60 | 30.25 |
| *7 | 22.2504 | 1.0261 | | | 27.60 |
| 8 | 26.4746 | 5.0123 | 1.88990 | 23.78 | 27.59 |
| 9 | 530.5588 | 0.0499 | | | 26.78 |
| 10 | 71.6542 | 0.6608 | 1.71377 | 38.28 | 25.48 |
| 11 | 29.2894 | 5.3597 | | | 23.76 |
| 12 | −27.5984 | 0.6152 | 1.76003 | 46.58 | 23.60 |
| 13 | 1844.7499 | DD[13] | | | 23.67 |
| 14 | 212.2718 | 3.2609 | 1.61176 | 64.00 | 25.59 |
| 15 | −46.9285 | 0.0499 | | | 25.73 |
| 16 | 34.2646 | 0.6514 | 1.89772 | 26.59 | 25.11 |
| 17 | 20.5180 | 4.7549 | 1.69922 | 57.76 | 24.14 |
| 18 | 1316.5316 | 0.0499 | | | 23.84 |
| 19 | 31.9207 | 4.6638 | 1.45168 | 91.77 | 21.03 |
| 20 | −34.1431 | 0.5273 | 1.89453 | 33.69 | 20.20 |
| 21 | 58.6020 | 2.7952 | | | 19.37 |
| 22(St) | ∞ | DD[22] | | | 18.87 |
| 23 | 31.7554 | 3.3247 | 1.89933 | 31.97 | 20.21 |
| 24 | −116.7855 | 0.0499 | | | 20.04 |
| 25 | 96.1218 | 0.5135 | 1.68579 | 51.70 | 19.63 |
| 26 | 18.5213 | 1.9639 | | | 18.77 |
| 27 | 63.8184 | 1.4432 | 1.76730 | 52.40 | 18.80 |
| 28 | −750.7549 | DD[28] | | | 18.80 |
| 29 | −746.0024 | 2.0733 | 1.90000 | 30.37 | 18.65 |
| 30 | −44.0402 | 1.3956 | | | 18.76 |
| 31 | −37.8372 | 0.5000 | 1.73013 | 56.21 | 18.50 |
| 32 | 25.5928 | DD[32] | | | 18.82 |
| *33 | 102.8617 | 7.4448 | 1.48750 | 83.05 | 41.94 |
| *34 | −43.1528 | 0.0500 | | | 42.53 |
| *35 | 126.4643 | 1.1303 | 1.45959 | 89.97 | 44.12 |
| *36 | 56.9771 | DD[36] | | | 44.09 |

TABLE 67
Example 23

| | Wide | Middle | Tele |
|---|---|---|---|
| Zr | 1.0 | 1.8 | 2.7 |
| f | 71.80 | 126.71 | 193.21 |
| FNo. | 4.12 | 4.12 | 4.12 |
| 2ω[°] | 31.6 | 18.8 | 12.4 |
| DD[5] | 0.10 | 36.05 | 48.14 |
| DD[13] | 12.27 | 7.84 | 0.10 |
| DD[22] | 0.94 | 0.39 | 2.07 |
| DD[28] | 5.00 | 2.69 | 0.10 |
| DD[32] | 5.46 | 28.88 | 44.42 |
| DD[36] | 35.00 | 18.87 | 11.98 |

TABLE 68
Example 23

| Sn | 6 | 7 |
|---|---|---|
| KA | 1.0000000E+00 | 1.0000000E+00 |
| A4 | 6.4509870E−06 | 1.9774283E−06 |
| A6 | −6.3935312E−09 | −6.2412267E−09 |
| A8 | 3.9740659E−11 | −1.9702824E−11 |
| A10 | 1.6897655E−14 | 2.4987305E−13 |

| Sn | 33 | 34 | 35 | 36 |
|---|---|---|---|---|
| KA | 1.0000000E+00 | 1.0000000E+00 | 1.0000000E+00 | 1.0000000E+00 |
| A4 | −6.5619995E−06 | −5.0919952E−07 | −1.9629659E−06 | −5.0651767E−06 |
| A6 | −1.2269426E−08 | −8.4870189E−09 | −2.7678394E−08 | −4.6638580E−08 |
| A8 | 1.6699938E−11 | 1.6260075E−11 | 1.0119118E−10 | 1.0897320E−10 |
| A10 | 1.9243627E−14 | 2.6828617E−15 | −1.1609156E−13 | −1.2333230E−13 |
| A12 | −1.1068901E−17 | 2.3008832E−17 | 2.7088896E−17 | 2.7495755E−17 |
| A14 | −7.4987030E−20 | −7.9717503E−20 | 4.5163396E−20 | 1.3207361E−19 |
| A16 | −5.0585672E−24 | −2.7898538E−23 | 1.8155022E−23 | −9.3993098E−23 |

### Example 24

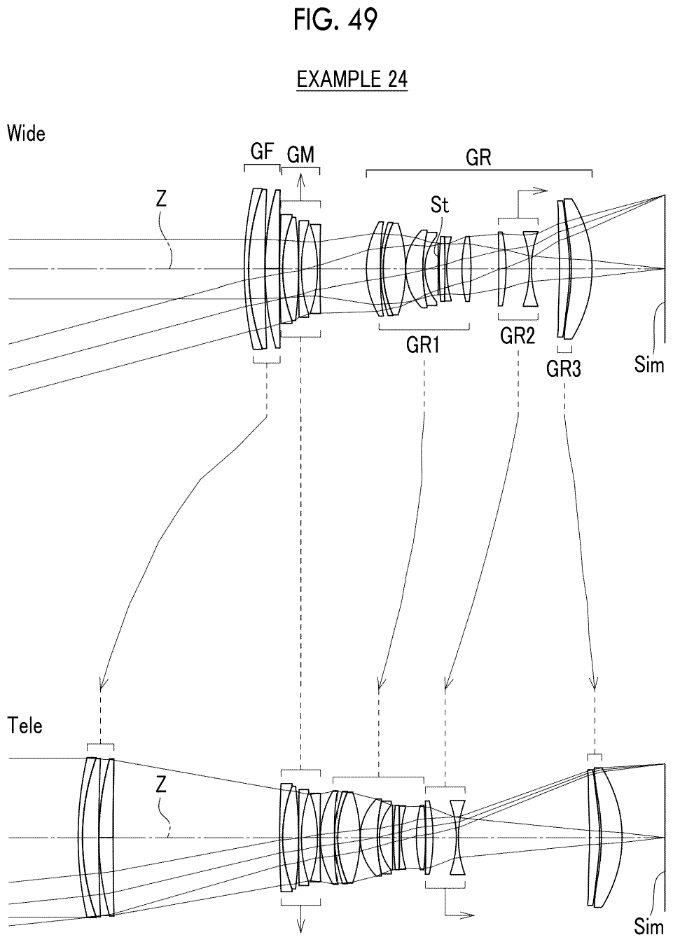

A configuration and a movement trajectory of a variable magnification optical system according to Example 24 are shown in FIG. 49. The variable magnification optical system according to Example 24 consists of the front group GF, the intermediate group GM, and the rear group GR in this order from the object side to the image side. The front group GF consists of one lens group having a positive refractive power. The intermediate group GM consists of one lens group having a negative refractive power. The rear group GR consists of the first subsequent lens group GR1 having a positive refractive power, the second subsequent lens group GR2 having a negative refractive power, and the third subsequent lens group GR3 having a positive refractive power, in this order from the object side to the image side.

During magnification change from the wide angle end to the telephoto end, the intermediate group GM remains stationary with respect to the image plane Sim, and the other lens groups move while changing the spacings between the adjacent lens groups. The variable magnification optical system includes one focusing group, and the focusing group consists of the second subsequent lens group GR2. During focusing from the infinite distance object to the short range object, the second subsequent lens group GR2 moves to the image side, and the other lens groups remain stationary with respect to the image plane Sim. The anti-vibration group consists of the intermediate group GM.

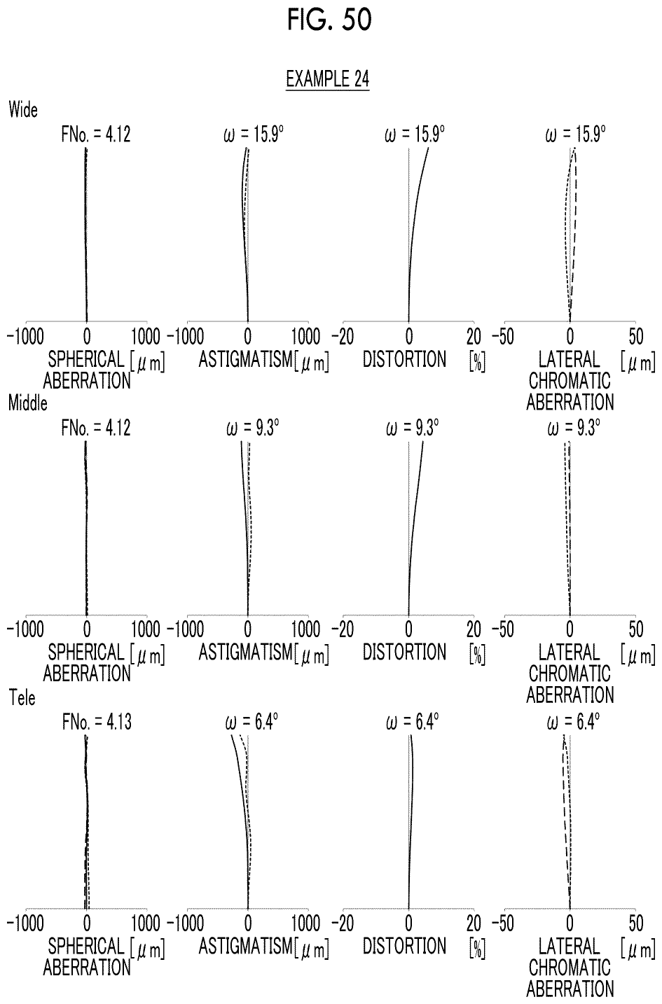

With respect to the variable magnification optical system according to Example 24, basic lens data is shown in Table 69, specifications and variable surface spacings are shown in Table 70, aspherical coefficients are shown in Table 71, and each aberration diagram is shown in FIG. 50.

TABLE 69
Example 24

| Sn | R | D | Nd | νd | ED |
|---|---|---|---|---|---|
| 1 | 112.2919 | 1.2021 | 1.84666 | 23.78 | 47.00 |
| 2 | 74.0135 | 4.5025 | 1.49700 | 81.54 | 46.53 |
| 3 | 557.5640 | 0.0474 | | | 46.42 |
| 4 | 91.1844 | 3.9402 | 1.59282 | 68.62 | 46.21 |
| 5 | 1207.6500 | DD[5] | | | 45.92 |
| 6 | 326.7828 | 0.8328 | 1.73537 | 55.67 | 31.79 |
| 7 | 45.0744 | 4.3931 | 1.83503 | 23.25 | 30.15 |
| 8 | −137.0944 | 0.0449 | | | 29.60 |
| 9 | 930.8370 | 0.7323 | 1.76697 | 52.44 | 28.22 |
| 10 | 44.1948 | 4.4720 | | | 26.31 |
| 11 | −42.1024 | 0.6758 | 1.89944 | 38.89 | 25.98 |
| 12 | 501.9343 | DD[12] | | | 25.80 |
| *13 | 28.4238 | 3.8915 | 1.60166 | 65.58 | 27.51 |
| *14 | 268.4335 | 0.0487 | | | 27.27 |
| 15 | 45.6080 | 0.7095 | 1.82382 | 23.85 | 27.16 |
| 16 | 34.6095 | 6.1804 | 1.43601 | 90.90 | 26.73 |
| 17 | −44.5905 | 0.0495 | | | 26.45 |
| 18 | 16.6031 | 4.7414 | 1.45079 | 83.54 | 22.64 |
| 19 | 50.0978 | 0.5590 | 1.79184 | 49.89 | 21.35 |
| 20 | 15.6518 | 3.6439 | | | 19.18 |
| 21(St) | ∞ | 0.2999 | | | 19.07 |
| 22 | 98.3072 | 1.6157 | 1.65497 | 59.75 | 18.88 |
| 23 | 468.2650 | 0.4999 | 1.86254 | 23.76 | 18.64 |
| 24 | 34.1822 | 4.1755 | | | 18.28 |
| 25 | 40.9144 | 2.5061 | 1.87464 | 35.58 | 18.75 |
| 26 | −100.0112 | DD[26] | | | 18.93 |
| 27 | −437.2726 | 1.9861 | 1.88094 | 27.80 | 21.38 |
| 28 | −56.8803 | 6.4537 | | | 21.52 |
| 29 | −33.7049 | 0.5663 | 1.74716 | 54.46 | 20.88 |
| 30 | 33.3570 | DD[30] | | | 21.75 |
| *31 | −140.4757 | 2.7856 | 1.76695 | 26.65 | 39.09 |
| *32 | −61.1936 | 0.4691 | | | 39.82 |
| *33 | −69.6276 | 5.7397 | 1.44364 | 65.57 | 40.10 |
| *34 | −41.5987 | DD[34] | | | 41.00 |

TABLE 70
Example 24

| | Wide | Middle | Tele |
|---|---|---|---|
| Zr | 1.0 | 1.8 | 2.7 |
| f | 71.53 | 126.22 | 192.47 |
| FNo. | 4.12 | 4.12 | 4.13 |
| 2ω[°] | 31.8 | 18.6 | 12.8 |
| DD[5] | 0.10 | 33.89 | 46.06 |
| DD[12] | 12.67 | 7.82 | 0.09 |
| DD[26] | 7.72 | 2.38 | 0.10 |
| DD[30] | 7.78 | 22.97 | 36.28 |
| DD[34] | 20.17 | 15.16 | 11.87 |

TABLE 71
Example 24

| Sn | 13 | 14 | 31 | 32 |
|---|---|---|---|---|
| KA | 1.0000000E+00 | 1.0000000E+00 | 1.0000000E+00 | 1.0000000E+00 |
| A4 | −4.8743015E−07 | 1.4205782E−05 | 1.2525150E−05 | 1.3988074E−05 |
| A6 | −1.3092026E−08 | −9.3077128E−09 | −4.2136825E−09 | −1.5776038E−09 |
| A8 | 1.5610587E−10 | 1.5848176E−10 | −4.3071649E−11 | −2.5143276E−11 |
| A10 | −5.5086653E−13 | −5.7151122E−13 | 2.0691393E−14 | −5.2970251E−15 |

| Sn | 33 | 34 |
|---|---|---|
| KA | 1.0000000E+00 | 1.0000000E+00 |
| A4 | −5.0281179E−06 | −8.0295708E−06 |
| A6 | 3.9872840E−08 | 2.9708198E−08 |
| A8 | −7.8656294E−12 | −2.4431054E−11 |
| A10 | −5.2096545E−14 | −1.7624184E−14 |

### Example 25

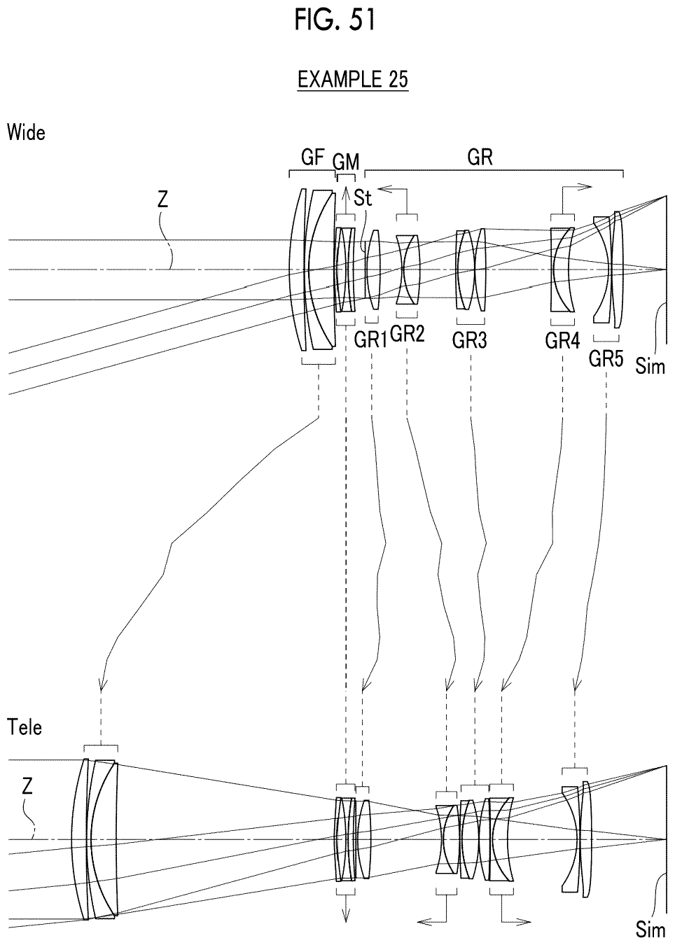

A configuration and a movement trajectory of a variable magnification optical system according to Example 25 are shown in FIG. 51. The variable magnification optical system according to Example 25 consists of the front group GF, the intermediate group GM, and the rear group GR in this order from the object side to the image side. The front group GF consists of one lens group having a positive refractive power. The intermediate group GM consists of one lens group having a negative refractive power. The rear group GR consists of, in this order from the object side to the image side, the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, and the fifth subsequent lens group GR5 having a negative refractive power.

During magnification change from the wide angle end to the telephoto end, the intermediate group GM remains stationary with respect to the image plane Sim, and the other lens groups move while changing the spacings between the adjacent lens groups. The variable magnification optical system includes two focusing groups. The focusing group on the object side consists of the second subsequent lens group GR2, and the focusing group on the image side consists of the fourth subsequent lens group GR4. During focusing from the infinite distance object to the short range object, the second subsequent lens group GR2 moves to the object side, the fourth subsequent lens group GR4 moves to the image side, and other lens groups remain stationary with respect to the image plane Sim. The anti-vibration group consists of the intermediate group GM.

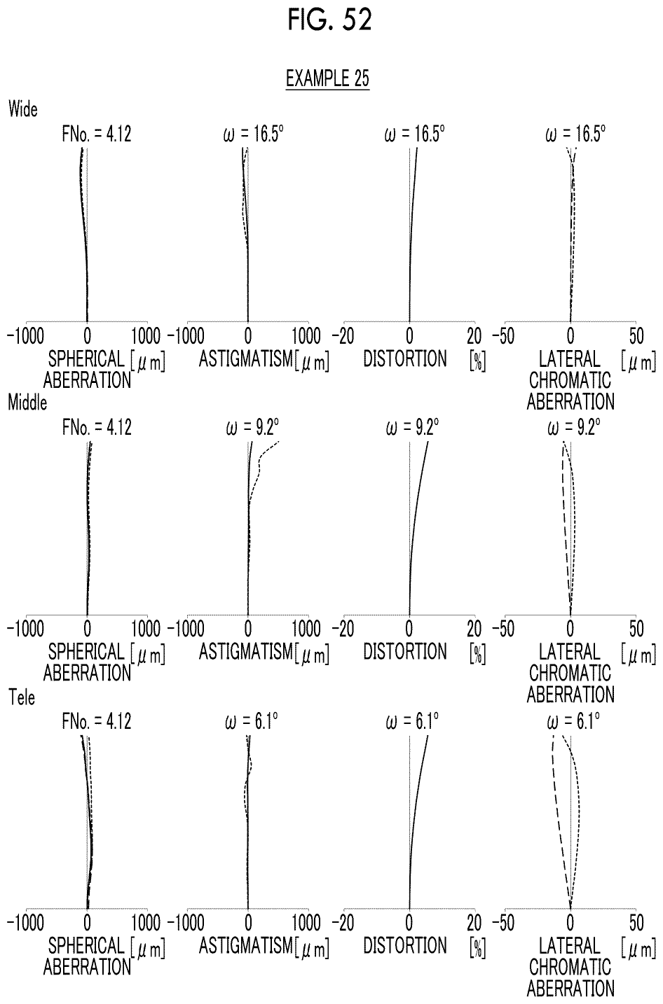

With respect to the variable magnification optical system according to Example 25, basic lens data is shown in Table 72, specifications and variable surface spacings are shown in Table 73, aspherical coefficients are shown in Table 74, and each aberration diagram is shown in FIG. 52.

TABLE 72
Example 25

| Sn | R | D | Nd | νd | ED |
|---|---|---|---|---|---|
| 1 | 82.3963 | 4.0543 | 1.51742 | 52.43 | 47.20 |
| 2 | 491.9470 | 0.0998 | | | 46.96 |
| 3 | 110.4722 | 1.2151 | 1.60342 | 38.03 | 46.42 |
| 4 | 41.8004 | 6.9293 | 1.49700 | 81.54 | 44.71 |
| 5 | 584.9204 | DD[5] | | | 44.48 |
| *6 | 66.0229 | 0.6361 | 1.74482 | 53.52 | 24.51 |
| *7 | 46.3447 | 2.4071 | | | 24.25 |
| 8 | −65.5612 | 0.6387 | 1.58869 | 54.33 | 24.19 |
| 9 | 78.1000 | 1.3996 | 1.97000 | 16.50 | 24.21 |
| 10 | 151.1488 | DD[10] | | | 24.16 |
| 11(St) | ∞ | 0.5000 | | | 22.56 |
| 12 | 36.9749 | 3.6341 | 1.49700 | 81.54 | 22.99 |
| 13 | −116.4930 | DD[13] | | | 22.87 |
| 14 | −31.4679 | 0.5287 | 1.71640 | 34.84 | 19.13 |
| 15 | 18.4935 | 4.4633 | 1.72108 | 28.95 | 19.88 |
| 16 | −69.3290 | DD[16] | | | 20.00 |
| 17 | 221.9347 | 0.5634 | 1.89621 | 23.34 | 22.49 |
| 18 | 33.6552 | 4.6349 | 1.49700 | 81.54 | 22.72 |
| 19 | −40.6996 | 0.0999 | | | 23.06 |
| 20 | 41.9659 | 2.9724 | 1.83661 | 44.34 | 23.80 |
| 21 | −231.5259 | DD[21] | | | 23.85 |
| 22 | −562.7449 | 0.6172 | 1.88235 | 39.77 | 24.06 |
| 23 | 18.2948 | 4.1222 | 1.71868 | 29.07 | 24.19 |
| 24 | 46.1525 | DD[24] | | | 24.44 |
| 25 | −24.6356 | 0.7894 | 1.52841 | 76.45 | 27.27 |
| 26 | −184.5817 | 0.1000 | | | 30.85 |
| *27 | 94.8982 | 3.1191 | 1.88884 | 20.56 | 32.91 |
| *28 | −464.1364 | DD[28] | | | 33.89 |

TABLE 73
Example 25

| | Wide | Middle | Tele |
|---|---|---|---|
| Zr | 1.0 | 1.8 | 2.7 |
| f | 71.62 | 126.16 | 192.14 |
| FNo. | 4.12 | 4.12 | 4.12 |
| 2ω[°] | 33.0 | 18.4 | 12.2 |
| DD[5] | 0.10 | 42.94 | 60.11 |
| DD[10] | 3.28 | 4.88 | 0.72 |
| DD[13] | 5.98 | 12.91 | 19.44 |
| DD[16] | 9.87 | 3.23 | 0.10 |
| DD[21] | 18.07 | 8.96 | 0.10 |
| DD[24] | 11.04 | 14.73 | 19.18 |
| DD[28] | 11.99 | 15.51 | 20.69 |

TABLE 74
Example 25

| Sn | 6 | 7 | 27 | 28 |
|---|---|---|---|---|
| KA | 1.0000000E+00 | 1.0000000E+00 | 1.0000000E+00 | 1.0000000E+00 |
| A4 | −4.8402978E−05 | −4.9813191E−05 | −1.1883688E−05 | −1.3126365E−05 |
| A6 | 2.2825605E−07 | 2.1689507E−07 | 5.3379378E−08 | 7.9500308E−08 |
| A8 | −6.3267891E−10 | −3.7202696E−10 | 1.3934467E−10 | −3.6467863E−10 |
| A10 | 3.0868098E−12 | 9.3482642E−13 | −3.1722628E−12 | 1.5423738E−12 |
| A12 | −3.3158025E−14 | −2.9260527E−14 | 1.2864493E−14 | −9.4164681E−15 |
| A14 | 1.0726189E−16 | 1.3232816E−16 | −1.5530210E−17 | 3.5187761E−17 |
| A16 | 8.9863777E−20 | 2.2330571E−20 | −1.3651650E−20 | −5.5798391E−20 |

### Example 26

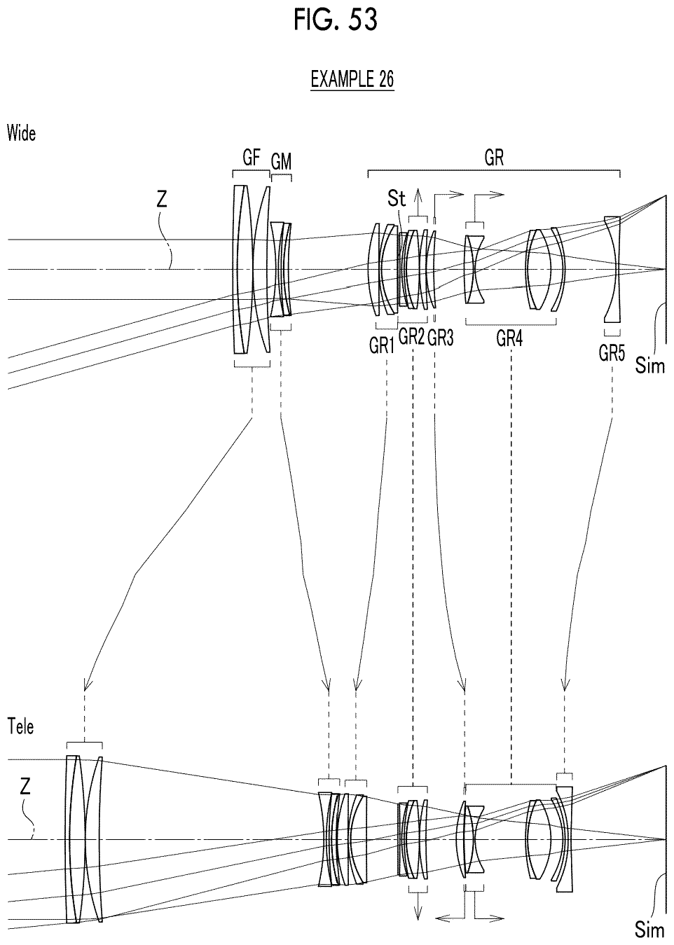

A configuration and a movement trajectory of a variable magnification optical system according to Example 26 are shown in FIG. 53. The variable magnification optical system according to Example 26 consists of the front group GF, the intermediate group GM, and the rear group GR in this order from the object side to the image side. The front group GF consists of one lens group having a positive refractive power. The intermediate group GM consists of one lens group having a negative refractive power. The rear group GR consists of the first subsequent lens group GR1 having a positive refractive power, the second subsequent lens group GR2 having a positive refractive power, the third subsequent lens group GR3 having a positive refractive power, the fourth subsequent lens group GR4 having a negative refractive power, and the fifth subsequent lens group GR5 having a negative refractive power, in this order from the object side to the image side.

During magnification change from the wide angle end to the telephoto end, the second subsequent lens group GR2 and the fourth subsequent lens group GR4 remain stationary with respect to the image plane Sim, and the other lens groups move while changing the spacings between the adjacent lens groups. The variable magnification optical system includes two focusing groups. The focusing group on the object side consists of the third subsequent lens group GR3, and the focusing group on the image side consists of two lenses, that is, a first lens and a second lens, among the lenses of the fourth subsequent lens group GR4 on the object side. During focusing from the infinite distance object to the short range object at the wide angle end, the focusing group on the object side and the focusing group on the image side move to the image side while changing the spacing therebetween, and the other lenses remain stationary with respect to the image plane Sim. During focusing from the infinite distance object to the short range object at the telephoto end, the focusing group on the object side moves to the object side, the focusing group on the image side moves to the image side, and the other lenses remain stationary with respect to the image plane Sim. The anti-vibration group consists of three lenses, that is, a first lens, a second lens, and a third lens, which are arranged in this order from the image side in the second subsequent lens group GR2.

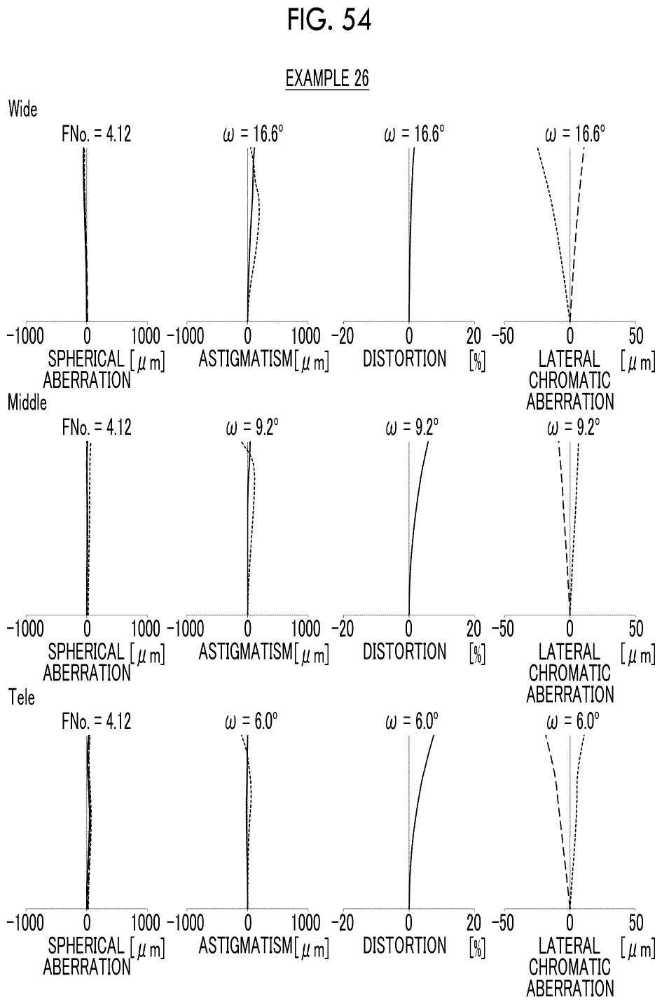

With respect to the variable magnification optical system according to Example 26, basic lens data is shown in Table 75, specifications and variable surface spacings are shown in Table 76, aspherical coefficients are shown in Table 77, and each aberration diagram is shown in FIG. 54.

TABLE 75
Example 26

| Sn | R | D | Nd | νd | ED |
|---|---|---|---|---|---|
| 1 | 655.3687 | 1.2306 | 1.79360 | 37.09 | 49.00 |
| 2 | 155.9980 | 4.2929 | 1.49700 | 81.54 | 48.89 |
| 3 | −188.1614 | 0.0467 | | | 48.90 |
| 4 | 78.0344 | 3.8377 | 1.49700 | 81.54 | 48.28 |
| 5 | 335.3725 | DD[5] | | | 48.03 |
| *6 | −62.7261 | 0.6905 | 1.67585 | 58.90 | 27.50 |
| *7 | 63.7639 | 0.7760 | | | 26.87 |
| 8 | 127.1738 | 0.6991 | 1.51952 | 78.18 | 26.87 |
| 9 | 52.9978 | 1.2814 | 1.94755 | 19.25 | 26.77 |
| 10 | 115.1764 | DD[10] | | | 26.71 |
| 11 | 42.2477 | 2.9889 | 1.53271 | 76.17 | 26.78 |
| 12 | 1024.7572 | 0.0477 | | | 26.65 |
| 13 | 37.7915 | 0.6752 | 1.90000 | 20.00 | 26.17 |
| 14 | 24.9696 | 4.3793 | 1.56955 | 68.08 | 25.36 |
| 15 | 1601.8182 | DD[15] | | | 25.05 |
| 16(St) | ∞ | 0.5276 | | | 21.34 |
| 17 | −740.3164 | 0.5429 | 1.78896 | 50.19 | 21.33 |
| 18 | 39.0771 | 0.6729 | | | 21.35 |
| 19 | 53.2431 | 0.5791 | 1.89824 | 39.01 | 22.69 |
| 20 | 31.1273 | 3.5825 | 1.51718 | 78.53 | 22.66 |
| 21 | −101.5655 | 0.0470 | | | 22.80 |
| 22 | 50.2318 | 1.7801 | 1.82170 | 46.84 | 23.11 |
| 23 | 164.4557 | DD[23] | | | 23.00 |
| 24 | 30.9489 | 2.0549 | 1.63010 | 61.14 | 22.37 |
| 25 | 121.3374 | DD[25] | | | 22.23 |
| 26 | 103.6118 | 2.5300 | 1.85884 | 23.76 | 19.64 |
| 27 | −31.1001 | 0.5011 | 1.82786 | 46.21 | 19.47 |
| 28 | 17.9146 | DD[28] | | | 17.93 |
| 29 | 49.0138 | 0.5795 | 1.90300 | 38.52 | 22.50 |
| 30 | 28.3016 | 6.4332 | 1.51671 | 51.87 | 22.75 |
| 31 | −23.5457 | 3.2938 | | | 23.19 |
| *32 | −22.6914 | 0.6243 | 1.89998 | 38.83 | 23.51 |
| *33 | −31.9558 | DD[33] | | | 24.27 |
| *34 | −39.9119 | 0.7913 | 1.59425 | 66.74 | 28.32 |
| *35 | 116.3228 | DD[35] | | | 30.79 |

TABLE 76
Example 26

| | Wide | Middle | Tele |
|---|---|---|---|
| Zr | 1.0 | 1.8 | 2.7 |
| f | 71.59 | 126.42 | 192.87 |
| FNo. | 4.12 | 4.12 | 4.12 |
| 2ω[°] | 33.2 | 18.4 | 12.0 |
| DD[5] | 2.50 | 40.93 | 62.02 |
| DD[10] | 21.86 | 12.01 | 0.10 |
| DD[15] | 0.15 | 3.85 | 8.67 |
| DD[23] | 0.10 | 2.29 | 8.37 |
| DD[25] | 8.40 | 6.21 | 0.13 |
| DD[28] | 13.92 | 13.92 | 13.92 |
| DD[33] | 14.02 | 4.39 | 0.85 |
| DD[35] | 13.10 | 22.73 | 26.28 |

TABLE 77
Example 26

| Sn | 6 | 7 | 32 | 33 |
|---|---|---|---|---|
| KA | 1.0000000E+00 | 1.0000000E+00 | 1.0000000E+00 | 1.0000000E+00 |
| A4 | 8.8119398E−07 | 7.7675706E−07 | −1.3069306E−05 | −1.7156948E−05 |
| A6 | 5.7100871E−09 | 4.9280789E−09 | 2.6508693E−07 | 2.1332278E−07 |
| A8 | −2.8716784E−11 | −2.5107416E−11 | −1.2892086E−09 | −1.0352187E−09 |
| A10 | 4.8195159E−14 | 4.3377175E−14 | 2.3642844E−12 | 1.5508057E−12 |

| Sn | 34 | 35 |
|---|---|---|
| KA | 1.0000000E+00 | 1.0000000E+00 |
| A4 | −3.2917152E−05 | −3.3729933E−05 |
| A6 | 1.0651716E−07 | 1.5692683E−07 |
| A8 | 2.3772032E−10 | −2.5249986E−10 |
| A10 | −1.5420805E−12 | −6.1723836E−14 |

### Example 27

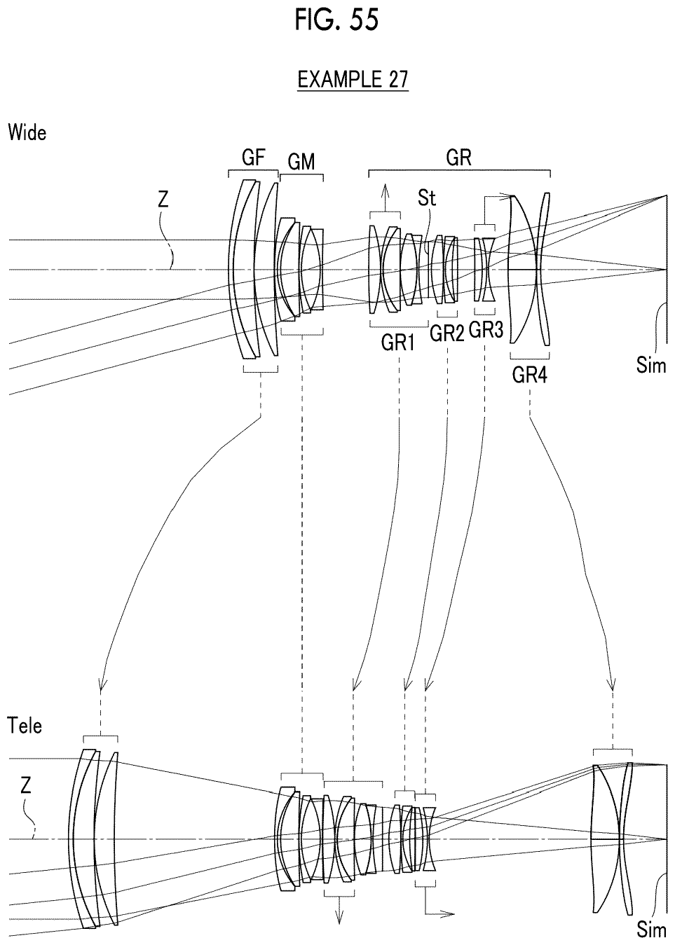

A configuration and a movement trajectory of a variable magnification optical system according to Example 27 are shown in FIG. 55. The variable magnification optical system according to Example 27 consists of the front group GF, the intermediate group GM, and the rear group GR in this order from the object side to the image side. The front group GF consists of one lens group having a positive refractive power. The intermediate group GM consists of one lens group having a negative refractive power. The rear group GR consists of the first subsequent lens group GR1 having a positive refractive power, the second subsequent lens group GR2 having a positive refractive power, the third subsequent lens group GR3 having a negative refractive power, and the fourth subsequent lens group GR4 having a positive refractive power, in this order from the object side to the image side.

During magnification change from the wide angle end to the telephoto end, the intermediate group GM remains stationary with respect to the image plane Sim, and the other lens groups move while changing the spacings between the adjacent lens groups. The variable magnification optical system includes one focusing group, and the focusing group consists of the third subsequent lens group GR3. During focusing from the infinite distance object to the short range object, the third subsequent lens group GR3 moves to the image side, and the other lens groups remain stationary with respect to the image plane Sim. The anti-vibration group consists of three lenses, that is, a first lens, a second lens, and a third lens, which are arranged in this order from the object side in the first subsequent lens group GR1.

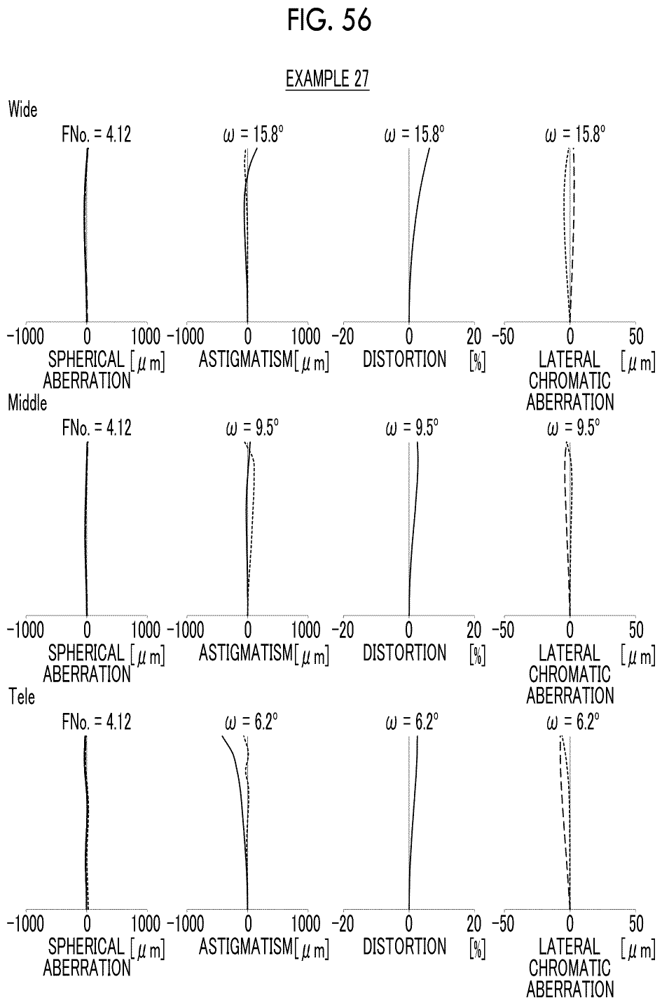

With respect to the variable magnification optical system according to Example 27, basic lens data is shown in Table 78, specifications and variable surface spacings are shown in Table 79, aspherical coefficients are shown in Table 80, and each aberration diagram is shown in FIG. 56.

TABLE 78
Example 27

| Sn | R | D | Nd | νd | ED |
|---|---|---|---|---|---|
| 1 | 84.6360 | 1.3075 | 1.90366 | 31.34 | 52.25 |
| 2 | 56.0616 | 5.7456 | 1.55397 | 71.76 | 51.17 |
| 3 | 198.0372 | 0.0496 | | | 50.96 |
| 4 | 59.3529 | 5.5497 | 1.49700 | 81.54 | 50.45 |
| 5 | 321.5654 | DD[5] | | | 50.10 |
| *6 | 81.5302 | 0.7562 | 1.63319 | 34.77 | 30.25 |
| *7 | 22.5645 | 0.9070 | | | 27.61 |
| 8 | 25.9350 | 5.0316 | 1.89818 | 24.99 | 27.60 |
| 9 | 358.5545 | 0.0498 | | | 26.74 |
| 10 | 70.6651 | 0.6604 | 1.76959 | 42.88 | 25.46 |
| 11 | 28.8885 | 5.2139 | | | 23.70 |
| 12 | −29.1289 | 0.6145 | 1.78076 | 51.03 | 23.54 |
| 13 | 366.3916 | DD[13] | | | 23.64 |
| 14 | 226.6599 | 3.2792 | 1.61662 | 63.24 | 25.51 |
| 15 | −45.6719 | 0.0496 | | | 25.65 |
| 16 | 33.9966 | 0.6485 | 1.89999 | 29.75 | 24.99 |
| 17 | 20.4330 | 4.6786 | 1.71002 | 57.22 | 24.02 |
| 18 | 695.2478 | 0.0498 | | | 23.71 |
| 19 | 30.8265 | 4.6455 | 1.44030 | 94.35 | 20.88 |
| 20 | −34.8779 | 0.5231 | 1.90000 | 30.40 | 20.03 |
| 21 | 56.7408 | 2.6194 | | | 19.20 |
| 22(St) | ∞ | DD[22] | | | 18.74 |
| 23 | 31.1220 | 3.2926 | 1.89999 | 30.42 | 19.99 |
| 24 | −122.3656 | 0.0496 | | | 19.82 |
| 25 | 95.8211 | 0.5085 | 1.68932 | 47.00 | 19.43 |
| 26 | 18.5431 | 1.8978 | | | 18.60 |
| 27 | 61.8134 | 1.4816 | 1.77599 | 51.51 | 18.63 |
| 28 | −522.9155 | DD[28] | | | 18.63 |
| 29 | −513.7880 | 2.0565 | 1.90000 | 28.20 | 18.34 |
| 30 | −42.2314 | 1.2466 | | | 18.41 |
| 31 | −37.2944 | 0.5000 | 1.74336 | 54.85 | 18.16 |
| 32 | 25.0758 | DD[32] | | | 18.46 |
| *33 | 99.4201 | 7.8127 | 1.48750 | 83.05 | 42.45 |
| *34 | −42.1243 | 0.0498 | | | 43.06 |
| *35 | 107.0013 | 1.1395 | 1.45959 | 89.97 | 44.49 |
| *36 | 51.7789 | DD[36] | | | 44.43 |

TABLE 79
Example 27

| | Wide | Middle | Tele |
|---|---|---|---|
| Zr | 1.0 | 1.8 | 2.7 |
| f | 71.80 | 126.70 | 193.20 |
| FNo. | 4.12 | 4.12 | 4.12 |
| 2ω[°] | 31.6 | 19.0 | 12.4 |
| DD[5] | 0.10 | 33.76 | 44.15 |
| DD[13] | 12.77 | 8.22 | 0.10 |
| DD[22] | 0.84 | 0.34 | 1.76 |
| DD[28] | 4.75 | 2.24 | 0.10 |
| DD[32] | 5.24 | 28.22 | 44.56 |
| DD[36] | 34.89 | 19.48 | 11.97 |

TABLE 80
Example 27

| Sn | 6 | 7 |
|---|---|---|
| KA | 1.0000000E+00 | 1.0000000E+00 |
| A4 | 7.4035119E−06 | 4.0459775E−06 |
| A6 | −1.3827933E−08 | −1.0866815E−08 |
| A8 | 6.0116501E−11 | −3.4283869E−12 |
| A10 | −1.0968481E−14 | 2.4472674E−13 |

| Sn | 33 | 34 | 35 | 36 |
|---|---|---|---|---|
| KA | 1.0000000E+00 | 1.0000000E+00 | 1.0000000E+00 | 1.0000000E+00 |
| A4 | −6.6769597E−06 | 5.3616594E−07 | 5.2229028E−07 | −3.5038227E−06 |
| A6 | −9.7951989E−09 | −5.7376401E−09 | −2.6055260E−08 | −4.6902700E−08 |
| A8 | 1.9740755E−11 | 1.4246334E−11 | 9.9060748E−11 | 1.1215162E−10 |
| A10 | 1.2130090E−14 | −2.3968325E−15 | −1.1267844E−13 | −1.1559969E−13 |
| A12 | −2.9407394E−17 | −2.2876157E−18 | 2.2453915E−17 | 3.5124190E−17 |
| A14 | −7.2525737E−20 | −9.0548996E−20 | 4.7205225E−20 | 1.1287463E−19 |
| A16 | 3.7408632E−23 | 5.4890255E−23 | −5.5905491E−23 | −1.9610978E−22 |

### Example 28

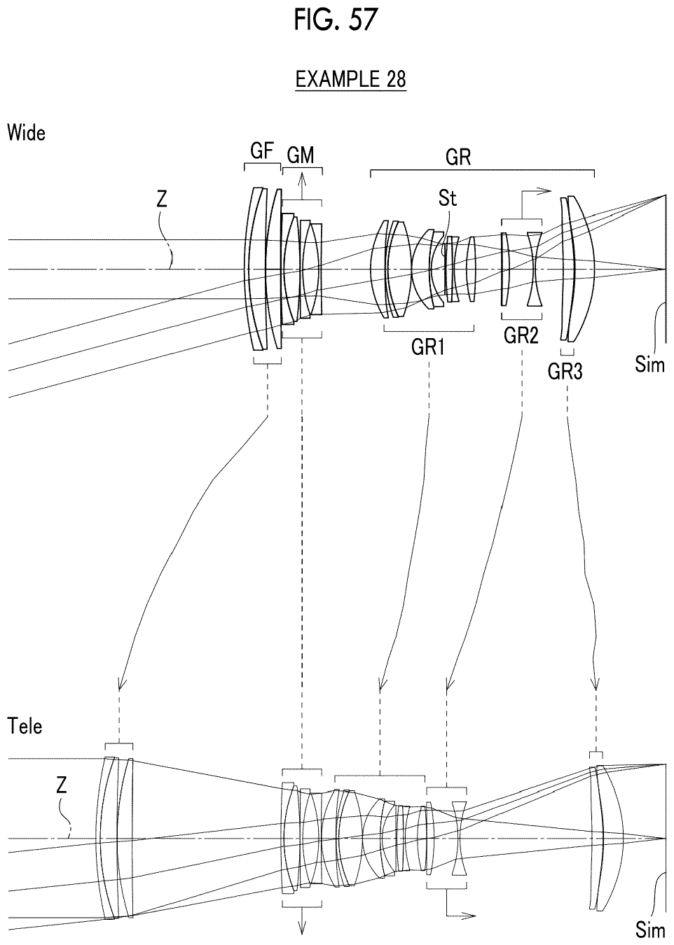

A configuration and a movement trajectory of a variable magnification optical system according to Example 28 are shown in FIG. 57. The variable magnification optical system according to Example 28 consists of the front group GF, the intermediate group GM, and the rear group GR in this order from the object side to the image side. The front group GF consists of one lens group having a positive refractive power. The intermediate group GM consists of one lens group having a negative refractive power. The rear group GR consists of the first subsequent lens group GR1 having a positive refractive power, the second subsequent lens group GR2 having a negative refractive power, and the third subsequent lens group GR3 having a positive refractive power, in this order from the object side to the image side.

During magnification change from the wide angle end to the telephoto end, the intermediate group GM remains stationary with respect to the image plane Sim, and the other lens groups move while changing the spacings between the adjacent lens groups. The variable magnification optical system includes one focusing group, and the focusing group consists of the second subsequent lens group GR2. During focusing from the infinite distance object to the short range object, the second subsequent lens group GR2 moves to the image side, and the other lens groups remain stationary with respect to the image plane Sim. The anti-vibration group consists of the intermediate group GM.

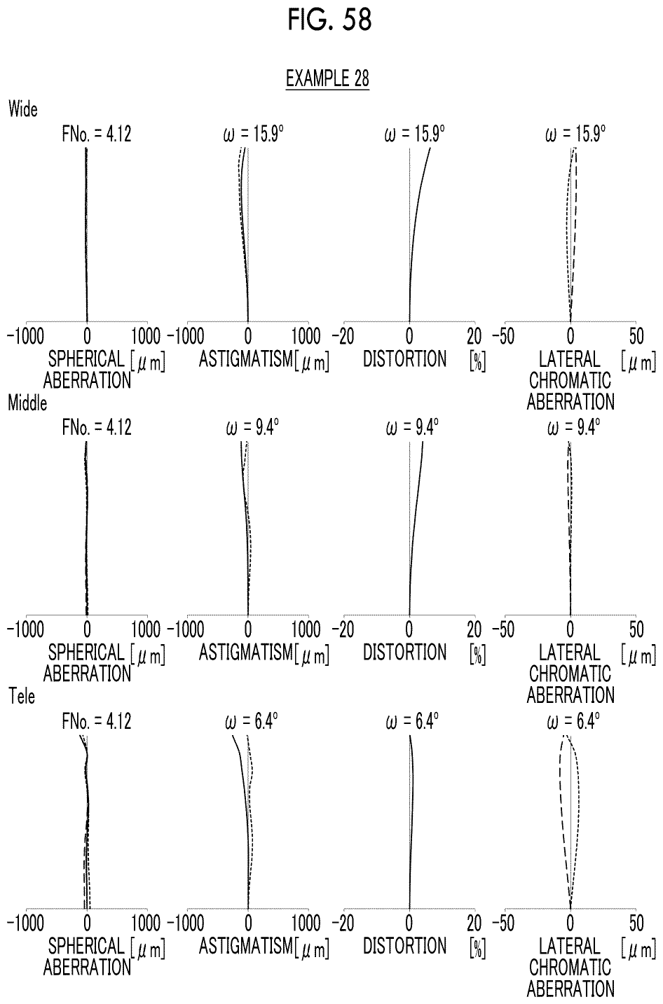

With respect to the variable magnification optical system according to Example 28, basic lens data is shown in Table 81, specifications and variable surface spacings are shown in Table 82, aspherical coefficients are shown in Table 83, and each aberration diagram is shown in FIG. 58.

TABLE 81
Example 28

| Sn | R | D | Nd | νd | ED |
|---|---|---|---|---|---|
| 1 | 110.1729 | 1.2015 | 1.84666 | 23.78 | 47.50 |
| 2 | 72.0702 | 4.6365 | 1.49700 | 81.54 | 46.97 |
| 3 | 588.3217 | 0.0442 | | | 46.85 |
| 4 | 85.4901 | 4.1576 | 1.59282 | 68.62 | 46.54 |
| 5 | 1282.0007 | DD[5] | | | 46.23 |
| 6 | 349.7312 | 0.8313 | 1.75161 | 54.01 | 32.38 |
| 7 | 44.0451 | 4.4183 | 1.83682 | 23.40 | 30.64 |
| 8 | −139.2548 | 0.0371 | | | 30.16 |
| 9 | 1097.3261 | 0.7309 | 1.78547 | 50.54 | 28.75 |
| 10 | 45.1816 | 4.4205 | | | 26.81 |
| 11 | −42.1137 | 0.6757 | 1.90001 | 38.83 | 26.63 |
| 12 | 537.9312 | DD[12] | | | 26.47 |
| *13 | 28.6568 | 4.0080 | 1.59740 | 66.25 | 28.51 |
| *14 | 275.0586 | 0.0440 | | | 28.30 |
| 15 | 45.6780 | 0.7298 | 1.85153 | 24.59 | 28.20 |
| 16 | 34.8197 | 6.5369 | 1.43671 | 90.79 | 27.74 |
| 17 | −43.8447 | 0.0465 | | | 27.48 |
| 18 | 16.7245 | 4.8533 | 1.44780 | 82.95 | 23.28 |
| 19 | 48.2545 | 0.5708 | 1.79519 | 49.55 | 21.95 |
| 20 | 15.7377 | 3.7801 | | | 19.61 |
| 21(St) | ∞ | 0.3001 | | | 19.48 |
| 22 | 95.7367 | 1.7834 | 1.65966 | 59.62 | 19.24 |
| 23 | −206.4425 | 0.4996 | 1.86813 | 23.68 | 18.96 |
| 24 | 34.2068 | 3.3625 | | | 18.51 |
| 25 | 40.1834 | 2.5306 | 1.87617 | 32.73 | 18.75 |
| 26 | −99.1930 | DD[26] | | | 18.93 |
| 27 | −702.3526 | 1.9931 | 1.85867 | 26.17 | 21.22 |
| 28 | −58.4684 | 6.5916 | | | 21.35 |
| 29 | −34.4647 | 0.5607 | 1.75413 | 53.75 | 20.69 |
| 30 | 32.2805 | DD[30] | | | 21.52 |
| *31 | −146.9189 | 3.0312 | 1.71779 | 29.11 | 40.74 |
| *32 | −61.5634 | 0.2090 | | | 41.55 |
| *33 | −70.3048 | 5.4110 | 1.44646 | 65.04 | 41.87 |
| *34 | −43.6534 | DD[34] | | | 42.50 |

TABLE 82
Example 28

| | Wide | Middle | Tele |
|---|---|---|---|
| Zr | 1.0 | 1.8 | 2.7 |
| f | 71.32 | 125.86 | 191.91 |
| FNo. | 4.12 | 4.12 | 4.12 |
| 2ω[°] | 31.8 | 18.8 | 12.8 |
| DD[5] | 0.10 | 29.51 | 40.98 |
| DD[12] | 13.65 | 7.95 | 0.09 |
| DD[26] | 7.21 | 2.48 | 0.10 |
| DD[30] | 7.72 | 23.03 | 36.35 |
| DD[34] | 19.76 | 14.88 | 11.80 |

TABLE 83
Example 28

| Sn | 13 | 14 | 31 | 32 |
|---|---|---|---|---|
| KA | 1.0000000E+00 | 1.0000000E+00 | 1.0000000E+00 | 1.0000000E+00 |
| A4 | −3.2188319E−07 | 1.4327719E−05 | 1.2236665E−05 | 1.3282538E−05 |
| A6 | −1.5260136E−08 | −1.0564110E−08 | −4.8343089E−09 | −3.4271250E−09 |
| A8 | 1.7943844E−10 | 1.7476391E−10 | −4.8370762E−11 | −2.4866953E−11 |
| A10 | −6.9306148E−13 | −7.0591835E−13 | 3.3008904E−14 | −9.7168824E−16 |

| Sn | 33 | 34 |
|---|---|---|
| KA | 1.0000000E+00 | 1.0000000E+00 |
| A4 | −5.0432977E−06 | −7.6699423E−06 |
| A6 | 4.1062228E−08 | 2.9104721E−08 |
| A8 | −9.4476804E−12 | −2.3018788E−11 |
| A10 | −5.2819712E−14 | −1.9043644E−14 |

Tables 84 to 95 show corresponding values of Conditional Expressions (1) to (53) of the variable magnification optical systems according to Examples 1 to 28. Preferable ranges of the conditional expressions may be set using the corresponding values of the examples shown in Tables 84 to 95 as the upper limits and the lower limits of the conditional expressions

TABLE 84

| Expression | | | | | | |
|---|---|---|---|---|---|---|
| number | | Example 1 | Example 2 | Example 3 | Example 4 | Example 5 |
| (1) | TLw/ft | 0.746 | 0.753 | 0.747 | 0.696 | 0.670 |
| (2) | Fnot × (TLt/ft) | 2.915 | 2.864 | 2.902 | 2.793 | 2.541 |
| (3) | fw/(ft × tanωt) | 3.536 | 3.461 | 3.596 | 3.536 | 3.658 |
| (4) | TLt/(ft × tanωt) | 9.564 | 9.361 | 9.718 | 9.071 | 8.626 |
| (5) | ft/(fw × tanωw) | 9.447 | 9.139 | 9.638 | 9.262 | 9.574 |
| (6) | TLw/(ft × tanωt) | 7.102 | 6.960 | 7.231 | 6.619 | 6.595 |
| (7) | fw/Dexw | −1.318 | −1.626 | −1.576 | −1.676 | −1.727 |
| (8) | DDL1STw/TLw | 0.303 | 0.379 | 0.480 | 0.462 | 0.454 |
| (9) | DDL1STw/f1 | 0.293 | 0.333 | 0.265 | 0.240 | 0.239 |
| (10) | DDL1STw/{(fw × tanωw) × log(ft/fw)} | 4.973 | 6.104 | 8.047 | 6.928 | 6.777 |
| (11) | \|(1 − βfoc²) × βfocR²\| | 4.383 | 3.991 | 4.777 | 5.295 | 5.845 |
| (12) | \|(1 − βfocA²) × βfocAR²\|/\|(1 − βfocB²) × | 0.189 | — | — | — | — |
| | βfocBR²\| | | | | | |
| (13) | \|(1 − βOIS) × βOISR\| | 1.852 | 1.490 | 1.510 | 1.461 | 1.503 |
| (14) | DDL1STt/TLt | 0.483 | 0.540 | 0.613 | 0.608 | 0.583 |
| (15) | DDL1STt/f1 | 0.131 | 0.083 | 0.048 | 0.048 | 0.051 |
| (16) | Denw/{(fw × tanωw) × log(ft/fw)} | 4.390 | 5.761 | 6.853 | 6.039 | 6.022 |
| (17) | Denw/(fw × ft)^{1/2} | 0.328 | 0.440 | 0.501 | 0.460 | 0.444 |
| (18) | Fnot/(ft/fw) | 1.078 | 1.059 | 1.074 | 1.089 | 1.078 |
| (19) | TLt/ft | 1.005 | 1.012 | 1.004 | 0.953 | 0.876 |
| (20) | Bfw/(ft × tanωt) | 0.539 | 0.674 | 0.593 | 0.540 | 0.562 |
| (21) | f1/fLn1 | −0.922 | −0.368 | −0.898 | −0.853 | −0.779 |
| (22) | f1/(ft/Fnot) | 2.238 | 2.424 | 3.916 | 3.930 | 3.693 |
| (23) | f1/(fw × ft)^{1/2} | 1.266 | 1.400 | 2.223 | 2.201 | 2.089 |
| (24) | f1/fw | 2.076 | 2.289 | 3.646 | 3.610 | 3.427 |
| (25) | ν1pave | 85.245 | 85.245 | 88.305 | 88.305 | 88.305 |
| (26) | dF1/(ft/Fnot) | 0.293 | 0.202 | 0.188 | 0.187 | 0.187 |

TABLE 85

| Expression | | | | | | |
|---|---|---|---|---|---|---|
| number | | Example 1 | Example 2 | Example 3 | Example 4 | Example 5 |
| (27) | EDf/TLt | 0.344 | 0.344 | 0.344 | 0.362 | 0.394 |
| (28) | EDf/EDr | 1.818 | 2.096 | 1.962 | 2.027 | 2.050 |
| (29) | fFw/(−fMw) | 3.128 | 2.981 | 1.637 | 1.560 | 1.558 |
| (30) | \|dFMw − dFMt\|/TLt | 0.326 | 0.378 | 0.408 | 0.390 | 0.336 |
| (31) | fw/fRw | 2.029 | 2.033 | 1.463 | 1.474 | 1.509 |
| (32) | ft/fRt | 3.846 | 3.512 | 1.476 | 1.084 | 0.816 |
| (33) | fRA1/fRA3 | 1.819 | — | — | — | — |
| (34) | fRA2/fRA4 | 2.001 | — | — | — | — |
| (35) | fRA4/fRA5 | 0.406 | — | — | — | — |
| (36) | fRB1/fRB2 | — | 2.969 | 4.111 | 4.635 | 5.346 |
| (37) | fRB1/fRB4 | — | 1.856 | 4.300 | 4.884 | 5.757 |
| (38) | fRB3/fRB5 | — | 1.006 | 0.796 | 0.824 | 0.813 |
| (39) | fRC1/fRC2 | — | — | — | — | — |
| (40) | fRD1/fRD2 | — | — | — | — | — |
| (41) | fRD3/fRD4 | — | — | — | — | — |
| (42) | fRE1/fRE3 | — | — | — | — | — |
| (43) | fRE3/fRE5 | — | — | — | — | — |
| (44) | fRE2/fRE4 | — | — | — | — | — |
| (45) | fRE4/fRE6 | — | — | — | — | — |
| (46) | fRF1/fRF3 | — | — | — | — | — |
| (47) | fRF2/fRF4 | — | — | — | — | — |
| (48) | fRG1/fRG2 | — | — | — | — | — |
| (49) | fRG3/fRG2 | — | — | — | — | — |
| (50) | fRG4/fRG5 | — | — | — | — | — |
| (51) | fRH1/fRH2 | — | — | — | — | — |
| (52) | fRH2/fRH4 | — | — | — | — | — |
| (53) | fRI1/fRI3 | — | — | — | — | — |

TABLE 86

| Expression | | | | | | |
|---|---|---|---|---|---|---|
| number | | Example 6 | Example 7 | Example 8 | Example 9 | Example 10 |
| (1) | TLw/ft | 0.799 | 0.829 | 0.761 | 0.773 | 0.756 |
| (2) | Fnot × (TLt/ft) | 3.279 | 3.229 | 3.075 | 3.128 | 3.002 |
| (3) | fw/(ft × tanωt) | 3.262 | 3.421 | 3.477 | 3.536 | 3.297 |
| (4) | TLt/(ft × tanωt) | 9.923 | 10.248 | 9.888 | 10.298 | 9.294 |
| (5) | ft/(fw × tanωw) | 8.693 | 9.203 | 8.970 | 8.913 | 9.070 |
| (6) | TLw/(ft × tanωt) | 7.011 | 7.634 | 7.125 | 7.355 | 6.743 |
| (7) | fw/Dexw | −1.296 | −1.157 | −1.245 | −1.083 | −1.466 |
| (8) | DDL1STw/TLw | 0.328 | 0.353 | 0.325 | 0.289 | 0.279 |
| (9) | DDL1STw/f1 | 0.350 | 0.397 | 0.296 | 0.178 | 0.291 |
| (10) | DDL1STw/{(fw × tanωw) × log(ft/fw)} | 5.306 | 6.271 | 5.167 | 4.638 | 4.435 |
| (11) | \|(1 − βfoc²) × βfocR²\| | 2.960 | 3.270 | 2.305 | 4.218 | 5.003 |
| (12) | \|(1 − βfocA²) × βfocAR²\|/\|(1 − βfocB²) × | — | — | — | — | — |
| | βfocBR²\| | | | | | |
| (13) | \|(1 − βOIS) × βOISR\| | 1.509 | 1.875 | 1.495 | 1.502 | 1.499 |
| (14) | DDL1STt/TLt | 0.509 | 0.481 | 0.482 | 0.567 | 0.471 |
| (15) | DDL1STt/f1 | 0.119 | 0.112 | 0.103 | 0.053 | 0.186 |
| (16) | Denw/{(fw × tanωw) × log(ft/fw)} | 4.828 | 5.792 | 4.248 | 3.865 | 3.908 |
| (17) | Denw/(fw × ft)^{1/2} | 0.392 | 0.444 | 0.334 | 0.306 | 0.306 |
| (18) | Fnot/(ft/fw) | 1.078 | 1.078 | 1.081 | 1.074 | 1.065 |
| (19) | TLt/ft | 1.131 | 1.113 | 1.057 | 1.082 | 1.043 |
| (20) | Bfw/(ft × tanωt) | 0.591 | 0.498 | 0.602 | 0.596 | 0.545 |
| (21) | f1/fLn1 | −1.007 | −0.639 | −0.665 | −0.785 | −1.113 |
| (22) | f1/(ft/Fnot) | 2.172 | 2.140 | 2.436 | 3.626 | 2.093 |
| (23) | f1/(fw × ft)^{1/2} | 1.229 | 1.210 | 1.373 | 2.058 | 1.195 |
| (24) | f1/fw | 2.015 | 1.986 | 2.253 | 3.376 | 1.965 |
| (25) | ν1pave | 66.965 | 75.151 | 88.305 | 88.305 | 68.697 |
| (26) | dF1/(ft/Fnot) | 0.258 | 0.241 | 0.250 | 0.192 | 0.390 |

TABLE 87

| Expression | | | | | | |
|---|---|---|---|---|---|---|
| number | | Example 6 | Example 7 | Example 8 | Example 9 | Example 10 |
| (27) | EDf/TLt | 0.305 | 0.310 | 0.327 | 0.319 | 0.335 |
| (28) | EDf/EDr | 1.964 | 1.779 | 1.937 | 1.971 | 1.879 |
| (29) | fFw/(−fMw) | 1.076 | 1.293 | 2.500 | 1.875 | 2.640 |
| (30) | \|dFMw − dFMt\|/TLt | 0.285 | 0.282 | 0.336 | 0.436 | 0.274 |
| (31) | fw/fRw | 1.081 | 1.245 | 1.593 | 1.484 | 2.015 |
| (32) | ft/fRt | 1.013 | 1.377 | 2.588 | 2.107 | 2.762 |
| (33) | fRA1/fRA3 | — | — | — | — | — |
| (34) | fRA2/fRA4 | — | — | — | — | — |
| (35) | fRA4/fRA5 | — | — | — | — | — |
| (36) | fRB1/fRB2 | — | — | — | — | — |
| (37) | fRB1/fRB4 | — | — | — | — | — |
| (38) | fRB3/fRB5 | — | — | — | — | — |
| (39) | fRC1/fRC2 | 0.537 | — | — | — | — |
| (40) | fRD1/fRD2 | — | 1.592 | — | — | 1.589 |
| (41) | fRD3/fRD4 | — | 0.247 | — | — | 0.226 |
| (42) | fRE1/fRE3 | — | — | 0.819 | 1.438 | — |
| (43) | fRE3/fRE5 | — | — | 0.730 | 1.203 | — |
| (44) | fRE2/fRE4 | — | — | 0.932 | 2.096 | — |
| (45) | fRE4/fRE6 | — | — | 1.063 | 0.396 | — |
| (46) | fRF1/fRF3 | — | — | — | — | — |
| (47) | fRF2/fRF4 | — | — | — | — | — |
| (48) | fRG1/fRG2 | — | — | — | — | — |
| (49) | fRG3/fRG2 | — | — | — | — | — |
| (50) | fRG4/fRG5 | — | — | — | — | — |
| (51) | fRH1/fRH2 | — | — | — | — | — |
| (52) | fRH2/fRH4 | — | — | — | — | — |
| (53) | fRI1/fRI3 | — | — | — | — | — |

TABLE 88

| Expression | | | | | | |
|---|---|---|---|---|---|---|
| number | | Example 11 | Example 12 | Example 13 | Example 14 | Example 15 |
| (1) | TLw/ft | 0.760 | 0.755 | 0.755 | 0.744 | 0.786 |
| (2) | Fnot × (TLt/ft) | 3.060 | 3.038 | 3.031 | 3.012 | 3.142 |
| (3) | fw/(ft × tanωt) | 3.297 | 3.296 | 3.292 | 3.345 | 3.159 |
| (4) | TLt/(ft × tanωt) | 9.344 | 9.277 | 9.287 | 9.280 | 9.223 |
| (5) | ft/(fw × tanωw) | 8.846 | 8.846 | 8.804 | 8.969 | 8.546 |
| (6) | TLw/(ft × tanωt) | 6.776 | 6.733 | 6.733 | 6.743 | 6.692 |
| (7) | fw/Dexw | −1.260 | −1.192 | −1.304 | −1.672 | −1.231 |
| (8) | DDL1STw/TLw | 0.211 | 0.328 | 0.300 | 0.297 | 0.383 |
| (9) | DDL1STw/f1 | 0.214 | 0.276 | 0.274 | 0.179 | 0.380 |
| (10) | DDL1STw/{(fw × tanωw) × log(ft/fw)} | 3.284 | 5.072 | 4.605 | 4.586 | 5.970 |
| (11) | \|(1 − βfoc²) × βfocR²\| | 4.828 | 4.221 | 4.002 | 3.198 | 3.861 |
| (12) | \|(1 − βfocA²) × βfocAR²\|/\|(1 − βfocB²) × | 0.198 | 0.291 | — | — | — |
| | βfocBR²\| | | | | | |
| (13) | \|(1 − βOIS) × βOISR\| | 1.893 | 2.042 | 1.771 | 2.193 | 1.635 |
| (14) | DDL1STt/TLt | 0.428 | 0.512 | 0.508 | 0.546 | 0.552 |
| (15) | DDL1STt/f1 | 0.136 | 0.101 | 0.104 | 0.052 | 0.111 |
| (16) | Denw/{(fw × tanωw) × log(ft/fw)} | 3.638 | 4.400 | 3.859 | 4.250 | 4.935 |
| (17) | Denw/(fw × ft)^{1/2} | 0.292 | 0.353 | 0.312 | 0.337 | 0.408 |
| (18) | Fnot/(ft/fw) | 1.080 | 1.080 | 1.074 | 1.086 | 1.076 |
| (19) | TLt/ft | 1.048 | 1.041 | 1.042 | 1.024 | 1.083 |
| (20) | Bfw/(ft × tanωt) | 0.516 | 0.556 | 0.470 | 0.537 | 0.460 |
| (21) | f1/fLn1 | −0.728 | −1.043 | −0.781 | −0.800 | −0.325 |
| (22) | f1/(ft/Fnot) | 2.184 | 2.622 | 2.405 | 3.636 | 2.296 |
| (23) | f1/(fw × ft)^{1/2} | 1.230 | 1.477 | 1.360 | 2.035 | 1.300 |
| (24) | f1/fw | 2.023 | 2.429 | 2.238 | 3.349 | 2.133 |
| (25) | ν1pave | 82.083 | 79.514 | 78.622 | 95.000 | 88.779 |
| (26) | dF1/(ft/Fnot) | 0.297 | 0.265 | 0.250 | 0.189 | 0.256 |

TABLE 89

| Expression | | | | | | |
|---|---|---|---|---|---|---|
| number | | Example 11 | Example 12 | Example 13 | Example 14 | Example 15 |
| (27) | EDf/TLt | 0.334 | 0.335 | 0.335 | 0.335 | 0.329 |
| (28) | EDf/EDr | 1.751 | 1.822 | 1.721 | 1.948 | 1.574 |
| (29) | fFw/(−fMw) | 2.959 | 2.543 | 3.198 | 2.408 | 4.073 |
| (30) | \|dFMw − dFMt\|/TLt | 0.275 | 0.345 | 0.353 | 0.380 | 0.316 |
| (31) | fw/fRw | 2.003 | 1.861 | 1.970 | 2.291 | 2.287 |
| (32) | ft/fRt | 3.447 | 3.491 | 3.462 | 3.746 | 4.773 |
| (33) | fRA1/fRA3 | 1.333 | 1.427 | — | 1.216 | — |
| (34) | fRA2/fRA4 | 4.200 | 2.068 | — | 1.030 | — |
| (35) | fRA4/fRA5 | 0.211 | 0.163 | — | 0.739 | — |
| (36) | fRB1/fRB2 | — | — | — | — | — |
| (37) | fRB1/fRB4 | — | — | — | — | — |
| (38) | fRB3/fRB5 | — | — | — | — | — |
| (39) | fRC1/fRC2 | — | — | — | — | — |
| (40) | fRD1/fRD2 | — | — | — | — | — |
| (41) | fRD3/fRD4 | — | — | — | — | — |
| (42) | fRE1/fRE3 | — | — | 0.668 | — | — |
| (43) | fRE3/fRE5 | — | — | 1.066 | — | — |
| (44) | fRE2/fRE4 | — | — | 2.119 | — | — |
| (45) | fRE4/fRE6 | — | — | 0.572 | — | — |
| (46) | fRF1/fRF3 | — | — | — | — | 0.537 |
| (47) | fRF2/fRF4 | — | — | — | — | 0.855 |
| (48) | fRG1/fRG2 | — | — | — | — | — |
| (49) | fRG3/fRG2 | — | — | — | — | — |
| (50) | fRG4/fRG5 | — | — | — | — | — |
| (51) | fRH1/fRH2 | — | — | — | — | — |
| (52) | fRH2/fRH4 | — | — | — | — | — |
| (53) | fRI1/fRI3 | — | — | — | — | — |

TABLE 90

| Expression | | | | | | |
|---|---|---|---|---|---|---|
| number | | Example 16 | Example 17 | Example 18 | Example 19 | Example 20 |
| (1) | TLw/ft | 0.566 | 0.557 | 0.515 | 0.489 | 0.597 |
| (2) | Fnot × (TLt/ft) | 3.178 | 3.185 | 2.955 | 2.874 | 3.592 |
| (3) | fw/(ft × tanωt) | 3.477 | 3.421 | 3.477 | 3.477 | 3.473 |
| (4) | TLt/(ft × tanωt) | 7.200 | 7.117 | 6.728 | 6.511 | 8.158 |
| (5) | ft/(fw × tanωw) | 9.447 | 9.385 | 9.510 | 9.770 | 9.038 |
| (6) | TLw/(ft × tanωt) | 5.299 | 5.129 | 4.823 | 4.575 | 5.583 |
| (7) | fw/Dexw | −1.798 | −1.769 | −1.876 | −1.959 | −1.624 |
| (8) | DDL1STw/TLw | 0.280 | 0.294 | 0.270 | 0.267 | 0.287 |
| (9) | DDL1STw/f1 | 0.279 | 0.299 | 0.266 | 0.258 | 0.257 |
| (10) | DDL1STw/{(fw × tanωw) × log(ft/fw)} | 3.479 | 3.573 | 3.076 | 2.969 | 3.600 |
| (11) | \|(1 − βfoc²) × βfocR²\| | 6.417 | 6.957 | 7.668 | 8.402 | 5.902 |
| (12) | \|(1 − βfocA²) × βfocAR²\|/\|(1 − βfocB²) × | 0.445 | 0.404 | 0.397 | 0.392 | 0.649 |
| | βfocBR²\| | | | | | |
| (13) | \|(1 − βOIS) × βOISR\| | 1.918 | 1.787 | 1.780 | 1.626 | 1.770 |
| (14) | DDL1STt/TLt | 0.401 | 0.444 | 0.413 | 0.428 | 0.512 |
| (15) | DDL1STt/f1 | 0.113 | 0.134 | 0.123 | 0.126 | 0.080 |
| (16) | Denw/{(fw × tanωw) × log(ft/fw)} | 3.174 | 3.205 | 2.819 | 2.702 | 2.748 |
| (17) | Denw/(fw × ft)^{1/2} | 0.237 | 0.241 | 0.209 | 0.195 | 0.215 |
| (18) | Fnot/(ft/fw) | 1.535 | 1.531 | 1.527 | 1.535 | 1.529 |
| (19) | TLt/ft | 0.769 | 0.773 | 0.719 | 0.696 | 0.872 |
| (20) | Bfw/(ft × tanωt) | 0.579 | 0.578 | 0.579 | 0.532 | 0.585 |
| (21) | f1/fLn1 | −0.593 | −0.520 | −0.489 | −0.432 | −0.732 |
| (22) | f1/(ft/Fnot) | 2.343 | 2.252 | 2.146 | 2.088 | 2.744 |
| (23) | f1/(fw × ft)^{1/2} | 0.931 | 0.897 | 0.857 | 0.829 | 1.093 |
| (24) | f1/fw | 1.527 | 1.471 | 1.405 | 1.360 | 1.795 |
| (25) | ν1pave | 88.305 | 88.305 | 88.305 | 88.305 | 82.482 |
| (26) | dF1/(ft/Fnot) | 0.265 | 0.302 | 0.263 | 0.262 | 0.221 |

TABLE 91

| Expression | | | | | | |
|---|---|---|---|---|---|---|
| number | | Example 16 | Example 17 | Example 18 | Example 19 | Example 20 |
| (27) | EDf/TLt | 0.315 | 0.313 | 0.337 | 0.348 | 0.279 |
| (28) | EDf/EDr | 1.549 | 1.562 | 1.600 | 1.621 | 1.426 |
| (29) | fFw/(−fMw) | 2.012 | 1.989 | 1.846 | 1.702 | 2.444 |
| (30) | \|dFMw − dFMt\|/TLt | 0.264 | 0.279 | 0.283 | 0.297 | 0.318 |
| (31) | fw/fRw | 1.949 | 1.944 | 1.905 | 1.807 | 2.081 |
| (32) | ft/fRt | 2.338 | 1.900 | 1.541 | 0.847 | 3.004 |
| (33) | fRA1/fRA3 | 1.573 | 1.580 | 1.623 | 1.687 | — |
| (34) | fRA2/fRA4 | 1.577 | 2.121 | 2.183 | 2.436 | — |
| (35) | fRA4/fRA5 | 0.691 | 0.306 | 0.346 | 0.244 | — |
| (36) | fRB1/fRB2 | — | — | — | — | — |
| (37) | fRB1/fRB4 | — | — | — | — | — |
| (38) | fRB3/fRB5 | — | — | — | — | — |
| (39) | fRC1/fRC2 | — | — | — | — | — |
| (40) | fRD1/fRD2 | — | — | — | — | — |
| (41) | fRD3/fRD4 | — | — | — | — | — |
| (42) | fRE1/fRE3 | — | — | — | — | 0.537 |
| (43) | fRE3/fRE5 | — | — | — | — | 1.460 |
| (44) | fRE2/fRE4 | — | — | — | — | 10.804 |
| (45) | fRE4/fRE6 | — | — | — | — | 0.717 |
| (46) | fRF1/fRF3 | — | — | — | — | — |
| (47) | fRF2/fRF4 | — | — | — | — | — |
| (48) | fRG1/fRG2 | — | — | — | — | — |
| (49) | fRG3/fRG2 | — | — | — | — | — |
| (50) | fRG4/fRG5 | — | — | — | — | — |
| (51) | fRH1/fRH2 | — | — | — | — | — |
| (52) | fRH2/fRH4 | — | — | — | — | — |
| (53) | fRI1/fRI3 | — | — | — | — | — |

TABLE 92

| Expression | | | | | | |
|---|---|---|---|---|---|---|
| number | | Example 21 | Example 22 | Example 23 | Example 24 | Example 25 |
| (1) | TLw/ft | 0.574 | 0.618 | 0.626 | 0.604 | 0.541 |
| (2) | Fnot × (TLt/ft) | 3.490 | 3.612 | 3.605 | 3.480 | 3.514 |
| (3) | fw/(ft × tanωt) | 3.468 | 3.532 | 3.421 | 3.313 | 3.488 |
| (4) | TLt/(ft × tanωt) | 8.079 | 8.341 | 8.054 | 7.512 | 7.981 |
| (5) | ft/(fw × tanωw) | 9.605 | 9.037 | 9.509 | 9.445 | 9.057 |
| (6) | TLw/(ft × tanωt) | 5.550 | 5.877 | 5.765 | 5.383 | 5.058 |
| (7) | fw/Dexw | −1.768 | −1.686 | −1.190 | −1.046 | −1.662 |
| (8) | DDL1STw/TLw | 0.346 | 0.370 | 0.452 | 0.460 | 0.200 |
| (9) | DDL1STw/f1 | 0.300 | 0.302 | 0.438 | 0.422 | 0.152 |
| (10) | DDL1STw/{(fw × tanωw) × log(ft/fw)} | 4.283 | 4.800 | 6.264 | 6.101 | 2.283 |
| (11) | \|(1 − βfoc²) × βfocR²\| | 6.591 | 6.473 | 4.501 | 3.734 | 4.397 |
| (12) | \|(1 − βfocA²) × βfocAR²\|/\|(1 − βfocB²) × | 0.664 | 0.641 | — | — | 0.403 |
| | βfocBR²\| | | | | | |
| (13) | \|(1 − βOIS) × βOISR\| | 1.512 | 1.713 | 2.993 | 3.040 | 1.407 |
| (14) | DDL1STt/TLt | 0.551 | 0.556 | 0.536 | 0.535 | 0.477 |
| (15) | DDL1STt/f1 | 0.086 | 0.068 | 0.197 | 0.077 | 0.090 |
| (16) | Denw/{(fw × tanωw) × log(ft/fw)} | 3.342 | 3.536 | 5.251 | 3.409 | 3.115 |
| (17) | Denw/(fw × ft)^{1/2} | 0.259 | 0.276 | 0.389 | 0.254 | 0.241 |
| (18) | Fnot/(ft/fw) | 1.498 | 1.529 | 1.531 | 1.535 | 1.536 |
| (19) | TLt/ft | 0.835 | 0.877 | 0.875 | 0.843 | 0.853 |
| (20) | Bfw/(ft × tanωt) | 0.589 | 0.702 | 1.668 | 0.935 | 0.584 |
| (21) | f1/fLn1 | −0.753 | −0.615 | −0.630 | −0.487 | −1.215 |
| (22) | f1/(ft/Fnot) | 2.765 | 3.120 | 2.663 | 2.717 | 2.923 |
| (23) | f1/(fw × ft)^{1/2} | 1.105 | 1.243 | 1.060 | 1.079 | 1.162 |
| (24) | f1/fw | 1.846 | 2.040 | 1.739 | 1.770 | 1.904 |
| (25) | ν1pave | 85.735 | 81.609 | 76.683 | 75.151 | 67.016 |
| (26) | dF1/(ft/Fnot) | 0.239 | 0.211 | 0.258 | 0.208 | 0.264 |

TABLE 93

| Expression | | | | | | |
|---|---|---|---|---|---|---|
| number | | Example 21 | Example 22 | Example 23 | Example 24 | Example 25 |
| (27) | EDf/TLt | 0.293 | 0.289 | 0.309 | 0.290 | 0.288 |
| (28) | EDf/EDr | 1.511 | 1.621 | 1.185 | 1.146 | 1.393 |
| (29) | fFw/(−fMw) | 1.977 | 2.661 | 3.758 | 3.690 | 2.094 |
| (30) | \|dFMw − dFMt\|/TLt | 0.343 | 0.351 | 0.284 | 0.283 | 0.366 |
| (31) | fw/fRw | 1.751 | 2.083 | 2.251 | 2.220 | 1.800 |
| (32) | ft/fRt | 2.084 | 3.827 | 3.165 | 3.354 | 2.091 |
| (33) | fRA1/fRA3 | — | — | — | — | 1.629 |
| (34) | fRA2/fRA4 | — | — | — | — | 2.318 |
| (35) | fRA4/fRA5 | — | — | — | — | 0.268 |
| (36) | fRB1/fRB2 | 0.720 | — | — | — | — |
| (37) | fRB1/fRB4 | 1.149 | — | — | — | — |
| (38) | fRB3/fRB5 | 0.766 | — | — | — | — |
| (39) | fRC1/fRC2 | — | — | — | — | — |
| (40) | fRD1/fRD2 | — | — | — | — | — |
| (41) | fRD3/fRD4 | — | — | — | — | — |
| (42) | fRE1/fRE3 | — | — | — | — | — |
| (43) | fRE3/fRE5 | — | — | — | — | — |
| (44) | fRE2/fRE4 | — | — | — | — | — |
| (45) | fRE4/fRE6 | — | — | — | — | — |
| (46) | fRF1/fRF3 | — | — | — | — | — |
| (47) | fRF2/fRF4 | — | — | — | — | — |
| (48) | fRG1/fRG2 | — | 0.063 | — | — | — |
| (49) | fRG3/fRG2 | — | 0.095 | — | — | — |
| (50) | fRG4/fRG5 | — | 2.414 | — | — | — |
| (51) | fRH1/fRH2 | — | — | 0.836 | — | — |
| (52) | fRH2/fRH4 | — | — | 0.586 | — | — |
| (53) | fRI1/fRI3 | — | — | — | 0.363 | — |

TABLE 94

| Expression | | | | |
|---|---|---|---|---|
| number | | Example 26 | Example 27 | Example 28 |
| (1) | TLw/ft | 0.620 | 0.626 | 0.607 |
| (2) | Fnot × (TLt/ft) | 3.543 | 3.519 | 3.377 |
| (3) | fw/(ft × tanωt) | 3.534 | 3.421 | 3.313 |
| (4) | TLt/(ft × tanωt) | 8.183 | 7.863 | 7.308 |
| (5) | ft/(fw × tanωw) | 9.031 | 9.510 | 9.445 |
| (6) | TLw/(ft × tanωt) | 5.900 | 5.765 | 5.409 |
| (7) | fw/Dexw | −1.722 | −1.202 | −1.103 |
| (8) | DDL1STw/TLw | 0.380 | 0.457 | 0.476 |
| (9) | DDL1STw/f1 | 0.313 | 0.468 | 0.467 |
| (10) | DDL1STw/{(fw × tanωw) × log(ft/fw)} | 4.951 | 6.325 | 6.352 |
| (11) | \|(1 − βfoc²) × βf0cR²\| | 7.020 | 4.878 | 3.883 |
| (12) | \|(1 − βfocA²) × βfocAR²\|/\|(1 − BfocB²) × BfocR²\| | 0.636 | — | — |
| (13) | \|(1 − βOIS) × βOISR\| | 1.704 | 3.030 | 3.170 |
| (14) | DDL1STt/TLt | 0.553 | 0.525 | 0.526 |
| (15) | DDL1STt/f1 | 0.065 | 0.107 | 0.085 |
| (16) | Denw/{(fw × tanωw) × log(ft/fw)} | 3.686 | 5.403 | 3.542 |
| (17) | Denw/(fw × ft)^{1/2} | 0.288 | 0.401 | 0.264 |
| (18) | Fnot/(ft/fw) | 1.530 | 1.531 | 1.531 |
| (19) | TLt/ft | 0.860 | 0.854 | 0.820 |
| (20) | Bfw/(ft × tanωt) | 0.646 | 1.662 | 0.918 |
| (21) | f1/fLn1 | −0.563 | −0.628 | −0.476 |
| (22) | f1/(ft/Fnot) | 3.107 | 2.516 | 2.551 |
| (23) | f1/(fw × ft)^{1/2} | 1.237 | 1.002 | 1.016 |
| (24) | f1/fw | 2.030 | 1.643 | 1.666 |
| (25) | ν1pave | 81.540 | 76.650 | 75.080 |
| (26) | dF1/(ft/Fnot) | 0.201 | 0.270 | 0.216 |

TABLE 95

| Expression | | | | |
|---|---|---|---|---|
| number | | Example 26 | Example 27 | Example 28 |
| (27) | EDf/TLt | 0.296 | 0.317 | 0.302 |
| (28) | EDf/EDr | 1.591 | 1.176 | 1.118 |
| (29) | fFw/(−fMw) | 2.537 | 3.654 | 3.532 |
| (30) | \|dFMw − dFMt\|/TLt | 0.359 | 0.267 | 0.260 |
| (31) | fw/fRw | 2.016 | 2.270 | 2.272 |
| (32) | ft/fRt | 3.573 | 3.121 | 3.558 |
| (33) | fRA1/fRA3 | — | — | — |
| (34) | fRA2/fRA4 | — | — | — |
| (35) | fRA4/fRA5 | — | — | — |
| (36) | fRB1/fRB2 | — | — | — |
| (37) | fRB1/fRB4 | — | — | — |
| (38) | fRB3/fRB5 | — | — | — |
| (39) | fRC1/fRC2 | — | — | — |
| (40) | fRD1/fRD2 | — | — | — |
| (41) | fRD3/fRD4 | — | — | — |
| (42) | fRE1/fRE3 | — | — | — |
| (43) | fRE3/fRE5 | — | — | — |
| (44) | fRE2/fRE4 | — | — | — |
| (45) | fRE4/fRE6 | — | — | — |
| (46) | fRF1/fRF3 | — | — | — |
| (47) | fRF2/fRF4 | — | — | — |
| (48) | fRG1/fRG2 | 0.037 | — | — |
| (49) | fRG3/fRG2 | 0.053 | — | — |
| (50) | fRG4/fRG5 | 1.735 | — | — |
| (51) | fRH1/fRH2 | — | 0.878 | — |
| (52) | fRH2/fRH4 | — | 0.569 | — |
| (53) | fRI1/fRI3 | — | — | 0.338 |

The variable magnification optical systems according to Examples 1 to 28 are configured to be small in size, and have an F-number of 4.2 or less in the entire variable magnification change range, thereby realizing a small F-number. In particular, in a part of the examples, the F-number is equal to or less than 3 in the entire magnification change range. In addition, in the variable magnification optical systems according to Examples 1 to 28, various aberrations are satisfactorily corrected in the entire magnification range, and high optical performance is maintained.

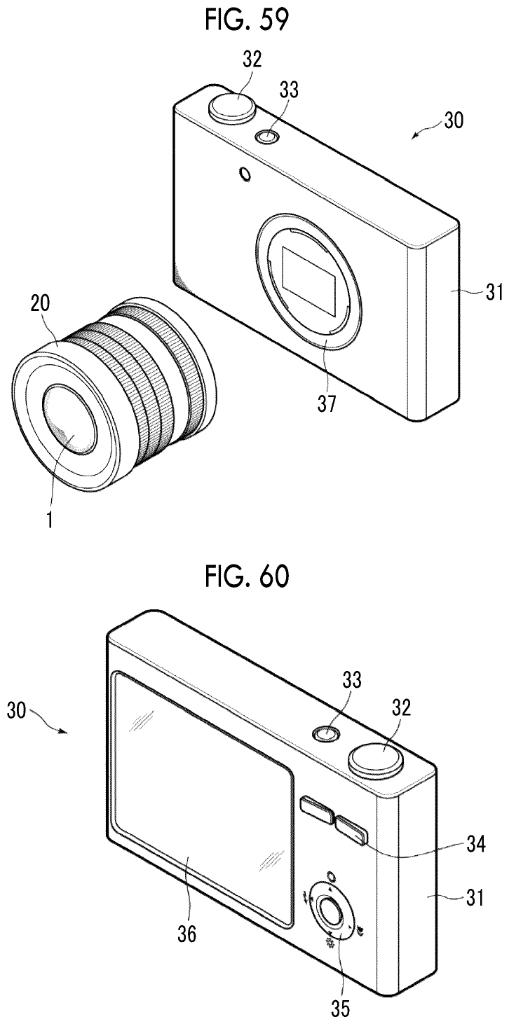

Hereinafter, an imaging apparatus according to the embodiment of the present disclosure will be described. FIGS. 59 and 60 are external views of a camera 30 that is the imaging apparatus according to the embodiment of the present disclosure. FIG. 59 is a perspective view of the camera 30, which is viewed from a front side, and FIG. 60 is a perspective view of the camera 30, which is viewed from a rear side. The camera 30 is a so-called mirrorless type digital camera in which an interchangeable lens 20 can be attachably and detachably mounted. The interchangeable lens 20 includes a variable magnification optical system 1 according to the embodiment of the present disclosure accommodated in a lens barrel.

The camera 30 comprises a camera body 31, in which a shutter button 32 and a power button 33 are provided on an upper surface of the camera body 31. Arear surface of the camera body 31 is provided with an operation unit 34, an operation unit 35, and a display unit 36. The display unit 36 can display the captured image and an image within an angle of view before capturing.

An imaging aperture on which light from an imaging target is incident is provided in a center portion of a front surface of the camera body 31, a mount 37 is provided at a position corresponding to the imaging aperture, and the interchangeable lens 20 is mounted on the camera body 31 through the mount 37.

An imaging element, such as a charge coupled device (CCD) or a complementary metal oxide semiconductor (CMOS), that outputs an imaging signal corresponding to a subject image formed by the interchangeable lens 20, a signal processing circuit that processes the imaging signal output from the imaging element to generate an image, a recording medium for recording the generated image, and the like are provided in the camera body 31. In the camera 30, a still image or a moving image can be captured by pressing the shutter button 32, and the image data obtained by this capturing is recorded on the recording medium.

While the technology of the present disclosure has been described above using the embodiment and the examples, the technology of the present disclosure is not limited to the embodiment and the examples, and can be subjected to various modifications. For example, the curvature radius, the surface spacing, the refractive index, the Abbe number, the aspherical coefficient, and the like of each lens are not limited to the values shown in the examples, and different values may be used.

In addition, the imaging apparatus according to the embodiment of the present disclosure is not limited to the above-described example and can have various aspects of, for example, a camera of a type other than a mirrorless type, a film camera, a video camera, and a security camera.

The following supplementary notes are further disclosed regarding the embodiment and the examples described above.

### Supplementary Note 1

A variable magnification optical system consisting of a front group, an intermediate group, and a rear group in this order from an object side to an image side, in which the front group consists of two or fewer lens groups having a positive refractive power, the intermediate group consists of two or fewer lens groups having a negative refractive power, the rear group consists of a plurality of lens groups, all spacings of adjacent lens groups change during magnification change, and in a case in which a sum of a distance on an optical axis from a lens surface of the front group closest to the object side to a lens surface of the rear group closest to the image side and a back focus of an entire system in terms of an air-equivalent distance, in a state in which an infinite distance object is in focus at a wide angle end, is denoted by TLw, a focal length of the entire system in a state in which the infinite distance object is in focus at a telephoto end is denoted by ft, an open F-number in a state in which the infinite distance object is in focus at the telephoto end is denoted by Fnot, a sum of the distance on the optical axis from the lens surface of the front group closest to the object side to the lens surface of the rear group closest to the image side and the back focus of the entire system in terms of the air-equivalent distance, in a state in which the infinite distance object is in focus at the telephoto end, is denoted by TLt, a focal length of the entire system in a state in which the infinite distance object is in focus at the wide angle end is denoted by fw, and a maximum half angle of view in a state in which the infinite distance object is in focus at the telephoto end is denoted by ωt, Conditional Expressions (1), (2), and (3) are satisfied, which are represented by 0.39<TLw/ft<0.89 (1), 2.2<Fnot×(TLt/ft)<4.5 (2), and 2<fw/(ft×tan ωt)<4.5 (3).

### Supplementary Note 2

The variable magnification optical system according to supplementary note 1, in which Conditional Expression (4) is satisfied, which is represented by 5<TLt/(ft×tan ωt)<10.5 (4).

### Supplementary Note 3

The variable magnification optical system according to supplementary note 1 or 2, in which in a case in which a maximum half angle of view in a state in which the infinite distance object is in focus at the wide angle end is denoted by ωw, Conditional Expression (5) is satisfied, which is represented by 7<ft/(fw×tan ωw)<12 (5).

### Supplementary Note 4

The variable magnification optical system according to any one of supplementary notes 1 to 3, in which Conditional Expressions (1-1) and (2-1) are satisfied, which are represented by 0.43<TLw/ft<0.83 (1-1), and 2.2<Fnot×(TLt/ft)<3.9 (2−1).

### Supplementary Note 5

The variable magnification optical system according to any one of supplementary notes 1 to 4, in which Conditional Expression (6) is satisfied, which is represented by 3.8<TLw/(ft×tan ωt)<8 (6).

### Supplementary Note 6

The variable magnification optical system according to any one of supplementary notes 1 to 5, in which in a case in which a distance on the optical axis from an image plane to a paraxial exit pupil position in a state in which the infinite distance object is in focus at the wide angle end is denoted by Dexw, a sign of Dexw is defined with the image plane as a reference such that a distance on the image side is positive and a distance on the object side is negative, and Dexw is calculated by, in a case which an optical member having no refractive power is disposed between the image plane and the paraxial exit pupil position, using the air-equivalent distance for the optical member, Conditional Expression (7) is satisfied, which is represented by −2.5<fw/Dexw<−0.91 (7).

### Supplementary Note 7

The variable magnification optical system according to any one of supplementary notes 1 to 6, in which an aperture stop is disposed between a lens surface of the intermediate group closest to the image side and the lens surface of the rear group closest to the image side, and in a case in which a distance on the optical axis from the lens surface of the front group closest to the object side to the aperture stop in a state in which the infinite distance object is in focus at the wide angle end is denoted by DDL1STw, Conditional Expression (8) is satisfied, which is represented by 0.1<DDL1STw/TLw<0.6 (8).

### Supplementary Note 8

The variable magnification optical system according to any one of supplementary notes 1 to 7, in which an aperture stop is disposed between a lens surface of the intermediate group closest to the image side and the lens surface of the rear group closest to the image side, and in a case in which a distance on the optical axis from the lens surface of the front group closest to the object side to the aperture stop in a state in which the infinite distance object is in focus at the wide angle end is denoted by DDL1STw, and a focal length of a lens group of the front group closest to the object side is denoted by fl, Conditional Expression (9) is satisfied, which is represented by 0.09<DDL1STw/fl<0.6 (9).

### Supplementary Note 9

The variable magnification optical system according to any one of supplementary notes 1 to 8, in which an aperture stop is disposed between a lens surface of the intermediate group closest to the image side and the lens surface of the rear group closest to the image side, and in a case in which a distance on the optical axis from the lens surface of the front group closest to the object side to the aperture stop in a state in which the infinite distance object is in focus at the wide angle end is denoted by DDL1STw, and a maximum half angle of view in a state in which the infinite distance object is in focus at the wide angle end is denoted by ωw, Conditional Expression (10) is satisfied, which is represented by 1<DDL1STw/{(fw×tan ωw)×log(ft/fw)}<10 (10).

### Supplementary Note 10

The variable magnification optical system according to any one of supplementary notes 1 to 9, in which at least one focusing group that moves along the optical axis during focusing is disposed in the variable magnification optical system, and in a case in which a focusing group in which an absolute value of a lateral magnification in a state in which the infinite distance object is in focus at the telephoto end is greatest, among the focusing groups of the variable magnification optical system, is defined as a maximum focusing group, the lateral magnification of the maximum focusing group in a state in which the infinite distance object is in focus at the telephoto end is denoted by βfoc, and a composite lateral magnification of all lenses closer to the image side than the maximum focusing group in a state in which the infinite distance object is in focus at the telephoto end is denoted by βfocR, Conditional Expression (11) is satisfied, which is represented by 1.5<|(1−βfoc²)×βfocR²|<10 (11).

### Supplementary Note 11

The variable magnification optical system according to any one of supplementary notes 1 to 10, in which only two focusing groups that move along the optical axis during focusing are disposed in the variable magnification optical system, and in a case in which a lateral magnification of the focusing group on the object side among the two focusing groups in a state in which the infinite distance object is in focus at the telephoto end is denoted by βfocA, a composite lateral magnification of all lenses closer to the image side than the focusing group on the object side in a state in which the infinite distance object is in focus at the telephoto end is denoted by βfocAR, a lateral magnification of the focusing group on the image side among the two focusing groups in a state in which the infinite distance object is in focus at the telephoto end is denoted by βfocB, and a composite lateral magnification of all lenses closer to the image side than the focusing group on the image side in a state in which the infinite distance object is in focus at the telephoto end is denoted by βfocBR, Conditional Expression (12) is satisfied, which is represented by 0.1<|(1−βfocA²)×βfocAR²|/|(1−βfocB²)×βfocBR²|<0.8 (12).

### Supplementary Note 12

The variable magnification optical system according to any one of supplementary notes 1 to 11, in which an anti-vibration group that moves in a direction intersecting with the optical axis during image shake correction is disposed closer to the image side than the front group, and in a case in which a lateral magnification of the anti-vibration group in a state in which the infinite distance object is in focus at the telephoto end is denoted by βOIS, and a composite lateral magnification of all lenses closer to the image side than the anti-vibration group in a state in which the infinite distance object is in focus at the telephoto end is denoted by βOISR, Conditional Expression (13) is satisfied, which is represented by 1<(1−βOIS)×βOISR|<4.5 (13).

### Supplementary Note 13

The variable magnification optical system according to supplementary note 12, in which at least one focusing group that moves along the optical axis during focusing is disposed in the variable magnification optical system, and the anti-vibration group is disposed closer to the object side than at least one focusing group.

### Supplementary Note 14

The variable magnification optical system according to supplementary note 12 or 13, in which the anti-vibration group is disposed in the intermediate group.

### Supplementary Note 15

The variable magnification optical system according to supplementary note 12 or 13, in which the anti-vibration group is disposed in the rear group.

### Supplementary Note 16

The variable magnification optical system according to any one of supplementary notes 1 to 15, in which an aperture stop is disposed between a lens surface of the intermediate group closest to the image side and the lens surface of the rear group closest to the image side, and in a case in which a distance on the optical axis from the lens surface of the front group closest to the object side to the aperture stop in a state in which the infinite distance object is in focus at the telephoto end is denoted by DDL1STt, Conditional Expression (14) is satisfied, which is represented by 0.2<DDL1STt/TLt<0.8 (14).

### Supplementary Note 17

The variable magnification optical system according to any one of supplementary notes 1 to 16, in which an aperture stop is disposed between a lens surface of the intermediate group closest to the image side and the lens surface of the rear group closest to the image side, and in a case in which a distance on the optical axis from the lens surface of the front group closest to the object side to the aperture stop in a state in which the infinite distance object is in focus at the telephoto end is denoted by DDL1STt, and a focal length of a lens group of the front group closest to the object side is denoted by fl, Conditional Expression (15) is satisfied, which is represented by 0.015<DDL1STt/fl<0.3 (15).

### Supplementary Note 18

The variable magnification optical system according to any one of supplementary notes 1 to 17, in which in a case in which a distance on the optical axis from the lens surface of the front group closest to the object side to a paraxial entrance pupil position in a state in which the infinite distance object is in focus at the wide angle end is denoted by Denw, and a maximum half angle of view in a state in which the infinite distance object is in focus at the wide angle end is denoted by ωw, Conditional Expression (16) is satisfied, which is represented by 1.5<Denw/{(fw×tan ωw)×log(ft/fw)}<8 (16).

### Supplementary Note 19

The variable magnification optical system according to any one of supplementary notes 1 to 18, in which in a case in which a distance on the optical axis from the lens surface of the front group closest to the object side to a paraxial entrance pupil position in a state in which the infinite distance object is in focus at the wide angle end is denoted by Denw, Conditional Expression (17) is satisfied, which is represented by 0.1<Denw/(fw×ft)^{1/2}<0.65 (17).

### Supplementary Note 20

The variable magnification optical system according to any one of supplementary notes 1 to 19, in which Conditional Expression (18) is satisfied, which is represented by 0.8<Fnot/(ft/fw)<2 (18).

### Supplementary Note 21

The variable magnification optical system according to any one of supplementary notes 1 to 20, in which Conditional Expression (19) is satisfied, which is represented by 0.45<TLt/ft<1.3 (19).

### Supplementary Note 22

The variable magnification optical system according to any one of supplementary notes 1 to 21, in which in a case in which the back focus of the entire system in terms of the air-equivalent distance in a state in which the infinite distance object is in focus at the wide angle end is denoted by Bfw, Conditional Expression (20) is satisfied, which is represented by 0.25<Bfw/(ft×tan ωt)<1.8 (20).

### Supplementary Note 23

The variable magnification optical system according to any one of supplementary notes 1 to 22, in which a lens group of the front group closest to the object side includes at least one negative lens, and in a case in which a focal length of the lens group of the front group closest to the object side is denoted by fl, and a focal length of a negative lens closest to the object side among the negative lenses included in the lens group of the front group closest to the object side is denoted by fLn1, Conditional Expression (21) is satisfied, which is represented by −1.6<fl/fLn1<−0.1 (21).

### Supplementary Note 24

The variable magnification optical system according to any one of supplementary notes 1 to 23, in which in a case in which a focal length of a lens group of the front group closest to the object side is denoted by fl, Conditional Expression (22) is satisfied, which is represented by 1<fl/(ft/Fnot)<5.5 (22).

### Supplementary Note 25

The variable magnification optical system according to any one of supplementary notes 1 to 24, in which in a case in which a focal length of a lens group of the front group closest to the object side is denoted by fl, Conditional Expression (23) is satisfied, which is represented by 0.5<fl/(fw×ft)^{1/2}<3.5 (23).

### Supplementary Note 26

The variable magnification optical system according to any one of supplementary notes 1 to 25, in which in a case in which a focal length of a lens group of the front group closest to the object side is denoted by fl, Conditional Expression (24) is satisfied, which is represented by 0.8<fl/fw<5 (24).

### Supplementary Note 27

The variable magnification optical system according to any one of supplementary notes 1 to 26, in which a lens group of the front group closest to the object side includes at least one negative lens, and in a case in which an average value of Abbe numbers of all positive lenses in the lens group of the front group closest to the object side based on a d line is denoted by v1pave, Conditional Expression (25) is satisfied, which is represented by 58<v1pave<96 (25).

### Supplementary Note 28

The variable magnification optical system according to any one of supplementary notes 1 to 27, in which in a case in which a thickness on the optical axis of a lens group of the front group closest to the object side is denoted by dF1, Conditional Expression (26) is satisfied, which is represented by 0.1<dF1/(ft/Fnot)<0.45 (26).

### Supplementary Note 29

The variable magnification optical system according to any one of supplementary notes 1 to 28, in which in a case in which an effective diameter of the lens surface of the front group closest to the object side is denoted by EDf, Conditional Expression (27) is satisfied, which is represented by 0<EDf/TLt<0.5 (27).

### Supplementary Note 30

The variable magnification optical system according to any one of supplementary notes 1 to 29, in which in a case in which an effective diameter of the lens surface of the front group closest to the object side is denoted by EDf, and an effective diameter of the lens surface of the rear group closest to the image side is denoted by EDr, Conditional Expression (28) is satisfied, which is represented by 1<EDf/EDr<2.5 (28).

### Supplementary Note 31

The variable magnification optical system according to any one of supplementary notes 1 to 30, in which in a case in which a focal length of the front group in a state in which the infinite distance object is in focus at the wide angle end is denoted by fFw, and a focal length of the intermediate group in a state in which the infinite distance object is in focus at the wide angle end is denoted by fMw, Conditional Expression (29) is satisfied, which is represented by 0.6<fFw/(−fMw)<5 (29).

### Supplementary Note 32

The variable magnification optical system according to any one of supplementary notes 1 to 31, in which in a case in which a spacing on the optical axis between a lens group of the front group closest to the object side and a lens group of the intermediate group closest to the image side in a state in which the infinite distance object is in focus at the wide angle end is denoted by dFMw, and a spacing on the optical axis between the lens group of the front group closest to the object side and the lens group of the intermediate group closest to the image side in a state in which the infinite distance object is in focus at the telephoto end is denoted by dFMt, Conditional Expression (30) is satisfied, which is represented by 0.15<dFMw−dFMt|/TLt<0.6 (30).

### Supplementary Note 33

The variable magnification optical system according to any one of supplementary notes 1 to 32, in which in a case in which a focal length of the rear group in a state in which the infinite distance object is in focus at the wide angle end is denoted by fRw, Conditional Expression (31) is satisfied, which is represented by 0.7<fw/fRw<4 (31).

### Supplementary Note 34

The variable magnification optical system according to any one of supplementary notes 1 to 33, in which in a case in which a focal length of the rear group in a state in which the infinite distance object is in focus at the telephoto end is denoted by fRt, Conditional Expression (32) is satisfied, which is represented by 0.5<ft/fRt<6.5 (32).

### Supplementary Note 35

The variable magnification optical system according to any one of supplementary notes 1 to 34, in which the rear group consists of a first subsequent lens group having a positive refractive power, a second subsequent lens group having a negative refractive power, a third subsequent lens group having a positive refractive power, a fourth subsequent lens group having a negative refractive power, and a fifth subsequent lens group having a negative refractive power, in this order from the object side to the image side.

### Supplementary Note 36

The variable magnification optical system according to supplementary note 35, in which in a case in which a focal length of the first subsequent lens group is denoted by fRA1, and a focal length of the third subsequent lens group is denoted by fRA3, Conditional Expression (33) is satisfied, which is represented by 0.5<fRA1/fRA3<4 (33).

### Supplementary Note 37

The variable magnification optical system according to supplementary note 35 or 36, in which in a case in which a focal length of the second subsequent lens group is denoted by fRA2, and a focal length of the fourth subsequent lens group is denoted by fRA4, Conditional Expression (34) is satisfied, which is represented by 0.5<fRA2/fRA4<8 (34).

### Supplementary Note 38

The variable magnification optical system according to any one of supplementary notes 35 to 37, in which in a case in which a focal length of the fourth subsequent lens group is denoted by fRA4, and a focal length of the fifth subsequent lens group is denoted by fRA5, Conditional Expression (35) is satisfied, which is represented by 0.05<fRA4/fRA5<3 (35).

### Supplementary Note 39

The variable magnification optical system according to any one of supplementary notes 1 to 34, in which the rear group consists of a first subsequent lens group having a positive refractive power, a second subsequent lens group having a positive refractive power, a third subsequent lens group having a negative refractive power, a fourth subsequent lens group having a positive refractive power, and a fifth subsequent lens group having a negative refractive power, in this order from the object side to the image side.

### Supplementary Note 40

The variable magnification optical system according to supplementary note 39, in which in a case in which a focal length of the first subsequent lens group is denoted by fRB1, and a focal length of the second subsequent lens group is denoted by fRB2, Conditional Expression (36) is satisfied, which is represented by 0.1<fRB1/fRB2<9 (36).

### Supplementary Note 41

The variable magnification optical system according to supplementary note 39 or 40, in which in a case in which a focal length of the first subsequent lens group is denoted by fRB1, and a focal length of the fourth subsequent lens group is denoted by fRB4, Conditional Expression (37) is satisfied, which is represented by 0.2<fRB1/fRB4<9 (37).

### Supplementary Note 42

The variable magnification optical system according to any one of supplementary notes 39 to 41, in which in a case in which a focal length of the third subsequent lens group is denoted by fRB3, and a focal length of the fifth subsequent lens group is denoted by fRB5, Conditional Expression (38) is satisfied, which is represented by 0.1<fRB3/fRB5<3 (38).

### Supplementary Note 43

The variable magnification optical system according to any one of supplementary notes 1 to 34, in which the rear group consists of a first subsequent lens group having a positive refractive power, a second subsequent lens group having a positive refractive power, and a third subsequent lens group having a negative refractive power, in this order from the object side to the image side.

### Supplementary Note 44

The variable magnification optical system according to supplementary note 43, in which in a case in which a focal length of the first subsequent lens group is denoted by fRC1, and a focal length of the second subsequent lens group is denoted by fRC2, Conditional Expression (39) is satisfied, which is represented by 0.1<fRC1/fRC2<2 (39).

### Supplementary Note 45

The variable magnification optical system according to any one of supplementary notes 1 to 34, in which the rear group consists of a first subsequent lens group having a positive refractive power, a second subsequent lens group having a positive refractive power, a third subsequent lens group having a negative refractive power, and a fourth subsequent lens group having a negative refractive power, in this order from the object side to the image side.

### Supplementary Note 46

The variable magnification optical system according to supplementary note 45, in which in a case in which a focal length of the first subsequent lens group is denoted by fRD1, and a focal length of the second subsequent lens group is denoted by fRD2, Conditional Expression (40) is satisfied, which is represented by 0.2<fRD1/fRD2<3.5 (40).

### Supplementary Note 47

The variable magnification optical system according to supplementary note 45 or 46, in which in a case in which a focal length of the third subsequent lens group is denoted by fRD3, and a focal length of the fourth subsequent lens group is denoted by fRD4, Conditional Expression (41) is satisfied, which is represented by 0.05<fRD3/fRD4<2 (41).

### Supplementary Note 48

The variable magnification optical system according to any one of supplementary notes 1 to 34, in which the rear group consists of a first subsequent lens group having a positive refractive power, a second subsequent lens group having a negative refractive power, a third subsequent lens group having a positive refractive power, a fourth subsequent lens group having a negative refractive power, a fifth subsequent lens group having a positive refractive power, and a sixth subsequent lens group having a negative refractive power, in this order from the object side to the image side.

### Supplementary Note 49

The variable magnification optical system according to supplementary note 48, in which in a case in which a focal length of the first subsequent lens group is denoted by fRE1, and a focal length of the third subsequent lens group is denoted by fRE3, Conditional Expression (42) is satisfied, which is represented by 0.1<fRE1/fRE3<3.5 (42).

### Supplementary Note 50

The variable magnification optical system according to supplementary note 48 or 49, in which in a case in which a focal length of the third subsequent lens group is denoted by fRE3, and a focal length of the fifth subsequent lens group is denoted by fRE5, Conditional Expression (43) is satisfied, which is represented by 0.1<fRE3/fRE5<3.5 (43).

### Supplementary Note 51

The variable magnification optical system according to any one of supplementary notes 48 to 50, in which in a case in which a focal length of the second subsequent lens group is denoted by fRE2, and a focal length of the fourth subsequent lens group is denoted by fRE4, Conditional Expression (44) is satisfied, which is represented by 0.2<fRE2/fRE4<15 (44).

### Supplementary Note 52

The variable magnification optical system according to any one of supplementary notes 48 to 51, in which in a case in which a focal length of the fourth subsequent lens group is denoted by fRE4, and a focal length of the sixth subsequent lens group is denoted by fRE6, Conditional Expression (45) is satisfied, which is represented by 0.05<fRE4/fRE6<3 (45).

### Supplementary Note 53

The variable magnification optical system according to any one of supplementary notes 1 to 34, in which the rear group consists of a first subsequent lens group having a positive refractive power, a second subsequent lens group having a negative refractive power, a third subsequent lens group having a positive refractive power, and a fourth subsequent lens group having a negative refractive power, in this order from the object side to the image side.

### Supplementary Note 54

The variable magnification optical system according to supplementary note 53, in which in a case in which a focal length of the first subsequent lens group is denoted by fRF1, and a focal length of the third subsequent lens group is denoted by fRF3, Conditional Expression (46) is satisfied, which is represented by 0.1<fRF1/fRF3<2 (46).

### Supplementary Note 55

The variable magnification optical system according to supplementary note 53 or 54, in which in a case in which a focal length of the second subsequent lens group is denoted by fRF2, and a focal length of the fourth subsequent lens group is denoted by fRF4, Conditional Expression (47) is satisfied, which is represented by 0.1<fRF2/fRF4<2.5 (47).

### Supplementary Note 56

The variable magnification optical system according to any one of supplementary notes 1 to 34, in which the rear group consists of a first subsequent lens group having a positive refractive power, a second subsequent lens group having a positive refractive power, a third subsequent lens group having a positive refractive power, a fourth subsequent lens group having a negative refractive power, and a fifth subsequent lens group having a negative refractive power, in this order from the object side to the image side.

### Supplementary Note 57

The variable magnification optical system according to supplementary note 56, in which in a case in which a focal length of the first subsequent lens group is denoted by fRG1, and a focal length of the second subsequent lens group is denoted by fRG2, Conditional Expression (48) is satisfied, which is represented by 0.01<fRG1/fRG2<1 (48).

### Supplementary Note 58

The variable magnification optical system according to supplementary note 56 or 57, in which in a case in which a focal length of the third subsequent lens group is denoted by fRG3, and a focal length of the second subsequent lens group is denoted by fRG2, Conditional Expression (49) is satisfied, which is represented by 0.01<fRG3/fRG2<1 (49).

### Supplementary Note 59

The variable magnification optical system according to any one of supplementary notes 56 to 58, in which in a case in which a focal length of the fourth subsequent lens group is denoted by fRG4, and a focal length of the fifth subsequent lens group is denoted by fRG5, Conditional Expression (50) is satisfied, which is represented by 0.5<fRG4/fRG5<5 (50).

### Supplementary Note 60

The variable magnification optical system according to any one of supplementary notes 1 to 34, in which the rear group consists of a first subsequent lens group having a positive refractive power, a second subsequent lens group having a positive refractive power, a third subsequent lens group having a negative refractive power, and a fourth subsequent lens group having a positive refractive power, in this order from the object side to the image side.

### Supplementary Note 61

The variable magnification optical system according to supplementary note 60, in which in a case in which a focal length of the first subsequent lens group is denoted by fRH1, and a focal length of the second subsequent lens group is denoted by fRH2, Conditional Expression (51) is satisfied, which is represented by 0.1<fRH1/fRH2<2.5 (51).

### Supplementary Note 62

The variable magnification optical system according to supplementary note 60 or 61, in which in a case in which a focal length of the second subsequent lens group is denoted by fRH2, and a focal length of the fourth subsequent lens group is denoted by fRH4, Conditional Expression (52) is satisfied, which is represented by 0.1<fRH2/fRH4<2 (52).

### Supplementary Note 63

The variable magnification optical system according to any one of supplementary notes 1 to 34, in which the rear group consists of a first subsequent lens group having a positive refractive power, a second subsequent lens group having a negative refractive power, and a third subsequent lens group having a positive refractive power, in this order from the object side to the image side.

### Supplementary Note 64

The variable magnification optical system according to supplementary note 63, in which in a case in which a focal length of the first subsequent lens group is denoted by fRI1, and a focal length of the third subsequent lens group is denoted by fRI3, Conditional Expression (53) is satisfied, which is represented by 0.1<fRI1/fRI3<2 (53).

### Supplementary Note 65

An imaging apparatus comprising: the variable magnification optical system according to any one of supplementary notes 1 to 64.

All of the documents, the patent applications, and the technical standards described in the present specification are incorporated in the present specification by reference to the same extent as in a case in which each of the documents, the patent applications, and the technical standards are specifically and individually described to be incorporated by reference.

What is claimed is:

1. A variable magnification optical system consisting of a front group, an intermediate group, and a rear group in this order from an object side to an image side,
wherein the front group consists of two or fewer lens groups having a positive refractive power,
the intermediate group consists of two or fewer lens groups having a negative refractive power,
the rear group consists of a plurality of lens groups,
all spacings of adjacent lens groups change during magnification change, and
in a case in which
a sum of a distance on an optical axis from a lens surface of the front group closest to the object side to a lens surface of the rear group closest to the image side and a back focus of the variable magnification optical system in terms of an air-equivalent distance, in a state in which an infinite distance object is in focus at a wide angle end, is denoted by TLw,
a focal length of the variable magnification optical system in a state in which the infinite distance object is in focus at a telephoto end is denoted by ft,
an open F-number in a state in which the infinite distance object is in focus at the telephoto end is denoted by Fnot,
a sum of the distance on the optical axis from the lens surface of the front group closest to the object side to the lens surface of the rear group closest to the image side and the back focus of the variable magnification optical system in terms of the air-equivalent distance, in a state in which the infinite distance object is in focus at the telephoto end, is denoted by TLt,
a focal length of the variable magnification optical system in a state in which the infinite distance object is in focus at the wide angle end is denoted by fw, and
a maximum half angle of view in a state in which the infinite distance object is in focus at the telephoto end is denoted by ωt,
Conditional Expressions (1), (2), and (3) are satisfied, which are represented by
$$0.39 < TLw / ft < 0.89 , \qquad ( 1 )$$
$$2.2 < Fnot \times ( TLt / ft ) < 4.5 , \\ and \qquad ( 2 )$$
$$2 < fw / ( ft \times tan ω t ) < 4.5 . \qquad ( 3 )$$

2. The variable magnification optical system according to claim 1,
wherein Conditional Expression (4) is satisfied, which is represented by
$$5 < TLt / ( ft \times tan ω t ) < 10.5 . \qquad ( 4 )$$

3. The variable magnification optical system according to claim 1,
wherein in a case in which a maximum half angle of view in a state in which the infinite distance object is in focus at the wide angle end is denoted by ωw,
Conditional Expression (5) is satisfied, which is represented by
$$7 < ft / ( fw \times tan ω w ) < 12. \qquad ( 5 )$$

4. The variable magnification optical system according to claim 1,
wherein Conditional Expressions (1-1) and (2-1) are satisfied, which are represented by
$$0.43 < TLw / ft < 0.83 , \\ and \qquad ( 1 - 1 )$$
$$2.2 < Fnot \times ( TLt / ft ) < 3.9 . \qquad ( 2 - 1 )$$

5. The variable magnification optical system according to claim 1,
wherein Conditional Expression (6) is satisfied, which is represented by
$$3. 8 < TLw / ( ft \times tan ω t ) < 8. \qquad ( 6 )$$

6. The variable magnification optical system according to claim 1,
wherein in a case in which
a distance on the optical axis from an image plane to a paraxial exit pupil position in a state in which the infinite distance object is in focus at the wide angle end is denoted by Dexw,
a sign of Dexw is defined with the image plane as a reference such that a distance on the image side is positive and a distance on the object side is negative, and
Dexw is calculated by, in a case which an optical member having no refractive power is disposed between the image plane and the paraxial exit pupil position, using the air-equivalent distance for the optical member,
Conditional Expression (7) is satisfied, which is represented by
$$- 2.5 < fw / Dexw < - 0.91 . \qquad ( 7 )$$

7. The variable magnification optical system according to claim 1,
wherein an aperture stop is disposed between a lens surface of the intermediate group closest to the image side and the lens surface of the rear group closest to the image side, and
in a case in which a distance on the optical axis from the lens surface of the front group closest to the object side to the aperture stop in a state in which the infinite distance object is in focus at the wide angle end is denoted by DDL1STw,
Conditional Expression (8) is satisfied, which is represented by
$$0 \text{.1} < DDL 1 STw / TLw < 0.6 . \qquad ( 8 )$$

8. The variable magnification optical system according to claim 1,
wherein an aperture stop is disposed between a lens surface of the intermediate group closest to the image side and the lens surface of the rear group closest to the image side, and
in a case in which
a distance on the optical axis from the lens surface of the front group closest to the object side to the aperture stop in a state in which the infinite distance object is in focus at the wide angle end is denoted by DDL1STw, and
a focal length of a lens group of the front group closest to the object side is denoted by fl,
Conditional Expression (9) is satisfied, which is represented by
$$0.09 < DDL 1 STw / f 1 < 0.6 . \qquad ( 9 )$$

9. The variable magnification optical system according to claim 1,
wherein an aperture stop is disposed between a lens surface of the intermediate group closest to the image side and the lens surface of the rear group closest to the image side, and
in a case in which
a distance on the optical axis from the lens surface of the front group closest to the object side to the aperture stop in a state in which the infinite distance object is in focus at the wide angle end is denoted by DDL1STw, and
a maximum half angle of view in a state in which the infinite distance object is in focus at the wide angle end is denoted by ωw,
Conditional Expression (10) is satisfied, which is represented by
$$1 < DDL 1 STw / \{ ( fw \times tan ω w ) \times log ( ft / fw ) \} < 10. \qquad ( 10 )$$

10. The variable magnification optical system according to claim 1,
wherein at least one focusing group that moves along the optical axis during focusing is disposed in the variable magnification optical system, and
in a case in which
a focusing group in which an absolute value of a lateral magnification in a state in which the infinite distance object is in focus at the telephoto end is greatest, among the focusing groups of the variable magnification optical system, is defined as a maximum focusing group,
the lateral magnification of the maximum focusing group in a state in which the infinite distance object is in focus at the telephoto end is denoted by βfoc, and
a composite lateral magnification of all lenses closer to the image side than the maximum focusing group in a state in which the infinite distance object is in focus at the telephoto end is denoted by βfocR,
Conditional Expression (11) is satisfied, which is represented by
$$1.5 < \vert ( 1 - β {foc}^{2} ) \times β {focR}^{2} \vert < 10. \qquad ( 11 )$$

11. The variable magnification optical system according to claim 1,
wherein only two focusing groups that move along the optical axis during focusing are disposed in the variable magnification optical system, and
in a case in which
a lateral magnification of the focusing group on the object side among the two focusing groups in a state in which the infinite distance object is in focus at the telephoto end is denoted by βfocA,
a composite lateral magnification of all lenses closer to the image side than the focusing group on the object side in a state in which the infinite distance object is in focus at the telephoto end is denoted by βfocAR,
a lateral magnification of the focusing group on the image side among the two focusing groups in a state in which the infinite distance object is in focus at the telephoto end is denoted by βfocB, and
a composite lateral magnification of all lenses closer to the image side than the focusing group on the image side in a state in which the infinite distance object is in focus at the telephoto end is denoted by βfocBR,
Conditional Expression (12) is satisfied, which is represented by
$$0.1 < \vert ( 1 - β {focA}^{2} ) \times β {focAR}^{2} \vert / \vert ( 1 - β {focB}^{2} ) \times β {focBR}^{2} \vert < 0.8 . \qquad ( 12 )$$

12. The variable magnification optical system according to claim 1,
wherein an anti-vibration group that moves in a direction intersecting with the optical axis during image shake correction is disposed closer to the image side than the front group, and
in a case in which
a lateral magnification of the anti-vibration group in a state in which the infinite distance object is in focus at the telephoto end is denoted by POIS, and
a composite lateral magnification of all lenses closer to the image side than the anti-vibration group in a state in which the infinite distance object is in focus at the telephoto end is denoted by βOISR,
Conditional Expression (13) is satisfied, which is represented by
$$1 < \vert ( 1 - β OIS ) \times β OISR \vert < 4.5 . \qquad ( 13 )$$

13. The variable magnification optical system according to claim 12,
wherein at least one focusing group that moves along the optical axis during focusing is disposed in the variable magnification optical system, and
the anti-vibration group is disposed closer to the object side than at least one focusing group.

14. The variable magnification optical system according to claim 12,
wherein the anti-vibration group is disposed in the intermediate group.

15. The variable magnification optical system according to claim 12,
wherein the anti-vibration group is disposed in the rear group.

16. The variable magnification optical system according to claim 1,
wherein an aperture stop is disposed between a lens surface of the intermediate group closest to the image side and the lens surface of the rear group closest to the image side, and
in a case in which a distance on the optical axis from the lens surface of the front group closest to the object side to the aperture stop in a state in which the infinite distance object is in focus at the telephoto end is denoted by DDL1STt,
Conditional Expression (14) is satisfied, which is represented by
$$0.2 < DDL 1 STt / TLt < 0.8 . \qquad ( 14 )$$

17. The variable magnification optical system according to claim 1,
wherein an aperture stop is disposed between a lens surface of the intermediate group closest to the image side and the lens surface of the rear group closest to the image side, and
in a case in which
a distance on the optical axis from the lens surface of the front group closest to the object side to the aperture stop in a state in which the infinite distance object is in focus at the telephoto end is denoted by DDL1STt, and
a focal length of a lens group of the front group closest to the object side is denoted by fl,
Conditional Expression (15) is satisfied, which is represented by
$$0.015 < DDL 1 STt / f 1 < 0.3 . \qquad ( 15 )$$

18. The variable magnification optical system according to claim 1,
wherein Conditional Expression (18) is satisfied, which is represented by
$$0.8 < Fnot / ( ft / fw ) < 2. \qquad ( 18 )$$

19. The variable magnification optical system according to claim 1,
wherein Conditional Expression (19) is satisfied, which is represented by
$$0.45 < TLt / ft < 1.3 . \qquad ( 19 )$$

20. The variable magnification optical system according to claim 1,
wherein in a case in which the back focus of the variable magnification optical system in terms of the air-equivalent distance in a state in which the infinite distance object is in focus at the wide angle end is denoted by Bfw,
Conditional Expression (20) is satisfied, which is represented by
$$0.25 < Bfw / ( ft \times tan ω t ) < 1.8 . \qquad ( 20 )$$

21. The variable magnification optical system according to claim 1,
wherein a lens group of the front group closest to the object side includes at least one negative lens, and
in a case in which
a focal length of the lens group of the front group closest to the object side is denoted by fl, and
a focal length of a negative lens closest to the object side among the negative lenses included in the lens group of the front group closest to the object side is denoted by fLn1,
Conditional Expression (21) is satisfied, which is represented by
$$- 1.6 < f 1 / fLn 1 < - 0.1 . \qquad ( 21 )$$

22. The variable magnification optical system according to claim 1,
wherein in a case in which a focal length of a lens group of the front group closest to the object side is denoted by fl,
Conditional Expression (22) is satisfied, which is represented by
$$1 < f 1 / ( ft / Fnot ) < 5.5 . \qquad ( 22 )$$

23. The variable magnification optical system according to claim 1,
wherein in a case in which a focal length of a lens group of the front group closest to the object side is denoted by fl,
Conditional Expression (23) is satisfied, which is represented by
$$0.5 < f 1 / {( fw \times ft )}^{1 / 2} < 3.5 . \qquad ( 23 )$$

24. The variable magnification optical system according to claim 1,
wherein in a case in which a focal length of a lens group of the front group closest to the object side is denoted by fl,
Conditional Expression (24) is satisfied, which is represented by
$$0.8 < f 1 / fw < 5. \qquad ( 24 )$$

25. The variable magnification optical system according to claim 1,
wherein a lens group of the front group closest to the object side includes at least one negative lens, and
in a case in which an average value of Abbe numbers of all positive lenses in the lens group of the front group closest to the object side based on a d line is denoted by v1pave,
Conditional Expression (25) is satisfied, which is represented by
$$58 < v 1 pave < 96. \qquad ( 25 )$$

26. The variable magnification optical system according to claim 1,
wherein in a case in which a thickness on the optical axis of a lens group of the front group closest to the object side is denoted by dF1,
Conditional Expression (26) is satisfied, which is represented by
$$0.1 < dF 1 / ( ft / Fnot ) < 0.45 . \qquad ( 26 )$$

27. The variable magnification optical system according to claim 1,
wherein in a case in which
a focal length of the front group in a state in which the infinite distance object is in focus at the wide angle end is denoted by fFw, and
a focal length of the intermediate group in a state in which the infinite distance object is in focus at the wide angle end is denoted by fMw,
Conditional Expression (29) is satisfied, which is represented by
$$0.6 < fFw / ( - fMw ) < 5. \qquad ( 29 )$$

28. The variable magnification optical system according to claim 1,
wherein in a case in which
a spacing on the optical axis between a lens group of the front group closest to the object side and a lens group of the intermediate group closest to the image side in a state in which the infinite distance object is in focus at the wide angle end is denoted by dFMw, and
a spacing on the optical axis between the lens group of the front group closest to the object side and the lens group of the intermediate group closest to the image side in a state in which the infinite distance object is in focus at the telephoto end is denoted by dFMt,
Conditional Expression (30) is satisfied, which is represented by
$$0.15 < \vert dFMw - dFMt \vert / TLt < 0.6 . \qquad ( 30 )$$

29. The variable magnification optical system according to claim 1,
wherein in a case in which a focal length of the rear group in a state in which the infinite distance object is in focus at the wide angle end is denoted by fRw,
Conditional Expression (31) is satisfied, which is represented by
$$0.7 < fw / fRw < 4. \qquad ( 31 )$$

30. The variable magnification optical system according to claim 1,
wherein in a case in which a focal length of the rear group in a state in which the infinite distance object is in focus at the telephoto end is denoted by fRt,
Conditional Expression (32) is satisfied, which is represented by
$$0.5 < ft / fRt < 6.5 . \qquad ( 32 )$$

31. An imaging apparatus comprising:
the variable magnification optical system according to claim 1.
